(19) United States
(12) Patent Application Publication
(10) Pub. No.: US 2009/0201231 A1
(43) Pub. Date: Aug. 13, 2009

(54) EL DISPLAY DEVICE

(75) Inventors: Hiroshi Takahara, Osaka (JP); Hitoshi Tsuge, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 12/361,069

(22) Filed: Jan. 28, 2009

(30) Foreign Application Priority Data
Feb. 13, 2008 (JP) 2008-031284
Feb. 14, 2008 (JP) 2008-033399
Apr. 15, 2008 (JP) 2008-105475
Jan. 22, 2009 (JP) 2009-011791

(51) Int. Cl. G09G 3/30

(52) U.S. Cl. 345/76

(57) ABSTRACT

An EL display device includes: a source driver circuit to output a video signal voltage; a gate driver circuit to select a pixel in a display screen; a first capacitor to maintain the video signal voltage; and a drive transistor to supply current to an EL element of a pixel. The video signal voltage is applied to the drive transistor to perform a predetermined operation, and written into the first capacitor. The video signal voltage maintained in the first capacitor is used to perform an offset cancel operation.

### BACKGROUND OF THE INVENTION

1. Field of the Invention

The present invention relates to EL display devices (organic light-emitting display devices) using an EL display panel (display device) or other types of self-emitting display panels (display devices) that use an organic or an inorganic electroluminescence (EL) element. The invention also relates to display panels and display devices including a capacitor (storage capacitor, additional capacitor) that maintains a video signal voltage (video signal data) Vsig at a pixel for a predetermined time period.

2. Description of the Related Art

In active-matrix type image display devices using organic electroluminescence (EL) material or inorganic EL material as the electro-optic converting material, the emission luminescence varies according to the current written in pixels. The EL display device is a self-emitting display that includes a light-emitting element for each pixel. The EL display device has a number of advantages over the liquid crystal display panel. Examples include better image viewability, higher emission efficiency, no backlight requirement, and faster response speed.

The organic EL (PLED, OLED, OEL) panel has been actively studied to realize an active-matrix panel. In the active-matrix system, the current that flows in the light-emitting element provided in each pixel circuit is controlled by the active element (generally, a thin-film transistor, a TFT, a FET, a MOS transistor) provided in each pixel circuit (see, for example, JP-A-2003-255856 (Kokai), JP-A-2003-271095 (Kokai)).

The organic EL display panel is structured by using a transistor array formed of low-temperature or high-temperature polysilicon. A drawback of the organic EL element, however, is that display nonuniformity occurs when there is variation in the transistor characteristics of the polysilicon transistor array.

When there is variation in the characteristic of a drive transistor 11a that supplies current to an EL element 15, a variation occurs in the converted current signal. Generally, the transistor 11a has a characteristic variation of 50% or more. The variation in the characteristic of the drive transistor therefore appears as display nonuniformity and degrades display image quality.

It is accordingly an object of the present invention to provide an EL display device that can provide a sufficient offset cancel period to compensate for the characteristic variation of the drive transistor, and that can therefore realize an image display free of characteristic display nonuniformity.

### SUMMARY OF THE INVENTION

According to an aspect of the present invention, there is provided an EL display device including a display screen in which a plurality of pixels each having an EL element is disposed in a matrix. The EL display device includes: a source driver circuit to output a video signal voltage; a gate driver circuit to select a pixel in the display screen; a first capacitor to maintain the video signal voltage; and a drive transistor to supply current to the EL element of the pixel. The video signal voltage is applied to the drive transistor to perform a predetermined operation, and written into the first capacitor. The video signal voltage maintained in the first capacitor is used to perform an offset cancel operation.

According to another aspect of the present invention, there is provided an EL display device including a display screen in which a plurality of pixels each having an EL element is disposed in a matrix. The EL display device includes: a source driver circuit to output a video signal voltage; a gate driver circuit to select a pixel in the display screen; a first capacitor to maintain a signal voltage; and a drive transistor to supply current to the EL element of the pixel. The signal voltage is applied to the pixel via the drive transistor to perform a predetermined operation, and written into the first capacitor. The signal voltage written into the first capacitor is used to continue the predetermined operation, after stopping the application of the signal voltage.

The present invention can provide a sufficient offset cancel period, and therefore enables the drive transistor to be desirably offset canceled. It is therefore possible to compensate for the characteristic variation of the drive transistor, making it possible to realize an image display having no characteristic display nonuniformity.

### BRIEF DESCRIPTION OF THE DRAWINGS

FIG. 1 is a diagram illustrating a pixel configuration of an EL display device.

FIG. 2 is an explanatory diagram representing a driving method of an EL display device.

FIG. 3 is an explanatory diagram of an EL display device.

FIG. 4 is a diagram illustrating a pixel configuration of an EL display device.

FIG. 5 is a diagram illustrating a pixel configuration of an EL display device.

FIG. 6 is an explanatory diagram of an EL display device.

FIG. 7 is an explanatory diagram of an apparatus using an EL display device.

FIG. 8 is an explanatory diagram of an apparatus using an EL display device.

FIG. 9 is an explanatory diagram of an apparatus using an EL display device.

FIG. 10 is a diagram illustrating a pixel configuration of an EL display device.

FIG. 11 is a diagram illustrating a pixel configuration of an EL display device.

FIG. 12 is an explanatory diagram representing a driving method of an EL display device.

FIG. 13 is an explanatory diagram representing a driving method of an EL display device.

FIG. 14 is a diagram showing a schematic illustration of how a video signal is fetched in a pixel through a source signal line.

FIG. 15 is an explanatory diagram representing an operation of a gate driver circuit 12a shown in FIG. 14.

FIG. 16 is an explanatory diagram of an EL display device according to an embodiment of the present invention.

FIG. 17 is a diagram representing an operation of a gate driver circuit 12 shown in FIG. 16.

FIG. 18 is a diagram representing an operation of the gate driver circuit 12 shown in FIG. 16.

FIG. 19 is an explanatory diagram representing a driving method of an EL display device according to an embodiment of the present invention.

FIG. 20 is an explanatory diagram representing a driving method of an EL display device according to an embodiment of the present invention.

FIG. 21 is an explanatory diagram representing a driving method of an EL display device according to an embodiment of the present invention.

FIG. 22 is an explanatory diagram representing a driving method of an EL display device according to an embodiment of the present invention.

FIG. 23 is an explanatory diagram of an EL display device according to an embodiment of the present invention.

FIG. 24 is an explanatory diagram of an EL display device according to an embodiment of the present invention.

FIG. 25 is an explanatory diagram of an EL display device according to an embodiment of the present invention.

FIG. 26 is an explanatory diagram representing a driving method of an EL display device according to an embodiment of the present invention.

FIG. 27 is an explanatory diagram representing a driving method of an EL display device according to an embodiment of the present invention.

FIG. 28 is an explanatory diagram representing a driving method of an EL display device according to an embodiment of the present invention.

FIG. 29 is an explanatory diagram of an EL display device according to an embodiment of the present invention.

FIG. 30 is an explanatory diagram representing a driving method of an EL display device according to an embodiment of the present invention.

FIG. 31 is an explanatory diagram representing a driving method of an EL display device according to an embodiment of the present invention.

FIG. 32 is an explanatory diagram representing a driving method of an EL display device according to an embodiment of the present invention.

FIG. 33 is an explanatory diagram representing a driving method of an EL display device according to an embodiment of the present invention.

FIG. 34 is an explanatory diagram representing a driving method of an EL display device according to an embodiment of the present invention.

FIG. 35 is an explanatory diagram representing a driving method of an EL display device according to an embodiment of the present invention.

FIG. 36 is an explanatory diagram representing a driving method of an EL display device according to an embodiment of the present invention.

FIG. 37 is an explanatory diagram representing a driving method of an EL display device according to an embodiment of the present invention.

FIG. 38 is an explanatory diagram representing a driving method of an EL display device according to an embodiment of the present invention.

FIG. 39 is an explanatory diagram representing a driving method of an EL display device according to an embodiment of the present invention.

FIG. 40 is an explanatory diagram representing a driving method of an EL display device according to an embodiment of the present invention.

FIG. 41 is an explanatory diagram representing a driving method of an EL display device according to an embodiment of the present invention.

FIG. 42 is an explanatory diagram of an EL display device according to an embodiment of the present invention.

FIG. 43 is an explanatory diagram representing a driving method of an EL display device according to an embodiment of the present invention.

FIG. 44 is an explanatory diagram representing a driving method of an EL display device according to an embodiment of the present invention.

FIG. 45 is an explanatory diagram representing a driving method of an EL display device according to an embodiment of the present invention.

FIG. 46 is an explanatory diagram of an EL display device according to an embodiment of the present invention.

FIG. 47 is an explanatory diagram representing a driving method of an EL display device according to an embodiment of the present invention.

FIG. 48 is an explanatory diagram representing a driving method of an EL display device according to an embodiment of the present invention.

FIG. 49 is an explanatory diagram representing a driving method of an EL display device according to an embodiment of the present invention.

FIG. 50 is an explanatory diagram representing a driving method of an EL display device according to an embodiment of the present invention.

FIG. 51 is an explanatory diagram representing a driving method of an EL display device according to an embodiment of the present invention.

FIG. 52 is an explanatory diagram of an EL display device according to an embodiment of the present invention.

FIG. 53 is an explanatory diagram representing a driving method of an EL display device according to an embodiment of the present invention.

FIG. 54 is an explanatory diagram of an EL display device according to an embodiment of the present invention.

FIG. 55 is an explanatory diagram of an EL display device according to an embodiment of the present invention.

FIG. 56 is an explanatory diagram of an EL display device according to an embodiment of the present invention.

FIG. 57 is an explanatory diagram of an EL display device according to an embodiment of the present invention.

FIG. 58 is an explanatory diagram of an EL display device according to an embodiment of the present invention.

FIG. 59 is an explanatory diagram of an EL display device according to an embodiment of the present invention.

FIG. 60 is an explanatory diagram of a power circuit of an EL display device according to an embodiment of the present invention.

FIG. 61 is an explanatory diagram of a power circuit of an EL display device according to an embodiment of the present invention.

FIG. 62 is an explanatory diagram of a power circuit of an EL display device according to an embodiment of the present invention.

FIG. 63 is an explanatory diagram of a power circuit of an EL display device according to an embodiment of the present invention.

FIG. 64 is an explanatory diagram of a power circuit of an EL display device according to an embodiment of the present invention.

FIG. 65 is an explanatory diagram of a power circuit of an EL display device according to an embodiment of the present invention.

FIG. 66 is an explanatory diagram of a power circuit of an EL display device according to an embodiment of the present invention.

FIG. 67 is an explanatory diagram of a power circuit of an EL display device according to an embodiment of the present invention.

FIG. 68 is an explanatory diagram of a power circuit of an EL display device according to an embodiment of the present invention.

FIG. 69 is an explanatory diagram of a power circuit of an EL display device according to an embodiment of the present invention.

FIG. 70 is an explanatory diagram of a power circuit of an EL display device according to an embodiment of the present invention.

FIG. 71 is an explanatory diagram of a power circuit of an EL display device according to an embodiment of the present invention.

FIG. 72 is an explanatory diagram of a power circuit of an EL display device according to an embodiment of the present invention.

FIG. 73 is an explanatory diagram of a power circuit of an EL display device according to an embodiment of the present invention.

FIG. 74 is an explanatory diagram of a power circuit of an EL display device according to an embodiment of the present invention.

FIG. 75 is an explanatory diagram of an EL display device according to an embodiment of the present invention.

FIG. 76 is an explanatory diagram of an EL display device according to an embodiment of the present invention.

FIG. 77 is an explanatory diagram of an EL display device according to an embodiment of the present invention.

FIG. 78 is an explanatory diagram representing a driving method of an EL display device according to an embodiment of the present invention.

FIG. 79 is an explanatory diagram representing a driving method of an EL display device according to an embodiment of the present invention.

FIG. 80 is an explanatory diagram of an EL display device according to an embodiment of the present invention.

FIG. 81 is an explanatory diagram of an EL display device according to an embodiment of the present invention.

FIG. 82 is an explanatory diagram of an EL display device according to an embodiment of the present invention.

FIG. 83 is an explanatory diagram of an EL display device according to an embodiment of the present invention.

FIG. 84 is an explanatory diagram representing a driving method of an EL display device according to an embodiment of the present invention.

FIG. 85 is an explanatory diagram of an EL display device according to an embodiment of the present invention.

FIG. 86 is an explanatory diagram of an EL display device according to an embodiment of the present invention.

FIG. 87 is an explanatory diagram of an EL display device according to an embodiment of the present invention.

FIG. 88 is an explanatory diagram representing a driving method of an EL display device according to an embodiment of the present invention.

FIG. 89 is an explanatory diagram representing a driving method of an EL display device according to an embodiment of the present invention.

FIG. 90 is an explanatory diagram of an EL display device according to an embodiment of the present invention.

FIG. 91 is an explanatory diagram of an EL display device according to an embodiment of the present invention.

FIG. 92 is an explanatory diagram of an EL display device according to an embodiment of the present invention.

FIG. 93 is an explanatory diagram of an EL display device according to an embodiment of the present invention.

FIG. 94 is an explanatory diagram of an EL display device according to an embodiment of the present invention.

FIG. 95 is an explanatory diagram of an EL display device according to an embodiment of the present invention.

FIG. 96 is an explanatory diagram of an EL display device according to an embodiment of the present invention.

FIG. 97 is an explanatory diagram of an EL display device according to an embodiment of the present invention.

FIG. 98 is an explanatory diagram representing a driving method of an EL display device according to an embodiment of the present invention.

FIG. 99 is an explanatory diagram representing a driving method of an EL display device according to an embodiment of the present invention.

FIG. 100 is an explanatory diagram of an EL display device according to an embodiment of the present invention.

FIG. 101 is an explanatory diagram representing a driving method of an EL display device according to an embodiment of the present invention.

FIG. 102 is an explanatory diagram of a source driver circuit of an EL display device according to an embodiment of the present invention.

FIG. 103 is an explanatory diagram of an EL display device according to an embodiment of the present invention.

FIG. 104 is an explanatory diagram of an EL display device according to an embodiment of the present invention.

FIG. 105 is an explanatory diagram of a source driver circuit of an EL display device according to an embodiment of the present invention.

FIG. 106 is an explanatory diagram of a source driver circuit of an EL display device according to an embodiment of the present invention.

FIG. 107 is an explanatory diagram of a source driver circuit of an EL display device according to an embodiment of the present invention.

FIG. 108 is an explanatory diagram of a source driver circuit of an EL display device according to an embodiment of the present invention.

FIG. 109 is an explanatory diagram of a source driver circuit of an EL display device according to an embodiment of the present invention.

FIG. 110 is an explanatory diagram of a source driver circuit of an EL display device according to an embodiment of the present invention.

FIG. 111 is an explanatory diagram representing a driving method of an EL display device according to an embodiment of the present invention.

FIG. 112 is an explanatory diagram of an EL display device according to an embodiment of the present invention.

FIG. 113 is an explanatory diagram of an EL display device according to an embodiment of the present invention.

FIG. 114 is an explanatory diagram of an EL display device according to an embodiment of the present invention.

FIG. 115 is an explanatory diagram representing a driving method of an EL display device according to an embodiment of the present invention.

FIG. 116 is an explanatory diagram representing a driving method of an EL display device according to an embodiment of the present invention.

FIG. 117 is an explanatory diagram representing a driving method of an EL display device according to an embodiment of the present invention.

FIG. 118 is an explanatory diagram representing a driving method of an EL display device according to an embodiment of the present invention.

FIG. 119 is an explanatory diagram representing a driving method of an EL display device according to an embodiment of the present invention.

FIG. 120 is an explanatory diagram representing a driving method of an EL display device according to an embodiment of the present invention.

FIG. 121 is an explanatory diagram representing a driving method of an EL display device according to an embodiment of the present invention.

FIG. 122 is an explanatory diagram of an EL display device according to an embodiment of the present invention.

FIG. 123 is an explanatory diagram of an EL display device according to an embodiment of the present invention.

FIG. 124 is an explanatory diagram of an EL display device according to an embodiment of the present invention.

FIG. 125 is an explanatory diagram of an EL display device according to an embodiment of the present invention.

FIG. 126 is an explanatory diagram of an EL display device according to an embodiment of the present invention.

FIG. 127 is an explanatory diagram of an EL display device according to an embodiment of the present invention.

FIG. 128 is an explanatory diagram of an EL display device according to an embodiment of the present invention.

FIG. 129 is an explanatory diagram representing a driving method of an EL display device according to an embodiment of the present invention.

FIG. 130 is an explanatory diagram representing a driving method of an EL display device according to an embodiment of the present invention.

### DESCRIPTION OF THE EMBODIMENTS

An EL display device of an embodiment of the present invention includes a capacitor (offset cancel capacitor) that maintains a predetermined voltage used for an offset cancel operation. The offset cancel capacitor, provided for each pixel, maintains a predetermined voltage, such as a video signal applied to the pixel, when the pixel is selected. The predetermined voltage maintained in the offset cancel capacitor is used to continue the offset cancel operation in a drive transistor even after the drive transistor pixel has become non-selected.

In traditional pixel configurations, the offset cancel operation is performed when a pixel is selected. Accordingly, the offset cancel operation is confined within the select period of a pixel row. The offset cancel operation time is therefore insufficient to realize a sufficient offset cancel operation.

According to the present embodiment, because the offset cancel capacitor that sustains the offset cancel operation is provided for each pixel, the offset cancel operation can be continuously performed even when the pixel is in the non-select state. Since this provides a sufficient offset cancel period for the drive transistor, the characteristic variation of a drive transistor 11a can be compensated for, and an image display free of characteristic display nonuniformity can be realized.

### First Embodiment

The following describes the First Embodiment of the present invention.

It should be noted that, in the drawings, the portions and components irrelevant to the description are omitted. As such, the elements illustrated in a particular figures can be applied to or combined with other figures even when the elements are not illustrated in these figures. Further, the figures contain portions or components that are enlarged or reduced for illustrative purposes. Note also that the First through Seventh Embodiments below may be combined.

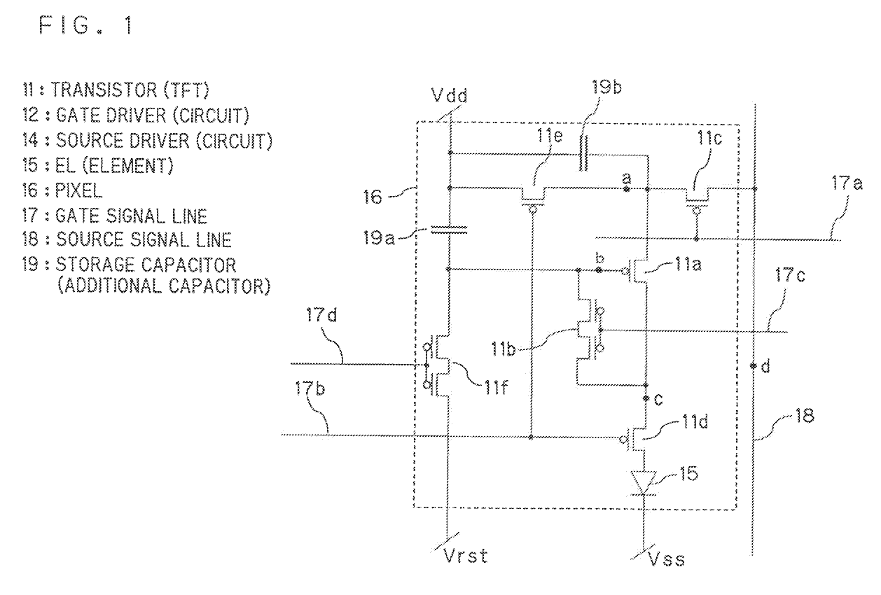

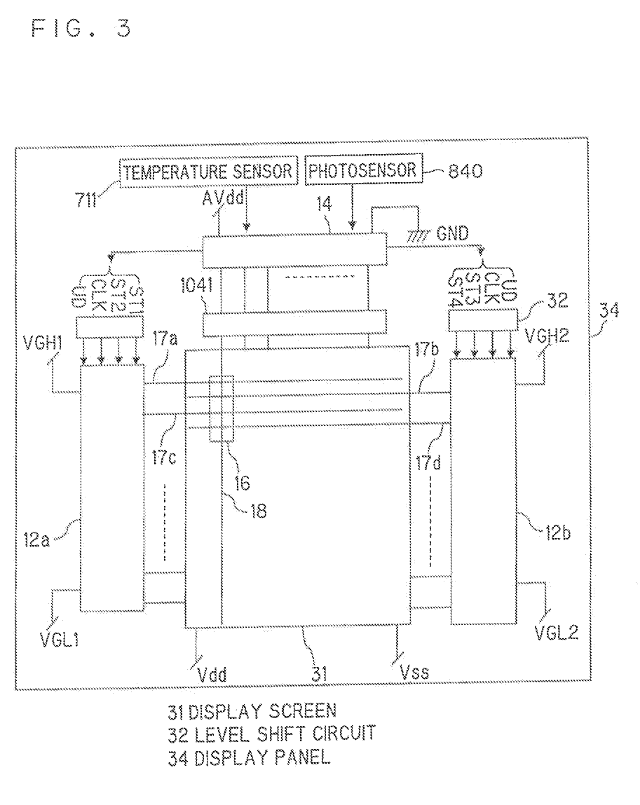

FIG. 1 depicts a pixel configuration of an EL display device of the First Embodiment. FIG. 3 is a configuration in which a gate driver circuit 12 and a source driver circuit IC 14 are connected to a display region 31 that includes pixels 16 disposed in a matrix.

As illustrated in FIG. 3, the gate driver circuit 12 receives a clock signal (CLK), start signals (ST1, ST2), and an up-down signal (UP). The clock signal (CLK) is in synchronism with a horizontal synchronizing signal (HD). As required, the clock signal (CLK) is produced with an oscillation module installed in the EL display device. A duty drive can be realized by controlling the start signal (ST2).

The signals applied to the gate driver circuit 12, such as the clock signal (CLK), the start signals (ST1, ST2), and the up-down signal (UP), are produced in the source driver IC 14, and applied to the gate driver circuit 12 after being level shifted by a level shift circuit formed on an array substrate. The clock signal and other signals used in the gate driver circuit 12 are supplied from the source driver IC 14.

The voltages (for example, VGH, VGL) to be level shifted are produced in the source driver IC 14, and the signals (such as CLK, UD, and ST) may be applied to the gate driver circuit 12 after being level shifted by a level shift circuit installed in the source driver IC 14.

The level shift circuit converts the output logic level voltage (for example, 3 V) of the source driver IC 14 into a voltage (for example, VGH, VGL) used in the gate driver circuit 12. The level shift circuit is formed or disposed inside or on the input stage of the gate driver circuit 12, or on the output stage of the source driver IC 14.

The clock signal (CLK) is used to sequentially displace a pixel row to be selected. The start pulse signals (ST) are used to designate a pixel row to be selected. By the clock signal (CLK), the start pulse signals (ST) are displaced in a shift register circuit of the gate driver circuit 12. The up-down signal (UD) is a vertical inversion switch signal for the screen. A gate signal line 17 is selected (ON voltage (VGL) is applied to the gate signal line 17) according to the position of a start pulse in the shift register circuit.

In the First Embodiment of the present invention, a transistor 11 of the pixel 16 is formed of a P-channel transistor, and the gate driver circuit 12 is also formed of a P-channel transistor. By using a P-channel transistor for both the transistor 11 of the pixel 16 and the gate driver circuit 12, the manufacturing cost of the EL display panel can be reduced.

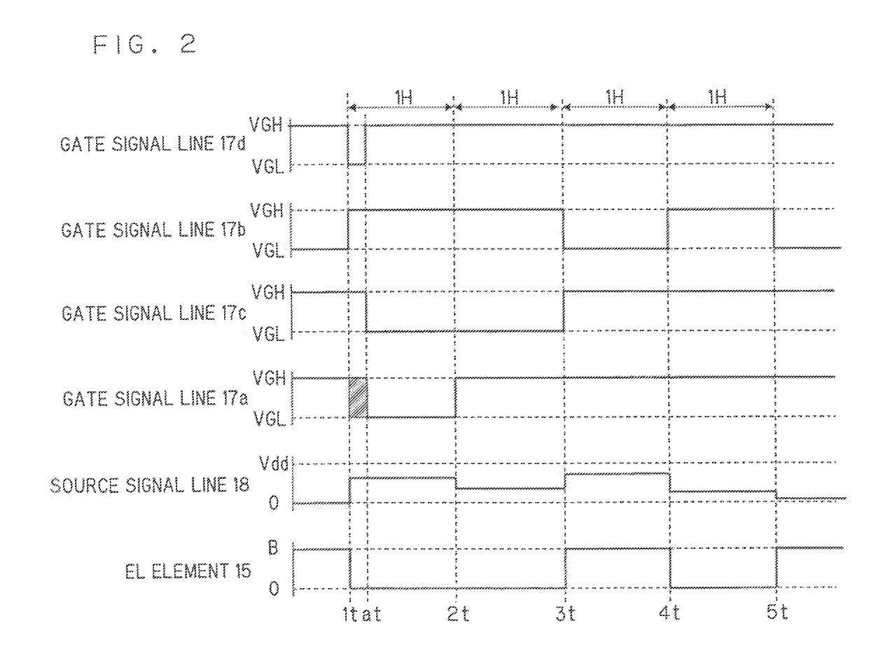

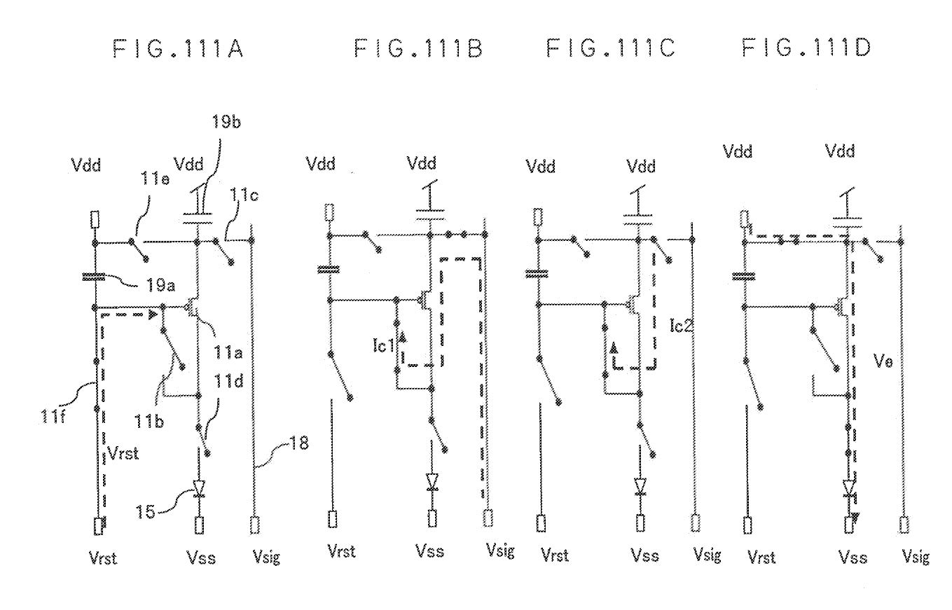

The source driver IC 14 may be a driver that outputs the video signal as a voltage signal or a current signal, for example. In this specification, for convenience of explanation, the source driver IC 14 is described as a voltage signal output driver. FIG. 2 and FIG. 111 are explanatory diagrams representing a driving method of the EL display device of this embodiment.

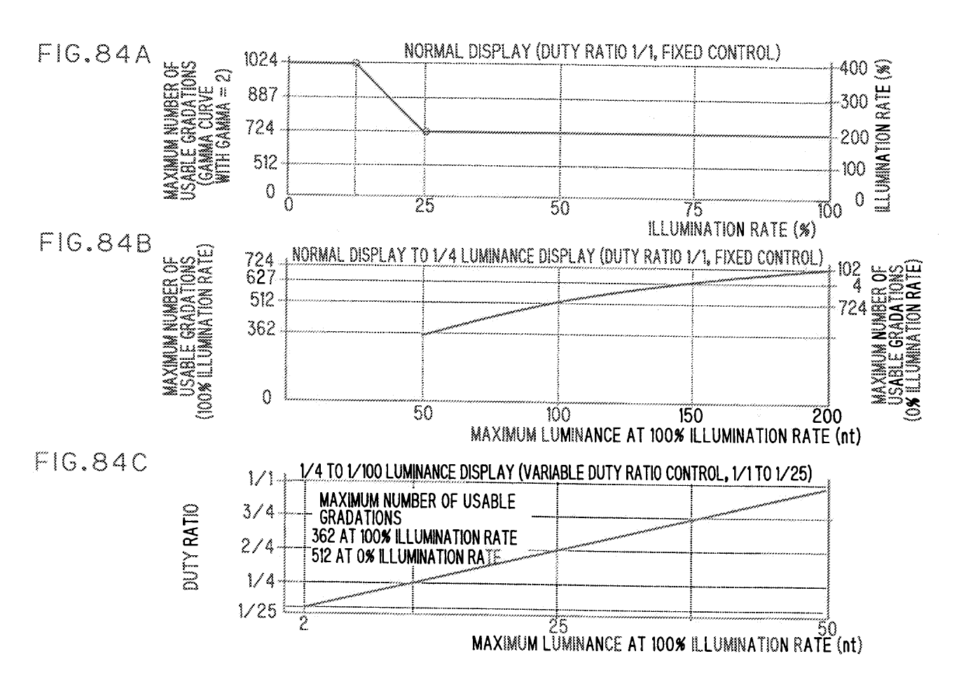

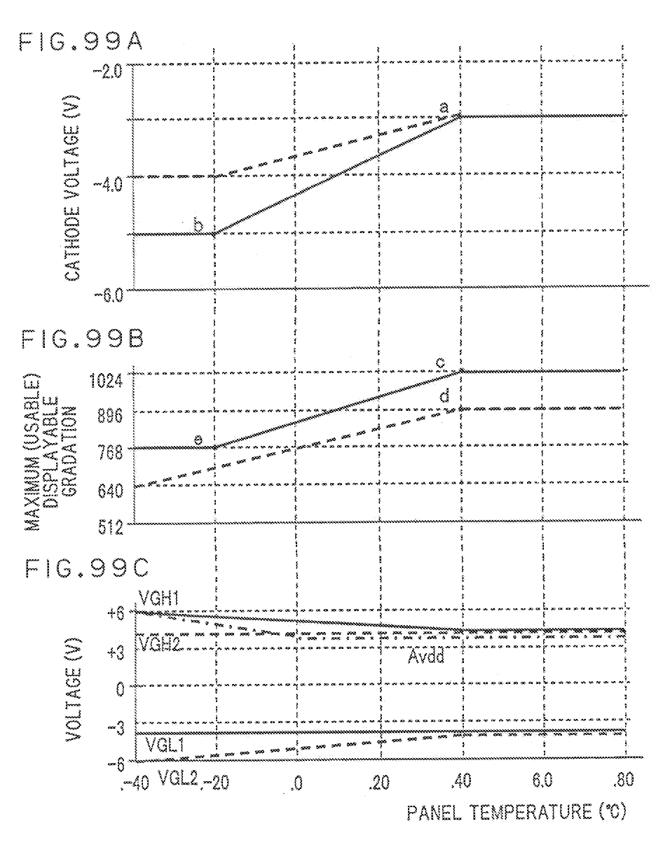

The display panel of the present embodiment includes pixels of R (red), G (green), and B (blue) disposed in a matrix format. In addition to the RGB pixels, white (W) pixels may be disposed. With the white-emitting pixels, a high-luminance display image can be realized. That is, the produced image display appears more luminous. Preferably, the panel configuration including the white (W) pixels is used in combination with the duty drive scheme or the maximum usable gradation display driving scheme represented in, for example, FIG. 84 and FIG. 99.

Further, the white pixels may be formed over the entire area of the display region, and the RGB pixels may be formed in a matrix using a color filter.

The RGB pixels may have different numerical apertures (or different pixel electrode areas). With different numerical apertures, the current density flown in an EL element 15 of each pixel can be varied. By varying the current density, the EL elements 15 of RGB can deteriorate at the same rate. With the same rate of RGB deterioration, the white balance in the display screen of the EL display device will not be disturbed even after extended use of the EL display device.

Preferably, the pixels are disposed so that the arrangement of the three primary colors will be different between adjacent pixel rows. For example, when the pixels are arranged R, G, and B from the left in the even-numbered rows, the pixel arrangement is B, G, and R in the odd-numbered rows. With such an arrangement, the diagonal resolution of the image can be improved even with small numbers of pixels. The pixels may be arranged in a delta configuration. External light or the light emitted by the EL display panel (emitted light from the EL element 15) or the like causes a photoconductor phenomenon when it falls on the source driver IC (source driver circuit) 14. This leads to malfunction. To avoid this, a light shielding film is formed underneath a source driver IC chip or the source driver circuit 14. That is, a light shield is formed or disposed between the source driver IC and the array substrate. The light shielding film is formed as a metal thin film, or a light absorbing film made of an organic or an inorganic material on a surface of the panel substrate. Preferably, the anode wires and cathode wires used to supply current to the EL elements 15 are used as the light shielding film (formed beneath the source driver IC chip). In this way, the anode and cathode wires can serve as both the light shielding film and the current (voltage) supply lines. This makes it easier to form the light shielding film, and cost is reduced. This configuration is not limited to the source driver circuit 14 being an IC chip. That is, the configuration is also applicable to the case where the source driver circuit 14 is a low-temperature polysilicon, a high-temperature polysilicon, or a semiconductor film (CGS) formed by solid-phase growth, or when the amorphous silicon technique is used. In either case, the light shielding film is formed on the rear side or beneath the source driver circuit 14.

As described above, in the EL display device of this embodiment, the source driver circuit 14 is a semiconductor IC (IC Chip), which is mounted on the display screen-forming substrate, and provided with the light shielding film formed beneath the source driver circuit and above the substrate. The source driver IC 14 is preferably structured to include a charge pump circuit, which produces voltages VGH and VGL used in the gate driver circuit 12. The voltage VGH turns off the transistor 11, and the voltage VGL turns on the transistor 11. Note that these voltage ON/OFF functionalities are only relevant when the transistor 11 is a P-channel transistor. When the transistor 11 is an N-channel transistor, the voltage VGH turns on the transistor 11, and the voltage VGL turns off the transistor 11. Further, VGH and VGL are power voltages for the gate driver circuit 12.

In FIG. 3, a gate driver circuit 12a applies voltages VGH1 and VGL1, and a gate driver circuit 12a applies voltages VGH2 and VGL2. When the switch transistor 11 is a P-channel transistor, VGL1 and VGL2 are different. VGH1 and VGH2 are common voltages (VGH1=VGH2). When the switch transistor 11 is an N-channel transistor, VGH1 and VGH2 are different. VGL1 and VGL2 are common (VGL1=VGL2).

In the pixel configuration of FIG. 1, the ON voltage (VGL) of a switch transistor 11d is higher than the ON voltage (VGL) of a switch transistor 11c. In other words, the potential difference (OFF voltage (VGH)−ON voltage (VGL)) of the switch transistor 11d is smaller than the potential difference (OFF voltage (VGH)−ON voltage (VGL)) of the switch transistor 11c. The ON resistance of the switch transistor 11d is relatively increased to prevent the channel voltage of the drive transistor 11a from being affected by changes in the (anode-cathode) voltage across the terminals of the EL element 15. The off-leak current of the switch transistor 11b can be reduced as well. Preferably, the switch transistor 11c is sufficiently turned on to lower the ON resistance.

For example, when the OFF voltage (VGH1=VGH2) is 6.0 (V), the ON voltage (VGL1) of the switch transistor 11c is set to −4.0 (V), and the ON voltage (VGL2) of the switch transistor 11d is set to −2.0 (V). When the OFF voltage (VGH1) of the OFF voltage switch transistor 11c is 6.0 (V), and the OFF voltage (VGH2) of the switch transistor 11d is 5.5 (V), OFF voltage (VGH1)−ON voltage (VGL1) of the switch transistor 11c is set to −10.0 (V), and OFF voltage (VGH2)−ON voltage (VGL2) of the switch transistor 11d is set to −8.0 (V). OFF voltage (VGH1)−ON voltage (VGL1) of the switch transistor 11c is set so that there is a potential difference of at least 1 V and at most 4 V relative to OFF voltage (VGH2)−ON voltage (VGL2) of the switch transistor 11d. The same applies to the other embodiments of the present invention.

The description of the present embodiment is given through the case where the transistor 11 is basically a P-channel transistor. However, the embodiment is not limited to this. For example, the drive transistor 11a may be a P-channel transistor, and the other switch transistors may be N-channel transistors. In either case, the off-leak current of the switch transistor 11 can be reduced, and desirable contrast can be realized.

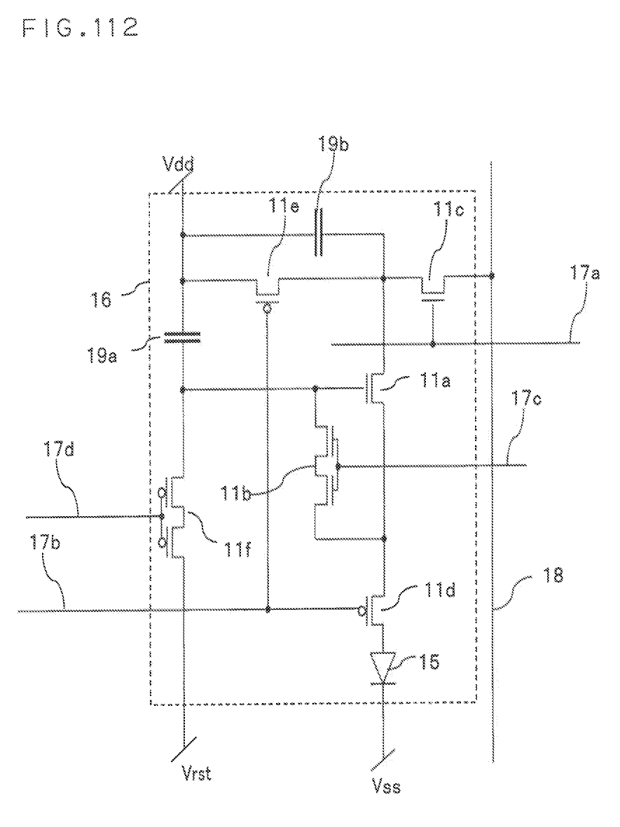

For example, as illustrated in FIG. 112, the drive transistor 11a may be realized by an N-channel transistor. Further, the switch transistor 11c and the switch transistor 11b may be N-channel transistors. In FIG. 1 and other figures, the switch transistors 11b, 11f, and 11c are preferably structured to include serially connected channels (multigate structure: dual gate, triple gate, etc.). The multigate structure is particularly preferred for the switch transistor 11c which applies video signal voltage Vsig to the pixels 16, the switch transistor 11f which applies reset voltage Vrst, and the switch transistor 11b which shorts between the gate terminal of the drive transistor 11a and the other terminals. It is also preferable that the switch transistors 11b, 11f, and 11c be N-channel transistors, because it reduces off-leak current.

The following describes a duty drive (black insert drive).

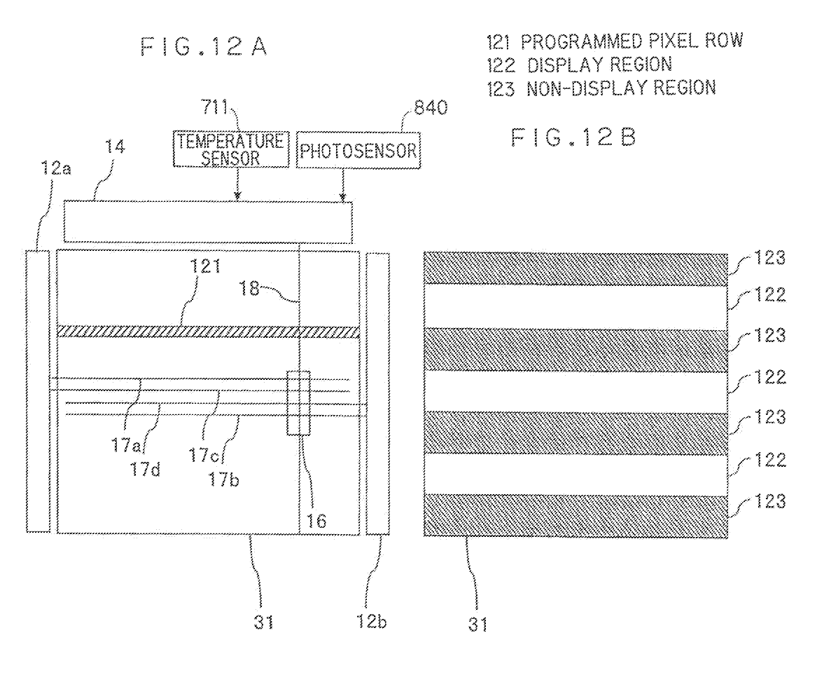

In an embodiment of the present: invention as represented by FIG. 1 and elsewhere, at least one of a transistor 11e and the transistor 11d is ON/OFF controlled, so that a duty drive represented in FIG. 12(b) can be realized. The diagram illustrated in FIG. 12 includes a programmed pixel row 121 (a pixel row with the video signal written in), and non-display regions 123 (a non-display pixel row or a group of non-display pixel rows (no current is flown, or only a small current is flown in the EL element 15) created by turning off at least one of the transistor 11e and the transistor 11d). The diagram also illustrates display regions 122 (a pixel row or a group of pixel rows with a current supplied to the EL element 15; both the transistor 11e and the transistor 11d are turned on). The non-display region 123 and the display region 122 are scanned in frame cycles or in synchronism with a horizontal synchronizing signal from the top to bottom of a display screen 31.

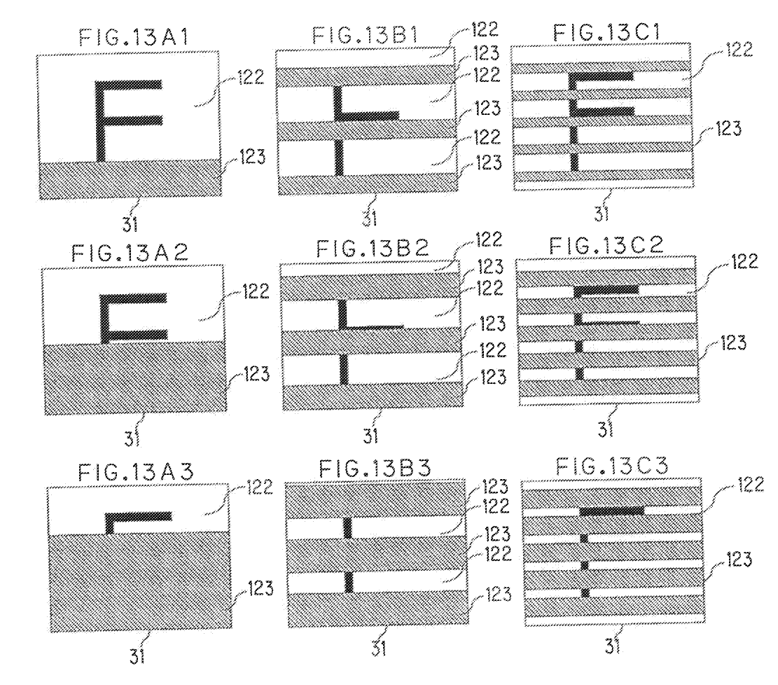

In the display depicted in FIG. 13(a), a single display region 122 is displaced from the top to bottom of the screen. With a low frame rate, the displacement of the display region 122 is visually recognized, particularly when the eye is closed, or the face is moved up and down.

This can be overcome by dividing the display region 122 as shown in FIG. 12(b) and FIG. 12(c). It is not required to equally divide the display region 122. For example, the display region may be divided into four regions: a display region 122a (area 1); a display region 122b (area 2); a display region 122c (area 1); and a display region 122d (area 4).

The display region 122 may be controlled in such a manner that the areas of the display regions 122 over a number of frames (fields), on average, have a target area. For example, in an exemplary driving method, when the display region 122 is to have an area 1/10 of the display screen 31, the area of the display region 122 is set to be 1/10, 1/20, 1/20, and ⅕ in the first, second, third, and fourth frames (fields), respectively, so that an area 1/10 of a predetermined display area (display luminance) is obtained over these four frames (fields).

In another exemplary driving method, R, G, and B on average have the same L period over a number of frames (fields) However, it is preferable that the number of frames (fields) be at most four frames (fields), because it otherwise causes flicker depending on the type of display image.

As used in the description of this embodiment, one “frame” or one “field” can be regarded as being synonymous or analogous to the image rewrite cycles of the pixels 16, or the scan cycle from the top to bottom (or from bottom to top) of the display screen 31.

Further, the average of L period over a number of frames (fields) may be different between R, G, and B to achieve an adequate white balance. This driving method is particularly effective when emission efficiency is different between R, G, and B. Further, the division number K (the number of divided display regions 122) may be different between R, G, and B. Increasing the division number for G than for R and B is particularly effective because the display region 122 is more recognizable in G than in R and B.

In the foregoing description of this embodiment, the division is described in terms of the area of the display region 122. However, this is for convenience of explanation, and the division of the area is more accurately the division of a period (time). In the context of FIG. 1, the ON period of the transistor 11d is divided. That is, dividing the area is synonymous or analogous to dividing a period (time).

As described, screen flickers can be reduced by dividing the display region 122 into plural regions. In this way, flickers do not occur, and a desirable image display can be realized. The number of divided regions may be increased. However, this comes with reduced image display performance. The frame rate of image display can be reduced to lower power consumption. For example, when the non-illumination region 123 is not divided, a flicker occurs when the frame rate is 45 Hz or less whereas, when the non-illumination region 123 is divided into six or more regions, a flicker does not occur until the frame rate is 20 Hz or less.

FIG. 13(a) represents a brightness adjusting method for the display region 122 being continuous as shown in the figure. The display luminance is the brightest in the display screen 31 of FIG. 13(a1). The next brightest is the display screen 31 of FIG. 13(a2), and the display screen 31 of FIG. 13(a3) is the darkest. A change from FIG. 13(a1) to FIG. 13(a3) (or vise versa) can be readily realized, for example, by the control of a shift register circuit 61 or the like of the gate driver circuit 12, as described above. Here, the voltage Vdd (anode voltage, etc.) shown in FIG. 1 does not need to be varied. Further, it is not required to vary the magnitude of the output program current or output program voltage of the source driver circuit 14. That is, the luminance of the display screen 31 can be varied without accompanying any change in power voltage or video signal.

In the transition from FIG. 13(a1) to FIG. 13(a3), no change occurs in the gamma characteristics of the screen. It is therefore possible to maintain the contrast and the gradation characteristics of the display image, regardless of the luminance of the display screen 31. This is a characteristic feature of this embodiment.

In the luminance adjustment of traditional screens, the gradation performance suffers when the luminance of the display screen 31 is low. Specifically, while a 64 gradation display is possible in a high luminance display, the number of gradations is reduced in half or less in a low luminance display. In contrast, with the driving method of this embodiment, the maximum 64 gradation display is possible irrespective of the display luminance of the screen.

FIG. 13(b) represents a brightness adjusting method for the display region 122 being divided as shown in FIG. 12. The display luminance is the brightest in the display screen 31 of FIG. 13(b1). The next brightest is the display screen 31 of FIG. 13(b2), and the display screen 31 of FIG. 13(b3) is the darkest. A change from FIG. 13(b1) to FIG. 13(b3) (or vise versa) can be readily realized, for example, by the control of the shift register circuit 61 or the like of the gate driver circuit 12, as described above. With the display region 122 divided as shown in FIG. 13(b), no flicker occurs even at a low frame rate.

Flickers can be prevented at even lower frame rates by dividing the display region 122 into smaller regions as shown in FIG. 13(c). However, this lowers the display performance of moving images. As such, the driving method of FIG. 13(a) is more suited for displaying moving images. The driving method of FIG. 13C is suitable when displaying still images, and when low power consumption is needed. The switch of the driving method from FIG. 13(a) to FIG. 13(c) can be readily realized by the control of the shift register 61.

In FIG. 13, the non-display regions 123 appear at regular intervals. However, the embodiment is not limited to this configuration. For driving, a half of the display screen 31 may be the display regions 122 and the non-display regions 123 repeatedly occurring at equal interval as in FIG. 13(c1), while the other half is a continuous area of the display region 122.

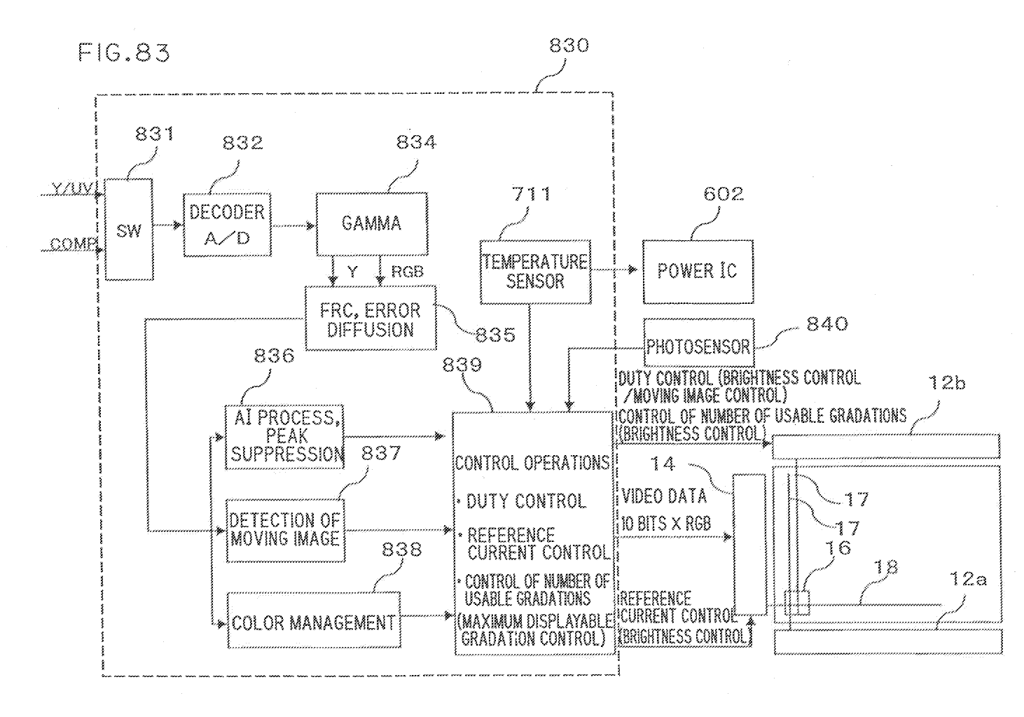

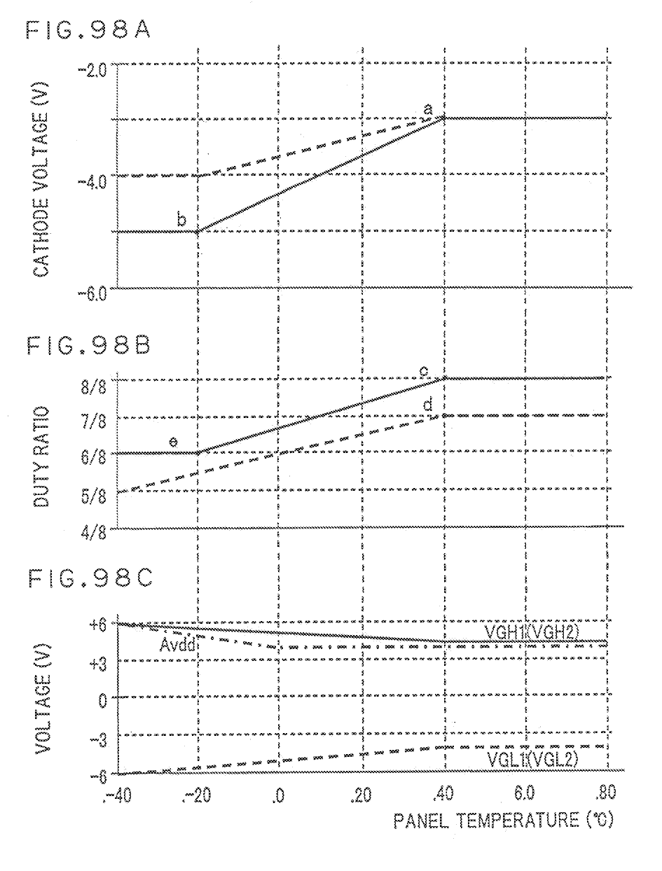

It is preferable that the video signal input to the EL display device be subjected to an addition or weighting process using a circuit structure shown in FIG. 83. With the circuit structure of FIG. 83, the current flowing in the display screen is determined or predicted, and a black, band-like non-illumination region is created on the image screen, for example, based on the current so determined. The size of this black, band-like non-illumination region is then varied. Alternatively, the width of the black, band-like non-illumination region is held constant, and the amplitude of the video signal is varied so that the magnitude of the current flowing in the display screen is controlled below a certain level. With this control, the current flowing into the display screen from the power circuit can be held below a certain level, and the generated heat in the EL display device can be suppressed. Further, as will be described with reference to FIG. 98 and FIG. 99, the generated heat in the EL display device can be suppressed by varying the output voltage of the power circuit (power IC). An even more desirable image display can be realized with a pixel configuration of an embodiment of the present invention.

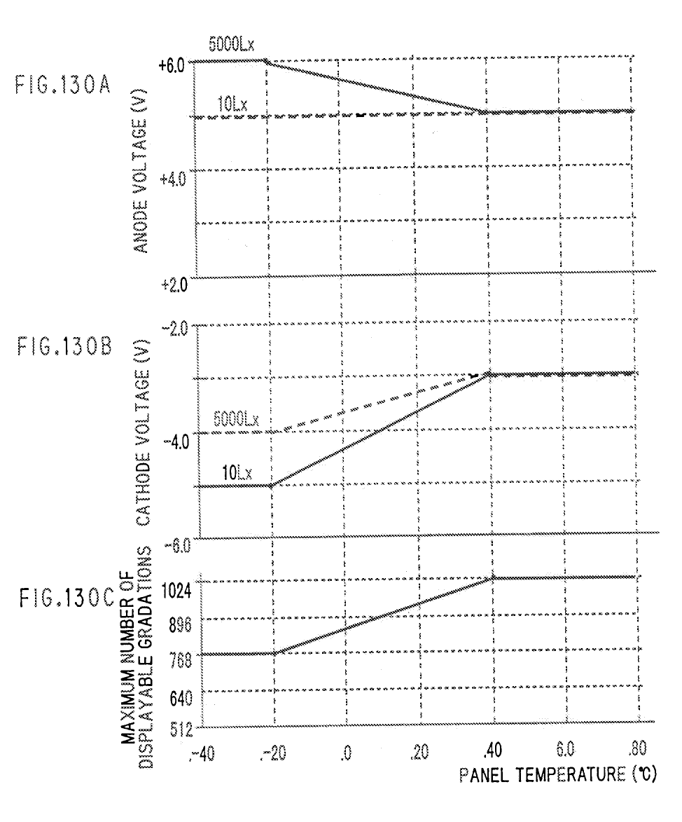

The image quality can be improved and the current can be suppressed with an illumination rate control drive (duty drive), a peak current suppress drive, and a maximum display gradation number control drive (see FIG. 12, FIG. 13, FIG. 84, FIG. 98, FIG. 99, FIG. 130, and elsewhere). The control timing at which the ON/OFF voltage of each gate signal line 17 is applied is controlled according to the operation of the corresponding switch transistor 1. The control of the gate driver circuit 12 can be realized by applying signals from the source driver IC 14 after level shifting in a level shift circuit 32.

In this specification, the duty ratio or other variables are described as being varied according to the illumination rate. However, the illumination rate has more than one meaning. For example, a “low illumination rate” means not only a small current flowing into the screen 31, but large numbers of pixels in a low gradation display forming an image. That is, the display image on the screen 31 includes large numbers of dark pixels (low gradation pixels).

Accordingly, a “low illumination rate” can be described as being a state containing a large amount of low gradation video data as determined by histogram processing of the video data forming the screen. A “high illumination rate” means that the current flowing in the screen 31 is large. It also means that the number of pixels of a high gradation display forming the image is large. That is, the image forming the screen 31 contains large numbers of bright pixels (high gradation pixels) A “high illumination rate” can be described as being a state containing a large amount of high gradation video data as determined by histogram processing of the video data forming the screen. That is, the control according to the illumination rate can be regarded as being synonymous or analogous to the control according to a gradation distribution state or a histogram distribution of the pixels.

It can be said from this that the control according to the illumination rate is the same as the control that is performed based on the image gradation distribution state in a manner that depends on situations (low illumination rate=large numbers of low gradation display pixels; high illumination rate=large numbers of high gradation display pixels).

Driving at a duty ratio of 1/1 in a normal display state, and lowering the duty ratio either stepwise or smoothly at or above a predetermined high illumination rate is synonymous or analogous to the operation or control in which the duty ratio is 1/1 when the number of low gradation or high gradation pixels falls within a certain range, and in which the duty ratio is lowered either stepwise or smoothly when the number of high gradation pixels exceeds a certain value.

The duty ratio control is performed over the illumination rate range of from 1/10 to 1/1. When the duty ratio is 1/1, and the display is a white raster display, the illumination rate is 100% (maximum white raster display). In a black raster, the illumination rate is 0% (complete black raster display).

The illumination rate is also a fraction with respect to the maximum current that flows in the anode or cathode of the panel (duty ratio=1/1). For example, when the maximum current that flows in the cathode is 100 mA, the illumination rate is 30% for a 30 mA current flowing at a duty ratio of 1/1 (30/100=30% (0.3)).

When the maximum current that flows in the cathode is 100 mA, and the sum of video data is at a maximum, a 50% illumination rate means that the current flowing in the cathode (anode) is 50% of the maximum current. Further, a 20% illumination rate means that the current flowing in the cathode is 20% of the maximum current. In the following, the illumination rate will generally be described according to this definition. The illumination rate, defined as the fraction with respect to the maximum current that flows in the anode or cathode of the panel, can also be regarded as the fraction with respect to the maximum current that flows in the whole EL element of the panel.

In this specification, the term “illumination rate” is used at a duty ratio of 1/1, unless otherwise specified. When the current is 20 mA at a duty ratio of 1/3, the illumination rate is (20 mA·3)/100 mA=60% (0.6). That is, when the duty ratio is 1/2, the current flowing in the anode (cathode) terminal is only half the maximum current value even when the illumination rate is 100%. When the anode current is 20 mA and the duty ratio is 1/1 at a 50% illumination rate, the anode current becomes 10 mA when the duty ratio is 1/2. When the anode current is 100 mA and the duty ratio is 1/1 at a 40% illumination rate, the illumination rate is 80% when the anode current becomes 200 mA.

As described above, the illumination rate is the fraction with respect to the amount of video data forming the screen. It also means the consumed current (power), or a fraction of the consumed current of the EL display panel.

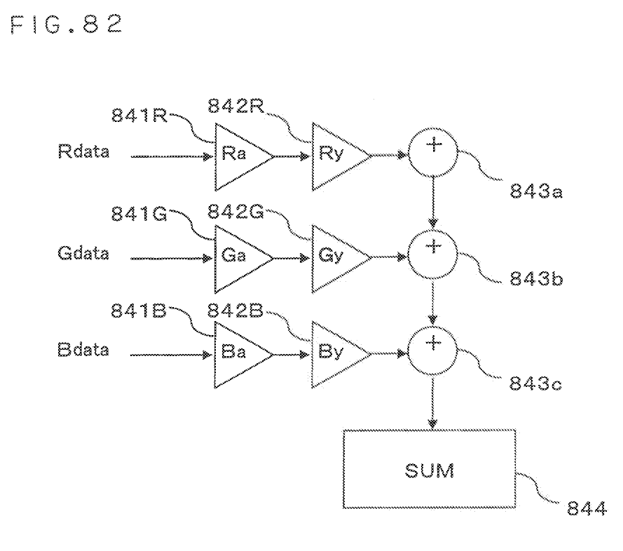

As an example, the illumination rate is determined from the sum of video data (FIG. 83), or more concisely, from the video data. When the input video signals are Y, U, and V, the illumination rate may be determined from the Y (luminance) signal. However, in the EL display panel, the value obtained from the Y signal does not give power consumption because R, G, and B have different emission efficiencies. Thus, even in the case of Y, U, and V signals, it is preferable to find the consumed current (consumed power) by first performing conversion into R, G, B signals, and then multiplying the signals by a coefficient to obtain a converted current according to R, G, and B. However, it is also possible to determine consumed current simply from the Y signal because it simplifies the circuit process (see, for example, FIG. 82 and FIG. 83). Note that the illumination rate may be determined from a measured current obtained by measuring the current flowing in the cathode (anode).

The illumination rate is expressed in terms of the current flowing in the panel. This is because, in the EL display panel, the power consumption abruptly increases when blue (B), having poor emission efficiency, is displayed over a large area (for example, as in the ocean). Further, the data sum is not simply a sum of video data, but a value of video data in terms of a consumed current. As such, the illumination rate is determined from the current used in each image with respect to the maximum current. Further, the data sum is not limited to one determined by addition. The data sum may be determined by a method in which the input video data is weighted by RGB before addition. Further, the data sum may be determined by extracting and processing data characteristic of the image. Further, the data sum may be determined by extracting data that fall within a specific range of a histogram (for example, 1σ about a means value) obtained by histogram processing of the input video data. That is, the data sum is a set of processed data, or a result of data processing.

The input video data generally means the video data input to the EL display device; however, it also means the video data input to the pixels of the EL display device. In other words, the input video data is the video data output from the source driver IC 14.

It is preferable that the number of gradations displayed in the EL display device be changed according to the illumination rate. For example, when the illumination rate is 50% or more, the image is displayed in gradations half the full gradation (in 512 gradations out of 1024 gradations). Below 50%, the image is displayed in full gradation. This embodiment is described with reference to FIG. 98, FIG. 99, FIG. 130, and elsewhere.

Note that the illumination rate is the fraction with respect the 100% white raster display at a maximum gradation in a normal driving scheme, such as the duty drive, in which the peak current is not suppressed. Accordingly, the illumination rate is 0% in a black raster display.

FIG. 83 is a block diagram of a drive circuit of the present embodiment. The following describes the drive circuit of this embodiment. The drive circuit of FIG. 83 is structured to receive two external signals: a Y/UV video signal, and a composite (COMP) video signal. A switch circuit 831 decides which video signal to input.

The video signal selected by the switch circuit 831 is decoded and AD converted by a decoder and an AD circuit, and converted into digital RGB image data. Each RGB image data has 8 bits. The RGB image data are gamma processed by a gamma circuit 834. At this time, a luminance (Y) signal is determined. The gamma process converts each RGB image data into 10 bit image data.

After the gamma process, the image data is subjected to an FRC process or an error diffusion process in a process circuit 835. By the FRC process or the error diffusion process, the RGB image data is converted to 6 bits. The image data is sent to an AI process circuit 836, where the data is subjected to an AI process (optimum image display process), an illumination rate calculation for a duty drive, and a calculation of maximum number of displayable gradations. In a moving image detecting circuit 837, a detection of moving image is performed. Based on the result of the moving image detecting process, the division driving of the display region 122 and the non-display region 123 is performed in the manner described with reference to FIG. 13 and elsewhere. In a color management circuit 838, a color management process is performed.

The results of processes in the AI process circuit 836, the moving image detecting circuit 837, and the color management circuit 838 are sent to an arithmetic circuit 839, which produces duty ratio control and reference current control data by conversion. The result of conversion is sent as control data to the source driver circuit 14 and the gate driver circuit 12.

The duty ratio control data is sent to the gate driver circuit 12b, and duty ratio control is performed. Usable gradation control data is sent to the source driver IC 14, and usable gradation number control is performed. The reference current control data is sent to the source driver circuit 14, and reference current control is performed. The image data, gamma corrected and subjected to the frame rate control (FRC) or the error diffusion process, is also sent to the source driver circuit 14.

In the EL display panel, there is no current flow in the EL element 15 in a black display. Accordingly, the luminance is 0 in the black display even when the non-display region 123 is created on the screen 31 as in the duty ratio drive of this embodiment. The white display luminance decreases as the area of the non-display region 123 is increased. However, since the luminance is 0 in the black display, the contrast is infinite. This makes the duty ratio drive the optimum driving method for the EL display panel. The same can be said for the reference current control. The luminance of the black display remains at 0 even when the magnitude of the reference current is varied. The white display luminance increases as the reference current is increased. Thus, a desirable image display can be realized also by the reference current control.

In the duty ratio control, the number of gradations remains the same over the full gradation range. The white balance is also maintained over the full gradation range. Further, by the duty ratio control, the luminance of the screen 31 can be varied by nearly 10 fold.

Because the luminance of the display screen is linearly related to the duty ratio or the inverse of the duty ratio, the brightness control of the display screen is easy.

In the reference current control, the amount of reference current is increased when increasing the luminance of the screen 31. As such, the current flowing in the EL element 15 increases only when the luminance of the screen 31 is high. This prevents the EL element 15 from degrading.

In the present embodiment, both the reference current control and the duty ratio control are used. When the screen 31 is a near white raster display, the reference current is held constant, and only the duty ratio is controlled to vary display luminance or other variables. When the screen 31 is a near black raster display, the duty ratio is held constant, and only the reference current is controlled to vary display luminance and other variables.

Preferably, the duty ratio is at most 1/1, and at least 1/16. More preferably, the duty ratio is at least 1/10. In this way, flicker can be suppressed. The variable range of the reference current is preferably at most 4 times, and more preferably at most 2.5 times.

The calculation of data sum may be based on either consumed current or luminance. Here, for simplicity, the description will be given through the case of the calculation based on luminance (image data). Generally, the calculation based on luminance (image data) is easier to process, and requires smaller hardware for the controller IC. Further, the calculation by luminance is more preferable because it generates fewer flickers in the duty ratio control, and therefore provides a wider dynamic range.

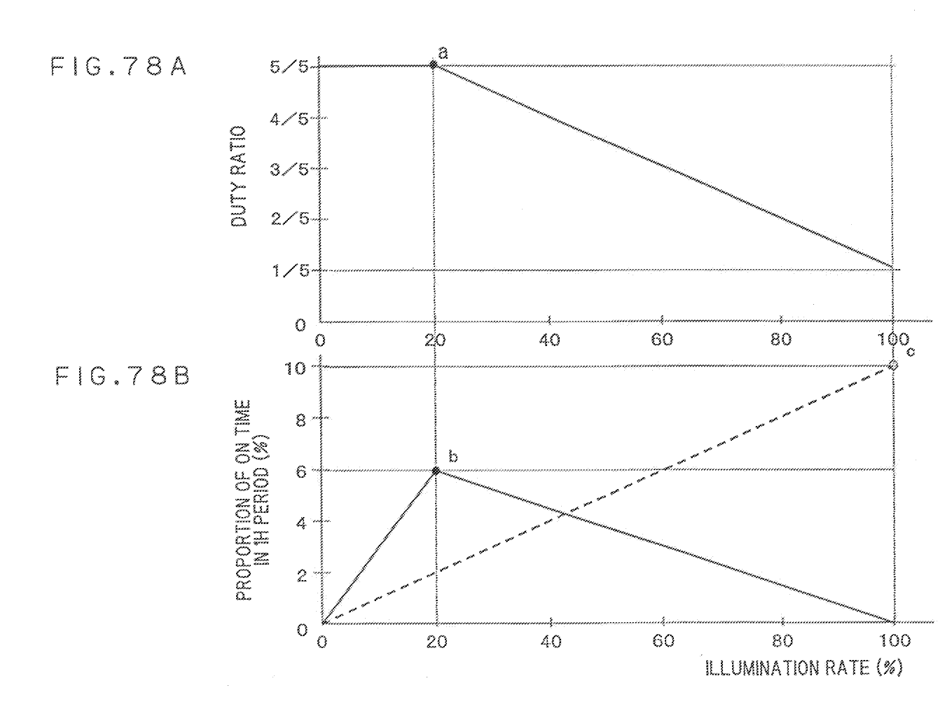

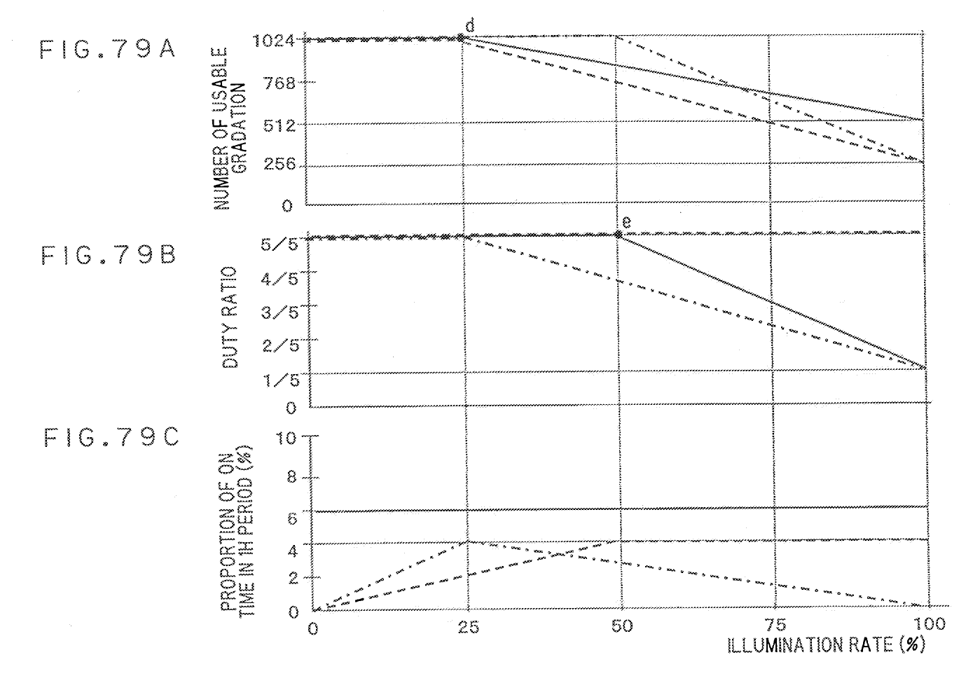

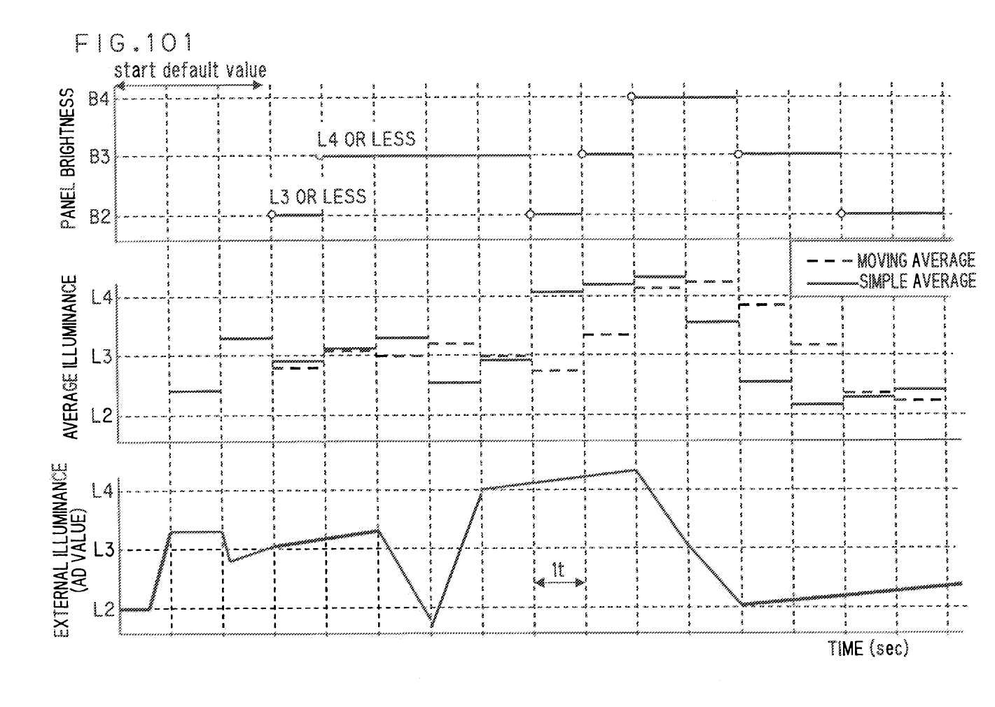

The foregoing is also applicable to the embodiments of, for example, FIG. 78, FIG. 79, FIG. 84, FIG. 98, FIG. 99, FIG. 101, FIG. 111, FIG. 112, and FIG. 130. Further, the present embodiment can be implemented in combination with these other embodiments.

Referring to FIG. 1, the pixel 16 includes two capacitors 19a and 19b, five switch transistors (11b, 11c, 11d, 11e, 11f), and a single drive transistor 11a. The transistor 11b is a threshold voltage compensating switch transistor, by which the transistor 11a is diode-connected to compensate for threshold voltage (threshold value). The transistor 11f is an initializing switch transistor, by which the reset voltage Vrst is applied to initialize the maintain capacitor 19a. The transistor 11d is provided to control emission of the EL element 15.

The switch transistors 11b and 11f have a multigate structure (at least a dual gate structure) to reduce off-leak. However, when the off characteristics of the switch transistors 11b and 11f are sufficient, these transistors may be provided as single gate transistors. Preferably, the switch transistor 11c also has a multigate structure.

The capacitor 19a (hereinafter, maintain capacitor 19a) is provided to maintain the potential at the gate terminal of the drive transistor 11a. The maintain capacitor 19a basically maintains the voltage that has been produced by offset canceling the characteristic variation of the drive transistor 11a.

The gate terminal of the switch transistor 11c is connected to a gate signal line 17a. The source terminal of the switch transistor 11c is connected to a source signal line 18. The switch transistor 11c is ON/OFF controlled according to a select signal from the gate driver circuit 12a.

The source terminal of the drive transistor 11a is connected to the drain terminal of the switch transistor 11c. The source terminal or drain terminal of the threshold voltage compensating switch transistor 11b is connected to a first terminal of the maintain capacitor 19a. As the drive transistor threshold voltage compensating switch transistor 11b is turned on (closed), an offset cancel voltage is maintained at the gate terminal of the drive transistor 11a.

The threshold voltage compensating switch transistor 11b is connected between the gate terminal and drain terminal of the drive transistor 11a. The transistor 11b shorts the gate and drain terminals of the drive transistor 11a in response to a scan signal applied to a gate signal line 17c, so as to diode-connect the drive transistor 11a. That is, the scan signal creates a diode-like state for the drive transistor 11a, and the voltage Vsig−Vth [V] is applied to the gate terminal of the drive transistor 11a. This voltage becomes the gate voltage of the drive transistor 11a.

Note that voltage Vsig is the video signal output to the source signal line 18 by the source driver IC 14. Vth is the threshold voltage of the drive transistor 11a. Further, Vth is the offset cancel voltage of the drive transistor 11a. Vth varies depending upon the characteristic of the drive transistor 11a.

The initializing switch transistor 11f is connected between a reset voltage line Vrst and the first terminal of the maintain capacitor 19a, and a reset voltage Vrst is applied to the gate terminal of the drive transistor 11a, and to the maintain capacitor 11a in response to a scan signal through a gate signal line 17d. As a result, the stored charge in the maintain capacitor 19a discharges A predetermined voltage (initializing voltage Vrst) is applied to the gate terminal of the drive transistor 11a.

Note that, in the pixel configuration of the embodiment represented in FIG. 1 and elsewhere, the voltages Vrst and Vsig are DC applied to the gate terminal of the drive transistor 11a. However, the embodiment is not limited to this, and the voltages Vrst and Vsig may be AC applied. Specifically, the voltages Vrst and Vsig may be applied to the gate terminal of the drive transistor 11a by blocking the DC component with a capacitor provided for the gate terminal of the drive transistor 11a.

Further, in the embodiment of the present invention represented in FIG. 1 and elsewhere, one of the terminals of the offset cancel capacitor 11b is connected to the anode voltage Vdd. However, the embodiment is not limited to this, as long as a predetermined constant voltage is maintained. Examples of such constant voltage include VGH and VGL. As such, one of the terminals of the switch transistor 11e may be connected to voltage Vdd (as in FIG. 1), and one of the terminals of the offset cancel capacitor 11b may be connected to voltage VGH (change from Vdd to VGH).

The switch transistor 11e is connected between an anode voltage Vdd wire or a Vdd electrode and the source terminal of the drive transistor 11a. The switch transistor is controlled by the ON/OFF voltage applied to the gate signal line 17b connected to the gate terminal of the switch transistor. The switch transistor 11e turns on when causing the EL element 15 to emit light, and applies the anode voltage Vdd to the source terminal of the drive transistor 11a.

The switch transistor 11d is connected (disposed) between the drain terminal of the drive transistor 11a and the anode terminal of the EL element 15, and is controlled by the ON/OFF signal (emission control signal) applied to the gate signal line 17b connected to the gate terminal of the switch transistor 11d. In response to the emission control signal, the switch transistor 11d transmits the drive current, generated in the drive transistor 11a, to the EL element 15. That is, the switch transistor 11d ON/OFF controls the current flowing in the current path of the EL element 15.

The maintain capacitor 19a is connected between the anode voltage Vdd wire (electrode) and the gate terminal of the drive transistor 11a, and maintains the anode voltage Vdd, and a charge corresponding to the voltage Vsig−Vth [V] applied to the gate terminal of the drive transistor 11a, for one frame.

Note that the voltages applied to the gate signal line 17 are OFF voltage (VGH) and ON voltage (VGL), the former being applied to turn off the switch transistors 11 (11b, 11c, 11d, 11e, 11f), and the latter being applied to turn on the switch transistors 11 (11b, 11c, 11d, 11e, 11f). Note, however, that this applies only to the case where the switch transistors are P-channel transistors.

As illustrated in FIG. 3, the voltage VGL is VGL1 in the gate driver circuit 12a, and VGL2 in the gate driver circuit 12b. That is, the gate driver circuits 12a and 12b have different ON voltages.

Accordingly, the ON voltage applied to the gate signal line 17a and the gate signal line 17c is VGL1, and the ON voltage applied to the gate signal line 17b and the gate signal line 17d is VGL2. Further, |VGL1|>|VGL2|. The voltage VGH applied to the gate signal line 17a may be the same as the voltage VGH applied to the gate signal line 17d. That is, the OFF voltage VGH1 of the gate driver circuit 12a may be the same as the voltage VGH2 of the gate driver circuit 12b.

In an embodiment of the present invention, the drive transistor 11a is described as being a P-channel transistor. However, the embodiment is not limited to this, and an N-channel transistor may be used. In this case, the ON voltage is VGH, and the OFF voltage is VGL.

Further, the source terminal of the drive transistor 11a is described as being connected to the anode voltage Vdd. However, the embodiment is not limited to this. For example, the source terminal of the drive transistor 11a may be connected to cathode voltage Vss or ground voltage GND. Further, the capacitor 18 may be replaced with a capacitor formed by the capacitance of a gate insulating film of the transistor 11.

The gate driver circuit 12a receives a start pulse ST1 that selects a gate signal line 17a, a start pulse ST2 that selects a gate signal line 17c, and a clock signal (CLK) that sequentially shifts the start pulses. Signal UD switches the vertical shift register direction of the start pulse in the gate driver circuit 12a.

The gate driver circuit 12b receives a start pulse ST3 that selects a gate signal line 17b, a start pulse ST4 that selects a gate signal line 17d, and a clock signal (CLK) that sequentially shifts the start pulses.

It is preferable that the gate driver circuit 12 additionally include an enable control terminal, as required. The gate driver circuit 12 includes a shift register circuit, which sequentially shifts the start pulse in synchronism with the clock signal (CLK) so as to change the position of the gate signal line 17 to be selected.

FIG. 2 represents drive voltages applied to the gate signal lines 17a, 17b, 17c, and 17d, the video signal voltage of the source signal line 18, and the emission state of the EL element 15.

FIG. 2 also represents the operating state (ON/OFF state) of the switch transistors, and the state of applied current or voltage in each operation.

It should be noted that, in FIG. 2, OFF voltage is VGH, and ON voltage is VGL for ease of explanation. The voltage Vsig applied to the source signal line 18 is no greater than the anode voltage Vdd. The ground voltage (GND)=0 V. Specifically, the video signal voltage Vsig falls in a range of 0.2 V to 5.0 V.

One horizontal scan period is 1H. FIG. 2 is merely a schematic representation, and as such, 1H may extend over several periods, or it may be shorter than one period.

FIG. 111 is an explanatory diagram depicting the operation of the pixel shown in FIG. 1. In FIG. 111, the switch transistors are depicted simply as switches for ease of explanation.

VGH is set to a voltage higher than the anode voltage Vdd by at least 0.5 V and at most 3.0 V. For example, when the anode voltage Vdd is 5 V, VGH is set to a voltage of from 5.5 V to 8 V.

During a time period from 1t to at, the pixel 16 receives ON voltage through the gate signal line 17d. This corresponds to FIG. 111(a). Application of the ON voltage (VGL) turns on the transistor 11f, and the reset voltage Vrst is applied to the gate terminal of the drive transistor 11a (point a).

In response to the reset voltage Vrst, the drive transistor 11a assumes a reset state. The reset state includes a state in which the drive transistor 11a is initialized, a state in which a predetermined voltage (initializing voltage) is applied to the gate terminal of the drive transistor 11a, and a state in which the drive transistor 11a assumes a predetermined state.

The reset voltage Vrst should be set to a voltage no greater than GND, and smaller than GND by at most −5 (V). For example, the reset voltage Vrst is set to −2.5 V. Preferably, the reset voltage Vrst is set to a voltage equal to or greater than VGL1, and no greater than GND. More preferably, Vrst is set to a voltage smaller than the lowest voltage of the video signal voltage Vsig by at most −1.0 V, and greater than the ON voltage (VGL) of the switch transistor 11c by at least 1.0 V.

Further, the reset voltage Vrst may be varied according to the video signal voltage Vsig. For example, the reset voltage Vrst is varied according to the gradation number of the video signal. Further, the reset voltage Vrst may be varied according to the video signal voltages of red (R), green (G), and blue (B). This is because the amplitude of the video signal varies between R, G, and B. In this case, a fixed reset voltage Vrst may be set for R, G, and B, irrespective of the gradation number. Further, the reset voltage Vrst may be varied according to the current consumed by the display screen. Further, the reset voltage Vrst may be varied according to the luminance of a display image.

The gate signal line 17c receives ON voltage after application of the reset voltage Vrst (at). Here, the ON voltage (VGL) is applied for longer than 1H. However, the embodiment is not limited to this, and the ON voltage may be applied for a time period shorter than 1H. At least, the ON voltage (VGL) is applied to the gate signal line 17c for a time period longer than that for the ON voltage (VGL) applied to the gate signal line 17a. Alternatively, the application time of ON voltage may overlap between the gate signals lines 17c and 17a. Preferably, the reset voltage Vrst is applied for at least 2 μs.

Application of ON voltage (VGL) to the gate signal line 17a turns on the switch transistor 11c, and Vsig applied to the source signal line 18 is applied to the offset canceling capacitor 19a. The video signal Vsig applied at point a is maintained throughout the time period in which the switch transistor 11b is ON.

Note that, in the shaded area of the gate signal line 17a shown in FIG. 2, either ON voltage (VGL) or OFF voltage (VGH) may be applied.

With the switch transistor 11c turned on, the video signal voltage Vsig is applied to the offset cancel capacitor 11b, which then stores the video signal voltage Vsig.

The ON voltage (VGL) applied to the gate signal line 17a turns on in the switch transistor 11c, which applies the video signal voltage Vsig to the pixel (from 1t to 2t, or at to 2t in FIG. 2). FIG. 111(b) represents this state. In FIG. 111(b), the switch transistor 11d, 11e, and 11f are OFF state (open state). The switch transistors 11c and 11b are ON state (closed state).

With the switch transistor 11b turned on, an offset cancel current Ic1 from the source signal line 18 flows into a current path formed between the channels of the drive transistor 11a and the transistor 11b.

The current Ic1, which is relatively large at the start, decreases as the offset cancel operation proceeds to an end. Basically, Ic1=0 at the end of the offset cancel. By the offset cancel operation, the capacitor 11a maintains a cancel voltage.

In response to the application of the video signal voltage Vsig, the drive transistor 11a, under applied voltage Vsig, varies the potential of the gate terminal at point b so that there will be no current flow into the channel of the drive transistor 11a (offset cancel operation). The varied voltage is maintained by the maintain capacitor 19a. This completes the offset cancel of the drive transistor 11a, bringing it to a state near the offset cancel state. The offset canceling capacitor 19b stores the video signal voltage Vsig.

Ideally, the offset cancel completes within a time period from 1t to 2t of FIG. 2. However, in a high-definition display panel, the offset cancel operation is insufficient because the time to select a single pixel row is too short. When the offset cancel is insufficient, the characteristic variation of the drive transistor 11a remains, and nonuniform luminance occurs on the screen 31 in a gradation display.

One of the objects of the present embodiment is to solve this problem.

The offset cancel operation may continue after time 2t. In FIG. 2, the time period 2t-3t corresponds to such a sustain period. This also corresponds to the state shown in FIG. 111(c).

In FIG. 111(c), the switch transistors 11e, 11d, 11f, and 11c are OFF state (open state), and the switch transistor 11b is ON state (closed state). In this case, offset cancel current Ic2 flows. Because the offset cancel operation is coming to an end, the offset cancel current Ic2 is very small. Accordingly, the offset cancel capacitor 19b may have only a small capacitance.

Note that, in the embodiment of FIG. 2, the sustain period of the offset cancel operation is 2t to 3t. However, the present embodiment is not limited to this. The sustain period of the offset cancel operation may be varied or set for each panel. In this embodiment, the offset cancel operation is performed for at least 1H (single-pixel-row select period). Preferably, the offset cancel period is at least 20 μs.

In FIG. 2, the video signal voltage Vsig is maintained in the pixel 16 during the time period 1t to 2t. After time 2t, because the switch transistor 11c is OFF state, the video signal voltage Vsig is not written into the pixel 16 even when the video signal voltage Vsig applied to the source signal line 18 is varied.

After the offset cancel operation, ON voltage is applied to the gate signal line 17b, and the switch transistor 11e turns on, supplying the anode voltage Vdd to the source terminal of the drive transistor 11a (state shown in FIG. 111(d)). Further, the switch transistor 11d turns on, and a drive current for the EL element 15 is supplied to the EL element 15 from the drive transistor 11a. With the applied current, the EL element 15 emits light.

In FIG. 2, ON voltage (VGL) is applied to the gate signal line 17b during the time period 3t to 4t, so as to turn on the switch transistor 11b and supply an emission current to the EL element 15. During the time period 4t to 5t, OFF voltage (VGH) is applied to the gate signal line 17b to turn off the switch transistor 11d and bring the EL element 15 into a non-emission state. The driving method of FIG. 78, FIG. 79, and FIG. 84 is realized in this manner, by applying ON/OFF voltage to the gate signal line 17b and controlling the current flow.

As described above, ON voltage or OFF voltage is applied to the gate signal line 17b, and current is supplied to the EL element 15 in synchronism with the ON/OFF voltage. The EL element emits light or stops emitting light in synchronism with the applied state of the ON/OFF voltage.

During the operation in which the EL element 15 is emitting or not emitting light (non-voltage program period, after 3t), the transistor 11b is open state. Here, when the EL element 15 is emitting light, the source terminal of the transistor 11a receives anode voltage Vdd (a fall of the channel voltage of the transistor 11e is ignored). When the EL element 15 is not emitting light, the transistor 11e and the transistor 11d are open state. When the EL element 15 is not emitting light, the source terminal of the drive transistor 11a is maintained at anode potential Vdd by the offset canceling capacitor 19a. This stabilizes the potential of the transistor 11a. The emission or non-emission of the EL element 15 may also be controlled by the duty control of the transistor 11d (for example, the transistor 11d is turned on/off to form a band-like non-display region on the display screen 31, and an image is displayed by scanning the non-display region from the top to bottom (and vice versa) of the display screen 31 in synchronism with a frame cycle or a field cycle).

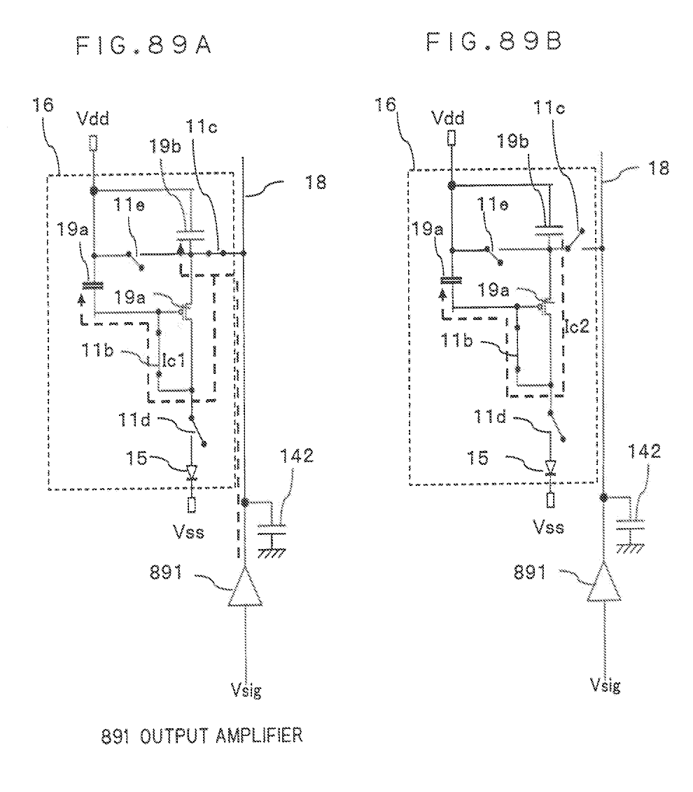

FIG. 89 represents the states of FIG. 111(b) and FIG. 111(c) in more detail. FIG. 89(a) corresponds to FIG. 111(b), and FIG. 89(b) corresponds to FIG. 111(c).

In FIG. 89(a), the video signal voltage Vsig output from an output amplifier 891 is applied to one of the terminals of the offset cancel capacitor 19b via the switch transistor 11c, and, simultaneously, offset cancel current Ic1 flows into the channel of the drive transistor 11a.

A transition to the state shown in FIG. 89(b) occurs after the select period of the pixels 16, and the switch transistor 11c is open state. In the state of FIG. 89(b), the video signal voltage Vsig maintained by the offset cancel capacitor 19b is the current supply, and the offset cancel current Ic2 flows continuously. In FIG. 89(b), the offset cancel current Ic2 becomes substantially 0, and the offset cancel operation completes. That is, an ideal offset cancel operation can be performed.

The output amplifier 891 is structured so that its driving capacity (current output capacity) is variable in each different stage. The output amplifier 891 is formed on the output stage of the source driver IC 14. The driving capacity of the output amplifier 891 can be varied by commands.

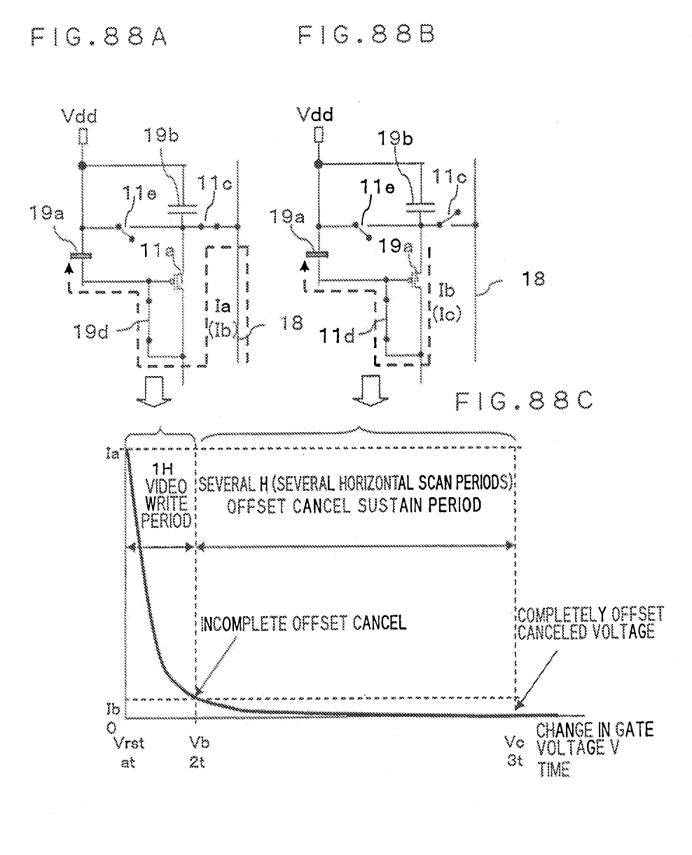

FIG. 88 represents a current (channel current Ic) that flows in the channel of the drive transistor 11a. In FIG. 88, Vc is the gate terminal voltage of the drive transistor 11a that has been ideally offset canceled. Vb is an insufficient offset cancel voltage, and the start voltage of an offset cancel operation is reset voltage Vrst. As illustrated in FIG. 88, during the time period at to 2t, the cancel current Ic1 (start current Ia) is initially large, and rapidly drops. At time 2t, the cancel current Ic1=Ib. At Ib, the current is still flowing, and accordingly the offset cancel is insufficient.

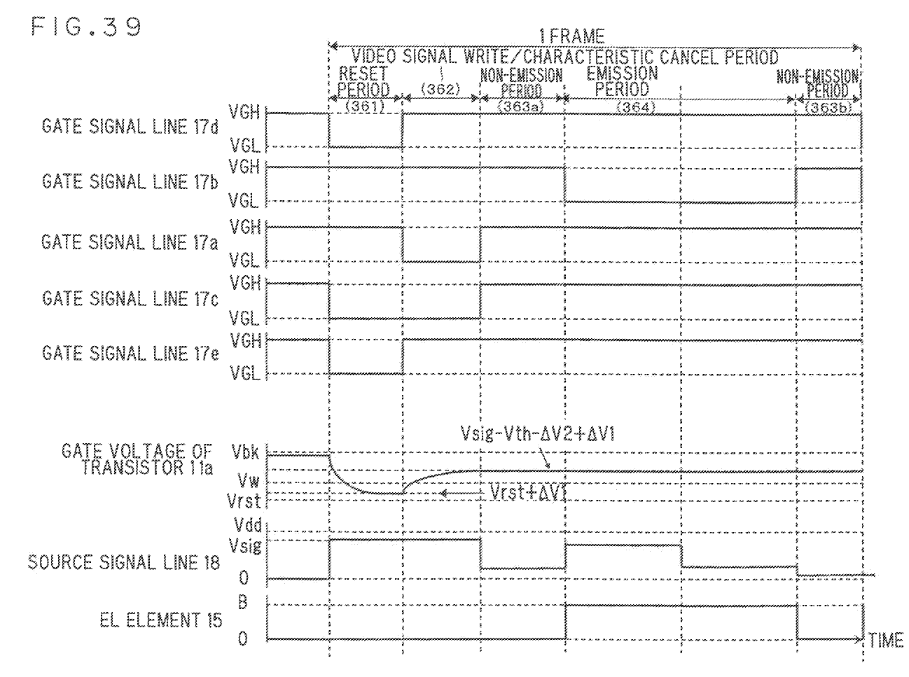

After time 2t (2t to 3t; FIG. 39(b)), the offset cancel state continues, and the offset cancel current Ic2 drops, before it becomes 0 at time t3.

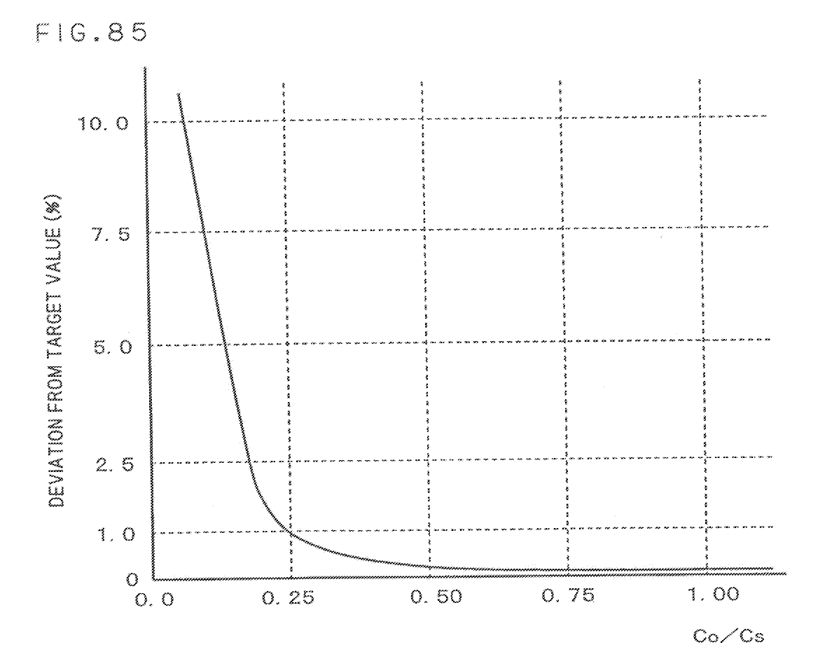

Here, when the capacitance of the maintain capacitor 19a is Cs (pF), and the capacitance of the offset cancel capacitor 19b is Co (pF), the relationship represented in FIG. 85 can be established.

In FIG. 85, the horizontal axis indicates the ratio (Co/Cs) between the capacitance Co (pF) of the offset cancel capacitor 19b and the capacitance Cs (pF) of the maintain capacitor 19a. The vertical axis indicates deviations from an ideal offset cancel state. The deviations are expressed as the voltage difference, in percent, from the ideal gate terminal voltage of the drive transistor 19a. For example, when the gate terminal voltage of the drive transistor 11a in a completely offset cancel state is 1.0 V, 10% error (deviation) means 1.0 (V)·(1−0.1)=0.9 (V). 2% error means 1.0 (V)·(1−0.02)=0.98 (V). The error from the target value is large (2% or more) in a Co/Cs range below 0.5. Accordingly, the offset cancel state is poor. As the value of Co/Cs decreases, the error from the target value abruptly increases.

The error from the target value is small (2% or less) in a Co/Cs range of 0.5 and above. Further, the drop rate of deviation from the target value remains small even with increasing Co values. To increase Co, the capacitance of the offset cancel capacitor needs to be increased. However, it is usually difficult to increase the capacitance of the capacitor because of pixel configuration limitations (the pixels cannot have a large capacitor in a high-definition panel). Yet, the maintain capacitor 19a must maintain charge for at least one frame period (or one field period; as used herein, one frame period is regarded as being the same as one field period). This calls for a capacitor with a relatively large, constant capacitance.

Considering this, Co/Cs is set to be at least 0.25. That is, the capacitor Co is formed so that Co:Cs=1:4 or more. Further, from the standpoint of the Cs size or the fraction of Cs with respect to Co, it is preferable Co/Cs=1.0 or less. That is, the capacitor Co is formed so that Co:Cs=1:1 or less.

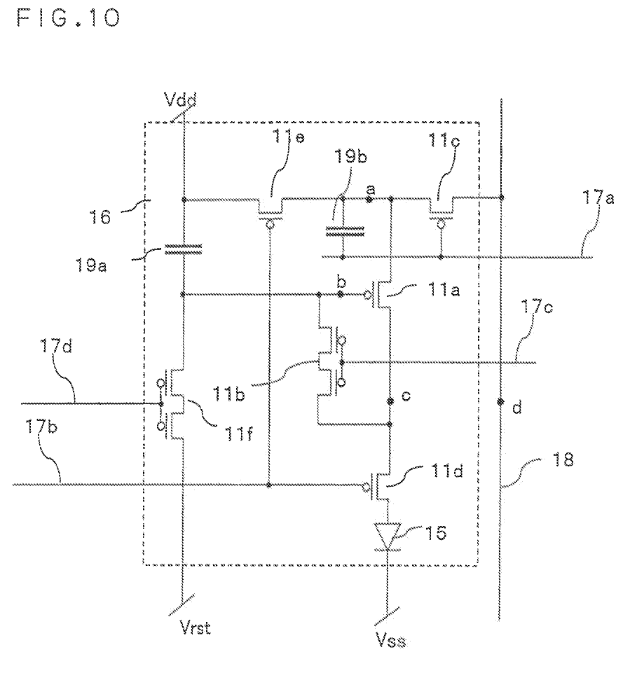

FIG. 10 is a modification example of FIG. 1. One terminal of the offset canceling capacitor 19a is connected to the gate signal line 17a. The gate signal line 17a, to which ON voltage (VGL) or OFF voltage (VGH) is applied, receives OFF voltage (VGH) during the time period other than after the video signal voltage has been written into the pixel 16 (after the voltage program period). Thus, the offset canceling capacitor 19a maintains a constant charge and is stable. The other structure is the same as that described in FIG. 1, and will not be described.

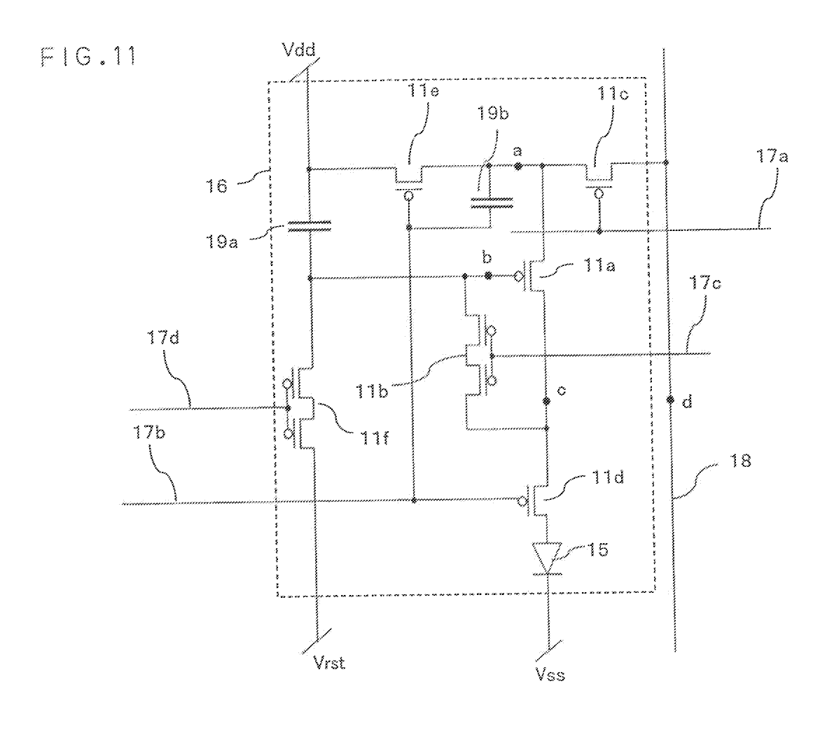

Note that, in FIG. 10, one terminal of the offset canceling capacitor 19a is connected to the gate signal line 17b. However, the embodiment is not limited to this. For example, as shown in FIG. 11, it can be connected to the gate signal line 17d. In the structure of FIG. 11, ON voltage (VGL) is applied to the gate signal line 17d only when reset voltage Vrst is applied. OFF voltage (VGH) is applied in the other periods. OFF voltage (VGH) is applied in the other periods. This enables the offset canceling capacitor 19a to maintain a constant charge, thereby stably maintaining the offset canceling capacitor 19a.

FIG. 11 is a modification example of FIG. 1. One terminal of the offset canceling capacitor 19a is connected to the gate signal line 17b. ON voltage (VGL) or OFF voltage (VGH) is applied to the gate signal line 17b. The gate signal line 17b receives OFF voltage (VGH) during the time period in which the video signal voltage is written into the pixel 16 (during the voltage program period). This enables the offset canceling capacitor 19a to maintain a constant charge, thereby stably maintaining the offset canceling capacitor 19a.

The following will describe the gate driver circuit 12 of the EL display device.

As illustrated in FIG. 3, the gate driver circuits 12a and 12b are provided on the left and right ends of the display screen 31, respectively. The gate driver circuit 12 may be provided in any vacant space of the display panel.

The gate driver circuits 12a and 12b control the gate signal lines 17a and 17b, respectively. The gate driver circuits 12a and 12b receive the ON voltage (VGL) and OFF voltage (VGH) of the gate signal lines 17. The OFF voltage (VGH) is a voltage equal to or greater than anode voltage Vdd, or in the vicinity of anode voltage Vdd. The ON voltage (VGL) is a voltage in the vicinity of cathode voltage Vss or ground voltage (GND). Note that the term “voltage in the vicinity of” means a voltage range of 3 V.

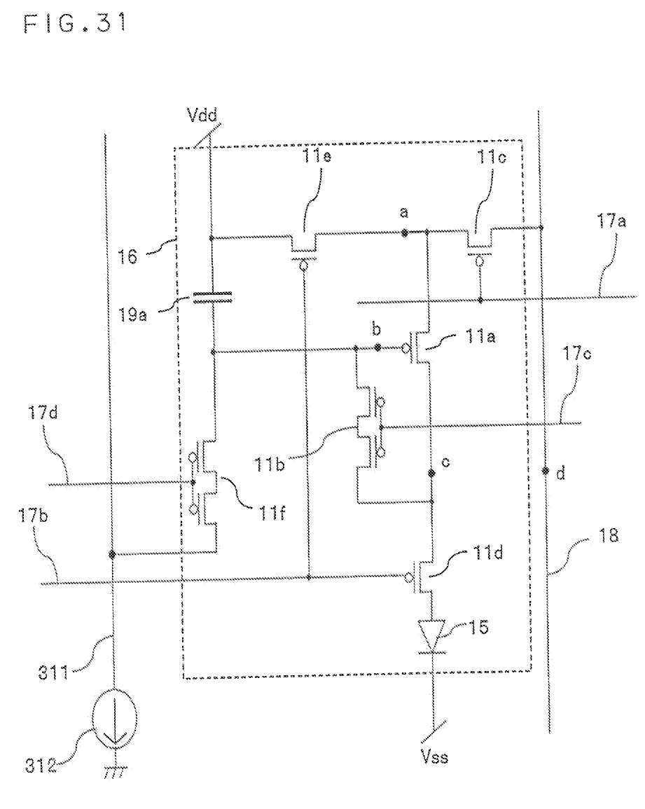

In the present embodiment, the OFF voltage and the ON voltage of the transistor 31 are VGH and VGL, respectively. However, the embodiment is not limited to this. The polarity of the ON voltage (VGL) and OFF voltage (VGH) is set according to the type of the channel (P-channel or N-channel) of the drive transistor 31a. Further, as illustrated in FIG. 31, one or more voltages of the gate driver circuit 12 may be GND voltage. In FIG. 31, the gate driver circuit 12b operates on VGH voltage, and VGL=GND voltage. The gate driver circuit 12a operates on VGH voltage and VGL1 voltage.

In this embodiment, the drive transistor 31a is a P-channel transistor. In this case, the ON voltage is VGL, and the OFF voltage is VGH. When the drive transistor 31a is an N-channel transistor, the ON voltage is VGH, and the OFF voltage is VGL. Note that, in line with FIG. 2, the voltages VGH1, VGH2, VGL1, and VGL2 may be installed. The analog voltage AVdd of the source driver circuit 14, and the voltages VGH1, VGH2, VGL1, and VGL2 of the gate driver circuit 12 are simultaneously activated by the ON1 command from a power supply (circuit) IC driving the EL display device, and the anode voltage Vdd and the cathode voltage Vss are activated by ON2.

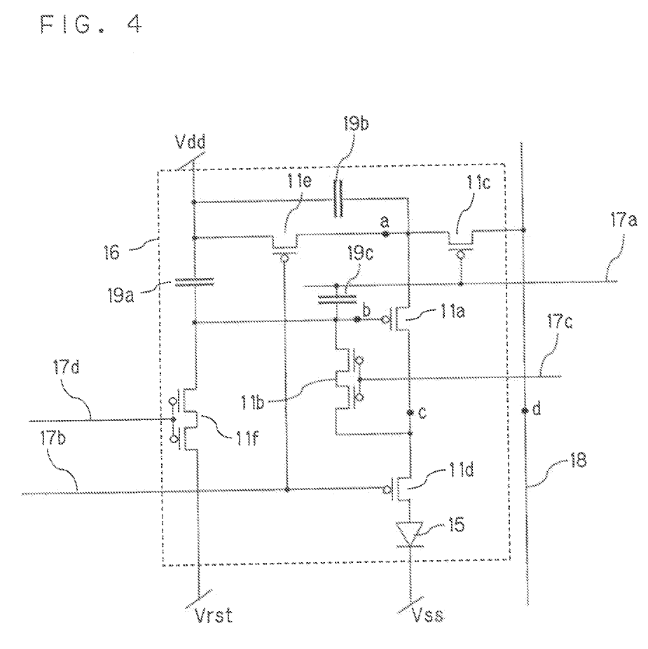

FIG. 4 is a modification example of FIG. 1. FIG. 4 differs from FIG. 1 in that it additionally includes a capacitor 11c. The provision of the capacitor 11c is intended, in part, to realize a desirable black display (high contrast display) with a punch-through voltage which generates as a result of a change in the voltage (VGL→VGH) applied to the gate signal line 17a. The operation involving VGL→VGH is the writing and maintaining of a video signal in the pixel 16, i.e., a control operation of the switch transistor 11c.

The capacitor 19c includes a first electrode connected to a current gate signal line 17a, and to the gate terminal of the transistor 11c. A second electrode of the capacitor 19c is commonly connected to the maintain capacitor 19a, and to the gate terminal of the drive transistor 11a.

Note that, when the drive transistor 11a is an N-channel transistor, the pixels 16 are configured so that the voltage applied to the gate signal line 17a (the voltage used in the operation in which a video signal is written into the pixels and maintained) changes from VGL to VGH.

When the OFF voltage and ON voltage applied to the gate signal line are VGH and VGL, respectively, a change in the voltage (VGL→VGH) applied to the gate signal line 17a increases the gate voltage of the drive transistor 11a by the amount of the correction voltage due to the coupling of the maintain capacitor 19a and the auxiliary capacitor 19c. This shifts the gate terminal voltage of the drive transistor 11a toward the anode voltage Vdd, thereby realizing a desirable black display.

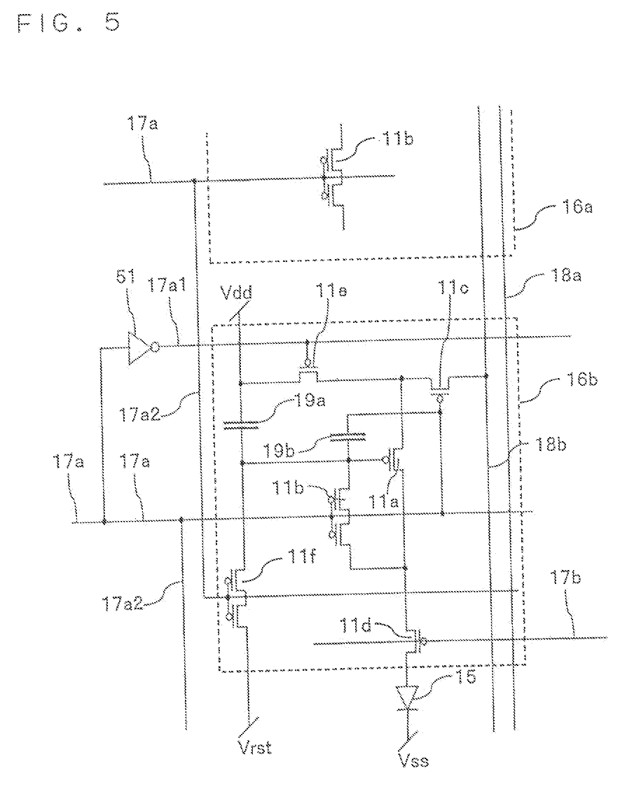

FIG. 5 is a modification example of FIG. 1 or FIG. 4. The structure of FIG. 5 is also usable in the EL display device of this embodiment. In FIG. 5, the pixel 16 includes two capacitors 19a and 19b, five switch transistors (11b, 11c, 11d, 11e, 11f), and a single drive transistor 11a. The transistor 11b is a threshold voltage compensating switch transistor, by which the transistor 11a is diode-connected to compensate for a threshold voltage. The transistor 11f is an initializing switch transistor, by which the reset voltage Vrst is applied to initialize the maintain capacitor 19a. The transistor 11d is provided to control emission of the EL element 15.

The switch transistor 11c is ON/OFF controlled by a select signal from the gate driver circuit 12a, with its gate terminal connected to the gate signal line 17a, and the source terminal to the source signal line 18.

The gate signal line 17a branches into a gate signal line 17a1 and a gate signal line 17a2. The gate signal line 17a1 is provided with an inverter circuit 51. Thus, the voltage (VGH or VGL) applied to the gate signal line 17a1 is the inverted voltage of the voltage (VGL or VGH) applied to the gate signal line 17a2.

The source signal line 18 includes a source signal line 18a and a source signal line 18b. Vertically adjacent pixels 16 (16a, 16b) are connected to different source signal lines 18. In the embodiment of FIG. 5, the pixel 16b is connected to the source signal line 18b, and the pixel 16a is connected to the source signal line 18a.

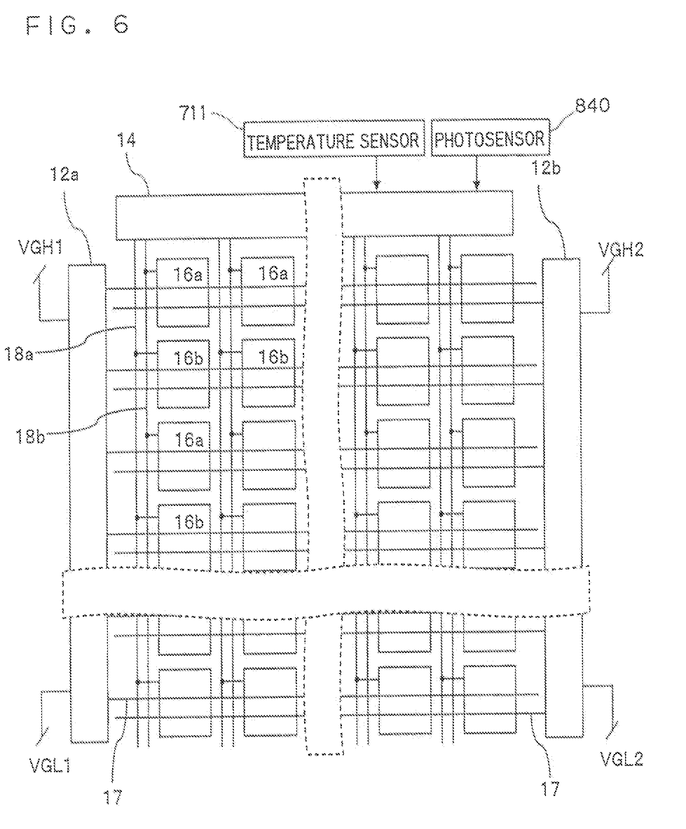

FIG. 6 illustrates how the gate signal lines 17 and the source signal lines 18 are connected to each other in the pixel configuration of FIG. 5. With the structures shown in FIG. 5 and FIG. 6, the gate signal line can be commonly used for the control of the switch transistor 11f used to apply the reset voltage Vrst, and for the control of the switch transistor 11c used to apply the video signal. This reduces the number of gate signal lines 17, and therefore increases the numerical aperture of the pixels 16.

Further, because more than one pixel row can assume the offset cancel state at the same time, a desirable offset cancel can be realized.

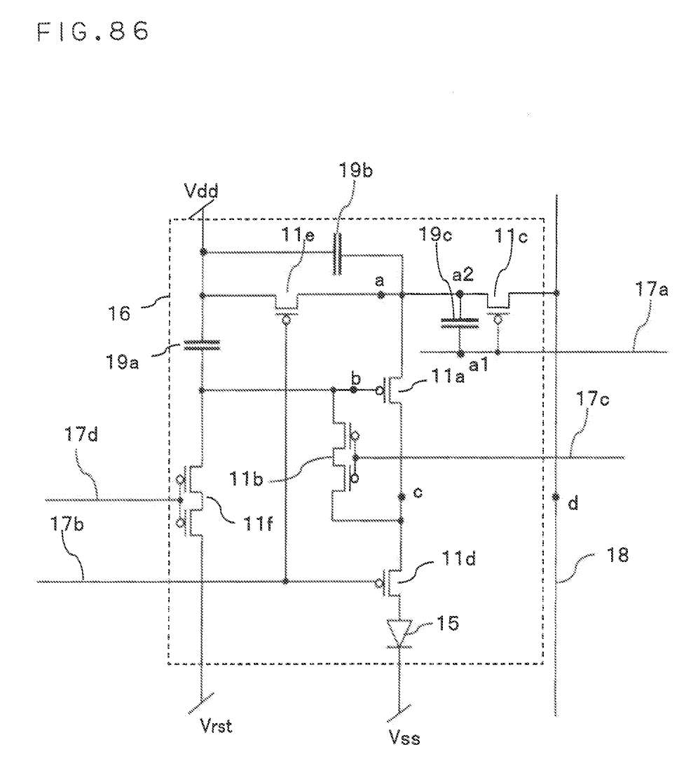

FIG. 86 illustrates a structure that includes a capacitor 11c in addition to the offset cancel capacitor 19b provided in the structure of FIG. 1. In FIG. 86, the capacitor 19c is connected to the gate terminal (gate signal line 17a) of the switch transistor 11c, and to one of the terminals of the capacitor 19b (the drain terminal of the switch transistor 11c).

The terminal potential of the capacitor 19c varies according to changes in voltage of the gate signal line 17a. The gate signal line 17a receives ON voltage (VGL) when the pixel 16 is selected, and OFF voltage (VGH) when the pixel 16 is not selected. That is, the voltage a1 of the capacitor 19c changes from VGL to VGH in response to a change in the state of the pixel 16 from select to non-select. Accordingly, changes in voltage a1 affects changes in voltage a2. Voltage a2 is the voltage produced by dividing a change in voltage a1 with the capacitor 19c and the capacitor 19c. At point a (voltage a2), a video signal voltage Vsig is applied when the pixel is selected. As the voltage a2 varies from VGL to VGH, the voltage (VGH−VGL) is divided and superimposed on the video signal voltage Vsig. Thus, the potential at point a is higher than the video signal voltage Vsig.

With the potential at point a2 higher than video signal voltage Vsig, the offset cancel operation represented in FIG. 111(c) can have a desirable state. The capacitance of the offset cancel capacitor 19b is usually small. Thus, when the offset cancel current Ic2 is large, the terminal potential of the offset cancel capacitor 19b drops abruptly, making it difficult to continue the offset cancel operation.

In the structure of FIG. 86, because a voltage higher than video signal voltage Vsig is maintained at point a, the offset cancel voltage can be increased, and a desirable offset cancel operation can be realized.

The operation, function, effect, and other characteristics of the offset cancel capacitor 19b in the structure of FIG. 86 were described in conjunction with FIG. 1, and will not be described further.

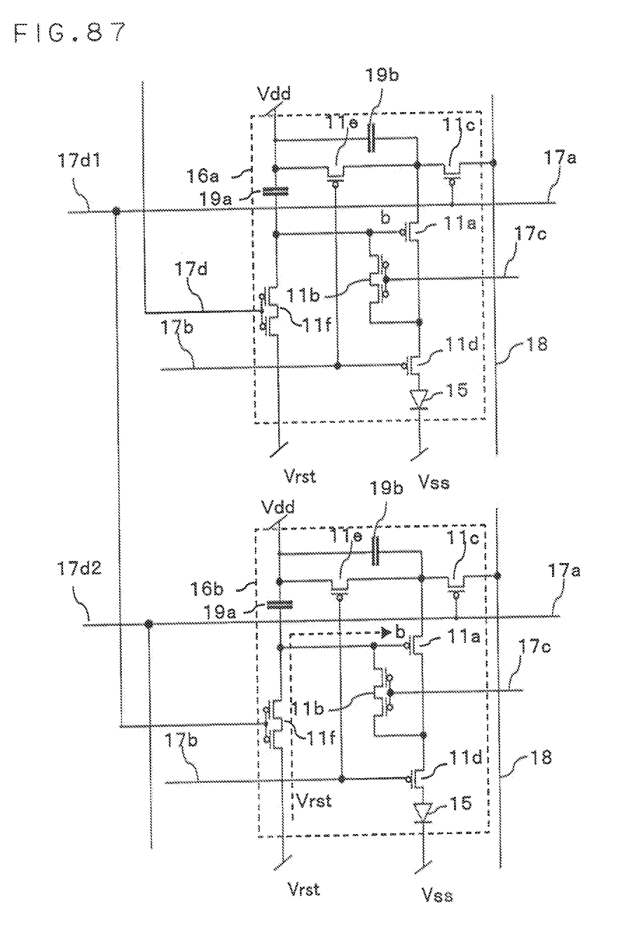

FIG. 87 is a modification example of FIG. 1. In FIG. 87, a gate signal line 17d1 that turns on/off the switch transistor 11c of the pixel 16a is commonly connected to a gate signal line 17d1 that turns on/off the switch transistor 11f of the pixel 16b of the next stage.

Thus, application of ON voltage to the gate signal line 17d1 turns on the switch transistor 11f that applies the reset voltage Vrst, and the reset voltage Vrst is applied to the drive transistor 11a of the pixel 16b. Simultaneously, the switch transistor 11c of the pixel 16a of the preceding stage is turned on, and the video signal voltage Vsig is written into the pixel 16a to start offset cancel operation. After 1H, the pixel 16a operates as in FIG. 111(c).

That is, by sequentially selecting the gate signal lines 17d, the application of the reset voltage Vrst, and the application of the video signal voltage Vsig to the other pixel rows (generally, the preceding pixel row) can be realized at the same time. This simplifies the structure of the gate driver circuits 12, making it possible to realize an EL display device having a narrow frame.

In FIG. 87, the gate signal line 17d of each pixel row is connected to the gate signal line 17d of the preceding pixel row. However, the embodiment is not limited to this. For example, the gate signal line 17d may be connected to a plurality of preceding or following pixel rows.

In the structure of FIG. 87, the gate signal lines 17d of multiple pixel rows are commonly connected, and the pixel row connected to the gate signal line 17d is commonly connected to the pixel row of the preceding or following stage. The other structure and operation are as in, for example, FIG. 1, and will not be described. The foregoing is also applicable to the other embodiments of this specification.

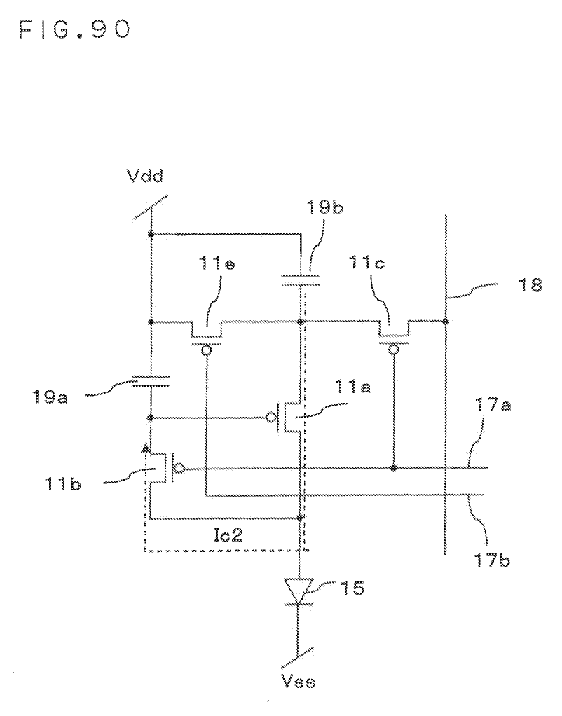

FIG. 90 is another embodiment: of the present invention. FIG. 90 differs from FIG. 1 in that the switch transistor 11d and the switch transistor 11f are not provided. The other structure is as in FIG. 1. As in this case, the technical idea of the present embodiment is applicable to a wide variety of pixel configurations.

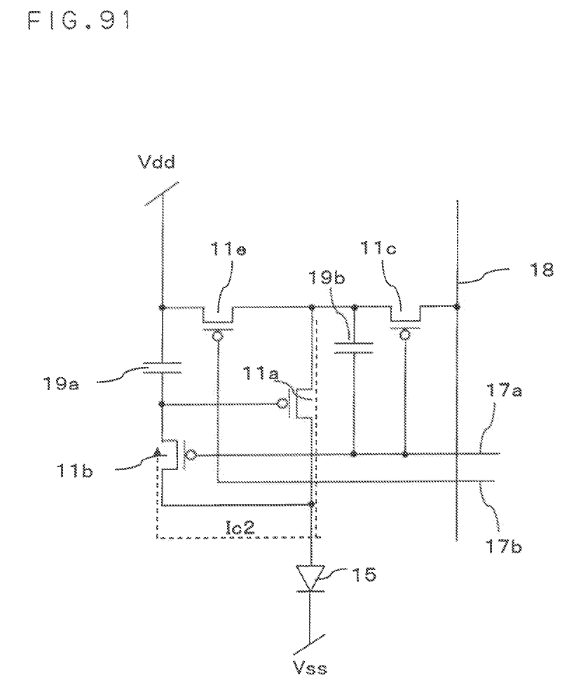

FIG. 91 illustrates another embodiment in which the capacitor 19b is connected differently from the embodiment of FIG. 90. In FIG. 91, one terminal of the capacitor 19b is connected to the drain terminal of the switch transistor 11c, and the other terminal is connected to the gate signal line 17a. The potential of the gate signal line 17a is at the OFF voltage (VGH) except when the pixel 16 is selected. That is, the potential is stably maintained except when the pixel 16 is selected, and the video signal voltage Vsig can be desirably maintained. The other structure and operation are as in FIG. 1 and FIG. 90, and will not be described.

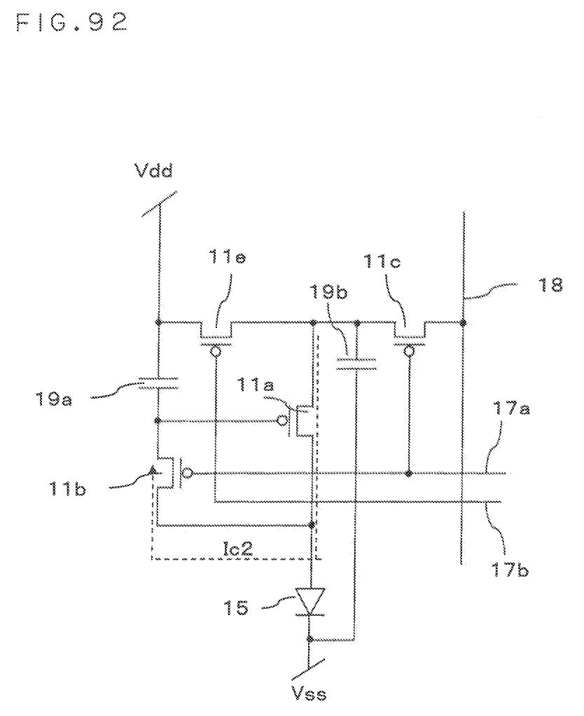

In the structure of, for example, FIG. 1, one of the terminals of the capacitor 19b is connected to anode voltage Vdd. However, the present embodiment is not limited to this. Any potential can be used as long as it can be stably maintained for a predetermined period. In the embodiment of FIG. 92, one terminal of the capacitor 19b is connected so that it has cathode voltage Vss. The other structure and operation are as in FIG. 1 and FIG. 90, and will not be described.

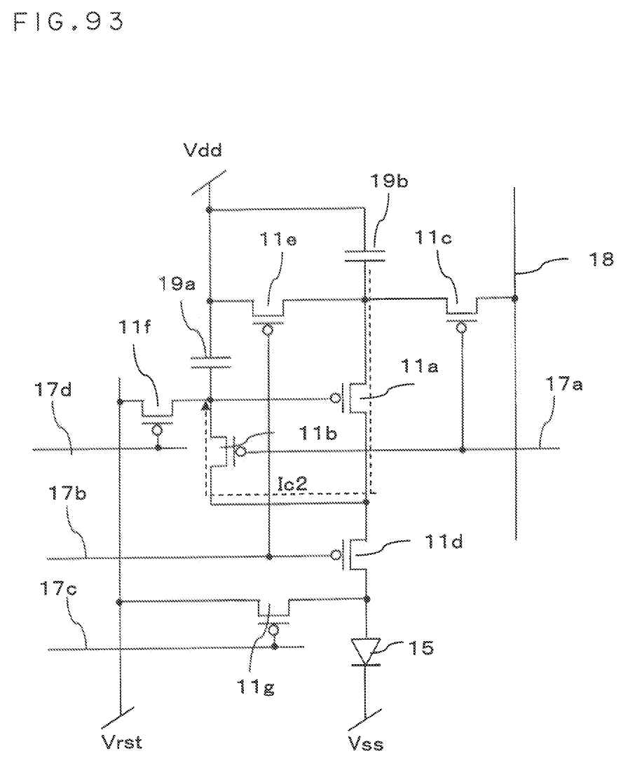

In the structure of FIG. 93, L switch transistor 11g is additionally provided in the structure of FIG. 1. The gate terminal of the switch transistor 11g is connected to a gate signal line 17g. Thus, by applying the ON voltage (VGL) to the gate signal line 17c, the reset voltage Vrst can be applied to the anode terminal of the EL element 15. The other structure and operation are as in FIG. 1 and FIG. 90, and will not be described.

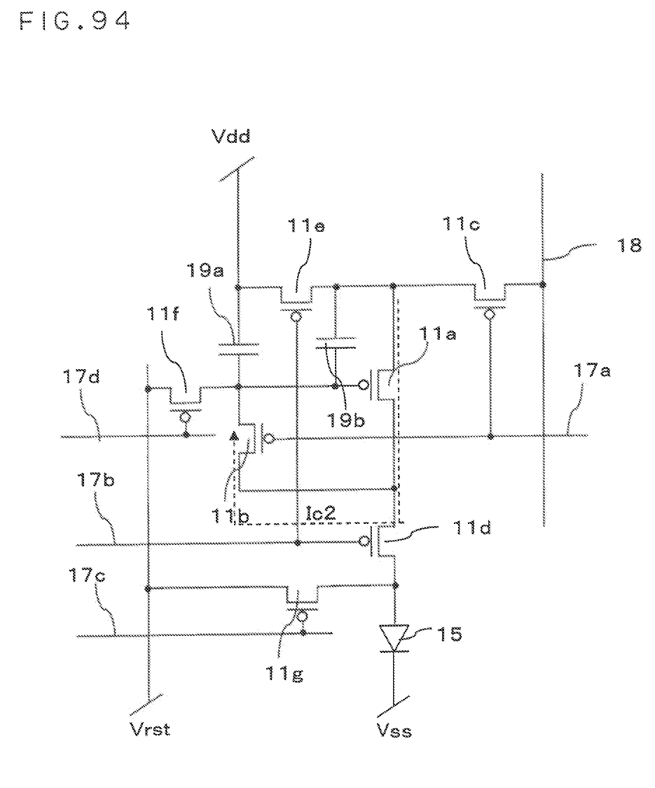

In the structure of FIG. 94, the capacitor 19b is connected differently from that shown in FIG. 93. One terminal of the capacitor 19b is connected to the drain terminal of the switch transistor 11c, and the other terminal is connected to the gate terminal of the drive transistor 11a. The gate terminal of the drive transistor 11a receives an offset voltage or video signal voltage Vsig, and the potential is maintained for one frame period. Thus, the potential can be used as the maintain voltage of the capacitor 19b. The other structure and operation are as in FIG. 1 and FIG. 90, and will not be described.

Note that the foregoing is also applicable to the other embodiments and structures of the specification. Further, the foregoing can be combined with the other embodiments and structures described in this specification.

### Second Embodiment

The following will describe the Second Embodiment of the present invention.

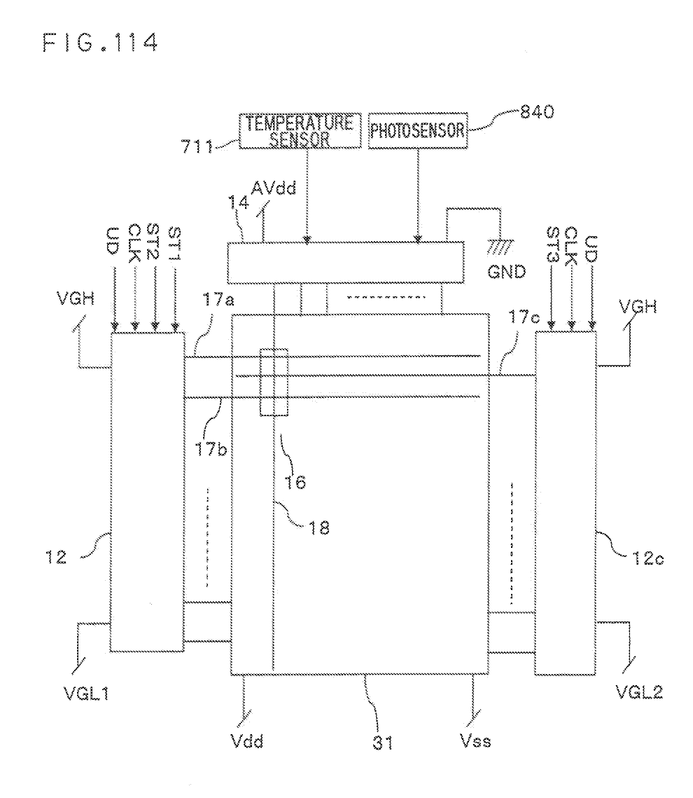

FIG. 114 is a block diagram illustrating the overall structure of an EL display device of the Second Embodiment.

In this embodiment, an EL element 15 includes a display screen 31 provided in a matrix format, and driver circuits that drive the display screen 31. More specifically, as illustrated in FIG. 114, the EL display device includes a source driver circuit (IC) 18, gate terminal gate driver circuits 12 and 12c, and the display screen 31 driven by these driver circuits.

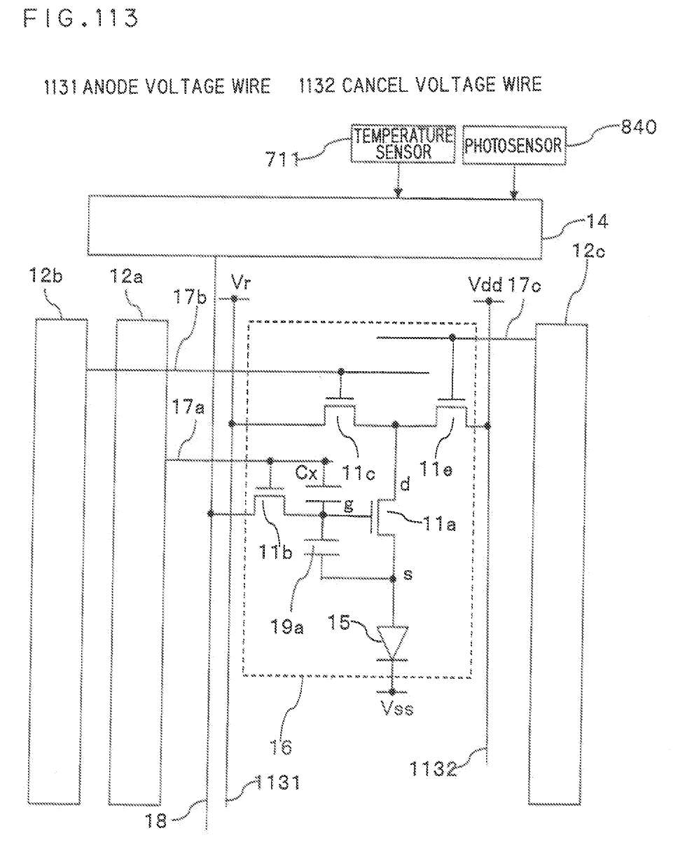

The gate driver circuit 12 shown in FIG. 114 is a combination of the gate driver circuits 12a and 12b of FIG. 113.

The display screen 31 includes row gate signal lines 17, column source signal lines 18, a pixel 16 disposed at each intersection of the gate signal lines 17 and the source signal lines 18, and an anode power wire 1131 corresponding to each column of the pixels 16. In other words, the anode power wire 1131 is formed parallel to the pixel column. A cancel voltage wire 1132, which supplies cancel voltage Vr, is also formed parallel to the pixel column, i.e., parallel to the source signal lines 18.

FIG. 113 is a circuit diagram depicting a specific structure and interconnections of the pixels 16 provided in the EL display device of FIG. 114

As illustrated in FIG. 113, each pixel 16 includes an EL element 15, switch transistors 11b, 11c, 11e, a drive transistor 11a, and a capacitor 19a.

The gate terminal d of the switch transistor 11b is connected to the gate signal line 17a, the drain terminal d to the source signal line 18, and the source terminal to the gate terminal g of the drive transistor 11a.

The drain terminal d of the drive transistor 11a is connected to the anode power wire 1131, and the source terminal s to the anode terminal of the EL element 15.

The cathode of the EL element 15 is connected to ground electrode (GND) or cathode electrode (voltage) Vss. Note that the ground electrode and the cathode electrode (voltage) Vss are common to the all pixels 16.

The capacitor 19a is connected between the source terminal s and gate terminal g of the drive transistor 11a.

According to this structure, the switch transistor 11b becomes conductive in response to a control signal supplied through the gate signal line 17, and the signal potential supplied through the source signal line 18 is sampled and maintained in the capacitor 19a.

With the switch transistor 11e turned on, the drive transistor 11a receives current through the anode power supply line 1131, and flows a drive current to the EL element 15 according to the signal potential maintained in the capacitor 19a.

The following describes the gate driver circuit 12. The gate driver circuit 12a supplies a sequential control signal (ON voltage or OFF voltage) to each gate signal line 17a to sequentially scan the pixels 16 line by line.

The gate driver circuit 12b, in synchronism with the line sequential operation (sequential select operation of the pixel rows), controls the transistor 11c that applies cancel voltage Vr to the drain terminal d of the drive transistor 11a. That is, the gate driver circuit 12b sequentially applies ON voltage or OFF voltage to the gate signal line 17b.

In synchronism with the line sequential scan, the gate driver circuit 12c controls the transistor 11e that applies anode voltage Vdd (or cathode voltage Vss) to the drain terminal d of the drive transistor 11a. That is, the gate driver circuit 12c sequentially applies ON voltage or OFF voltage to the gate signal line 17c.

Note that the gate driver circuits 12a, 12b, and 12c are not limited to the three-driver configuration. As illustrated in FIG. 114, the gate driver circuits 12a and 12c may form a single gate driver circuit 12.

Preferably, each gate driver circuit 12 outputs a different voltage (ON voltage or OFF voltage) to the gate signal line 17. In the embodiment of FIG. 114, the gate driver circuit 12 and the gate driver circuit 12c output the same ON voltage (VGH), but different OFF voltages (VGL). (The gate driver circuit 12 outputs VGL1, and the gate driver circuit 12c outputs VGL2.) That is, |VGL1|<|VGL2|. Note that VGL1 and VGL2 are expressed accompanied by absolute value signs because these voltages are negative. Vr<Vdd so that Vr voltage is sufficiently applied to the drive Transistor 11a.

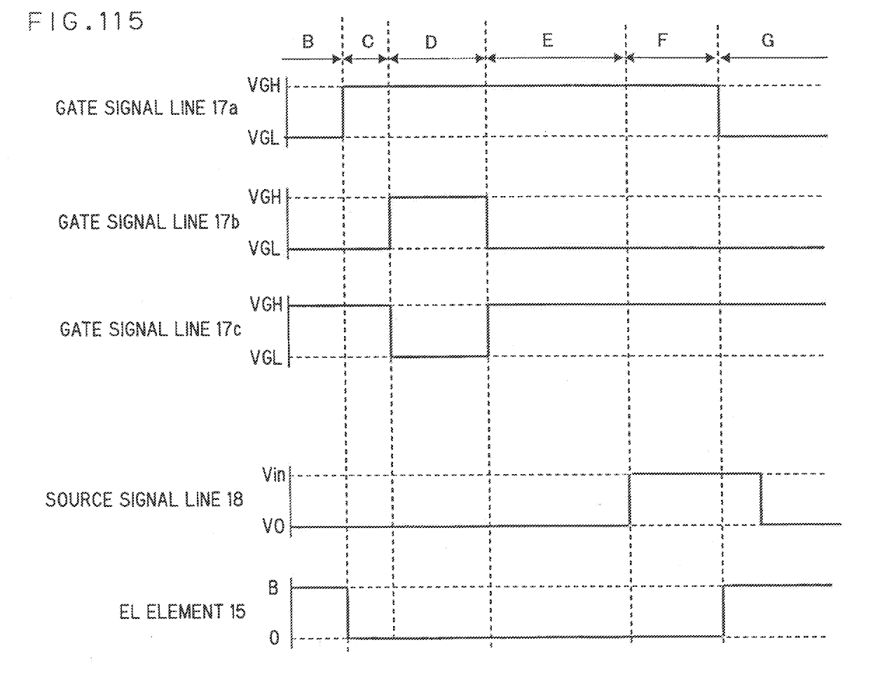

The gate driver circuit 12 receives a start pulse ST1 that selects a gate signal line 17a, a start pulse ST2 that selects a gate signal line 17b, and a clock signal (CLK) that sequentially shifts the start pulses. Signal UD switches the vertical shift register direction of the start pulse in the driver circuit 12. The configuration shown in FIG. 115 is also possible.

The gate driver circuit 12c receives a start pulse ST3 that selects a gate signal line 17c, and a clock signal (CLK) that sequentially shifts the start pulse.

It is preferable that the gate driver circuit 12 additionally include an enable control terminal, as required. The gate driver circuit 12 includes a shift register circuit, which sequentially shifts the start pulse in synchronism with the clock signal (CLK) so as to change the position of the gate signal line 17 to be selected.

The switch between a first potential (cancel voltage) and anode voltage Vdd, which are applied to the drain terminal d of the drive transistor 11a, is made by the switch transistor 11c and the switch transistor 11e. The operations of the switch transistor 11c and the switch transistor 11e are exclusive to each other.

Accordingly, when the switch transistor 11c is ON, the switch transistor 11e is OFF. When the switch transistor 11c is OFF, the switch transistor 11e is ON.

The switch transistor 11c is operated sequentially, whereas the switch transistor 11e generally assumes the ON state when current is supplied to the EL element 15.

By the ON/OFF control of the switch transistor 11e, the duty drive described in FIG. 78, FIG. 79, FIG. 84, and FIG. 98 can be realized. Further, the foregoing may be combined with the driving scheme described in FIG. 99.

The foregoing is analogous to the embodiment of FIG. 1 and other related figures. The description of the First Embodiment explained with reference to FIG. 1 and elsewhere is applicable to the Second and Third Embodiments. It is also possible to combine the embodiments of this specification.

The emission and non-emission of the EL element 15 is performed by the duty drive of the switch transistor 11e. In the duty drive, non-display regions 123 (or display regions 122) are created on the display screen 31 to suppress the current that flows into the EL element 15. The band-like non-display regions 123 are created on the display screen 31 by turning on/off, for example, the switch transistor 11e or 11d, and the non-display regions 123 are scanned from the top to bottom (and vice versa) of the screen 31 in synchronism with a frame cycle (a field cycle).

The source driver circuit 18, which supplies a signal voltage to the source signal lines 18, switches the voltage applied to the drain terminal d of the drive transistor 11a. The switch is made between a first potential (cancel voltage) and a second potential (anode voltage Vdd), so as to maintain a voltage corresponding to the threshold voltage Vth of the drive transistor 11a in the capacitor 19a. This is performed after the switch transistor 11b becomes conductive, and while reference potential V0 is being supplied to the source signal lines 18.

By the threshold voltage correction function, the adverse effect of the characteristic variation of the drive transistor 11a of each pixel 16 can be canceled.

The pixel 16 shown in FIG. 113 has a mobility correction function, in addition to the threshold voltage correction function described above.

After the switch transistor 11b becomes conductive, the source driver circuit 18 switches the applied voltage of the source signal lines 18 from reference potential V0 to signal potential at a first timing. After the first timing, the source driver circuit 18 controls the switch transistors 11c and 11e to cancel the ON voltage of the gate signal line 17a at a second timing, bringing the switch transistor 11b in a non-conducting state. By appropriately setting the time period between the first timing and the second timing, the signal potential maintained in the capacitor 19a is corrected with respect to mobility μ of the drive transistor 11a.

Here, the gate driver circuit can optimize the time period (mobility correction period) between the first timing and the second timing by adjusting a relative phase difference between the video signal supplied by the source driver circuit 18, and the control signal supplied by the gate driver circuit 12b and 12c.

Further, the source driver circuit 18 may cause the video signal undergoing a switch from the reference potential to the signal potential to rise with an angle, so that the mobility correction period between the first timing and the second timing can automatically follow the signal potential.

The pixel 16 shown in FIG. 113 also has a bootstrap function. The gate driver circuits 12b and 12c, with the signal potential maintained in the capacitor 19a, apply OFF voltage to the gate signal line 17b, and ON voltage to the gate signal line 17c, so as to change the potential at the drain terminal d of the drive transistor 11a from Vr to Vdd. Further, the switch transistor 11b is brought into a non-conducting state to electrically separate the gate terminal g of the drive transistor 11a from the source signal line 18. With this operation, the gate potential Vg follows the fluctuations of the source potential Vs of the drive transistor 11a, making it possible to maintain a constant voltage Vgs between the gate terminal g and the source terminal s.

FIG. 115 is a timing chart explaining the operation of the pixel 16 illustrated in FIG. 113. The chart schematically represents changes in potential of the gate signal lines 17a, 17b, and 17c, changes in potential of the source signal line 18, and an emission state of the EL element 15, on a common time axis.

For the sake of explanation, the timing chart incorporates divided periods B to G in line with the changing operation of the pixel 16.

In emission period B, the EL element 15 is in the emission state. This is followed by the line sequential scan in a new field. In the first period C, the switch transistor 11b turns on, and the gate potential Vg of the drive transistor 11a is initialized.

Next, in period D, the switch transistor 11c turns on, applying cancel voltage Vr to the drain terminal d of the drive transistor 11a, and initializing the source potential Vs of the drive transistor 11a. The initialization of the gate potential Vg and the source potential Vs of the drive transistor 11a completes the preparation for the threshold voltage correction operation. The voltage Vr does not turn on the EL element 15 (no current flow), and turns off the drive transistor 11a.

The threshold voltage correction operation is actually carried out in the next threshold correction period E. A voltage corresponding to threshold voltage Vth is maintained between the gate terminal g and the drain terminal d of the drive transistor 11a. In practice, a voltage corresponding to Vth is written into the capacitor 19a connected between the gate terminal g and the drain terminal d of the drive transistor 11a.

Next, in sampling period/mobility correction period F, the signal potential Vin of the video signal is written into the capacitor 19a in such a manner that signal potential Vin is added to Vth, and the mobility correction voltage ΔV is subtracted from the voltage maintained in the capacitor 19a.

In the next emission period G, the EL element 15 emits light at a luminance according to signal voltage Vin. Here, because the signal voltage Vin has been adjusted by the voltage corresponding to threshold voltage Vth, and by the mobility correction voltage ΔV, the emission luminance of the EL element 15 will not be affected by the variation of the threshold voltage Vth or the mobility μ of the drive transistor 11a.

Note that, the bootstrap operation is performed at the beginning of the emission period G, and the gate potential Vg and the source potential Vs of the drive transistor 11a rise, with the gate-source voltage (Vgs=Vin+Vth−ΔV) of the drive transistor 11a maintained constant.

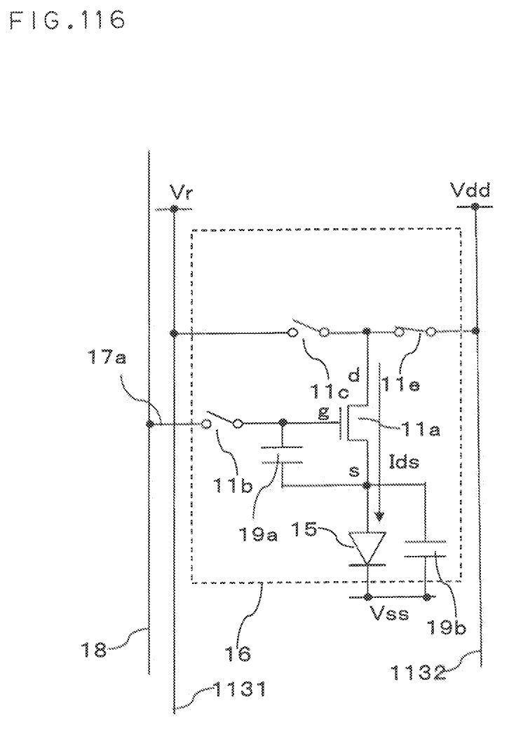

Referring to FIG. 116 to FIG. 121, the following specifically describes the operation of the pixel 16 shown in FIG. 113. Note that FIG. 116 to FIG. 121 respectively correspond to periods B to G of the timing chart shown in FIG. 115. Further, in FIG. 116 to FIG. 121, for ease of understanding and explanation, the capacitor component of the EL element 15 is represented by the capacitor 19b. As illustrated in FIG. 116, in emission period B, the switch transistor 11e is turned on, and the switch transistor 11c is turned off. Accordingly, the potential at the drain terminal d of the drive transistor 11a is the anode voltage Vdd, and the drive transistor 11a supplies drive current Ids to the EL element 15.

As illustrated in the figure, the drive current Ids is supplied to the EL element 15 via the drive transistor 11a held at anode voltage Vdd, and flows into the common ground electrode (GND, etc.) or cathode electrode (voltage) Vss.

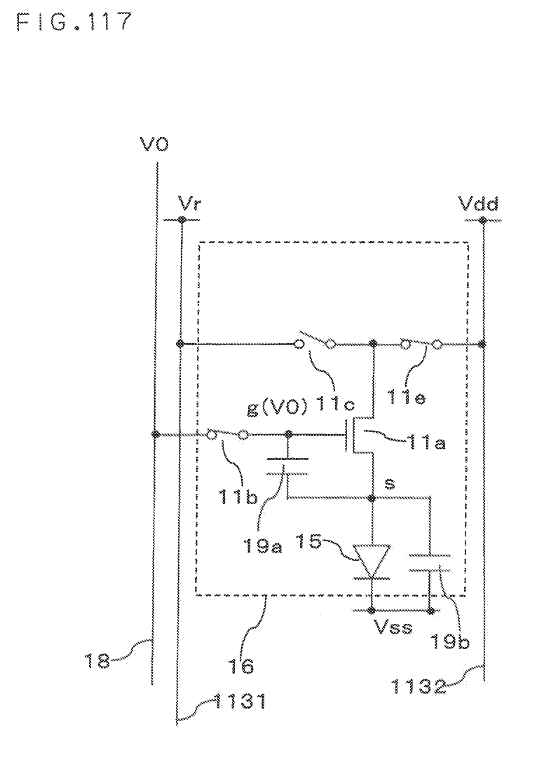

Next, in period C, as illustrated in FIG. 117, the potential of the gate signal line 17a varies toward the anode voltage Vdd (ON voltage is applied). As a result, the switch transistor 11b turns on, and the gate potential Vg of the drive transistor 11a is initialized (reset) to the reference potential V0 of the source signal line 18.

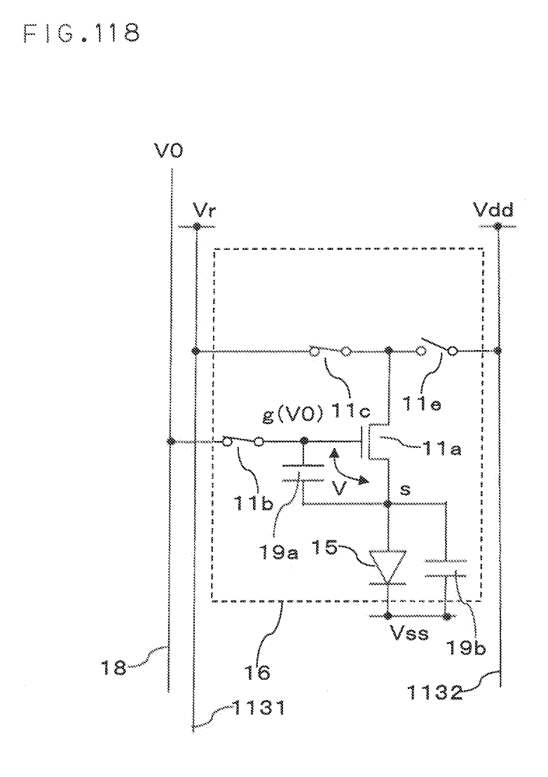

Next, in period D, as illustrated in FIG. 118, the potential at the drain terminal d of the drive transistor 11a varies from anode voltage Vdd to cancel voltage Vr sufficiently smaller than the reference potential V0 of the source signal line 18.

As a result, the source potential Vs of the drive transistor 11a is initialized (reset or canceled) to cancel voltage Vr sufficiently smaller than the reference potential V0 of the source signal line 18.

Specifically, a low cancel voltage Vr is set at the drain terminal d of the drive transistor 11a so that the gate-source voltage Vgs (difference between gate potential Vg and source potential Vs) of the drive transistor 11a becomes larger than the threshold voltage Vth of the drive transistor 11a.

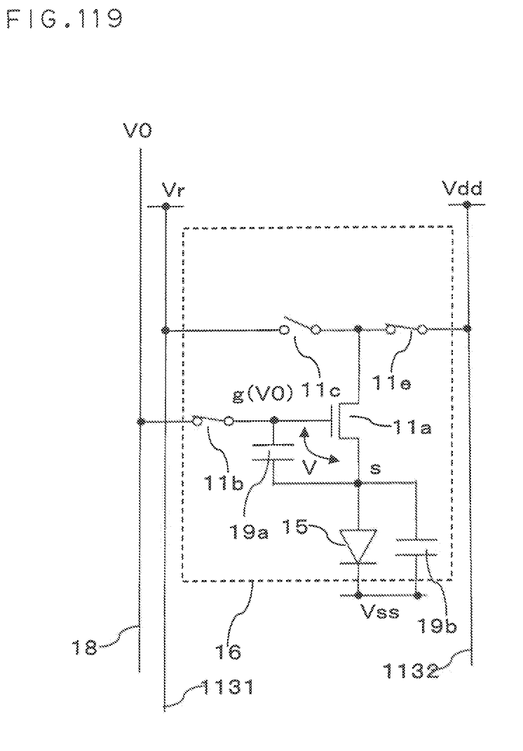

Next, in threshold correction period E, as illustrated in FIG. 119, the potential at the drain terminal d of the drive transistor 11a changes from the low cancel voltage Vr to anode voltage Vdd, and the source potential Vs of the drive transistor 11a starts increasing.

The current is cut off (no current flow) when the voltage Vgs across the gate and source terminals of the drive transistor 11a becomes threshold voltage Vth. In this manner, a voltage corresponding to the threshold voltage Vth of the drive transistor 11a is written into the capacitor 19a. This is the threshold voltage correction operation. Here, in order to ensure that the current mostly flows into the capacitor 19a, and not into the EL element 15, such a potential is set to the common ground electrode or cathode electrode (voltage) Vss that the EL element 15 is cut off.

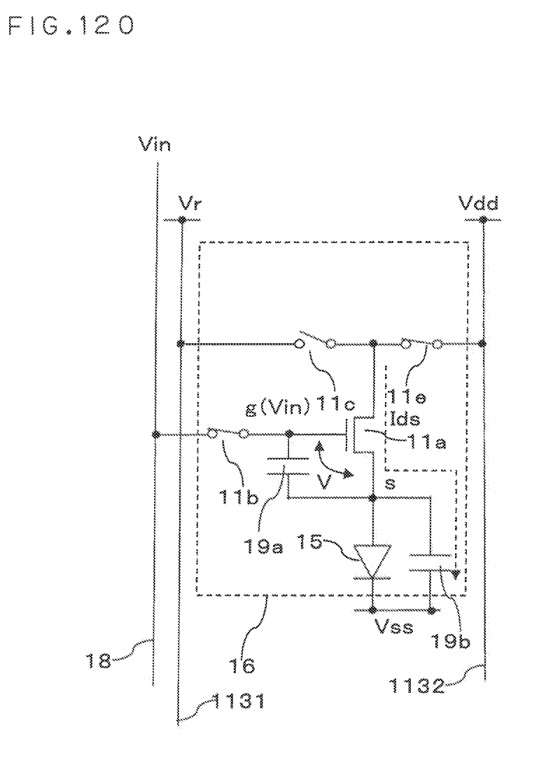

Next, in sampling period/mobility correction period F, as illustrated in FIG. 120, the potential of the source signal line 18 varies from reference potential V0 to signal potential Vin at the first timing, and the gate potential Vg of the drive transistor 11a becomes Vin.

Here, because the EL element 15 is initially in a cut-off state (high impedance state), the drain current Ids of the drive transistor 11a flows into the capacitor 19 (parasitic capacitor 19b) of the EL element 15.

In response, the capacitor 19 (parasitic capacitor 19b) of the EL element 15 starts charging. As a result, the source potential Vs of the drive transistor 11a starts increasing, and the gate-source voltage Vgs of the drive transistor 11a becomes Vin+Vth−ΔV at the second timing. Sampling of signal potential Vin and adjustment of correction amount ΔV are performed in this manner. Ids increases with increase in Vin, with a corresponding increase in the absolute value of ΔV. This enables mobility correction according to the level of emission luminance. Further, when Vin is constant, the absolute value of ΔV increases as the mobility μ of the drive transistor 11a is increased. In other words, because the amount of negative feedback ΔV increases as the mobility μ increases, the variation of the mobility μ of each pixel 16 can be eliminated.

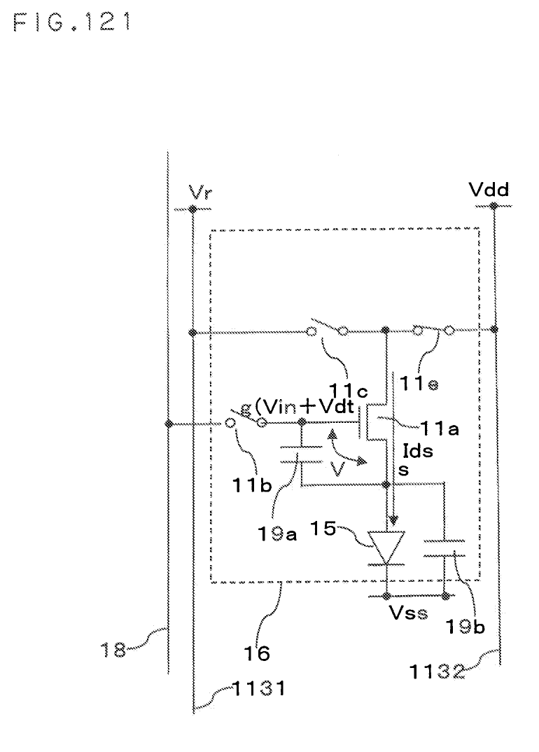

Finally, in emission period G, as illustrated in FIG. 121, the potential of the gate signal line 17 varies toward the low potential side, and the switch transistor 11b is turned off. As a result, the gate terminal g of the drive transistor 11a is separated from the source signal line 18. At the same time, the drain current Ids starts flowing into the EL element 15. In response, the anode potential of the EL element 15 increases according to the drive current Ids.

Increase in the anode potential of the EL element 15 means increase in the source potential Vs of the drive transistor 11a. By the bootstrap operation of the capacitor 19a, the increase in the source potential Vs of the drive transistor 11a is accompanied by an increase in the gate potential Vg of the drive transistor 11a. The gate potential Vg increases by the same increment as the source potential Vs. Accordingly, the gate-source voltage Vgs of the drive transistor 11a is maintained constant at Vin+Vth−ΔV during the emission period.

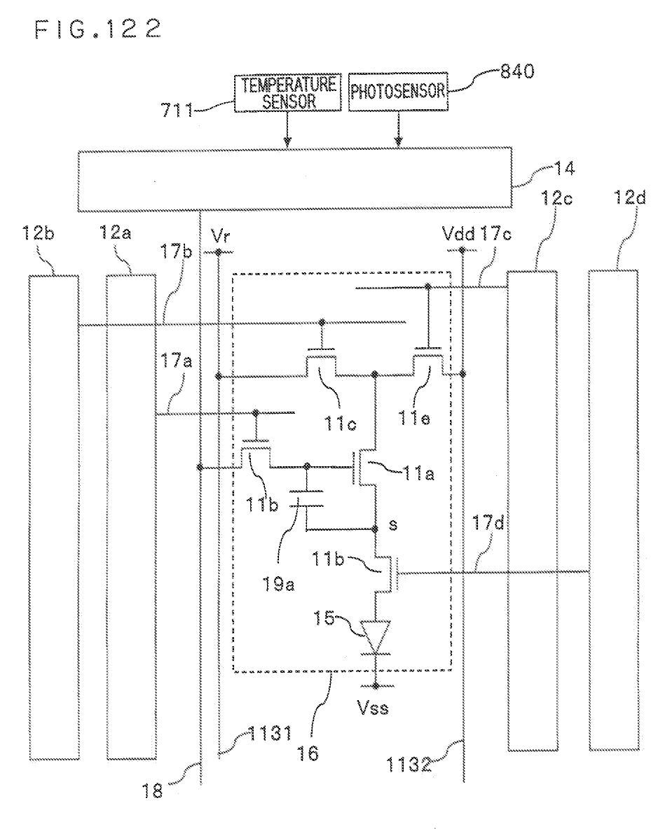

FIG. 122 is a modification example of FIG. 113.

A fourth switch transistor 11d is formed between the anode terminal of the EL element 15 and the drain terminal d of the drive transistor 11a. The switch transistor 11d is connected to the gate signal line 17d, and a gate driver circuit 12d applies ON/OFF voltage to the gate signal line 17d.

As described above in FIG. 120 and elsewhere, the mobility variation of the drive transistor 11a can be corrected. That is, FIG. 120 represents a method in which the switch transistor 11a is turned on for a short period by the switch transistor 11e.

The “short period” is a time period of 0.05 μs or more and 5 μs or less. Preferably, the short period is varied according to the video signal voltage Vsig applied to the pixel. It is also preferable that the short period be varied according to the illumination rate. The change may be linear or nonlinear, or even stepwise (for example, the short period may be 0.1 μs when the illumination rate is 50% or more, and 2 μs when the illumination rate is less than 50%).

As illustrated in FIG. 115, it is preferable to control or vary the duty ratio in correlation with the illumination rate. In this way, the peak current can be suppressed, and the power consumption can be averaged. When the illumination rate is high, the duty ratio is reduced (made smaller). This suppresses the peak current. The maximum usable gradation number control is also performed. These operations will be described with reference to FIG. 78, FIG. 79, FIG. 83, FIG. 84, FIG. 98, FIG. 99, FIG. 130, and elsewhere.

The ON time ratio (in percent; hereinafter, “ON ratio”) for one horizontal scan period (1H) is the period corresponding to FIG. 120. The ON time is the duration in which the switch transistors 11b and 11e are ON (closed time). When 1H is 20 μs, 10% ON time is 2 μs.

The mobility correction effect of the drive transistor 11a is enhanced as the ON ratio increases. However, in this case, discharge occurs in the capacitor 19, which increases the gate terminal potential of the drive transistor 11a (toward the anode voltage), and varies the current that flows into the EL element 15.

In the offset cancel drive, black gradations (low gradations) are offset canceled, and the characteristic variation of the drive transistor 11a is not noticeable. However, in white gradations (high gradations), the characteristic variation of the drive transistor 11a becomes noticeable because of the far distance from the offset cancel point. Mobility accounts for such characteristic variations of the drive transistor 11a.

At low illumination rates, the number of low gradation display pixels is large. At high illumination rates, the number of high gradation display pixels is large. Accordingly, the ON ratio is preferably determined as indicated by the dashed line at the bottom of FIG. 115. Specifically, the ON ratio is 0 at a low illumination rate, and it is increased as the illumination rate increases.

It should be noted here that the large numbers of low gradation display pixels at low illumination rates are statistics, and it may not be the case in actual practice. Similarly, the large numbers of high gradation display pixels at high illumination rates are based on statistics. In actual practice, the number of low and high gradation display pixels varies depending on display patterns, and the type of video signal. It is therefore preferable that the ON ratio be made variable according to display patterns, and the type of input video signal (PC video, AV video, etc.).

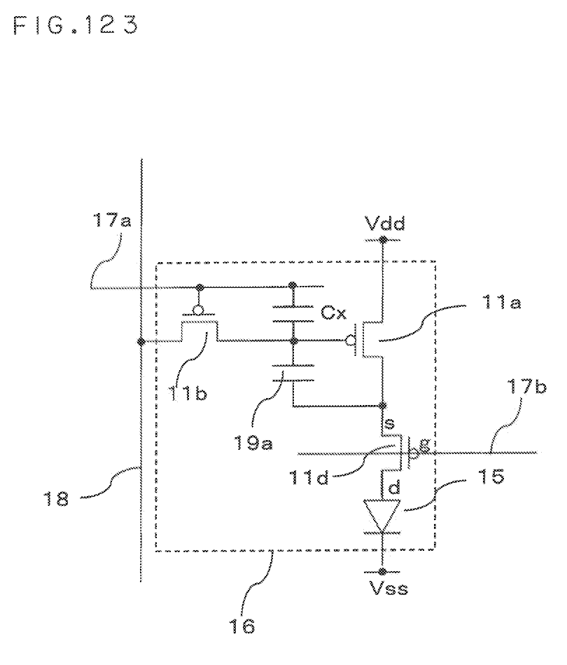

As illustrated in FIG. 113 and FIG. 123, it is also effective to actively form a capacitor Cx between the gate signal line 17a and the gate (G) terminal of the transistor 11a, in order to increase the punch-through voltage. The capacitance of the capacitor Cx is preferably at least 1/10 and at most ½, and more preferably at least ⅛ and at most ⅓ of the regular capacitance of the capacitor 19a.

The capacitance (Cb (pF)) of the capacitor Cx that generates a punch-through voltage is related to the capacitance (Ca (pF)) of the charge maintain capacitor 19a. The capacitance Cb is also related to the terminal voltage Vw (V) at the gate (G) terminal of the transistor 11a under a white peak current (white raster display, the maximum luminance), and to the voltage Vb (V) at the gate (G) terminal of the transistor 11a under a black display current (basically, current=0, black display). Preferably, the following condition is satisfied:

Ca/(200Cb)≦|Vw−Vb|≦Ca/(8Cb)

Note that, |Vw−Vb| is the absolute value of the difference between the white display terminal voltage (V) of the drive transistor, and the black display terminal voltage (V) of the drive transistor (a variable voltage range).

More preferably, the following condition is satisfied:

Ca/(100Cb)≦|Vw−Vb|≦Ca/(10Cb)

The transistor 11b is a P-channel transistor, and the P-channel has at least a double gate structure, preferably at least a triple gate structure, and more preferably at least a quadruple structure. It is also preferable to serially form or dispose capacitors whose capacitance is at least equal to and at most 10 times the source-gate (SD or gate-drain (GD)) capacitance of the transistor 11b (capacitance with the transistor turned on).

The foregoing is effective not only for the pixel configuration of FIG. 113 and FIG. 123, but for the other pixel configurations. The capacitor Cx is disposed in such a manner that it shifts and prevents the current from flowing into the drive transistor 11a when the switch transistor 11b is turned off. The N-channel of the switching transistor 11b has at least a double gate. This is necessary to prevent leaking.

In FIG. 113, the drive transistor 11a is an N-channel transistor, and the switch transistor 11b, which applies a video signal to the pixels, is also an N-channel transistor. The gate signal line 17a controlling the switch transistor 11b receives high voltage (VGH) when the pixel 16 is selected, and low voltage (VGL) when the pixel 16 is non-selected.

When the pixel 16 changes from a select state to a non-select state, a voltage change (VGH to VGL) occurs at one terminal of the capacitor Cx electrically connected to the gate signal line 17a. The voltage change from VGH to VGL in the capacitor Cx is transmitted as a punch-through voltage to the other terminal of the capacitor Cx (the terminal connected to the gate terminal of the drive transistor 11a). That is, a voltage proportional to the change from VGH to VGL is applied to the gate terminal of the drive transistor 11a, and consequently, the gate terminal voltage of the drive transistor 11a drops. As a result, the drive transistor 11a operates so as not to flow current. This further improves the black display level, making it possible to realize desirable contrast.

Similarly, in FIG. 123, the drive transistor 11a is a P-channel transistor, and the switch transistor 11b, which applies a video signal to the pixels, is also a P-channel transistor. That is, the drive transistor 11a and the switch transistor 11b are channel transistors of the same polarity. The gate signal line 17a controlling the switch transistor 11b receives low voltage (VGL) when the pixel 16 is selected, and high voltage (VGH) when the pixel 16 is non-selected.

Thus, when the pixel 16 changes from a select state to a non-select state, a voltage change (VGL to VGH) occurs at one terminal of the capacitor Cx electrically connected to the gate signal line 17a. The voltage change from VGL to VGH in the capacitor Cx is transmitted as a punch-through voltage to the other terminal of the capacitor Cx (the terminal connected to the gate terminal of the drive transistor 11a). That is, a voltage proportional to the change from VGL to VGH is applied to the gate terminal of the drive transistor 11a, and consequently, the gate terminal voltage of the drive transistor 11a shifts towards a high voltage As a result, the drive transistor 11a operates so as not to flow current. This further improves the black display level, making it possible to realize desirable contrast.

It is preferable to vary the size (capacitance) of the punch-through voltage capacitor Cx according to the pixel modulating R, G, and B. This is because the drive current of the EL element 15 differs between R, G, and B, and because the cut off voltage of each EL element 15 is different. Another reason is that the voltage (current) to be programmed at the gate (G) terminal of the drive transistor 11a of the EL element 15 is accordingly different. For example, when the capacitance CxR for R pixel is 0.02 pF, the capacitance for the pixels of the other colors G and B is set to 0.025 pF (CxG=0.025 pF, CxB=0.025 pF). Further, when the capacitance CxR for R pixel is 0.02 pF, the capacitance CxG for G pixel is 0.03 pF, and the capacitance CxB for B pixel is 0.025 pF. By varying the capacitance of the capacitor Cx for the pixels of R, G, B, the offset drive current can be adjusted for each different color of RGB. In this way, the black display level can be optimized for each color of RGB.

The foregoing is also applicable to the other pixel configurations such as in the First Embodiment described in, for example, FIG. 1, and the Third embodiment. It is also possible to combine the embodiments of this specification.

The foregoing described the case where the capacitance of the capacitor Cx that generates a punch-through voltage is varied. However, the punch-through voltage should be understood in terms of the capacitance of the maintain capacitor 19a relative to the capacitance of the capacitor Cx that generates a punch-through voltage. As such, the embodiment is not limited to varying the capacitor Cx for each pixel of R, G, and B. That is, the capacitance of the maintain capacitor 19a may be varied.

For example, when capacitance 11aR of R pixel is 1.0 pF, capacitance 11aG of G pixel and capacitance 11aB of B pixel are 1.2 pF and 0.9 pF, respectively. Here, the capacitance of the punch-through capacitor Cx is common to RGB. That is, in the present embodiment, the capacitance ratio between the maintain capacitor 19a and the punch-through-voltage-generating capacitor Cx for at least one of the RGB pixels is different from the others. Note that, both the capacitance of the maintain capacitor 19a, and the capacitance of the punch-through-voltage-generating capacitor Cx may be varied between the RGB pixels.

Further, the capacitance of the punch-through-voltage capacitor Cx may be varied depending on the position, left or right, of the screen 31.

The foregoing is also applicable to the other pixel configurations, display panels (display devices), and driving methods such as in the First Embodiment described in, for example, FIG. 1, and the Third through Seventh embodiments. It is also possible to combine the embodiments of this specification.

Because the pixel 16 near the gate driver circuit 12 is on the signal supply side, the gate signal rises quickly (high slew rate), and accordingly the punch-through voltage is large. The pixel disposed (formed) at the end of the gate signal line 17 has a dull signal waveform (because the gate signal line 17 has capacitance). Accordingly, the gate signal rises slowly (slow slew rate), and the punch-through voltage is small. For this reason, the punch-through voltage capacitance Cx of the pixel 16 connected closer to the gate driver circuit 12 is reduced, and the capacitance Cx is increased at the end of the gate signal line 17. For example, the capacitor has a capacitance difference of about 10% on the left and right of the screen.

Similarly, the capacitance of the punch-through voltage capacitor Cx may be varied on the top and bottom of the screen 31. This is because the screen 31 has a luminance gradient due to the problem involving the capacitor Ca and the write timing of the video signal. The value of the capacitor Cx is varied along the source signal line 18. For example, the capacitor Cx may have a capacitance difference of about 10% on the top and bottom of the screen.

The generating punch-through voltage is determined by the capacitance ratio between the maintain capacitor 19a and the punch-through-voltage-generating capacitor Cx. Thus, the embodiment, described to vary the size of the punch-through-voltage-generating capacitor Cx on the left and right of the screen, is not limited to this. The punch-through-voltage-generating capacitor Cx may be held constant on the left and right of the screen, and the capacitance of the charge maintain capacitor 19a may be varied on the left and right of the screen. Further, both the capacitance of the punch-through-voltage-generating capacitor Cx, and the capacitance of the charge maintain capacitor 19a may be varied on the left and right of the screen. The same applies to the vertical direction of the screen 31.

In the structure or scheme represented in FIG. 1, the video signal voltage Vsig is maintained in the offset cancel capacitor 19b formed for each pixel. By maintaining the video signal voltage Vsig in the offset cancel capacitor 19b, the offset cancel operation can continue even after the pixel 16 has been selected, and a desirable offset cancel can be realized.

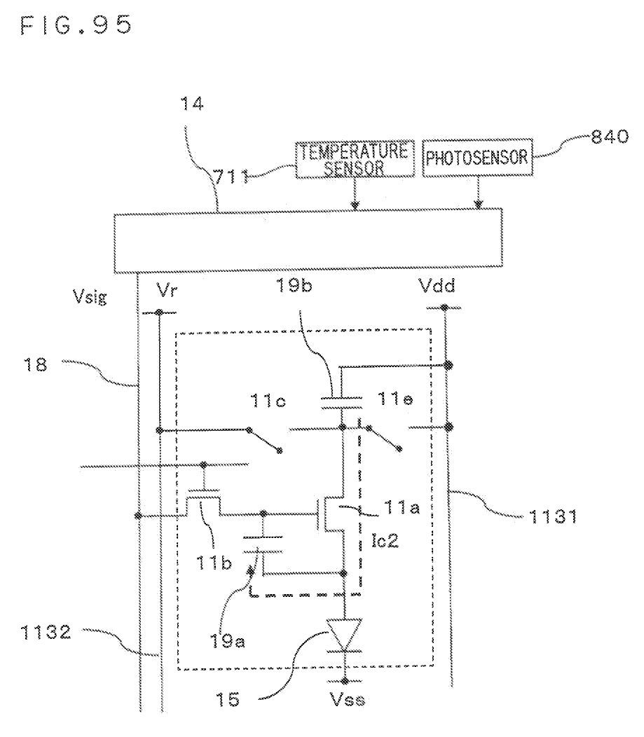

FIG. 95 illustrates a structure in which the capacitor 19b is added to the pixel configuration or the EL display device of the present embodiment represented in FIG. 113, FIG. 123, and elsewhere. The capacitor 19b maintains cancel voltage Vr, not video signal voltage Vsig.

As illustrated in FIG. 118, the cancel voltage Vr is applied for a short time period to the source terminal (or drain terminal) of the drive transistor 11a. However, because of the short apply time, the cancel operation may not be sufficient.

Because the capacitor 19b that maintains cancel voltage Vr is formed in the pixel 16, the cancel operation can continue with the cancel voltage Vr maintained in the capacitor 19b, even after the switch transistor 11c has been turned off. This enables the cancel operation to be performed over a plurality of horizontal scan periods.

As described above, in the present embodiment, predetermined voltages (video signal voltage Vsig, cancel voltage Vr, etc.) are applied to the pixel 16, and these voltages are maintained at the capacitor 19b and used to continue predetermined operations by the maintained voltages (offset cancel operation, cancel operation, etc.), even after the application of the predetermined voltages has been finished. Further, the present embodiment is a configuration or a structure adapted to continue predetermined operations.

Note that, in an embodiment of the present invention, the capacitor 19b that maintains predetermined voltages (video signal voltage Vsig, cancel voltage Vr, etc.) is described as being provided for the pixel 16. However, the embodiment is not limited to this. For example, a diode may be formed in the pixel, and the predetermined voltages may be maintained in the junction capacitor of the diode. Further, a transistor element may be formed in the pixel, and the predetermined voltages may be maintained in the parasitic capacitor (for example, gate capacitor) of the transistor.

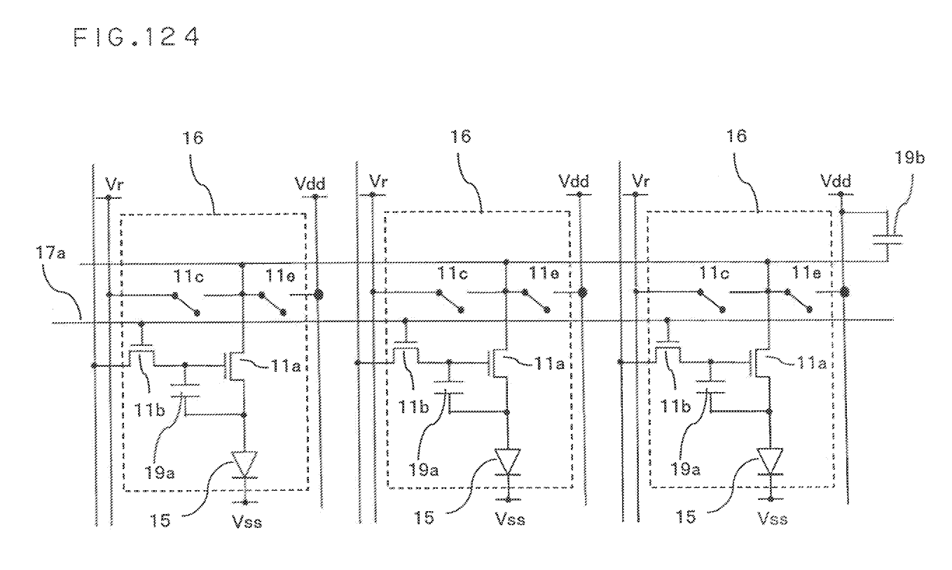

Further, the capacitor 19b that maintains the predetermined voltages (video signal voltage Vsig, cancel voltage Vr, etc.) has been described as being formed in the pixel 16. However, the embodiment is not limited to this. For example, as illustrated in FIG. 124 through FIG. 126, the capacitor 19b may be provided for a group of common pixels 16 (pixel row, pixel column).

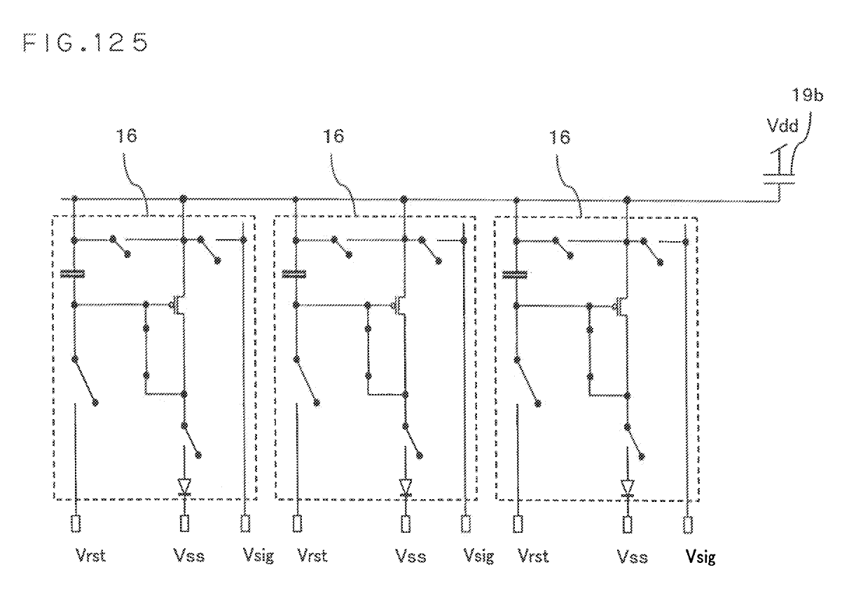

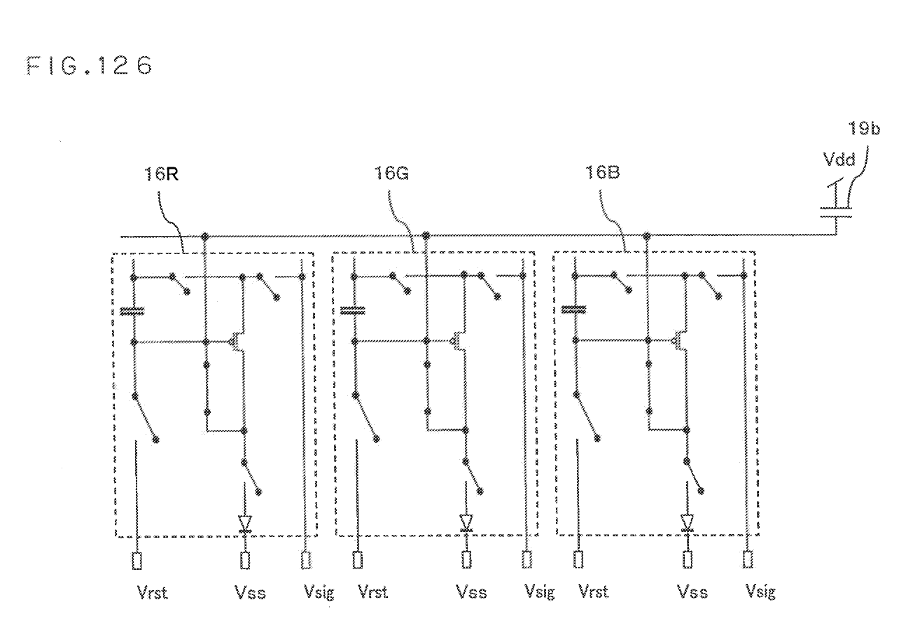

FIG. 124 illustrates a structure in which a single capacitor 19b is provided for a single pixel row, an in which cancel voltage Vr is maintained in the capacitor 19b. FIG. 125 illustrates a structure in which a single capacitor 19b is provided for a single pixel row, and in which video signal voltage Vsig is maintained in the capacitor 19b. This structure is effective when the video signal voltage Vsig is a common signal to a pixel row or a pixel column. FIG. 126 illustrates a structure in which a single capacitor 19b is provided for a single pixel row, and in which reset voltage Vrst is maintained in the capacitor 19b.

In the structures of FIG. 124 through FIG. 126, the switch transistor (11c or 11f) that applies reset voltage Vrst or cancel voltage Vr to each pixel is disposed. However, the embodiment is not limited to this. For example, the switch transistor (11c or 11f) may be provided for a set of RGB pixels. Further, the switch transistor (11c or 11f) may be provided for each pixel row or each pixel column.

When the power circuit (power IC) that generates voltages such as anode voltage Vdd and cathode voltage Vss is externally provided, it is preferable that the ON/OFF signal used for the ON/OFF control of the power circuit (power IC) be generated (instructed) by the source driver IC 14. The anode voltage Vdd and the cathode voltage Vss are applied (supplied) to the panel 34 after the voltages VGH and VGL have been applied (supplied).

The foregoing is also applicable to the other embodiments of this specification.

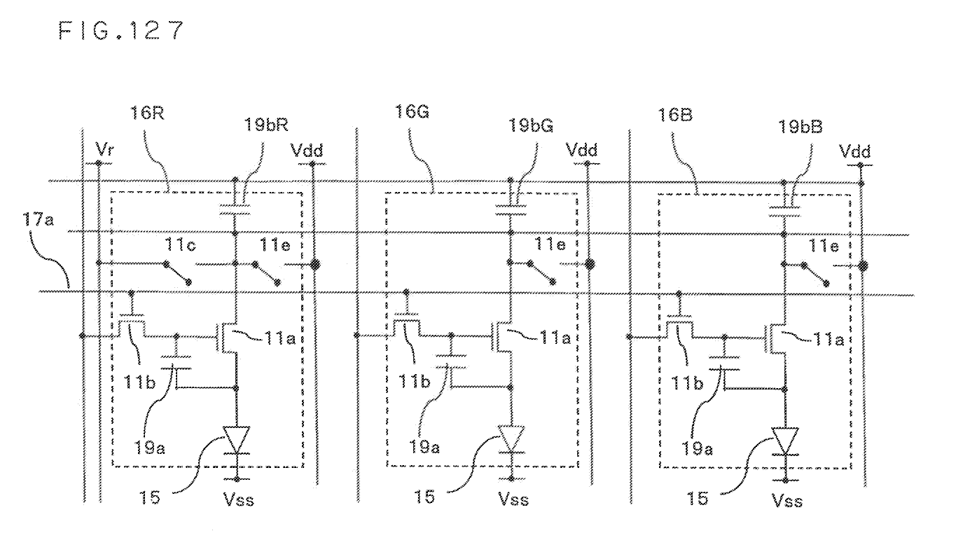

As illustrated in FIG. 127, the interconnection and the switch transistor 11c that apply the cancel voltage Vr may be formed or provided for a plurality of pixels (for example, a set of RGB pixels). Further, the capacitor 19b may be different for each color of R, G, and B. By varying the capacitance of the capacitor 19b between R, G, and B, the operations such as the offset cancel operation, the reset operation, and the cancel operation can be optimized for each different characteristic of RGB.

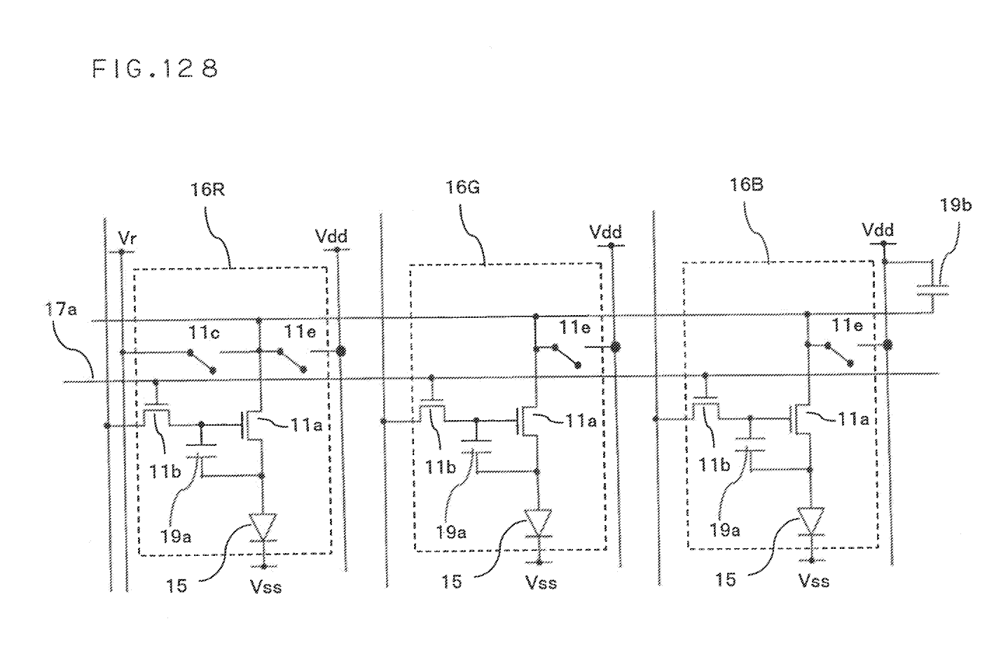

As illustrated in FIG. 128, the interconnection and the switch transistor 11c that apply the cancel voltage Vr, and the capacitor 19b may be formed or provided for a plurality of pixels (for example, a set of RGB pixels). This simplifies the pixel configuration, and increases the numerical aperture of the pixel 16. The foregoing is also applicable to the other embodiments of this specification.

The capacitance of the capacitor 19b may vary at different parts of the display screen 31. For example, the capacitance of the capacitor 19b is varied on the sides (left and right) and the center of the screen. In this way, the operations such as the offset cancel operation, the reset operation, and the cancel operation can be optimized at different parts of the screen. The same applies to the maintain capacitor 19a. The operations such as the write of the video signal voltage Vsig, and the offset cancel operation can be optimized at different parts of the screen.

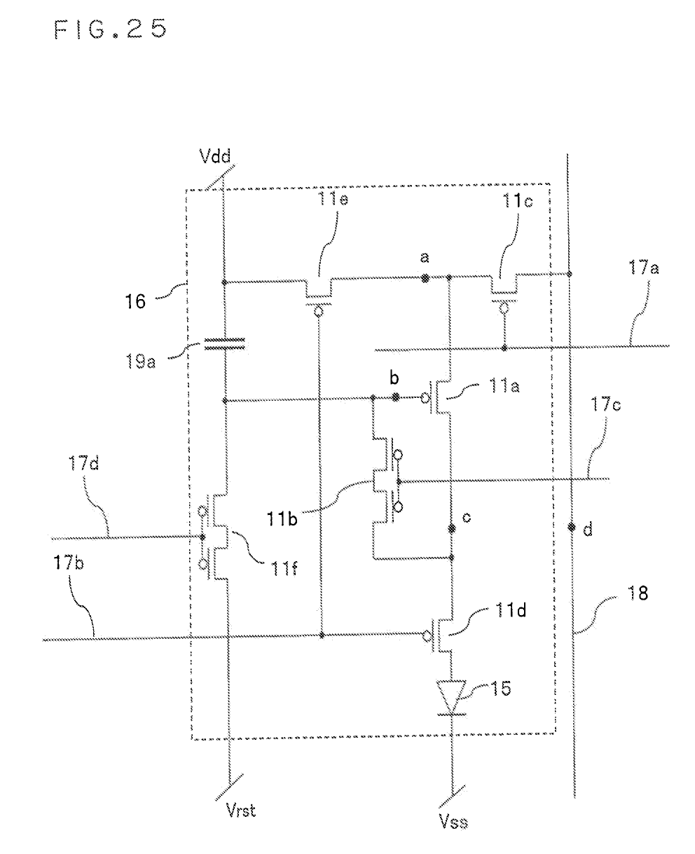

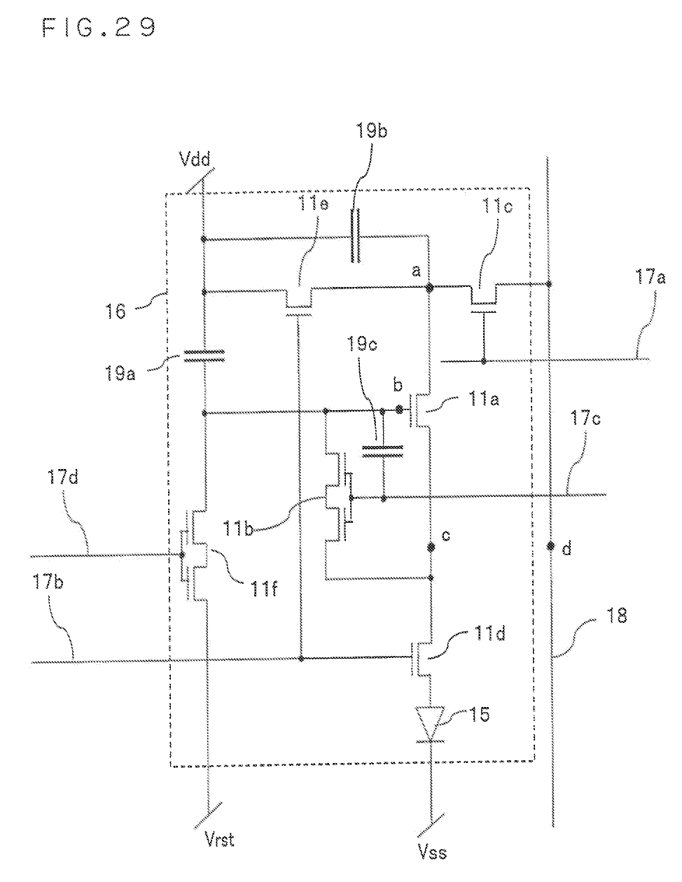

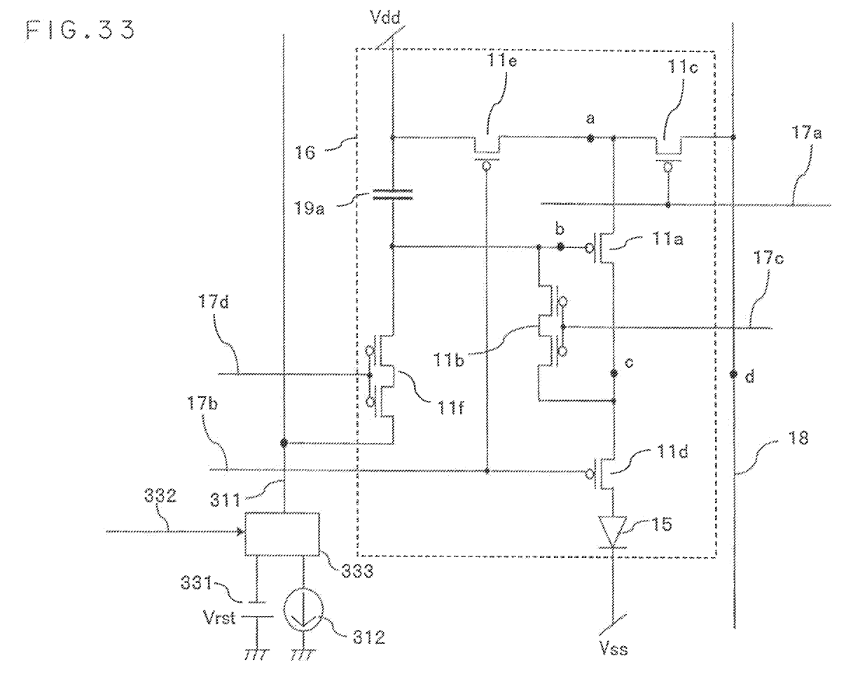

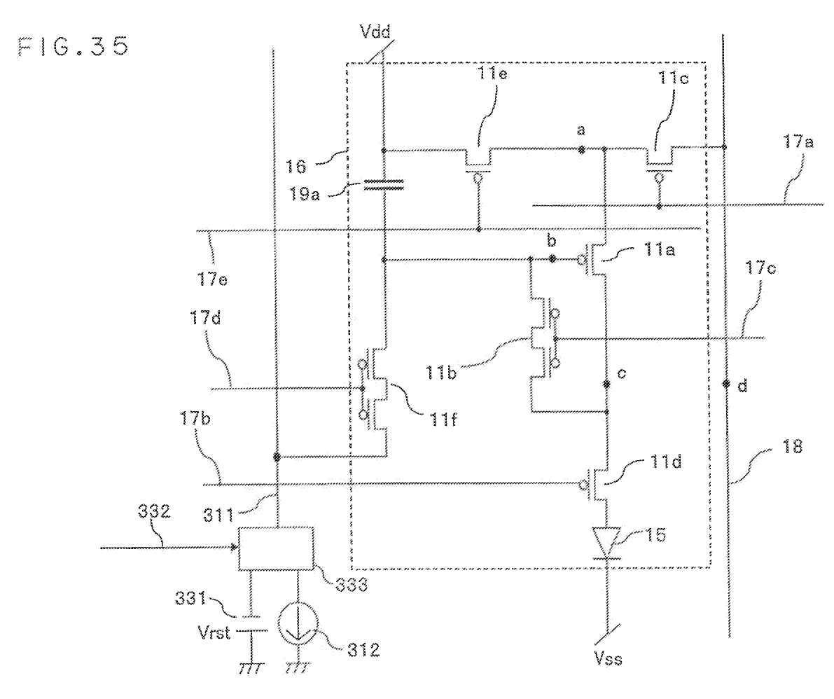

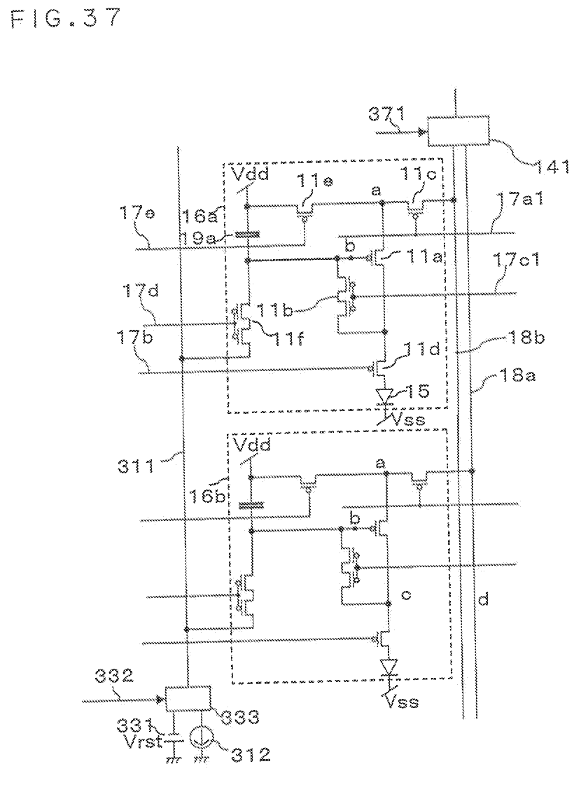

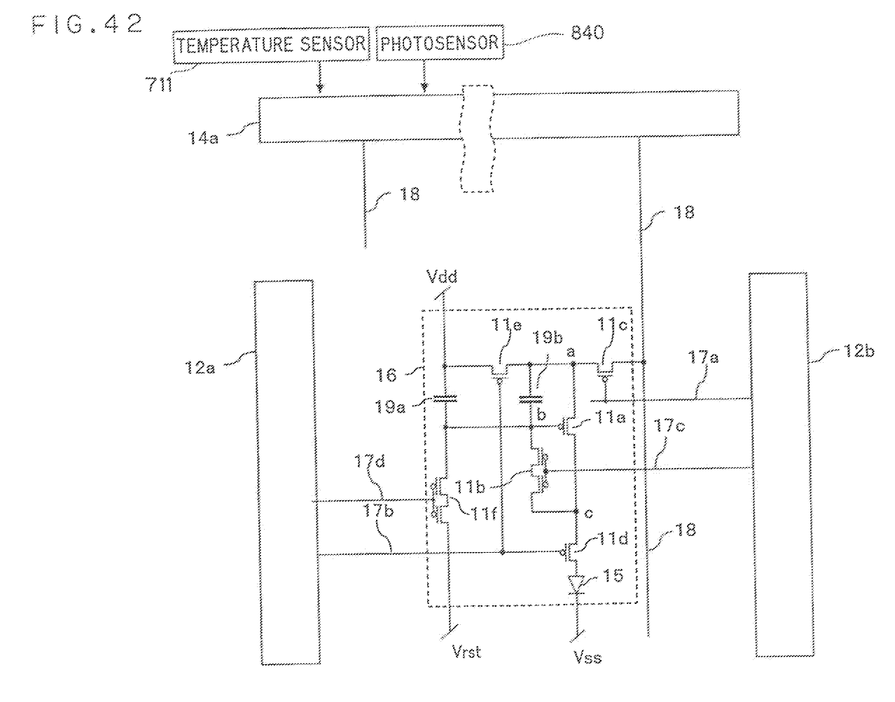

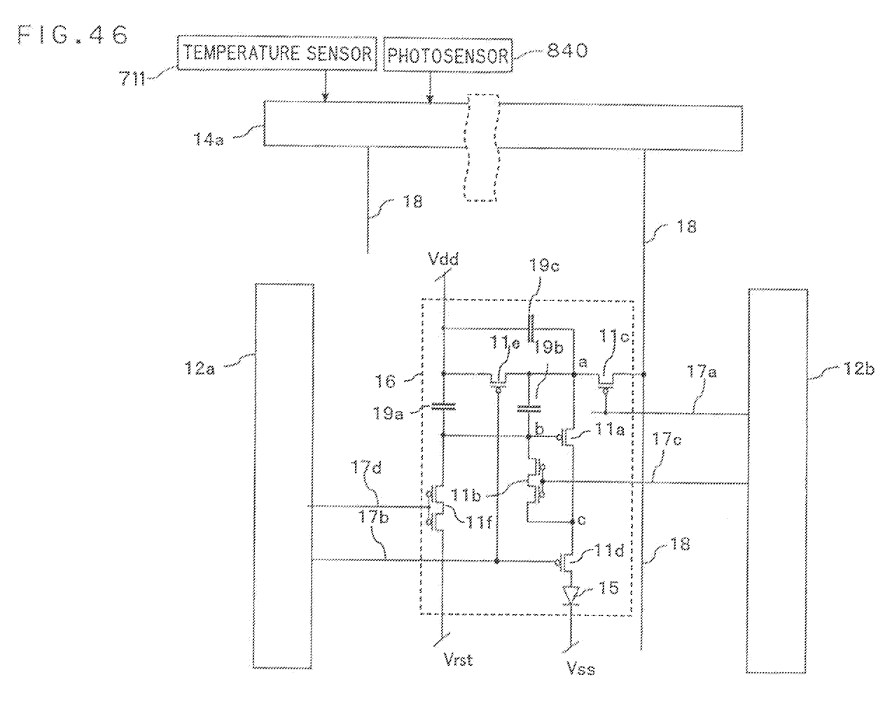

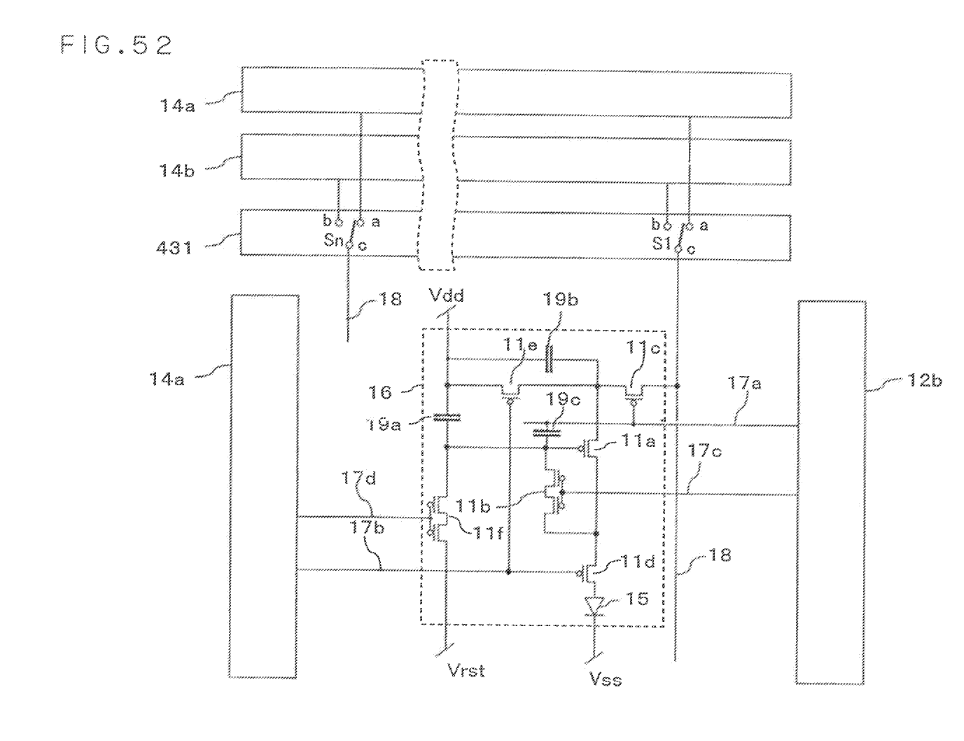

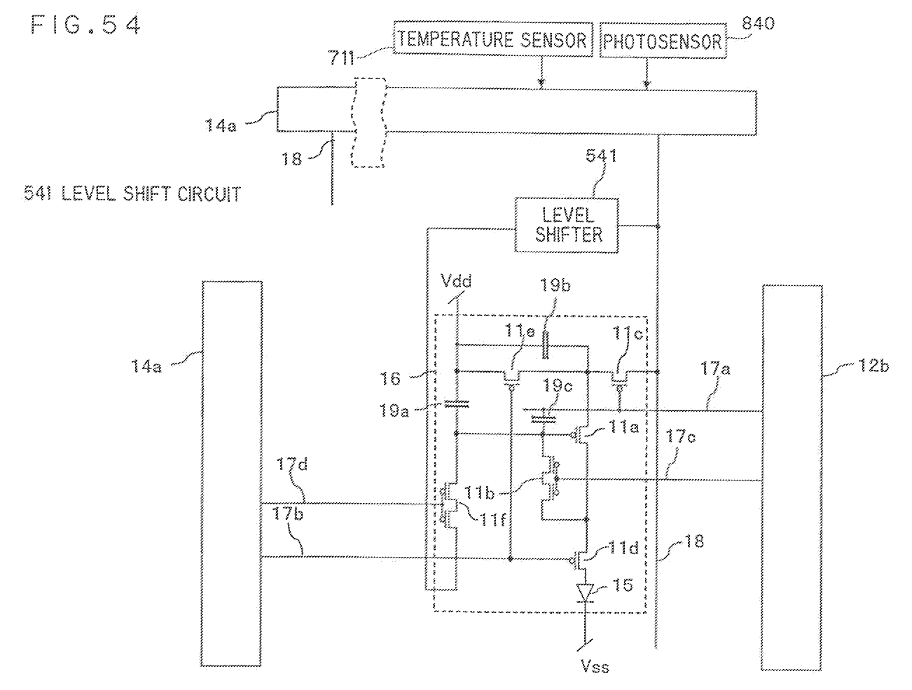

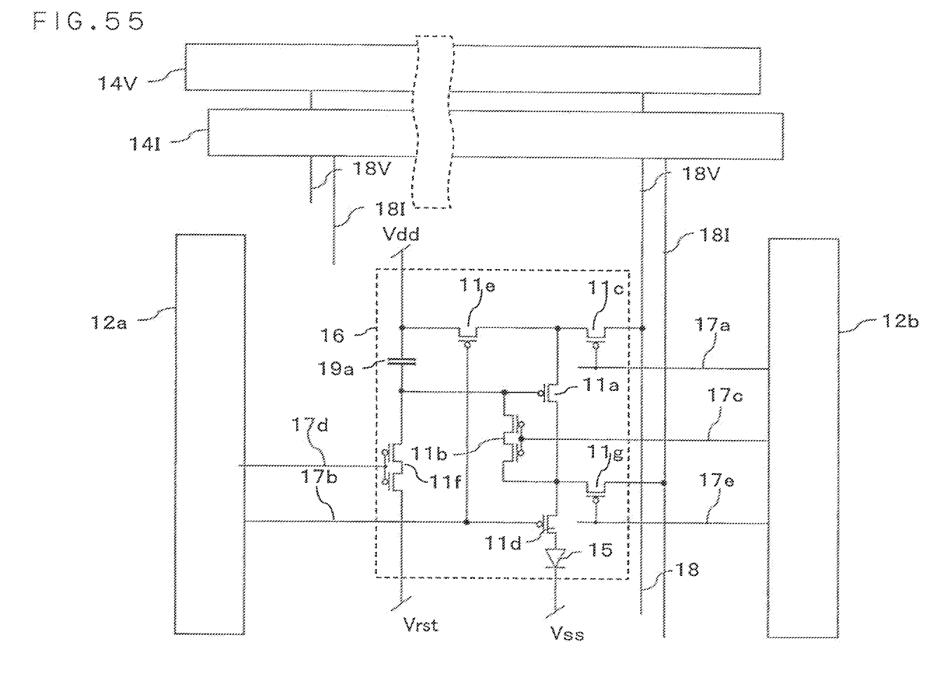

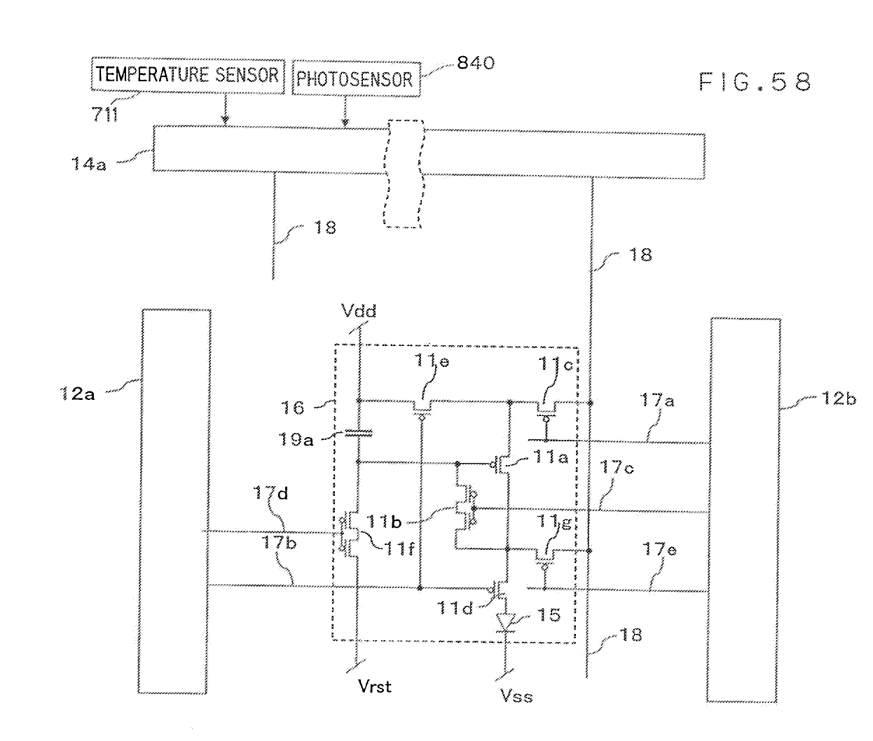

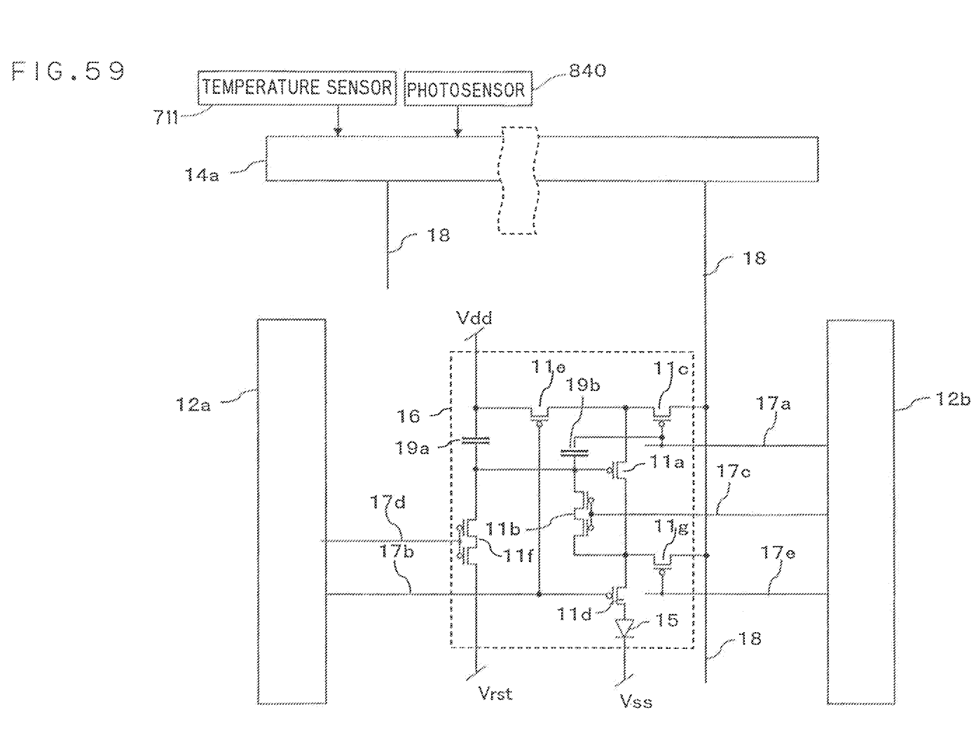

The foregoing is also applicable to the other embodiments of this specification. Further, it is also possible to combine this embodiment with the other embodiments. However, for simplicity and for ease of explanation, such multiple or combined structures are not illustrated or described in other embodiments. The foregoing is also applicable to the EL display panel or EL display device of, for example, FIG. 1, FIG. 4, FIG. 5, FIG. 10, FIG. 11, FIG. 25, FIG. 29, FIG. 31, FIG. 33, FIG. 35, FIG. 37, FIG. 42, FIG. 46, FIG. 52, FIG. 54, FIG. 55, FIG. 58, FIG. 59, FIG. 86, FIG. 90, FIG. 91, FIG. 92, FIG. 93, FIG. 94, FIG. 95, FIG. 113, FIG. 123, and FIG. 124 through FIG. 128.

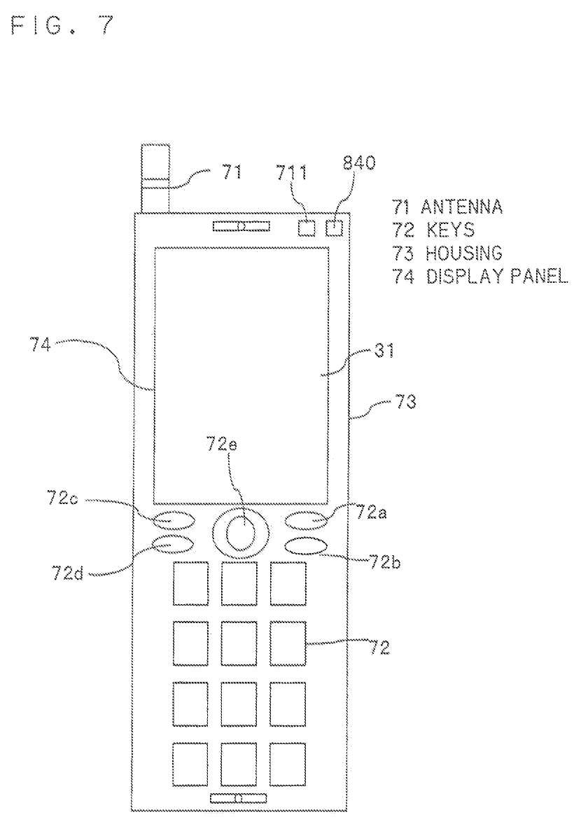

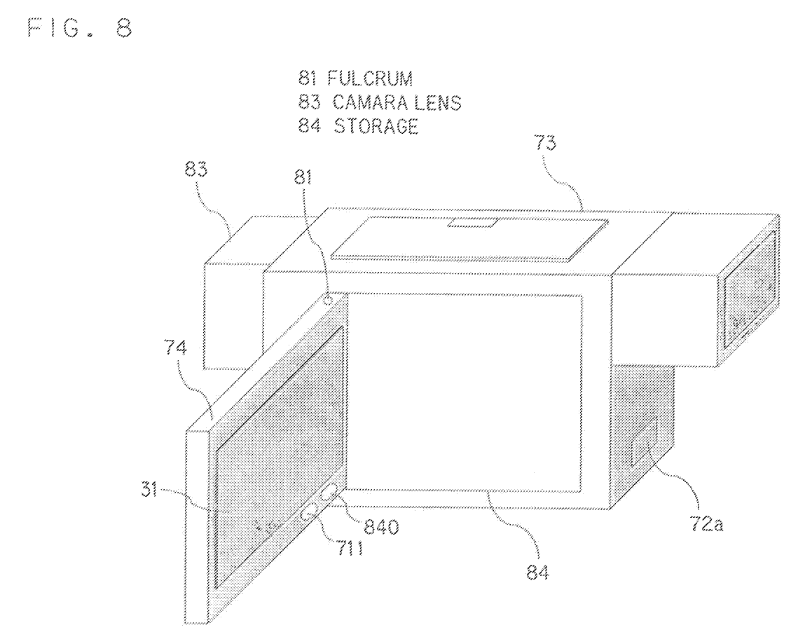

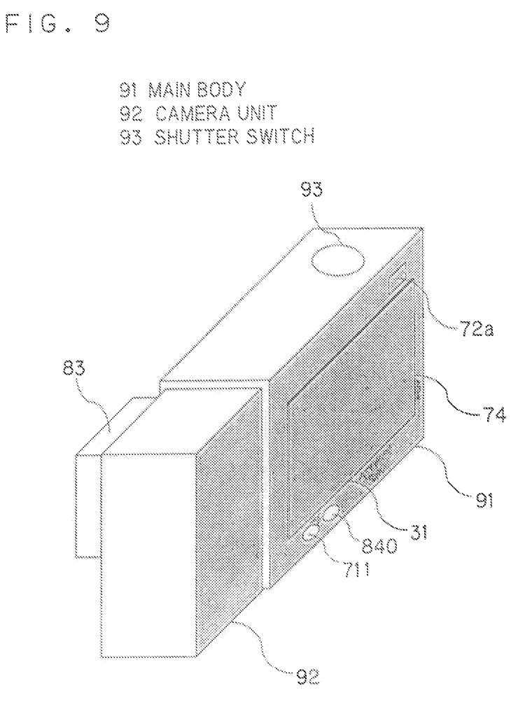

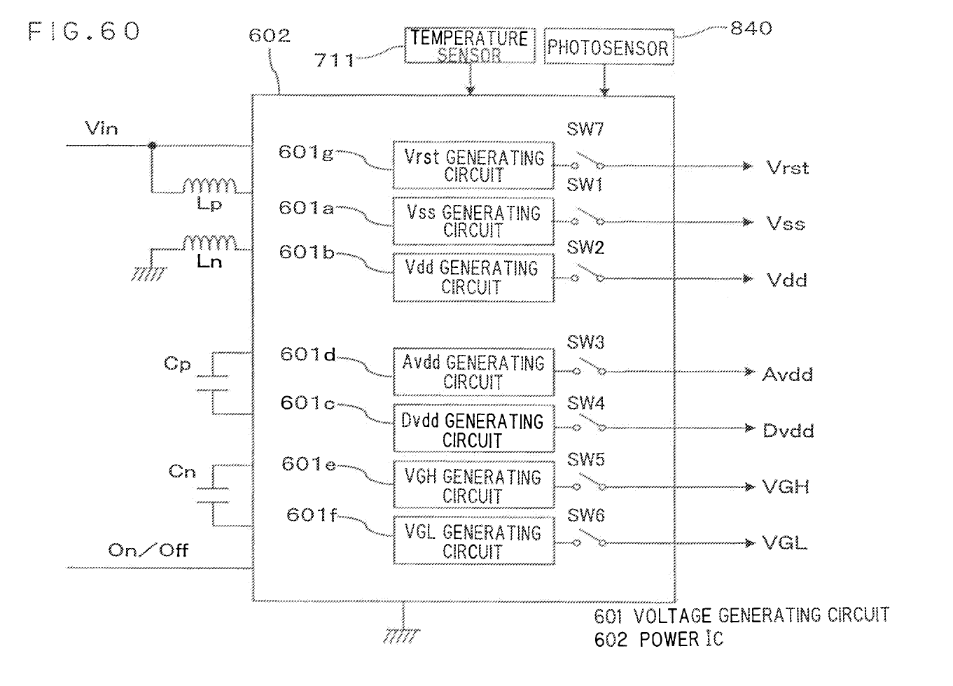

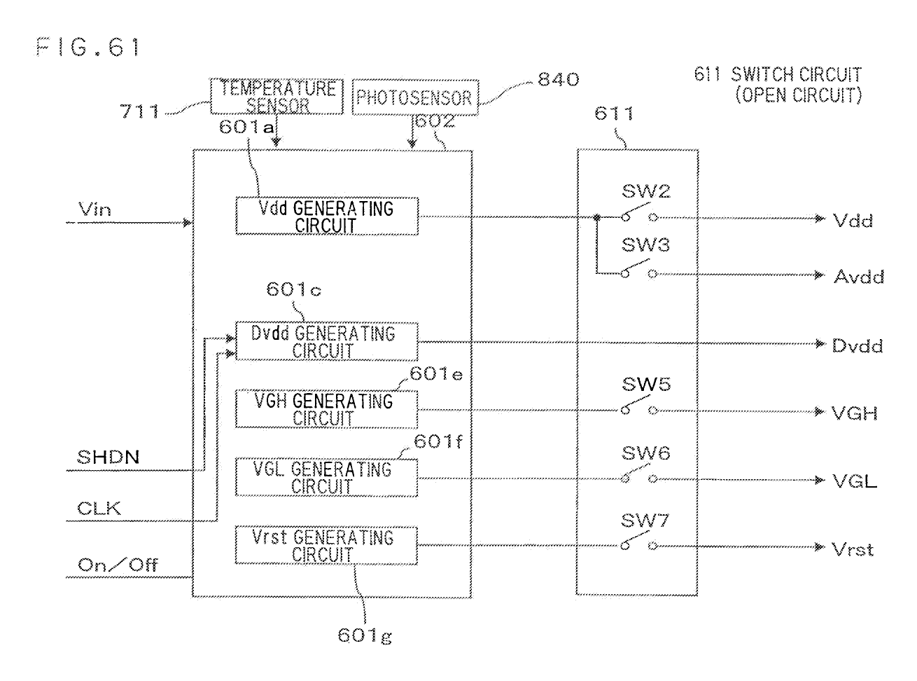

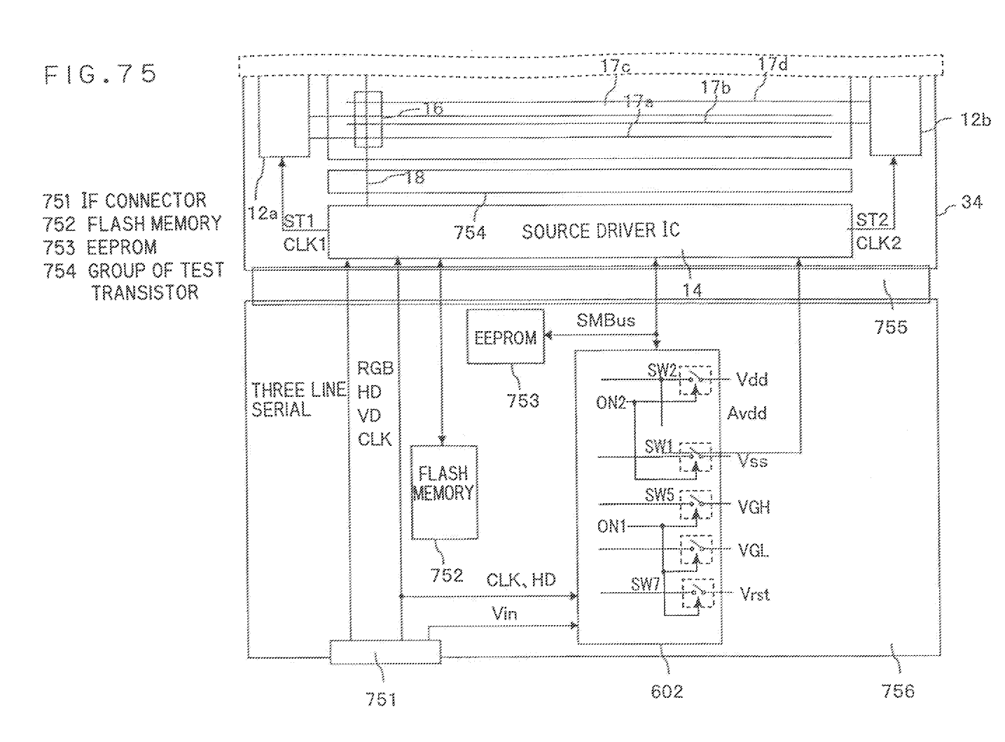

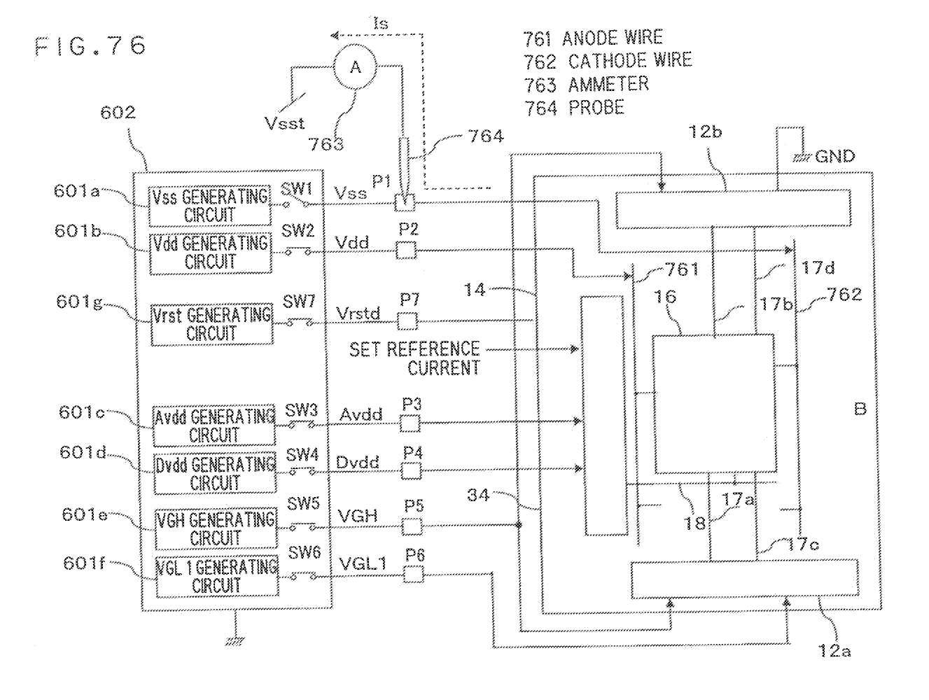

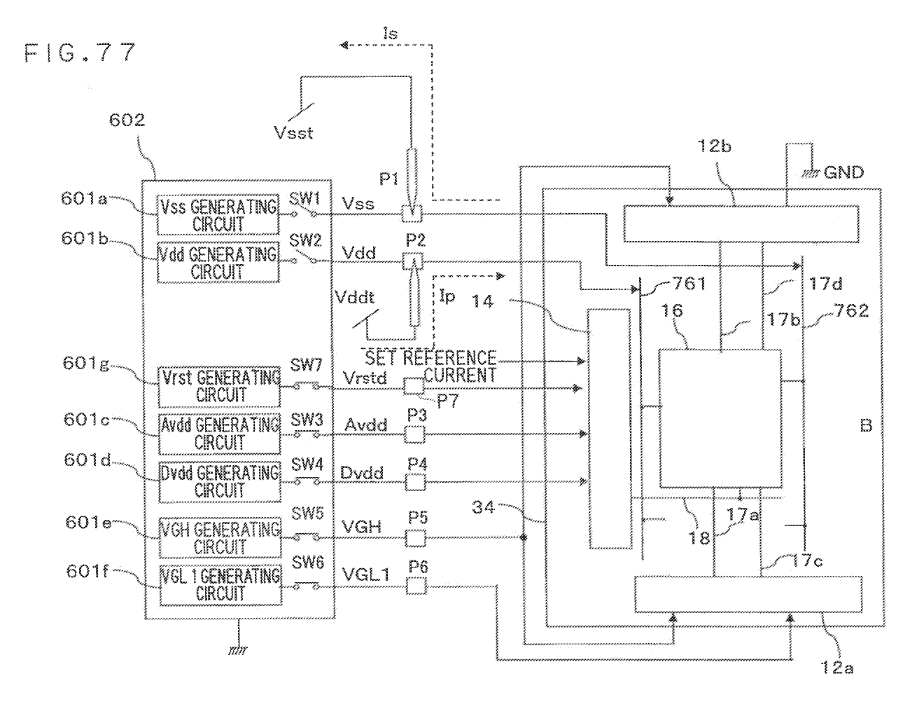

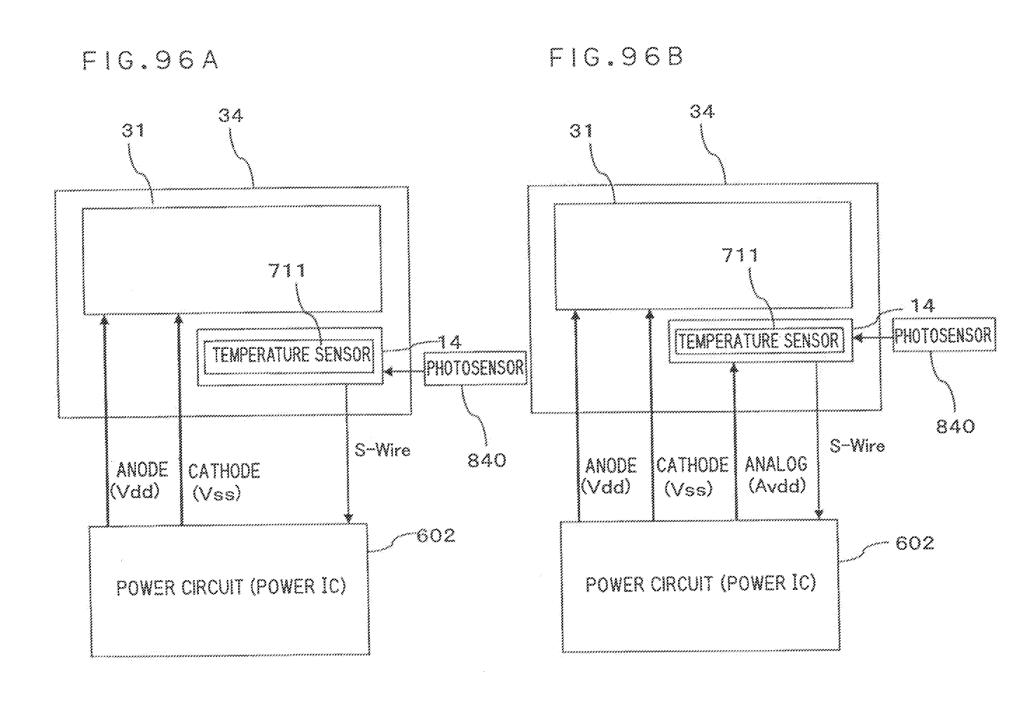

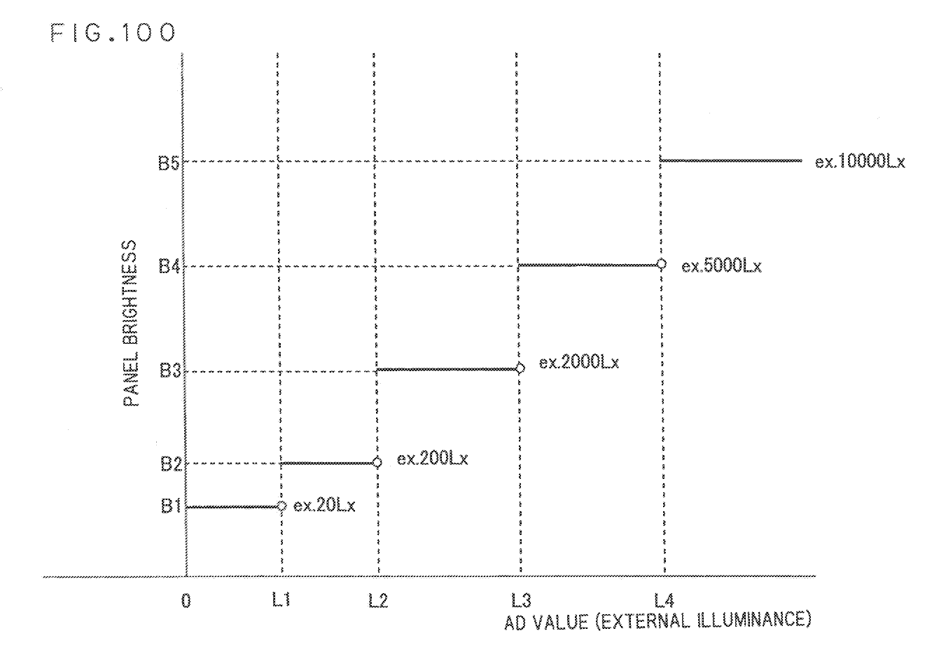

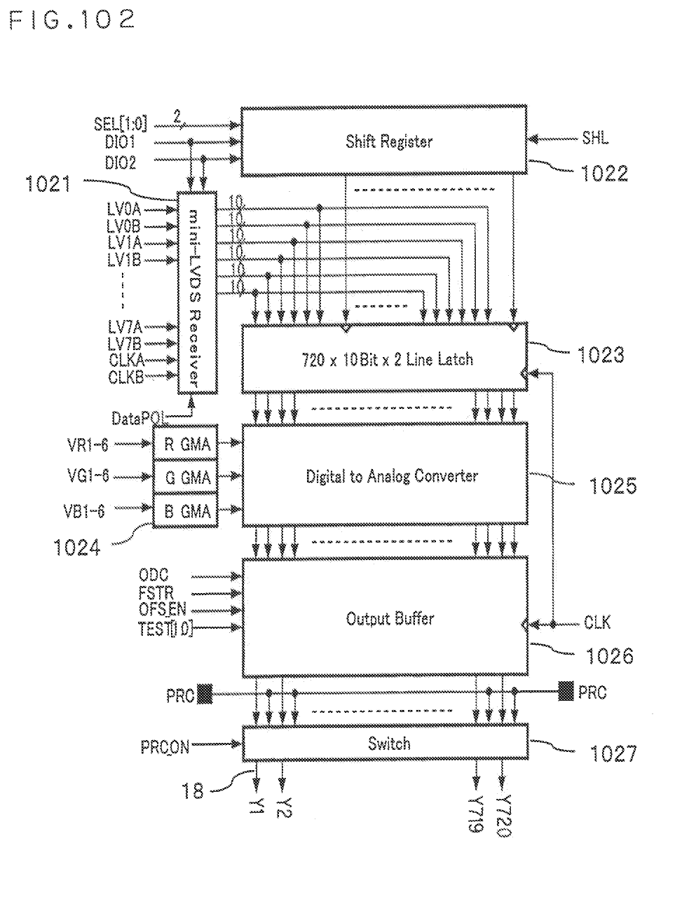

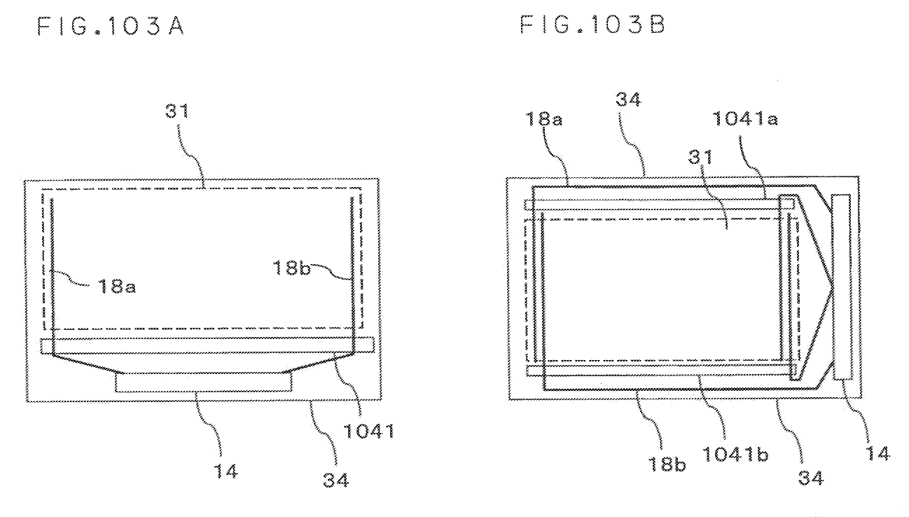

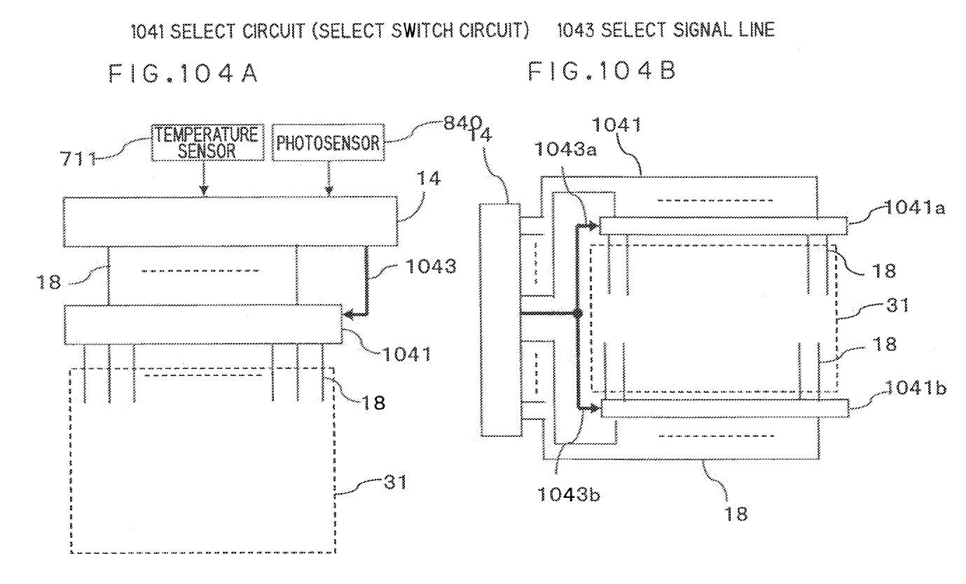

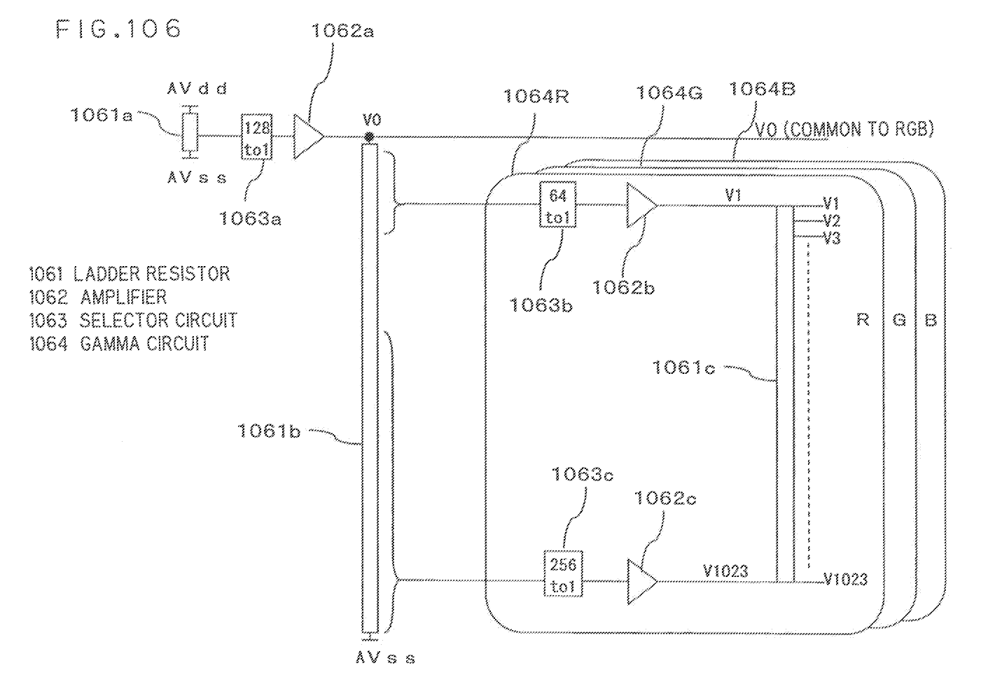

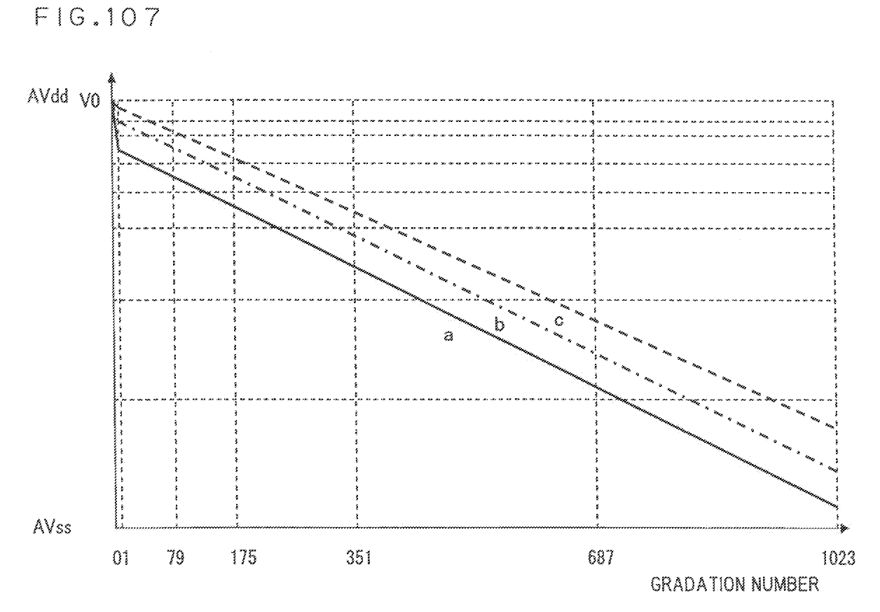

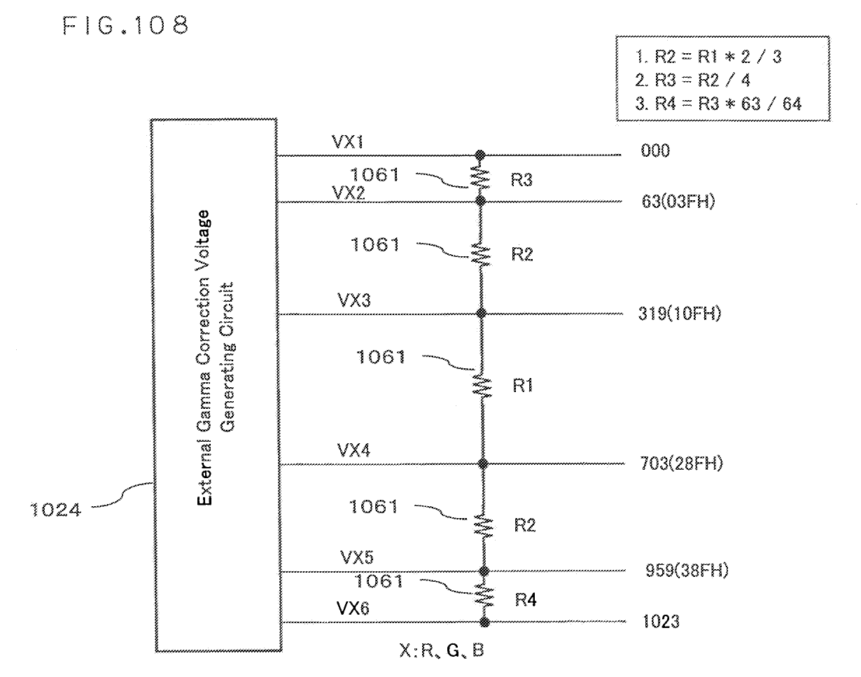

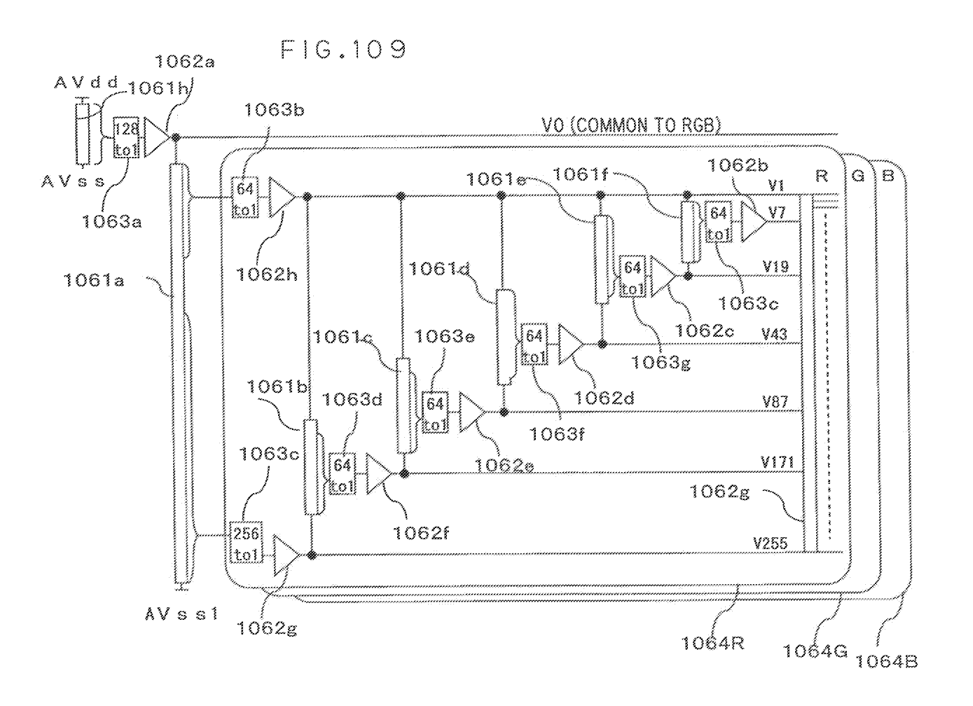

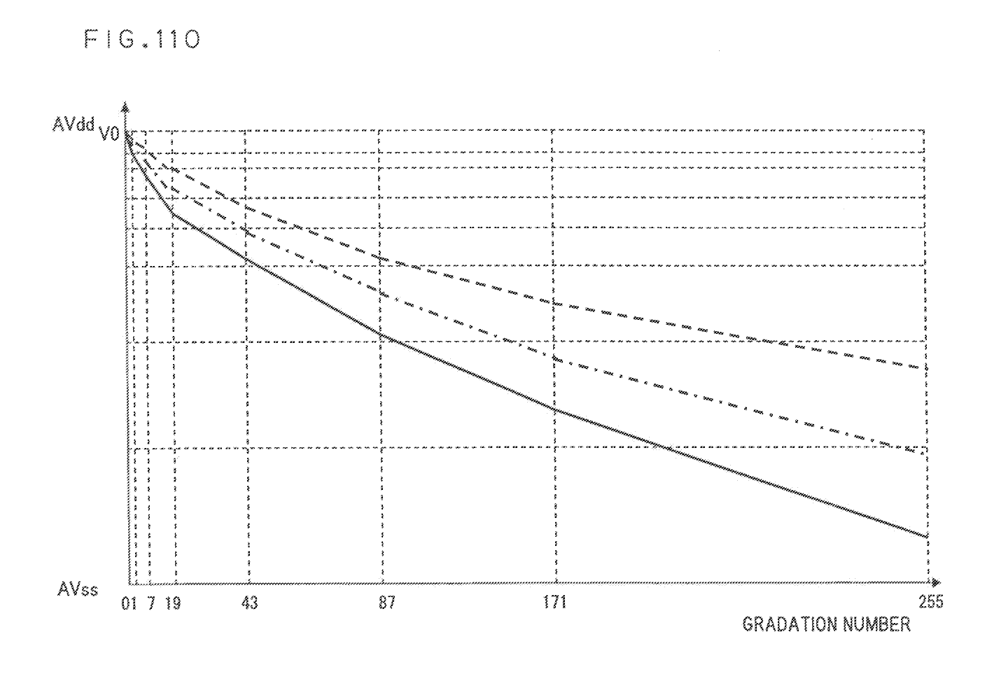

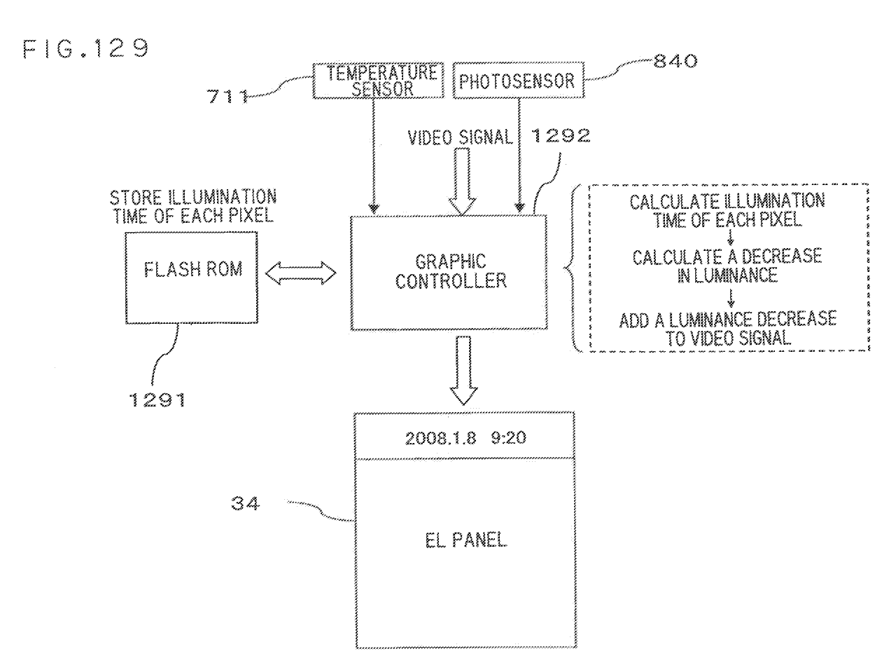

The same can be said for the other embodiments. For example, the pixel configurations exemplified above or described in this specification may be combined with the methods or schemes of, for example, FIG. 12, FIG. 13, FIG. 61, FIG. 75, FIG. 76, FIG. 77, FIG. 78, FIG. 79, FIG. 83, FIG. 84, FIG. 85, FIG. 98, FIG. 99, FIG. 100, and FIG. 101, and with the structures, the configurations, and the methods of FIG. 7, FIG. 8, FIG. 9, FIG. 60, FIG. 83, FIG. 96, FIG. 102, FIG. 103, FIG. 104, FIG. 106, FIG. 107, FIG. 108, FIG. 109, FIG. 110, FIG. 111, FIG. 112, and FIG. 129.

### Third Embodiment

The following describes the Third Embodiment of the present invention. Note that the structures and schemes described above can be applied to or combined with the structures and schemes described below.

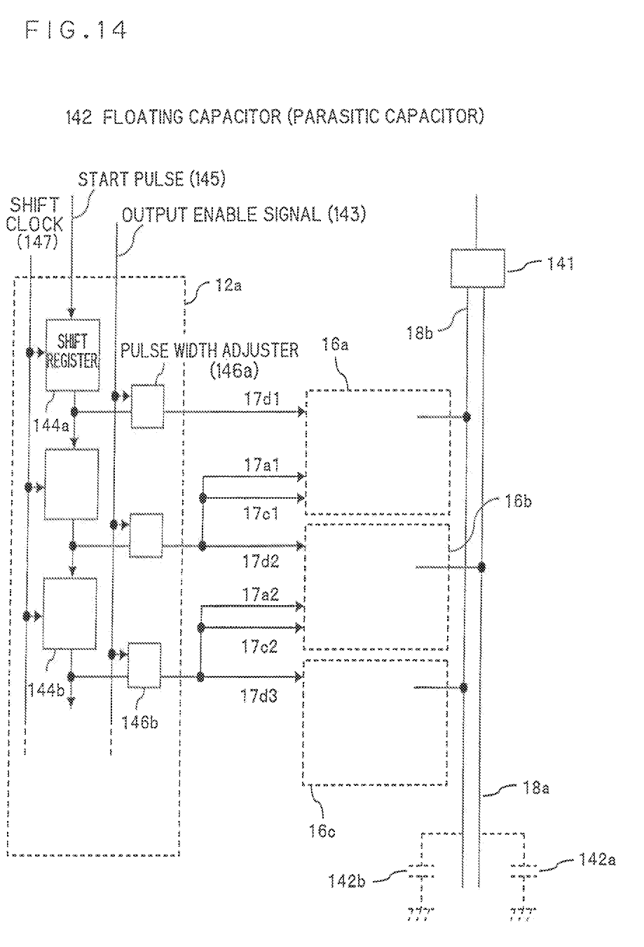

FIG. 14 illustrates a circuit for one column of an EL display panel of this embodiment. Through switching means 141, the source signal line 18 is divided into a source signal line 18a and a source signal line 18b in each row, and the source signal lines connected to the pixels of the even-numbered rows and the odd-numbered rows are different (also see, for example, FIG. 6).

Each pixel 16 has the circuit structure of, for example, FIG. 1, FIG. 4, FIG. 10, FIG. 25, FIG. 29, FIG. 42, FIG. 46, FIG. 52, FIG. 54, FIG. 55, FIG. 58, FIG. 59, FIG. 86, FIG. 87, FIG. 90, FIG. 91, FIG. 92, FIG. 93, FIG. 94, FIG. 95, FIG. 113, FIG. 122, and FIG. 124 through FIG. 128. That is, the embodiment described below is applicable to the other embodiments of this specification, or the embodiments may be combined with one another.

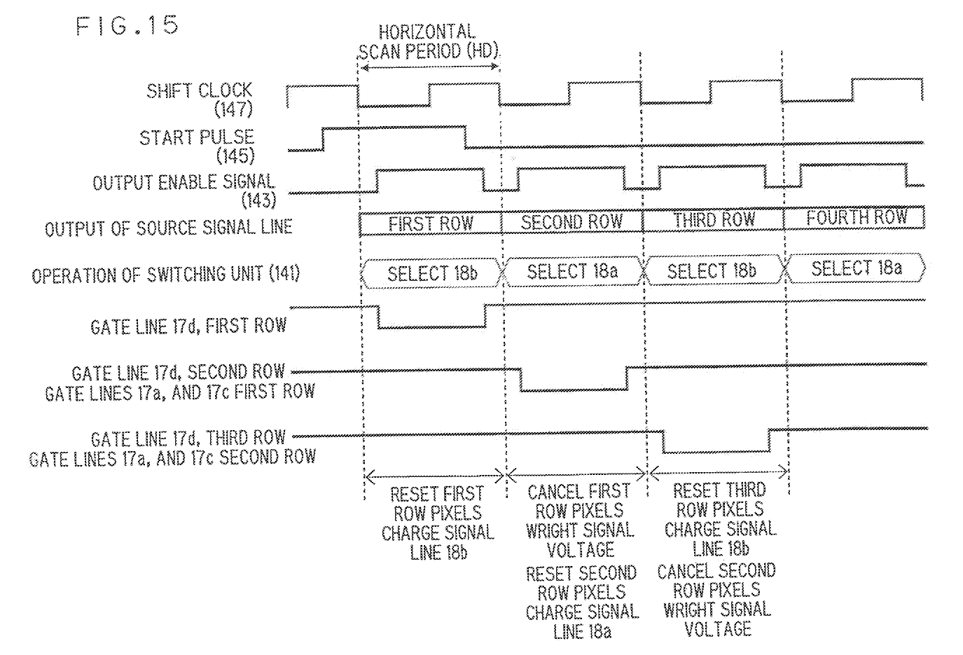

A gate driver circuit 12a has a shift register structure, so that the clock shifts a pulse to the subsequent stages one after another. By providing interconnections to the gate signal lines 17 in the manner illustrated in FIG. 14, the signal waveforms represented in FIG. 15 can be realized.

The cycle of a shift clock is set to one horizontal scan period (1H), and a start pulse is input so that the pulse is output only for one horizontal scan period. In this way, a circuit is realized in which a pulse is generated for one horizontal scan period one after another at the timing of each horizontal scan period which lags behind the other between the rows.

The output from each stage of the shift register is fetched in the gate signal lines 17 as shown in FIG. 14, and the switching means 141 is operated in the manner shown in FIG. 15. In response, in the first one horizontal scan period (1H), the gate voltage of the drive transistor 11a of the pixels 16 of the first row is initialized with a Vrst power supply. At the same time, a signal voltage of predetermined gradations corresponding to the pixels of the first row, supplied from the source signal line, is charged into the source signal line 18b via the switching means 141. The source signal line 18a is not charged. The source signal line 18a is separated from the source driver output by the switching means 141.

In the next one horizontal scan period, the switching means 141 is operated to charge the source signal line 18a. Here, because the source signal line 18b is separated from the source driver output, the signal voltage corresponding to the pixels of the first row remain charged by a floating capacitor 142b of the source signal line. Thus, the gate signal line 17a and the gate signal line 17c are scanned to bring the transistors 11c and 11b of the pixel 16a in a conducting state, so as to write a gradation signal into the drive transistor 11a of the pixel, and perform the cancel operation of characteristic variation. At the same time, for the pixels of the second row, a gradation signal voltage corresponding to the pixel 16b is charged into the source signal line 18a, and the gate terminal of the drive transistor 11a is initialized with the Vrst power supply.

The floating capacitor 142 is formed by, for example, the capacitance that generates at the intersection of the gate signal line 17 and the source signal line 18, and the coupling capacitance of the source signal line 18 and the pixel electrode. In FIG. 14 and elsewhere, the capacitor 142 is described as being a floating capacitor. However, the embodiment is not limited to this. The capacitor may be formed by using the source signal line 18 as one of the electrodes.

By switching the source signal line 18a and the source signal line 18b between each horizontal scan period, the gradation signal applied to the source signal line is maintained for two horizontal scan periods, making it possible to increase the write time of the signal to the pixel circuit 16.

In the structure of the pixel circuit shown in FIG. 1 and elsewhere, the cancel operation of characteristic variation is performed while writing the gradation signal into the drive transistor 11a. The cancel operation of characteristic variation is performed while the transistors 11f, 11d, and 11e are off, and the transistor 11b is on. The characteristic variation is canceled as the gate potential of the drive transistor 11a varies to make the drain current of the drive transistor 11a zero.

The gate potential of the drive transistor 11a is varied by the drain current charge. Since the final state is 0 or an infinitely small current (on the order of picoampere), it takes time to charge and discharge the maintain capacitor 19a keeping the gate potential. Accordingly, the cancel operation takes time.

When one horizontal scan period (1H) is long, the cancel operation can complete within one horizontal scan period. However, when the number of vertical lines is large, and one horizontal scan period is shorter than 40 μs, the cancel operation does not proceed to completion, and the characteristic compensation will be incomplete. This leads to the problem of nonuniformity due to characteristic variations.

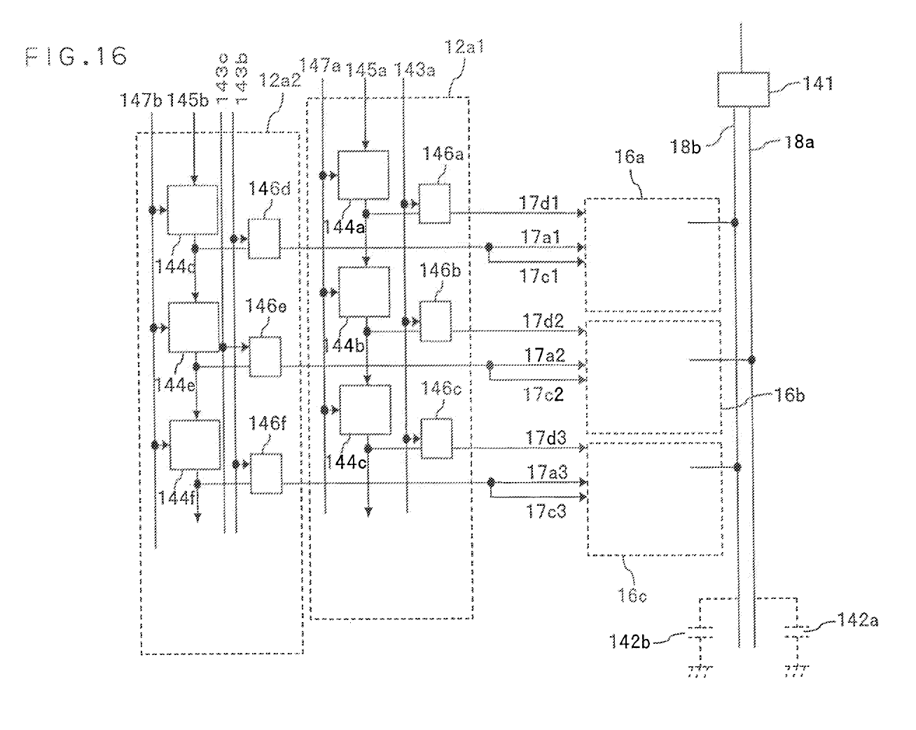

As a countermeasure, in order to provide a cancel time longer than one horizontal scan period, the gate driver circuit 12a is structured from two gate driver circuits, 12a1 and 12a2, as illustrated in FIG. 16. The drive transistor 11a is initialized one horizontal scan period in advance before the horizontal scan period in which a corresponding video signal is input. Further, the write of the gradation voltage to the drive transistor 11a, and the characteristic cancel operation are performed from the horizontal scan period in which a video signal is input to the source signal line 18a or 18b. Because the switching means 141 operates to maintain the video signal for two horizontal scan periods, the write of the gradation voltage, and the characteristic cancel operation can be performed for two horizontal scan periods.

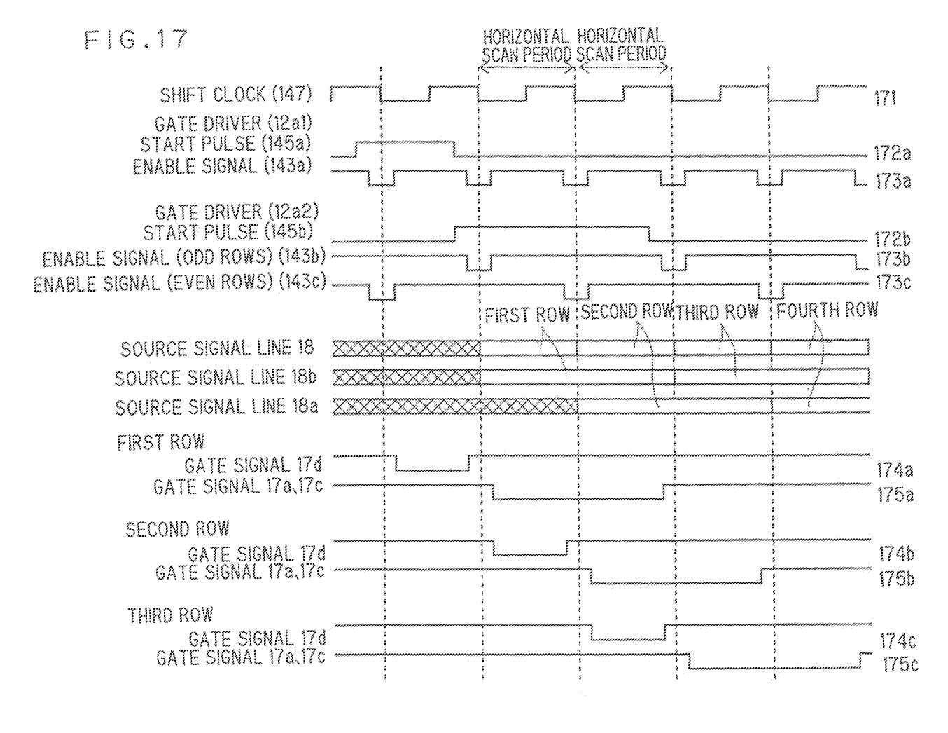

To realize this, as illustrated in FIG. 17, a start pulse 172b for the shift register 12a2 is input. The transistors 17a and 17c of each row are turned on for two horizontal scan periods. The ON timing is in synchronism with the video signal of the source signal lines 18, 18a, and 18b. Because the video signal is channeled into the source signal lines 18a and 18c between even-numbered rows and odd-numbered rows, the frequency is reduced in half and the write time becomes twice as long.

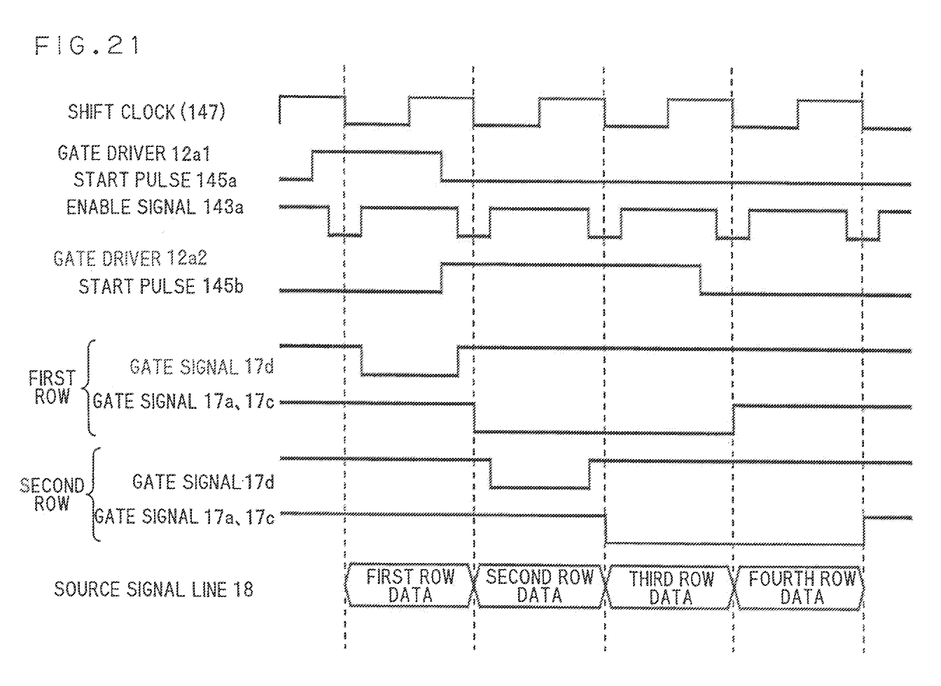

An enable signal 173 prevents the pixels of multiple rows from being simultaneously selected by a dull waveform which occurs during pulse propagation. As such, the enable signal 173 is not required when the pixel rows are not selected simultaneously, or when the simultaneous selection does not cause a problem. The present embodiment can be implemented without the enable signal 173. For example, FIG. 21 illustrates input waveforms and operations concerning the gate driver circuit 12a2 that generates a signal used to perform a characteristic cancel, without an enable signal.

Referring to the waveforms of FIG. 17, the characteristic correction operation for the drive transistor 11a can be performed for two horizontal scan periods. However, it requires the initialize operation of the drive transistor 11a one horizontal scan period before the horizontal scan period in which the video signal is input. That is, the operation must start one horizontal scan period before. Thus, when the front row cannot be detected, the initialization may fail.

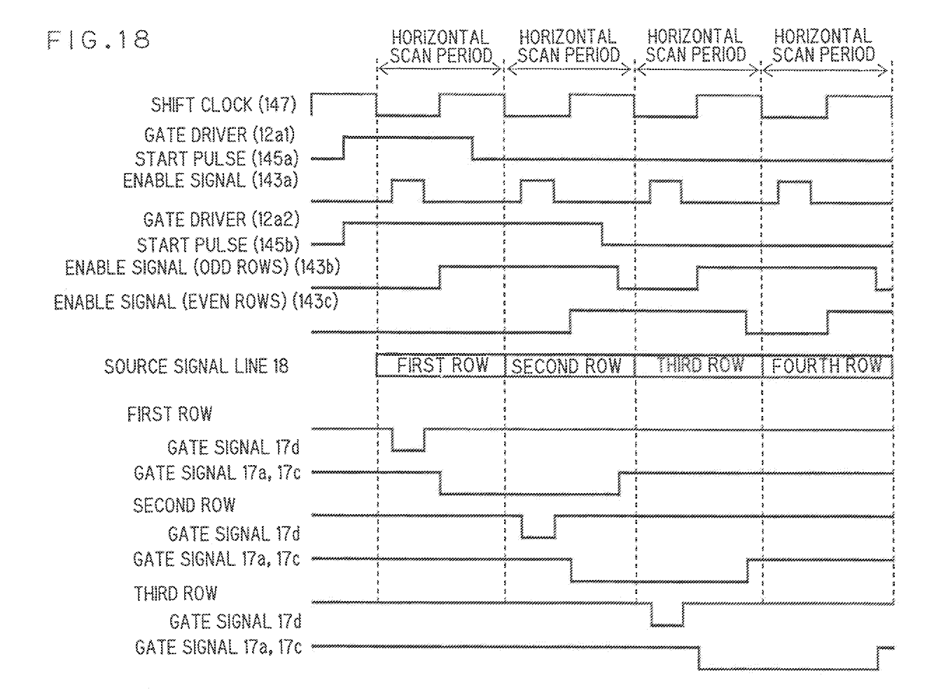

As a countermeasure, as illustrated in FIG. 18, a signal pattern was devised in which the initialize operation is simultaneously performed when inputting the video signal for the first row. Since the characteristic correction operation cannot be performed at the time of initialize operation, the characteristic correction operation is performed after the initialization over the course of two horizontal scan periods (2H).

In the configuration of FIG. 18, the initialize operation is performed in the first half of the first of the two horizontal scan periods, and the write of the signal to the pixel, and the characteristic compensate operation are performed in the second half and the next horizontal scan period. When the gate driver has a shift register structure, and when the horizontal scan period coincides with the shift clock, different switch operations are performed for the first half and second half of the horizontal scan period by cutting the pulse width with the enable signal.

A low level period of the gate signal line 17d is the initialize period of the drive transistor 11a. A low level period of the gate signal lines 17a and 17c is the characteristic cancel period of the drive transistor 11a, and the gradation write period of the pixels.

Because the low level period of the gate signal lines 17a and 17c can be set longer than one horizontal scan period, a cancel period of 45 μs, 1.5 times longer than that possible in conventional structures, can be provided even when the horizontal scan period is 30 μs. This makes it possible to correct the characteristic variation of the drive transistor. Because the initialize operation itself completes within about 2 to 10 μs, the cancel period can be increased to at the maximum of 2 to 10 μs shorter than two horizontal scan periods.

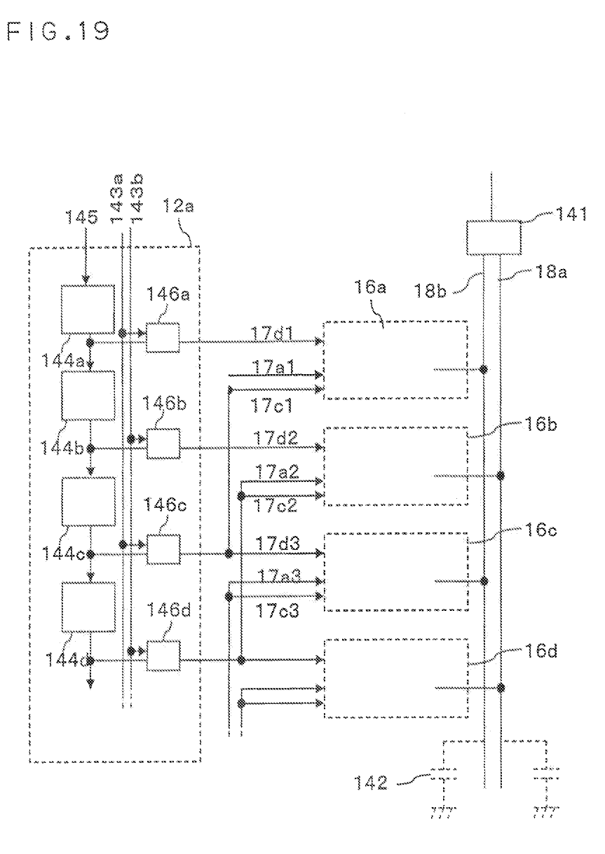

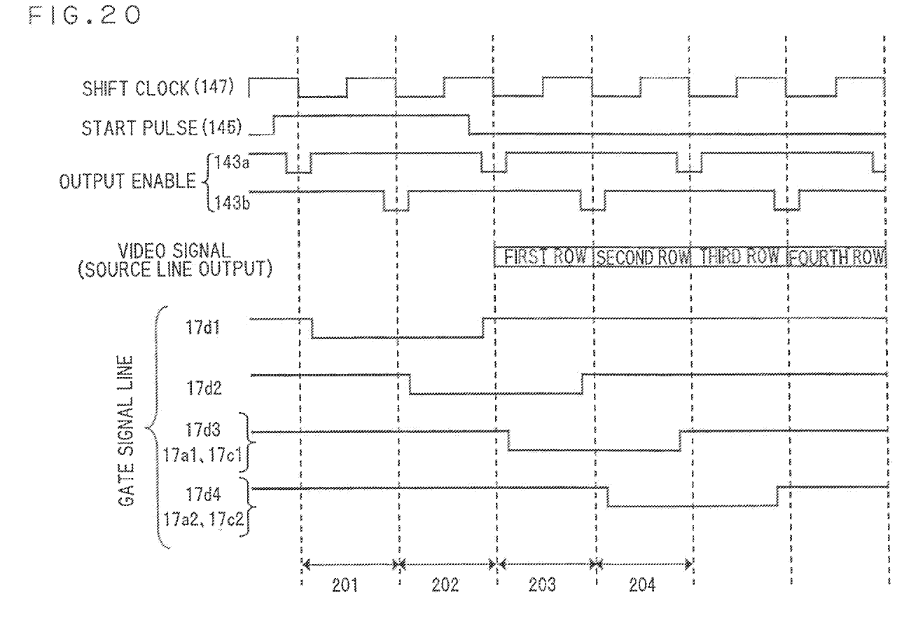

FIG. 19 and FIG. 20 represent a method for increasing the cancel period to longer than one horizontal scan period with one system of shift registers in the gate driver circuit 12a.

For example, when canceling for two horizontal scan periods, the gate signal lines 17a and 17c need to be in a conducting state for two horizontal scan periods. As such, the start pulse for the gate driver circuit 12a is input for the duration of two horizontal scan periods. In this way, the cancel and gradation write time car be set to two horizontal scan periods. A pulse for the gate signal line 17d also needs to be produced for initialization.

In the pixel circuit structure illustrated in FIG. 1 and FIG. 25, the gate signal line 17d, the drive transistor 11a, and the switch transistor 11c cannot be conductive simultaneously (shorting occurs between different voltages). It is therefore required that the initialization pulse do not overlap with the cancel and gradation write pulse for the pixels of the same row.

Specifically, a pulse from two horizontal scan periods before may be used as the initialization pulse. As illustrated in FIG. 19, when the output of the shift registers to the gate signal line 17d is common to the gate signal lines for the cancel and the gradation signal write, the same pixel 16a is initialized within two horizontal scan periods 201 and 202, using the signal of the stage two rows below (signal after two horizontal scan periods), as illustrated in FIG. 20. Further, the characteristic cancel and the write of the gradation signal for the drive transistor 11a are performed within two horizontal scan periods 203 and 204. In the same manner, the operations for the pixels 16b and 16c are performed at the timing lagged by one horizontal scan period.

This method is not limited to a cancel in two horizontal scan periods, and can also be performed when three or more horizontal scan periods are required. Source signal lines corresponding to the pixels of a single column are prepared in numbers corresponding to the required number (integer) of horizontal scan periods, and the pulse width of the start pulse for the gate driver circuit 12a is input for the required number of horizontal scan periods. This can be carried out by taking out a characteristic cancel gate signal and a gradation signal write gate signal from the shift register of the stage subsequent by the number of required horizontal scan periods from the shift register of the stage from which an initialize gate signal is taken out. These signals are then input to the pixels of the same row.

In order for the video signal to be written into the pixels of the corresponding row, it is required to input a start pulse for the video signal in advance. The start pulse needs to precede the video signal by at least the duration of the horizontal scan period in which a cancel is performed. In FIG. 20, the input precedes the video signal by two horizontal scan periods.

To reduce the cost of the source driver, a select driving scheme is often employed in which a voltage corresponding to a plurality of pixels is output in time series from a single output. Unlike a scheme that does not employ the select driving scheme, the input timing of the video signal corresponding the pixels depends on display colors.

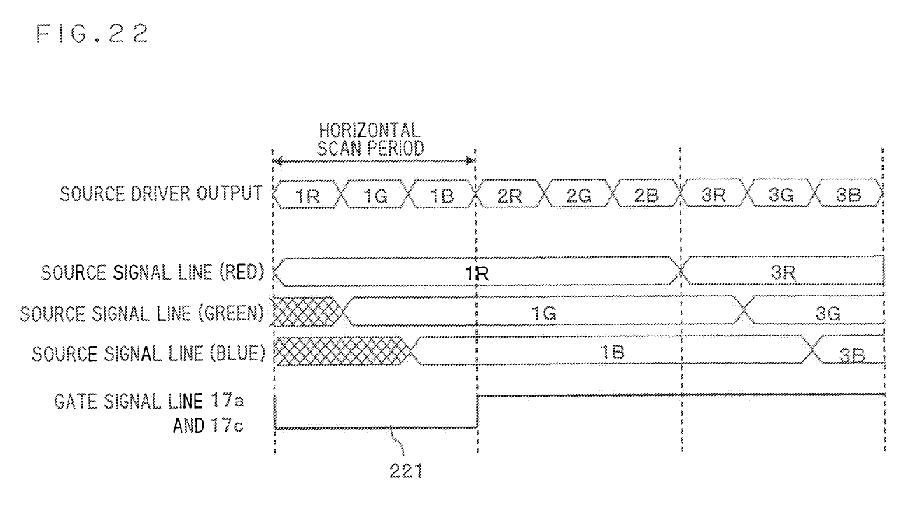

For example, in a three-select drive in which a single output is made for the three pixels of red, green, and blue, the signals for green (G) and blue (B) vary in the middle of a horizontal scan period, as opposed to the beginning of the period in red (R), as illustrated in FIG. 22. When the gate signal lines 17a and 17c have an input waveform 221, the video signal of the immediately preceding row is written into the pixels of green and blue, and then a video signal of the current row is written according to the change in the source signal line.

This is not problematic in displays such as a liquid crystal display, in which the last voltage of the write (voltage present when the gate signal line is turned off) is maintained in the pixels for one frame to produce a display at a predetermined luminance. In the organic EL display panel having the pixel configuration of this embodiment, the characteristic variation of the drive transistor 11a is corrected when writing the video signal into the drive transistor 11a.

In order to reduce the correction time, the initialize operation is performed prior to writing, so as to initialize the gate terminal of the drive transistor 11a with a low voltage (a voltage that causes the drive transistor 11a to flow more current than in a white display).

The characteristic correction proceeds faster with smaller initialize voltages. When the voltage of the immediately preceding row is applied during a select drive, even the slightest amount of which varies the gate voltage of the drive transistor 11a to the voltage of the immediately preceding row. Accordingly, the writing of the gradation signal by the video signal of the immediately preceding row, and the correction of the variation characteristic of the transistor are performed with the voltage of the immediately preceding row being applied. This eliminates the effect of initialization. This problem is not specific to the three-select drive, but is common to all signal line select drives involving the selection of two or more lines.

In this embodiment, in performing a select drive, the characteristic cancel operation is carried out after the voltages of all signal lines used for writing in the same horizontal scan period have been determined.

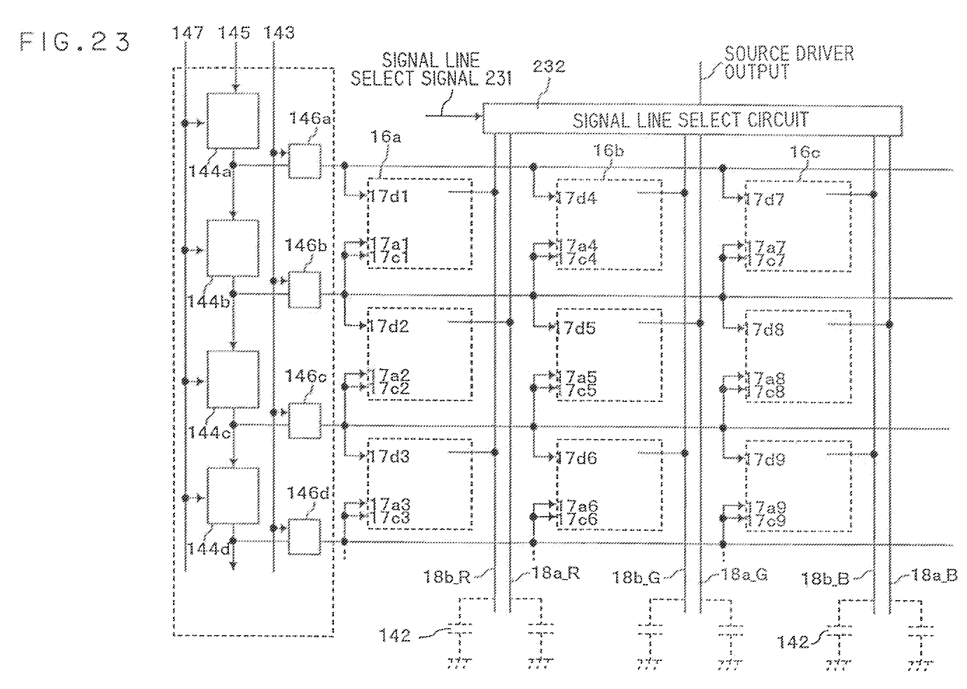

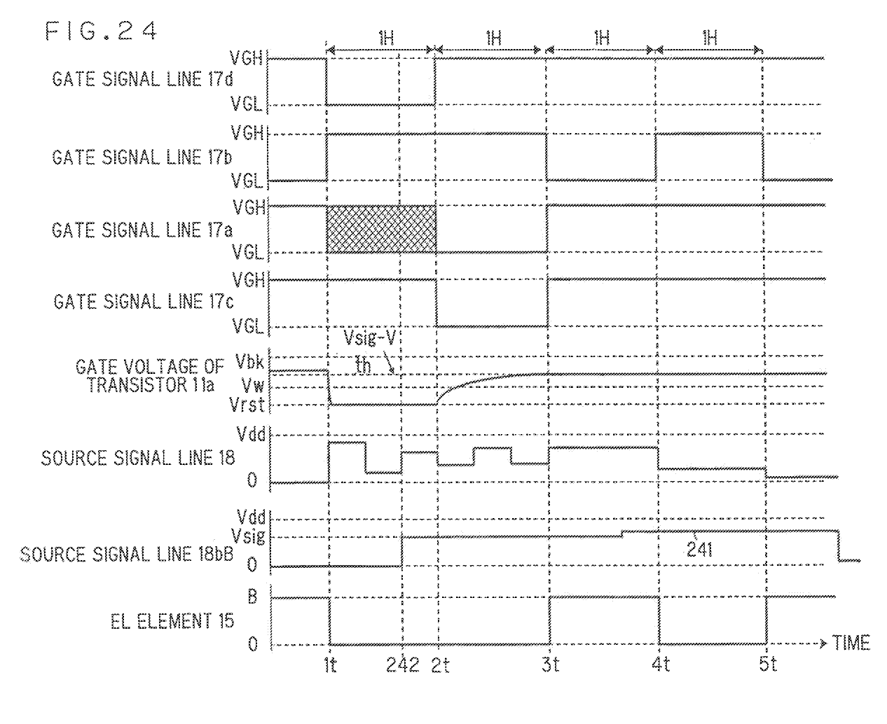

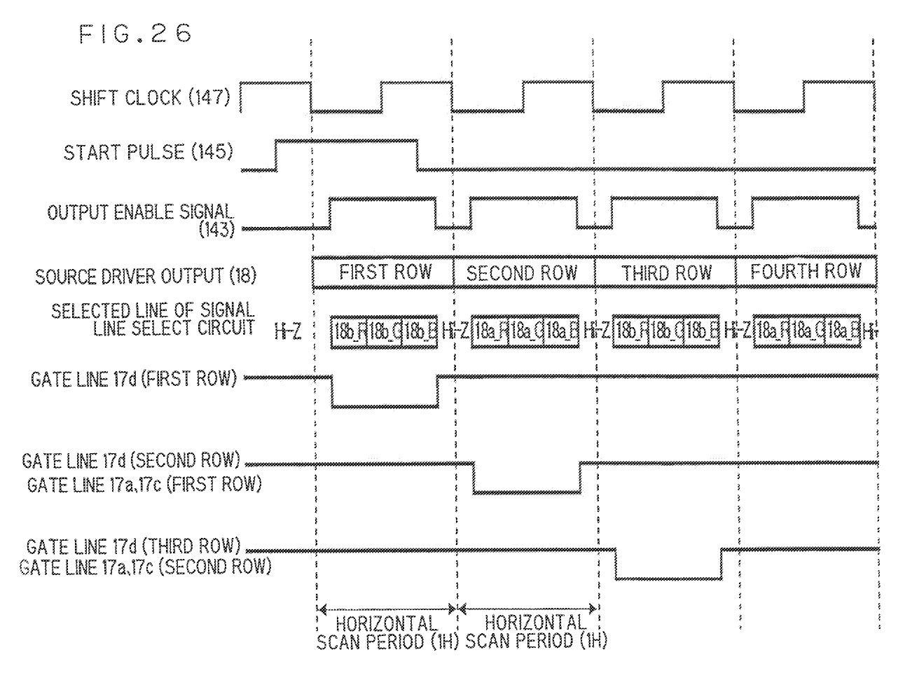

FIG. 23, FIG. 24, and FIG. 26 represent an exemplary embodiment. Here, the select drive is based on a three-select driving scheme in which the signals lines of red, green, and blue are selected one after another. However, this example is also applicable to the two-select drive, four-select drive, and higher select drives.

To provide a cancel time, two signal lines are provided for each column, and different source signal lines are used for even-numbered rows and odd-numbered rows. FIG. 23 illustrates a structure in which the gate driver circuit 12a is operated with one system of shift register circuit. FIG. 26 illustrates signal inputs using the gate driver circuit 12a of FIG. 23, and the operation of a signal line select circuit 232. The signal line is switched between red (R), green (G), and blue (B) within one horizontal scan period. Further, for selection, the switch between the source signal line 18b for the odd-numbered rows, and the source signal line 18a for the even-numbered rows is made every one horizontal scan period.

In this scheme, the initialize timing and the writing to the video signal line of the current row occur at the same time, and the writing of the video signal into the pixel is performed in the next horizontal scan period. Accordingly, the video signal does not vary during the signal line writing and the characteristic variation correction of the drive transistor 11a, making it possible to perform the usual drive even with the select drive.

FIG. 24 is a timing chart for one pixel. The chart includes the gate signal line 17b, not described previously. Concerning the gate signal line 17b, the switch connected thereto must be non-conductive in the initialize period, the characteristic cancel period, and the write period of a gradation signal to the drive transistor. The switch may be conductive or non-conductive in other periods. This also applies to the other embodiments. In the example of FIG. 24, conduction and non-conduction are repeated.

To accommodate the three-select drive, the source signal line 18 sends a signal for three pixels during one horizontal scan period. Changes induced by the signal line select circuit in the voltage of a source signal Line 18bB corresponding to the blue pixels of the odd-numbered rows are represented by a waveform 241.

The gradation signal for the first row varies at the timing designated 242. Here, the gate signal line 17b is off state, so that the video signal of the immediately preceding line will not be written into the gate terminal of the drive transistor 11a. The gate signal line 17a, which is off in the structure of the gate driver circuit 12 shown in FIG. 23, may be in the ON state. The ON state may be realized by changing the configuration of the gate driver circuit 12. This is possible because the voltage of the immediately preceding row is not applied to the initialized gate terminal, even through it is applied to the source terminal of the drive transistor 11a.

After time 2t, the gate signal lines 17c and 17a become conductive, applying a gradation voltage to the drive transistor 11a, and performing the characteristic cancel operation. Here, as in FIG. 26, the source signal line 18bB is separated from each source signal line by the signal line select circuit 232.

By a floating capacitor 233 of the source signal line, the voltage written by the source driver is maintained for two horizontal scan periods. The value of the maintained voltage is written into the pixel to write a predetermined voltage. During the time period 2t to 3t, the gate voltage of the drive transistor 11a gradually decreases from the written source voltage (Vsig) by the amount of threshold voltage Vth (Vsig−Vth). At time 3t, a predetermined voltage is written, and the gate signal line 17b becomes conductive. As a result, a predetermined current flows into the EL element 15, and the EL element 15 emits light.

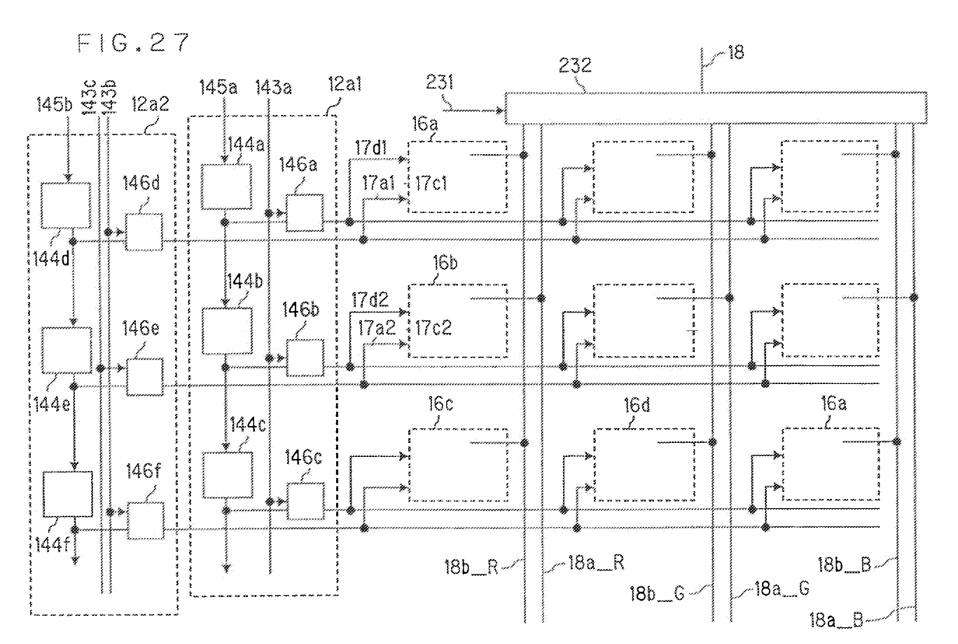

FIG. 27 illustrates a structure in which two systems of shift register is used for the gate driver circuit 12a. With this structure, the pulse width for the gate signal lines 17a and 17c can be set differently from the pulse width for the gate signal line 17d, by individually setting the start pulse.

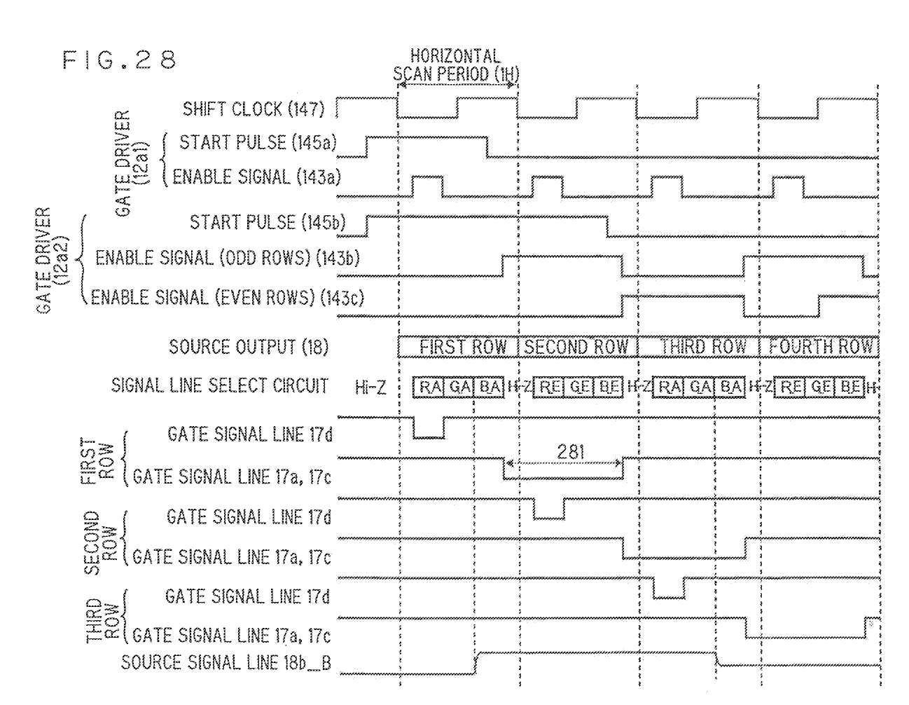

FIG. 28 illustrates input waveforms of the gate driver circuits 12a1 and 12a2, and waveforms of the respective gate signal lines. An initialization pulse is produced for the gate driver circuit 12a1 that generates an initializing signal. Initialization takes about 10 μs to complete, although it depends on the capability of the power supply that generates Vrst. The gate signal line 17d is brought into the ON state only briefly.

This is because since the characteristic cancel period is long and cannot occur simultaneously with the initialize period, a short initialize period is important to enable the initialize operation, the characteristic cancel operation, and the gradation signal write operation within two horizontal scan periods.

In the embodiments of FIG. 27 and FIG. 37, two pixel rows are selected within one horizontal scan period. However, the present embodiment is not limited to this. Three or more pixel rows may be simultaneously selected. When simultaneously selecting three or more pixel rows, the number of source signal lines 18 is increased. Generally, the source signal lines 18 are increased in numbers corresponding to the number of pixel rows to be simultaneously selected within one horizontal scan period.

The pixel rows to be simultaneously selected do not need to be adjacent pixel rows. The pixel rows may be simultaneously selected in units of two pixel rows. For example, in an exemplary driving scheme, the first pixel row and the third pixel row are selected in the first horizontal scan period, and the second pixel row and the fourth pixel row are selected in the second horizontal scan period.

Further, the write timing of the video signal voltage Vsig may be different between the pixel rows that are simultaneously selected. For example, when selecting the first pixel row and the second pixel row, the second pixel row may be selected 5 μs after the first pixel row. With different select timings, inrush current or the like can be suppressed. Further, a select circuit 1041 may be provided, and the timing may be adjusted with the select circuit 1041.

In FIG. 28, the write is performed only in the select period in which the source output is red. However, it can be performed in the select periods of red and green, or in part of the select period of red. A transition to the characteristic cancel period cannot occur in the blue source signal line 18aB or 18bB, because the blue source signal line 18aB or 18bB, to which the video signal of the current row is written last, does not receive the voltage of the corresponding pixels until the blue select period.

Because the characteristic cancel operation is not possible, the select periods of red and green can be used as the initialize period. In the characteristic cancel and gradation signal write operation, a pulse that can select two horizontal scan periods is produced by the shift register circuit of the gate driver circuit 12a2, and an enable signal is used that provides an enable period for the odd-numbered rows and the even-numbered rows in time periods excluding the initialize period or the period in which the video signal is not written.

The characteristic cancel and gradation signal write period of first row is indicated by 281. At the beginning of the period 281, the write to the blue pixel has been finished. However, provided that the source signal line 18aB or 18bB for the blue pixels has been changed to a predetermined voltage selected by the signal line select circuit, the gate signal lines 17a and 17c may be brought into the low level. The period 281 may be set so that it ends before the voltage corresponding to the pixels of a different row is applied to the same source signal line. When the signal line select speed is high, the characteristic cancel period can be set between the end of the writing and the end of the next horizontal scan period. This realizes a display with a high threshold voltage correction capability for the drive transistor 11a.

Note that gate signal line 17a may be at low level throughout the two horizontal scan periods, because it does not affect the gate voltage of the drive transistor 11a even when the transistor 11c becomes conductive. In this case, the shift register output is input for the gate signal line 17c via the enable signal. For the gate signal line 17a, the shift register output is input without using the enable signal, or via a different enable signal.

The foregoing described the case where the transistor used for the pixel circuit 16 is a P-channel transistor; however, the N-channel transistor illustrated in FIG. 29 may be used for the transistor. The same applies to the other pixel configurations of this embodiment.

In the organic EL element 15, the anode and cathode may be reversed, and the potential Vss may be greater than Vdd. FIG. 29 includes the capacitor 19b; however, the embodiment can be implemented without the capacitor 19b. The same applies to the other pixel configurations of this embodiment.

By comparing FIG. 29 and FIG. 4, the punch-through capacitor 19c in FIG. 4 is disposed between the gate signal line 17a and the gate terminal of the drive transistor 11a, whereas the punch-through capacitor 19c in FIG. 29 is disposed between the gate signal line 17c and the gate terminal of the drive transistor 11a.

With the capacitor 19b, the voltage is maintained for one frame, until the next video signal is written into the pixel, and accordingly, the potential at point a is maintained. In other words, the voltage applied (written) to point a is maintained until the transistor 11c turns on and the video signal is written into the pixel 16.

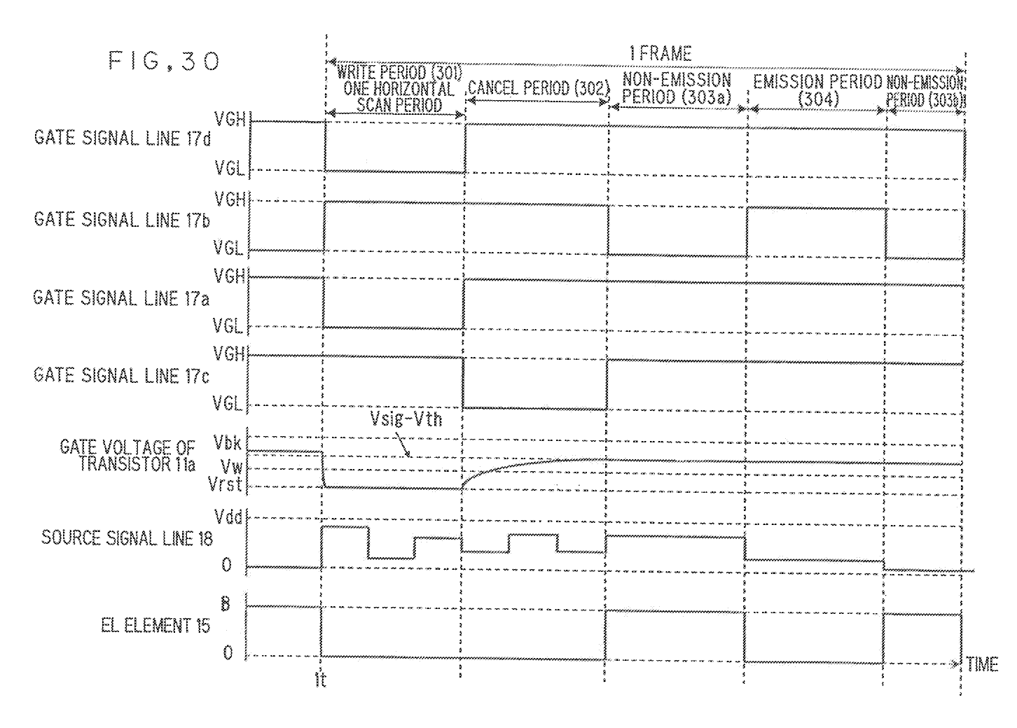

By making the transistor 11b conductive with the maintained potential, the characteristic variation of the drive transistor 11a can be canceled with a signal according to the gradation signal. This corresponds to cancel period 302 represented in FIG. 30.

The cancel period (offset cancel period) can be set arbitrarily according to the structure of the gate driver circuit 12, irrespective of the length of the horizontal scan period. The writing of the video signal, and the initialization of the drive transistor 11a are carried out before the cancel period 302 (period 301). Only the transistors 11f and 11c are conducive. The gate potential of the drive transistor 11a is initialized with the Vrst power supply, and, at the same time, a predetermined voltage is written into the capacitor 19b through the source signal line 18.

Because the capacitor 19b maintains a predetermined gradation voltage, only one source signal line 18 may be used, and the transistor 11c may be turned on only for one horizontal scan period. Alternatively, with two source signal lines 18, the gradation voltage may be maintained both in the floating capacitor of the source signal line 18, and the capacitor 19b. In this case, the capacitor 19b can be reduced.

Upon completion of the offset cancel, current is applied to the EL element 15 to cause emission of a predetermined luminance. This period corresponds to emission period 304. Here, transistors 11d and 11e become conductive, and supply current to the EL element 15.

Non-emission periods 303 preceding and following the emission period 304 are periods inserted to provide effects such as improvement of moving image viewability by black insertion. The black insertion involves a duty drive, as described with reference to FIG. 12, FIG. 13, FIG. 84, FIG. 98, FIG. 99, and elsewhere. Here, at least one of the transistors 11d and 11e is non-conductive. The period 303 is not required when illumination is provided at all times and no black insertion is provided.

Note that the switching means 141 and the signal line select circuit 232 in this embodiment are not necessarily required to be formed on the array substrate, and may be installed in the source driver IC.

The description of this embodiment has been described through the case where two source signal lines are connected to the pixels of the same column. However, the embodiment can also be implemented with three or more source signal lines. Generally, when the number of source signal lines is N, and when these source signal lines are connected at the intervals of N pixels, the source signal line can maintain the gradation voltage for N horizontal scan periods, and the characteristic cancel period can be increased. By the provision of a cancel period, the pixel circuit is able to maintain a gate voltage closer to the characteristic of the drive transistor 11a, improving display nonuniformity. More than one pixel row may be selected at the same time.

Concerning the N source signal lines, connecting the pixel circuit to source signal lines that are different between at least adjacent pixels enables the source signal lines to maintain the gradation signal for two horizontal scan periods, making it possible to increase the characteristic cancel period, and obtaining an EL display device with less display nonuniformity.

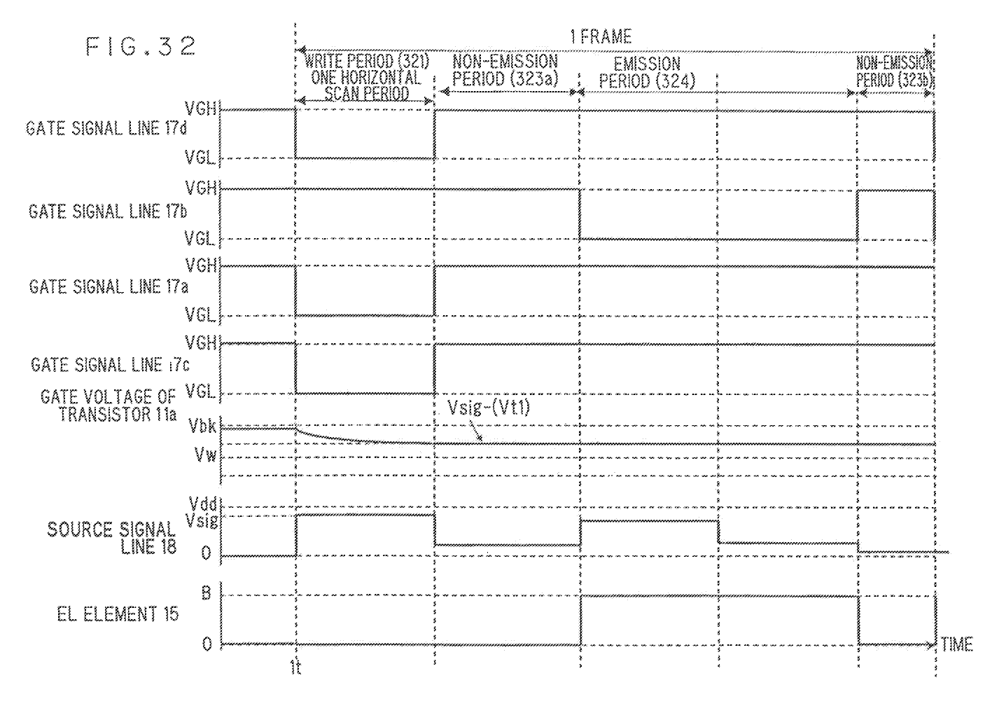

FIG. 31 illustrates a circuit in which the power supply (reset voltage Vrst) used to initialize the gate terminal voltage of the drive transistor 11a is changed from voltage supply to current supply. FIG. 32 represents waveforms of the gate signal lines according to the circuit structure of FIG. 31. In the circuit structure of FIG. 31, the operation of a single pixel includes a write period 321, an emission period 324, and a non-emission period 323 in one frame. The non-emission period 323 is used for black insertion (duty drive, intermittent display drive) to improve operation visibility or other qualities. In embodiments of the present invention, the non-emission period 323 may or may not be provided. The ability to compensate for characteristic variation can be improved regardless.

In the write period 321, the transistors 11b, 11c, and 11f become conductive. In response, the voltage of the source signal line 18 is applied to the source terminal of the drive transistor 11a. By the transistor 11b, the gate and drain terminals of the drive transistor 11a become the same potential, generating gate and drain voltages that cause the current supplied from a current supply 312 to become the drain current of the drive transistor 11a.

Thus, in the write period 321, the gate voltage of the transistor 11a becomes Vsig−Vt1, when the voltage of the source signal line 18 is video signal voltage Vsig. Here, Vt1 is the source-drain voltage of when the current (Irst) of the current supply 312 is flown into the drive transistor 11a, and it takes different values depending on the characteristic of the drive transistor 11a.

When the reset current Irst flows into the drive transistor 11a (EL element 15), the voltage after characteristic variation correction is applied to the gate terminal of the drive transistor 11a. As a result, an EL display device with no display nonuniformity can be realized.

In conventional structures, the characteristic variation is completely corrected when Irst=0 (black display). As the current increases, current variation is generated due to uncorrectable mobility variation. Thus, display nonuniformity is easily generated at high gradations.

Display nonuniformity is not easily recognizable at low luminance, and becomes more noticeable in intermediate to high gradations. Thus, it is more preferable to perform correction in the more noticeable intermediate to high gradations, instead of performing characteristic correction with a current that corresponds to zero gradation. By setting the current value of the output current Irst of the initializing current supply to intermediate to high gradations, display nonuniformity in these noticeable gradations can be eliminated first. Further, because display nonuniformity is not easily recognizable in the unnoticeable gradations even in structures in which mobility variation occurs, the display nonuniformity level can be improved over the whole gradation range. In the present embodiment, current Irst is flown daring the cancel operation of the characteristic variation of the drive transistor, so as to vary the current range in which the characteristic cancel is performed most frequently.

The circuit illustrated in FIG. 33 additionally includes, in the structure of FIG. 31, an initializing voltage supply (which outputs reset voltage Vrst) 331, and a switching unit 333 that switches between the voltage supply 331 and the current supply 312. In varying the voltage of the transistor 11a with the current supply 312, it takes time for the current flowing into the drive transistor 11a to change to Irst in the pixel that was used in the black display performed in the previous frame. Accordingly, the gate voltage of the drive transistor 11a does not easily become Vsig−Vt1 within the write period 321. The additional elements are provided to prevent this problem.

A change in the gate voltage of the drive transistor 11a within the write period 321 occurs more easily when the drain current of the drive transistor 11a is large. As more current flows, the charge and discharge rate of the maintain capacitor 19a increases, and the gate voltage varies more easily.

Thus, in order to increase the rate of change of the gate voltage, the voltage supply 331 is used instead of the current supply 312 to supply a low voltage (lower voltages for whiter displays as in the circuit structure of FIG. 33) to the drive transistor 11a in the early stage of the write period 321, so as to increase the drain current of the drive transistor 11a in the early stage of the write period 321, and thereby increase the speed of the cancel operation, performed by the reset current supply 312, in the remaining period.

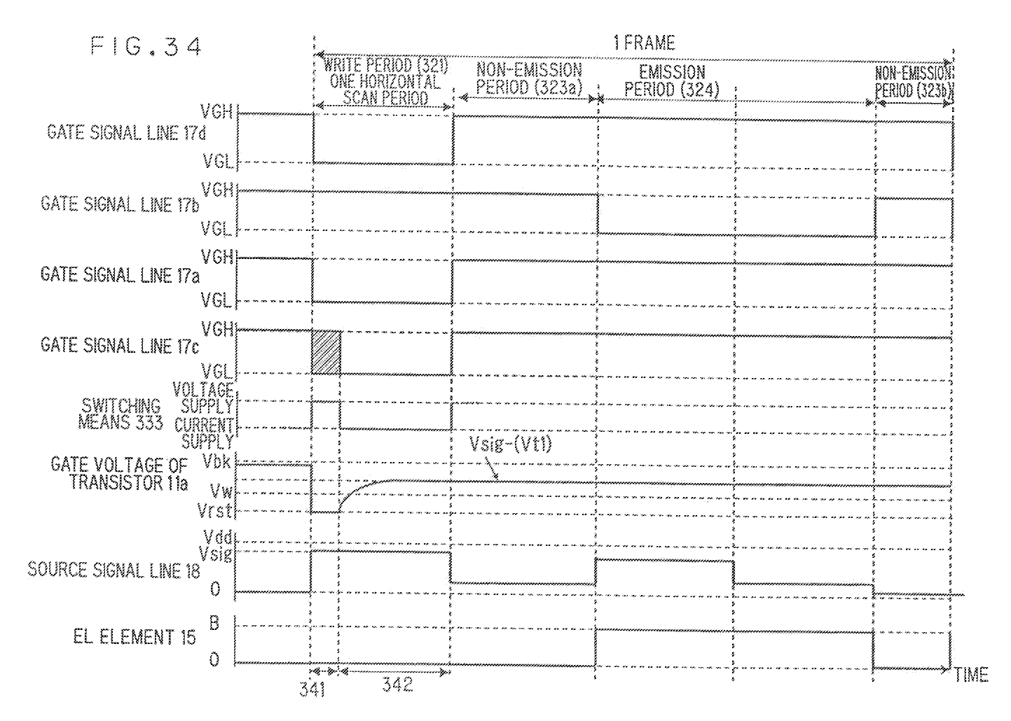

FIG. 34 represents gate signals, and the operation of the switching means in the circuit structure of FIG. 33. In the write period 321, the gate voltage of the drive transistor 11a is Vrst in period 341 in which the voltage is supplied.

The rate of change of the gate voltage when the switching means 333 switches to the current supply 312 increases as the reset voltage Vrst decreases. However, when too low, the difference of the gate potential from a predetermined gradation becomes too large, and the voltage may not be able to vary to a predetermined value.

It is therefore preferable that the reset voltage Vrst take a value of about (white display voltage) to (white display voltage −5 (V)). In the next period 342, the gate voltage varies to Vsig−Vt1, based on the current supply 312, and the source signal line voltage Vsig written in.

Here, because the drain current of the transistor 11a is larger, and the charge and discharge rate of the storage capacitor 19 is faster than in the structure of FIG. 32, the rate of change to Vsig−Vt1 is faster even with the voltage apply period 341 included. This enables the characteristic correction to be performed in even shorter time periods.

FIG. 35 illustrates a circuit structure in which the gate signal lines are individually controlled with the transistors 11e and 11d. In a single pixel, one frame includes a reset period 361, a video signal write/characteristic cancel period 362, a non-emission period 363, and an emission period 364.

The power supply that initializes (resets) the drive transistor 11a is realized by the voltage supply 331 and the current supply 312. The time period in which the voltage supply 331 is applied is a reset period 365, and the time period in which the current supply 312 is applied is a reset period 366.

Note that, in the reset period 361, the drive transistor 11a is initialized based on the current output from the current supply 312, and the reset voltage and current are written into the pixels in the same column and using the same reset line 311. Thus, the reset period 361 must fall in one horizontal scan period.

In the video signal write/characteristic cancel period 362, a voltage corresponding to the video signal is supplied in the same column using the same source signal line 18. Thus, the video signal write/characteristic cancel period 362 must fall in one horizontal scan period. When the reset and the characteristic cancel do not take time, the reset period 361 and the video signal write/characteristic cancel period 362 may be provided within one horizontal scan period.

In the scheme of the present embodiment, the gate voltage of the drive transistor 11a is initialized not only with the voltage supply 331, but with the current supply 312.

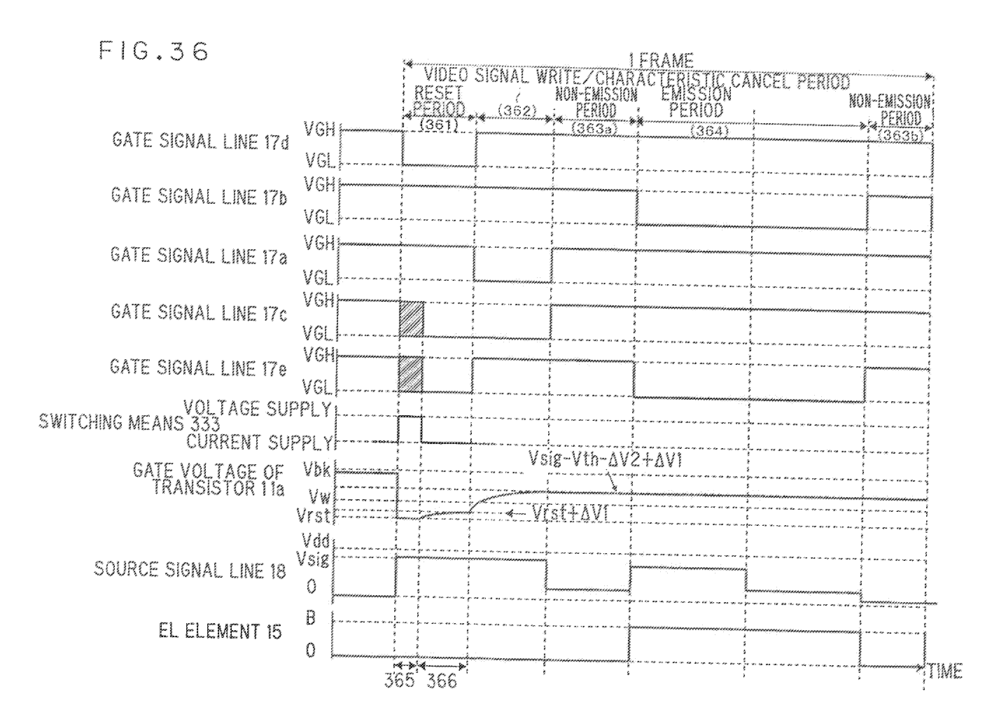

As illustrated in FIG. 36, in period 365 of the reset period 361, the gate voltage of the drive transistor 11a is initialized to Vret by the voltage supply 331, as in conventional structures. Here, the transistors 11e and 11b may be turned on or off by the gate signal lines 17e and 17c. However, it is preferable that at least one of these transistors be turned off, from the standpoint of preventing a through current due to the characteristic of the drive transistor 11a from flowing into the Vrst power supply from the Vdd power supply.

In the present embodiment, a period 366 is provided in the reset period 361, and the drive transistor 11a is initialized with the current supply 312, by the switching of the switching means 333. The transistors 11f, 11b, and 11e are ON state so that the current of the current supply 312 becomes the drain current of the drive transistor 11a.

It is preferable that the current value of the current supply 312 in period 366 be set so that the gate voltage of the drive transistor 11a takes a value close to the Vrst of the voltage supply 331. Because the drive transistor 11a has characteristic variation, Vrst may be the average voltage of the pixels formed in the EL display device. By the provision of the period 366, the gate voltage of the drive transistor 11a varies to Vrst+ΔV1. Here, ΔV1 corresponds to the gate voltage variation of when the current (Irst) of the current supply 312 is flown.

In the video signal write/characteristic cancel period 362, a video signal is supplied through the source signal line 18. Because the transistor 11b is ON state and the transistor 11f is OFF state, the gate voltage of the drive transistor 11a varies to Vsig−Vth, where Vsig is the video signal voltage, Vth is the threshold voltage (threshold value). A change to Vsig−Vth occurs when the characteristic cancel period is sufficiently long. Since the period 362 must end within one horizontal scan period, the characteristic cancel period can have only about 40 μs.

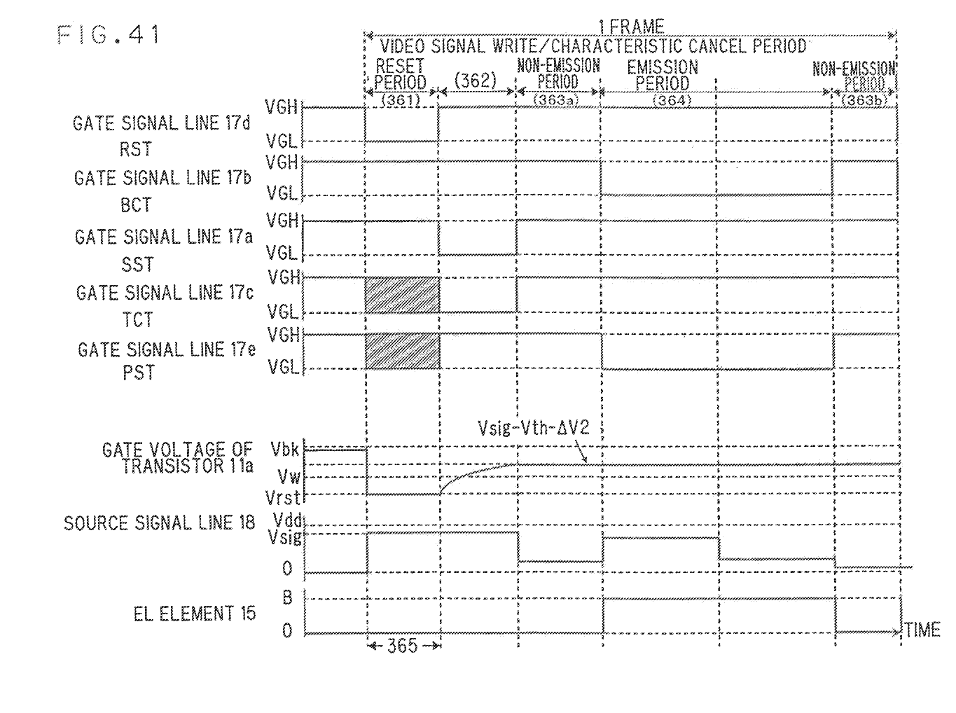

Accordingly, in the structure of FIG. 41 in which there is no period 366, the gate voltage can vary to only (Vsig−Vth−ΔV2). In this case, a potential change corresponding to ΔV2 will be deficient. There will accordingly be a large drain current ΔI2 in the drive transistor 11a to make up for ΔV2. ΔI2 varies according to the characteristic variation of the drive transistor 11a. This causes variation in the current that flows in the EL element 15, and display nonuniformity occurs.

With the period 366, the potential at the end of period 361 is shifted by ΔV1, and therefore the gate voltage at the end of period 362 is Vsig−Vth−ΔV2+ΔV1. Because the constant current applied by the current supply shifts the gate voltage of the transistor 11a by ΔV1, ΔV1 increases when the drive transistor 11a has a large ΔI2 with respect to ΔV2 (when it flows a large current), and ΔV1 decreases (also to negative values) when the drive transistor 11a has a small ΔI2 with respect to ΔV2.

In display nonuniformity, ΔV1 is large and the gate voltage increases in pixels having a large current flow (large ΔI2 for ΔV2). In pixels with a small current, ΔV1 is small, and the gate voltage drops. In pixels that flow large current, the current flow slows as the gate voltage of the drive transistor 11a increases. In pixels that flow small current, more current flows as the gate voltage decreases. This acts to reduce the difference in the amount of current between the pixels, making it possible to improve display nonuniformity.

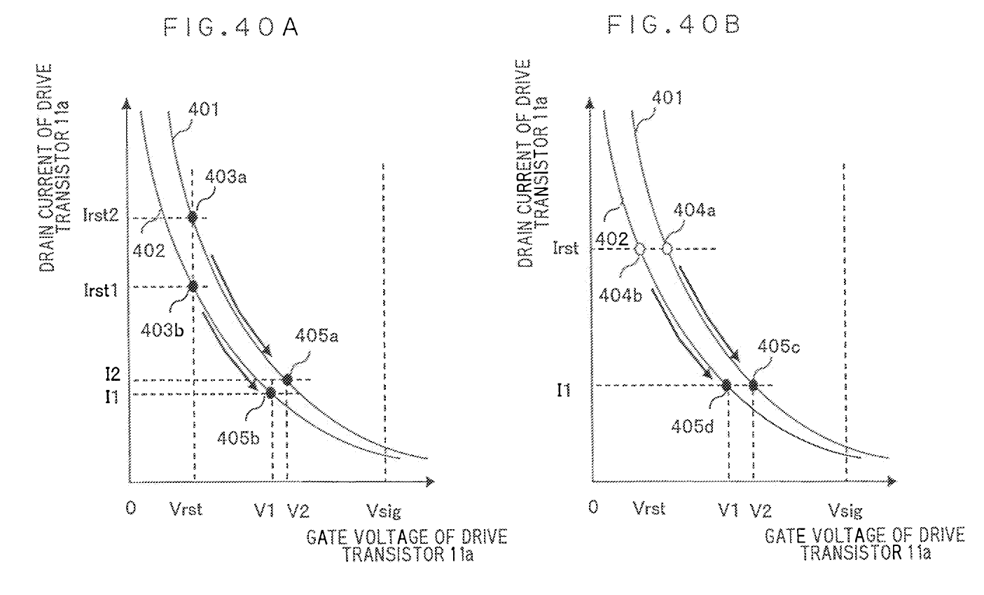

FIG. 40 represents a difference in current value at the end of the video signal write/characteristic cancel period 362 in drive transistors 11a having different current-voltage characteristics. In FIG. 40(a), the reset period 361 is realized only with the voltage supply. In FIG. 40(b), the reset period 361 is realized with the current supply.

In FIG. 40(a), because the drive transistor 11a is initialized only with the voltage supply, the drive transistors 11a of two pixels with characteristics 401 and 402 have different current values, Irst1 and Irst2, for the gate voltage Vrst.

This corresponds to point 403a for characteristic 401, and point 403b for characteristic 402. Next, in the video signal write/characteristic cancel period 362, a video signal is written into the source potential of the drive transistor 11a, and the gate potential, by the threshold cancel operation, starts to vary from the source potential to a point decreased by the amount of threshold voltage. As an example, this takes about 100 μs. Thus, in one horizontal scan period, the change does not sufficiently proceed to cancel voltage 406, and stops at point 405.

The amount of voltage change is determined by the flowing current, and the floating capacitor (ΔV=I·T/C, where i is the flowing current, T the length of cancel period 362, and C the floating capacitor). The current at point 403a is larger than at point 403b. Accordingly, the amount of potential change is larger in the transistor represented by curve 401, and the voltage varies to V2.

In curve 402, the voltage only varies to V1 because the current is small at point 403b. The drain currents at point 405a and point 405b are different, I2 and I1, respectively, and this difference may be visually recognized as display nonuniformity.

On the other hand, when a reset is performed using the current supply, the gate voltages with respect to drain current Irst are different, Vrst1 and Vrst2, between the curves 401 and 402 (points 404a and 404b), at the end of the reset period 361, as represented in FIG. 40(b). Next, in response to the cancel in the video signal write/characteristic cancel period 362, ΔV is the same in curves 401 and 402, and the voltages vary to V1 and V2, respectively, by the same amount of potential shift (points 405C and 405d). This is because of the same current Irst and no variation in the floating capacitor, and the same cancel time as afforded by the same panel. Here, the drain current is I1 in the both curves, and the current value written after the characteristic cancel period 362 will be the same even when the drive transistors 11a have different characteristics. There will accordingly be no display nonuniformity.

By individually setting the gate voltage of the drive transistor 11a with a constant current in the reset period, there will be only a small current variation even when the gate voltage of the drive transistor 11a, because of a short cancel period, differs from the voltage that is completely characteristic canceled.

A reset using only the current supply may be performed in period 366, without providing period 365. However, because it takes time to vary the gate voltage to a voltage close to Vrst by the current supply 312, it is preferable to perform the reset by the current supply 312 after the voltage has been varied to a voltage close to Vrst by the voltage supply 331. The voltage supply 331, the switching means 333, and the period 365 may not be provided when the reset period 361 is long, and when the current supply 312 alone can vary the voltage to Vrst+ΔV1.

The EL display device of the pixel circuit structure illustrated in FIG. 35 may be implemented in combination with a structure in which a plurality of source signal lines are provided for the pixels of the same column, and in which a video signal is written into the adjacent pixels of the source signal line direction through different source signal lines to increase the write time. For example, FIG. 37 illustrates a circuit provided with two source signal lines.

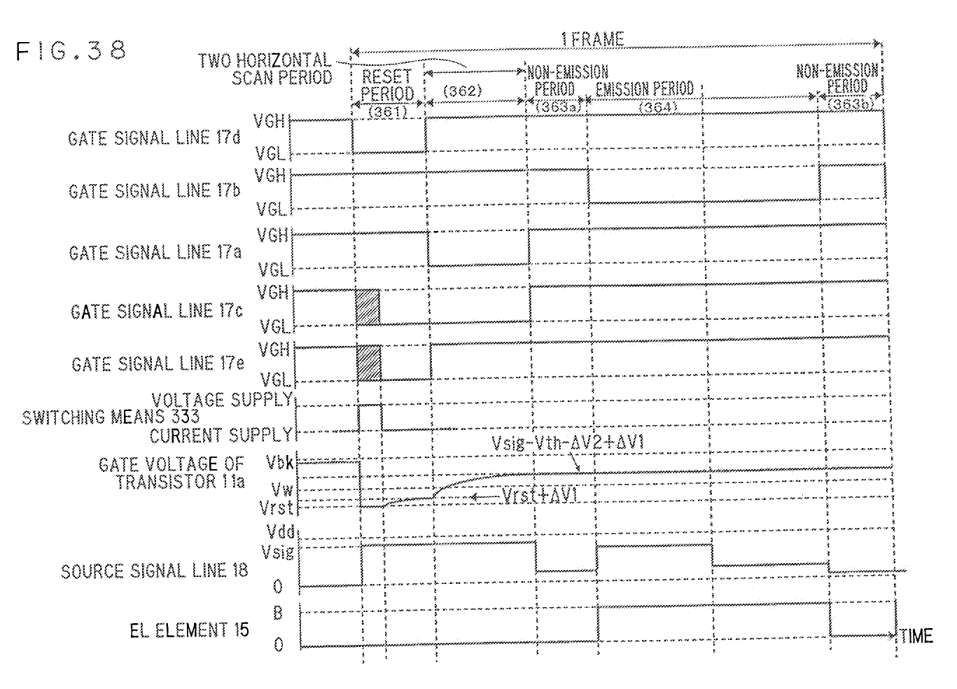

With two source signal lines 18, as described in FIG. 14, FIG. 16, FIG. 19, and elsewhere, the gradation signal applied to the source signal lines 18 varies every two horizontal scan periods. This makes it possible to increase the video signal write/characteristic cancel period 362 to at most two horizontal scan periods. For example, the drive waveforms represented in FIG. 38 can be realized. With a longer period 362, the time required for the gate voltage of the drive transistor 11a to vary can be increased. This reduces the absolute value of error ΔV2, enabling a more accurate cancel.

In the structure of FIG. 37, (only one reset line 311 is provided for the pixels of the same column. However, a plurality of (for example, two) reset lines 311 may be provided as with the source signal lines 18. In this case, the reset period 361 can be increased to at most two horizontal scan periods, and the reset voltage will be more in accordance with the characteristic of the drive transistor 11a.

In the structures of FIG. 37 and FIG. 35, the current supply 312 and the voltage supply 333 are connected to the reset line 311 via the switching means 333. However, the voltage supply 311 will not be required, and only the current supply 312 can be used to provide the reset period 361, provided that the current supply 312 can vary the gate voltage of the drive transistor 11a until a predetermined initial potential is obtained within one horizontal scan period. Here, the operation for one frame period will look like the one represented in FIG. 39.

The gate voltage of the drive transistor 11a converges to Vrst+ΔV1. Since the value of Vrst+ΔV1 is the same even when the voltage supply 331 is used together as in FIG. 36 and FIG. 38, the effect of initialization will remain essentially the same. It is therefore possible to use only the current supply.

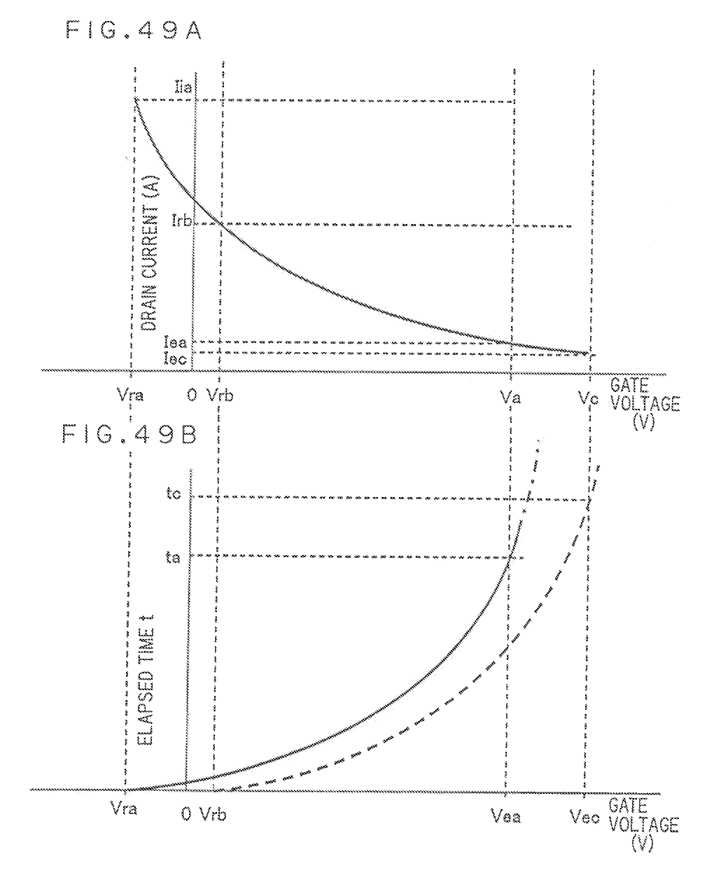

As described above with reference to FIG. 40 and elsewhere, when the drive transistor 11a is a P-channel transistor, the current that flows through the channel decreases as the gate terminal voltage is increased. FIG. 49 represents this relationship. In FIG. 49, the horizontal axis indicates the gate terminal voltage of the drive transistor 11a. The values are positive toward the right. The vertical axis of the graph indicates the current that flows through the channel (across the source and drain terminals) of the drive transistor 11a. The values are positive upward. In the lower graph, the vertical axis indicates elapsed time, and the values are positive upward.

In the figure, the drain current of the drive transistor 11a decreases in response to the offset operation which starts as the reset voltage Vra is applied to the drive transistor 11a and the transistor 11b is closed. The current that flows first in response to the applied reset voltage Vea is Iia, which decreases with time and becomes Iea at voltage Vea of a preset gradation (first gradation), and Iec at voltage Vec of another preset gradation (second gradation).

The lower graph is a plot of elapsed time against gate terminal voltage. The time required between reset voltage Vra and Vea is ta. However, a change from reset voltage Vra to Vec takes a considerably long time, as indicated by dash-dot line. Accordingly, it takes a considerably long offset time before the gate terminal voltage of the drive transistor 11a becomes Vec.

When the reset voltage Vrst is Vrb, the gate voltage varies in the manner of the curve indicated by dashed line in the lower graph. The channel current decreases with time from Irb. The gate terminal voltage reaches Vea at time tb, and Vec at time tc.

When reset voltage Vrst=Vrb, the gate terminal voltage becomes Vec after elapsed time tc, and the current becomes Iec. This is in contrast to the considerably long time required to reach current Iec as in the solid line of the lower graph. Instead, the target value Iec is reached in a relatively short time period.

From the relationship represented in FIG. 49, it can be seen that the target value current can flow in the EL element 15 within a specified elapsed time (offset cancel period) when the reset voltage Vrst is varied between the first and second gradations.

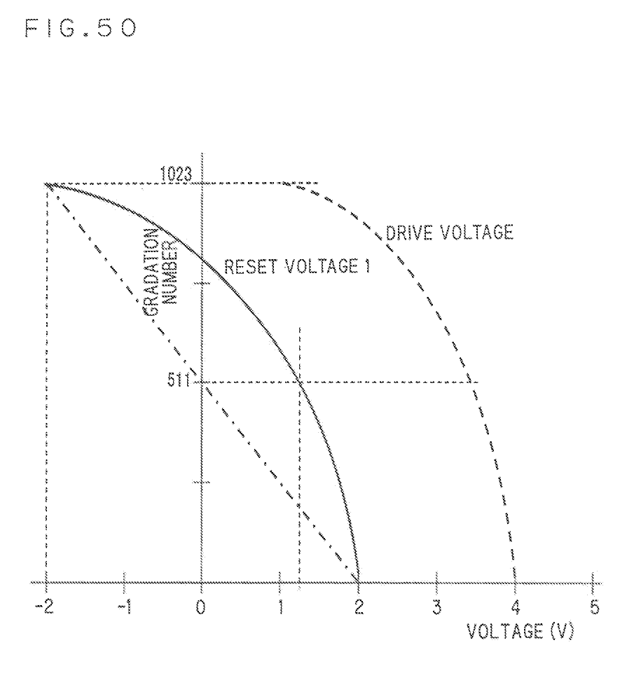

As represented in FIG. 50, there is an appropriate relationship between gradation voltage (the voltage applied to the drive transistor 11a) and reset voltage Vrst.

In FIG. 50, the horizontal axis indicates voltage (the voltage applied to the drive transistor 11a), and the vertical axis indicates gradation number. In FIG. 50, the drive transistor 11a is a P-channel transistor. As such, the gate terminal voltage of the drive transistor 11a is small when the gradation is high, and large (close to the anode voltage) when the gradation is low.

In FIG. 50, the drive voltage (gradation voltage, program voltage) is indicated by dashed line. As the reset voltage Vrst, a voltage of a certain value below the gradation voltage is applied as the reset voltage. Reset voltage 1 is indicated by solid line. At gradation 1023, the reset voltage Vrst is −2 V, and about 1.3 V at gradation 511.

Reset voltage 1 represents a case where a voltage of a certain value below the gradation voltage (drive voltage) is applied. However, the present invention is not limited to this. For example, the reset voltage may be a straight line with respect to the gradation, as indicated by dash-dot line (reset voltage 2) in FIG. 50. Further, the reset voltage may be nonlinear or stepwise with respect to the gradation.

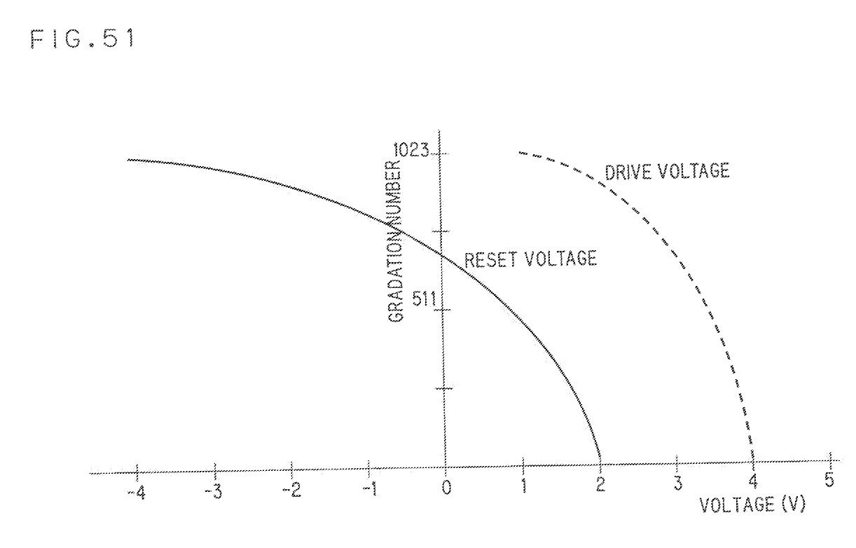

Further, as represented in FIG. 51, the reset voltage (solid line) may be nonlinear to the gradation. The reset voltage may be smaller for higher gradations, and the difference between the drive voltage and the reset voltage may be smaller for lower gradations.

The reset voltage Vrst is set as in FIG. 51 for the reasons below. At high gradations, the drive transistor 11a has a large channel at the time of offset, and accordingly the offset cancel can be performed sufficiently even when the reset voltage Vrst and the drive voltage have large absolute voltages. Another reason is that the gradation display can be performed properly even when the voltage does not sufficiently converge to an offset voltage.

On the other hand, the reset voltage Vrst is set as in FIG. 51 for the reasons below. At high gradations, the drive transistor 11a has a large channel at the time of offset, and accordingly the offset cancel can be performed sufficiently even when the reset voltage Vrst and the drive voltage have large absolute voltages. Another reason is that the gradation display can be performed properly even when the voltage does not sufficiently converge to an offset voltage.

At low gradations, the drive transistor 11a has a small channel at the time of offset, and the offset cancel cannot be performed sufficiently without lowering the absolute voltages of the reset voltage Vrst and the drive voltage.

As described above, one of the technical ideas of this embodiment is to vary the reset voltage Vrst according to the gradation voltage. That is, a technical idea of the embodiment is to vary the reset voltage Vrst according to the video signal voltage. Here, the corresponding change in reset voltage Vrst means that the reset voltage Vrst is varied or different reset voltages Vrst are used for at least an arbitrary, first gradation and second gradation. The driving scheme described in FIG. 42 and elsewhere is based on this scheme, and intends to provide the foregoing effects.

The following will describe another embodiment of the present invention with reference to FIG. 42. In FIG. 42, a capacitor 19b is disposed or formed between the drive transistor 11a and the source terminal of the drive transistor 11a. The capacitor 19b is connected to the wire to which the reset voltage Vrst is applied, and the wire to which a video signal Vsig is applied through the source signal line 17. The capacitance of the capacitor 19b is set to be at least 50% and at most 150% of the capacitance of the maintain capacitor 19a.

In the following, for ease of understanding, the capacitance of the maintain capacitor 19a will be described as being considerably larger than the capacitance of the capacitor 19b, and a voltage change at terminal a of the capacitor 19b will be described as being completely reflected at terminal b (a structure somewhat unrealistic, but presented for ease of understanding). For example, when the potential at point a varies from 5V to 3 V, the potential at point b becomes 5−3=2 V.

The capacitor 19b serves to vary the potential of the reset voltage Vrst with the video signal voltage Vsig. Thus, the capacitor 19b is disposed (formed) so that one of its terminals is connected to the wire to which the reset voltage Vrst is applied or the wire to which the reset voltage Vrst is transmitted, and the other terminal is connected to the wire to which the video signal voltage Vsig is applied or the wire to which the video signal voltage Vsig is transmitted. Further, the capacitor 19b is provided so that the voltage generated by the interaction of the video signal voltage Vsig and the reset voltage Vrst applied thereto acts on the voltage or potential applied to or maintained at the gate terminal of the drive transistor 11a.

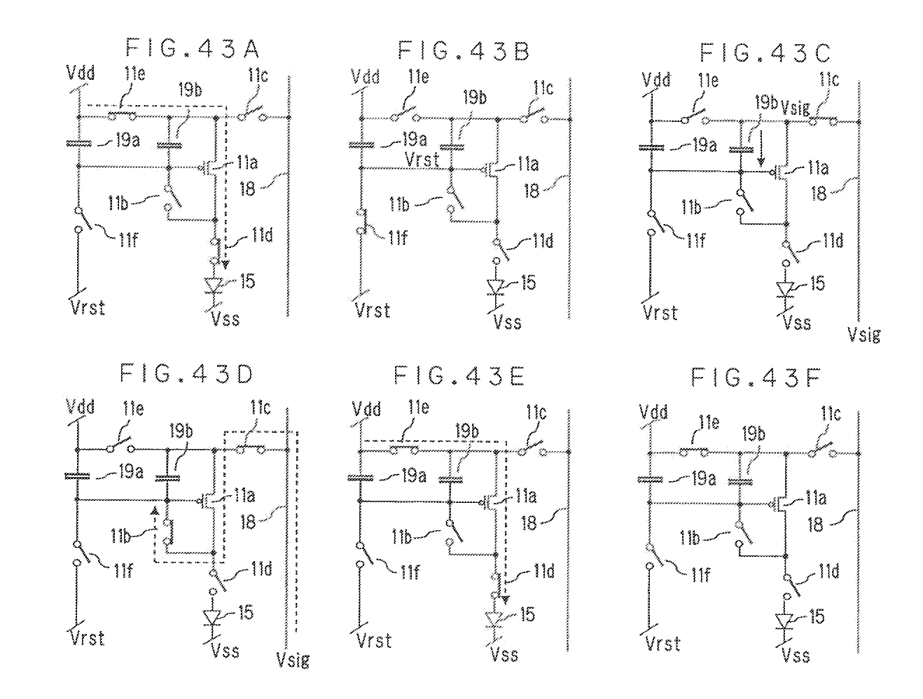

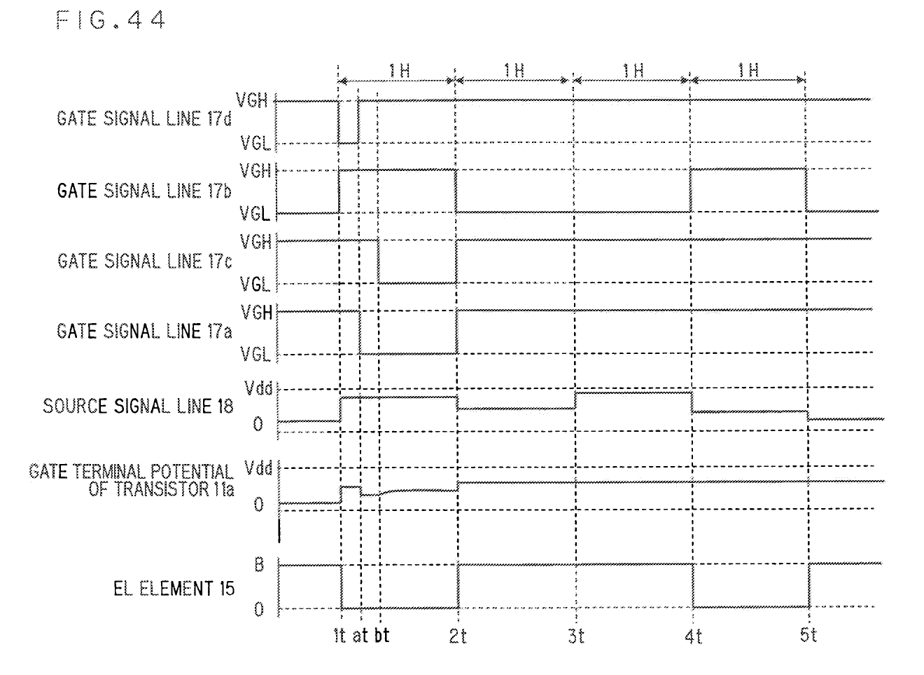

FIG. 43 is an explanatory diagram explaining the operation of the pixel configuration of FIG. 42. In FIG. 42 and other figures, the current path is indicated by dashed line, and the switch transistors 11 are depicted as switches. The transistors 11 are OFF when the switches are open, and ON when the switches are closed. FIG. 44 is a timing chart of the operation depicted in FIG. 43. Note that, in this specification, the timing charts are only schematically represented, as in the present and other embodiments of the present invention.

In the state of FIG. 43(a), current is supplied to the EL element 15, and the EL element 15 emits light (illumination).

The voltage program operation (the operation or period in which the current flowing into the EL element 15 of the pixel 16 is refreshed) begins in FIG. 43(b). First, switch transistor 11f turns on, and the reset voltage Vrst is applied to the gate terminal of the drive Transistor 11a. The reset voltage Vrst is preferably at least −2 V and at most 3 V.

As the switch transistor 11f turns on, the reset voltage Vrst is applied in periods it to at of FIG. 44. During the time period in which the reset voltage Vrst is applied, the switch transistors 11b, 11e, 11c, and 11d are OFF.

Next, as illustrated in FIG. 43(c), the switch transistor 11c turns on. As the switch transistor 11c turns on, video signal voltage Vsig is applied to point a of FIG. 42. As an example, the video signal voltage Vsig is a voltage of at least 0V and at most 5 V. The video signal voltage Vsig varies according to a video signal.

As a result of the foregoing operation, the reset voltage Vrst is applied to point b of FIG. 42, and then the video signal voltage Vsig is applied to point a. Ideally, the voltage Vsig is divided between the maintain capacitors 19a and 19b. The proportions of the divided voltages are determined by the capacitance ratio of the maintain capacitors 19a and 19b.

For ease of explanation, the reset voltage Vrst is −1 V, and the video signal voltage is 1 V or 4 V. It is assumed here that 1 V is the voltage used to flow the maximum current (white display current) to the EL element 15, and that 4 V is the voltage that does not cause a current flow (black display current) into the EL element 15. The anode voltage Vdd is assumed to be 5 V.

When the video signal voltage Vsig is 1 V, 1 V is applied to point a, and −1 V at point b in FIG. 43(b). Before the application of 1 V at point a (FIG. 43(a)), a voltage of 5 V is applied to point a.

In this state, the voltage applied to point a varies from 5 V to 1 V by the voltage Vsig. In response to the potential change from 5 V to 1 V at point a (a voltage change of 5−1=4 V), the potential at point b changes by 4 V (assumed here that the capacitance of the maintain capacitor 19a is considerably larger than the capacitance of the capacitor 19b). As a result, the potential at point b varies from −1 V to −5 V (−1 V+(−4) V). By the foregoing operation, when the video signal voltage Vsig is 1 V, the potential at the gate terminal voltage (point b) of the drive transistor 11a becomes −5 V.

When the video signal voltage Vsig is 4 V, 4 V is applied to point a, and −1 V at point b in FIG. 43(b). Before the application of 4 V at point a (FIG. 43(a)), a voltage of 5 V is applied to point a.

In this state, the voltage applied to point a varies from 5 V to 4 V by the voltage Vsig. In response to the potential change from 5 V to 4 V at point a (a voltage change of 5−4=1 V), the potential at point b changes by 1 V (assumed here that the capacitance of the maintain capacitor 19a is considerably larger than the capacitance of the capacitor 19b). As a result, the potential at point b varies from −1 V to −2 V (−1 V+(−1) V). By the foregoing Operation, when the video signal voltage Vsig is 4 V, the potential at the gate terminal voltage (point b) of the drive transistor 11a becomes −2 V.

When the video signal voltage Vsig is 1 V, the potential at the gate terminal voltage (point b) of the drive transistor 11a is −5 V. Accordingly, the potential difference between the video signal voltage Vsig and the reset voltage Vrst is 1−(−5)=6 V.

When the video signal voltage Vsig is 4 V, the potential at the gate terminal voltage (point b) of the drive transistor 11a is −2 V. Accordingly, the potential difference between the video signal voltage Vsig and the reset voltage Vrst is 4−(−2)=6 V.

That is, when the video signal voltage Vsig=1 V, the offset cancel operation starts at reset voltage Vrst=−5 V (FIG. 43(d)). When the video signal voltage Vsig=4 V, the offset cancel operation starts at reset voltage Vrst=−2 V (FIG. 43(d)).

As described above, in the embodiment of FIG. 42, the reset voltage Vrst varies according to a video signal. That is, the relationship between video signal voltage (drive voltage) and reset voltage 1 explained in FIG. 50 is realized.

In FIG. 43(c), a reset voltage Vrst for starting the offset cancel is decided (set) with the video signal voltage Vsig. This is because the initial reset voltage Vrst (FIG. 43(b)) varies according to the magnitude of video signal voltage Vsig (FIG. 50).

The foregoing description of this embodiment has been given through the case where, for ease of understanding or explanation, the capacitance of the maintain capacitor 19a is considerably larger than the capacitance of the capacitor 19b, and where the potential applied to point a is reflected at point b in FIG. 42, or the potential applied to point b is reflected at point a in FIG. 42.

However, in actual practice, the voltage reflected (varied) at point b varies depending on such factors as the capacitances of the maintain capacitors 19a and 19b, the parasitic capacitance of the drive transistor 11a, the parasitic capacitance of other switching transistors 11, and the punch-through voltage of the gate signal lines 17.

Thus, in the present embodiment, the capacitance of the capacitor 19, and the operation of the switching transistors 11 are determined taking into account the influence of these factors. This is not a departure from the technical idea of the present embodiment. Note that the capacitances or the capacitance ratio of the capacitors 19b and 19a are determined according to the voltage set to point b.

For example, depending on the characteristic of the insulating film, the capacitors 19 can have a capacitance c of nonlinear characteristics with respect to the applied voltage. Thus, by forming the capacitors 19 or other elements with appropriate design or considerations, the reset voltage Vrst can vary (nonlinearly) with respect to drive voltage Vsig as in FIG. 51, even with the configuration and the driving scheme of FIG. 42.

In applying the reset voltage Vrst in FIG. 42B, the potential at point a varies when the reset voltage Vrst is applied with the switch transistor 11e turned off. In response to the video signal voltage Vsig applied next in FIG. 42C, the potential at point b varies using the potential at point a as reference.

As described above, by setting or changing the control timing of each transistor 11 to various states, it is possible to realize a wide variety of schemes, and to control potential as in point a and point b.

The state of FIG. 43(c) corresponds to periods at to bt in FIG. 44. The reset voltage Vrst varies according to video signal voltage Vsig.

FIG. 43(d) corresponds to an offset cancel period. The switch transistors 11e, 11d, are 11f open, and the switch transistors 11c and 11b are closed. By setting the switch transistors 11 this way, the video signal voltage Vsig is applied to the gate terminal of the drive transistor 11a through the channel of the drive transistor 11a. The current (drain current) for the video signal voltage Vsig decreases nonlinearly following the application of the reset voltage Vrst as in FIG. 49. The offset cancel continues for 1H (one horizontal scan period, bt to 2t in FIG. 44).

FIG. 43(e) represents an emission period of the EL element 15 (2t to 4t, and 5t and after in FIG. 44). The switch transistors 11c, 11b, and 11f are off (open), and the switch transistors 11e and 11d are on (closed). The anode voltage supply Vdd supplies current to the EL element 15 via the switch transistor 11e, the drive transistor 11a, and the switch transistor 11d.

FIG. 43(f) represents an operation in a display period. The operation corresponds to a non-emission period of the EL element 15 (4t to 5t in FIG. 44). By the ON/OFF control of at least one of the switch transistors 11d and 11e, the image display (black insert drive, duty drive) of FIG. 12, FIG. 13, FIG. 84, FIG. 98, FIG. 99, and elsewhere can be realized.

In the display period, the driving method represented in FIG. 43(e) and FIG. 43(f) is performed. Whether the image to be displayed is a moving image, a still image, or a semi-moving image is automatically detected, and the ON/OFF period or ON/OFF timing of at least one of the switch transistors 11d and 11e is controlled. In this way, an image display can be properly performed for both moving and still images.

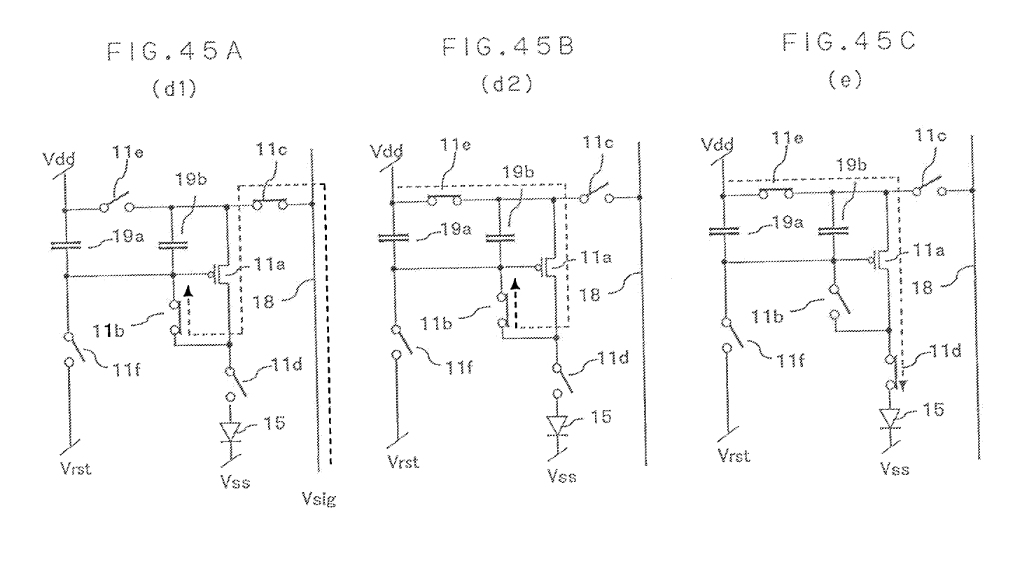

FIG. 45 is another example of the driving method of the embodiment described in FIG. 43. In the driving method of FIG. 45, the period of FIG. 43(d) is divided into two periods (FIG. 45(d1), FIG. 45(d2)).

The driving method of FIG. 45 is intended to perform mobility variation correction for the drive transistor 11a. The driving method of FIG. 43 mainly corrects only variation Vt.

In the period of FIG. 45(d), the switch transistor 11e is OFF (as in FIG. 45(d1)), whereas the switch transistor 11e is ON in FIG. 45(d2). Thus, as illustrated in FIG. 45(d2), the current flows in the path indicated by dashed line.

In FIG. 43(e), the switch transistor 11e is ON, and the switch transistor 11b is OFF. That is, in the driving method of FIG. 45(d2), the switch transistor 11e is turned on for a short time period with the switch transistor 11b turned on, before the period of FIG. 43(e). In other words, it is a driving scheme in which the ON state of the switch transistor 11b is extended for a short time period when turning on the switch transistor 11e.

The short time period is at least 0.05 μs and at most 5 μs. Preferably, the short time period is varied according to the video signal voltage Vsig applied to the pixel. It is also preferable to vary the short time period according to the illumination rate. The change may be linear, nonlinear, or stepwise (for example, the short time may be 0.1 μs for 50% or higher illumination rate, and 2 μs for less than 50% illumination rate).

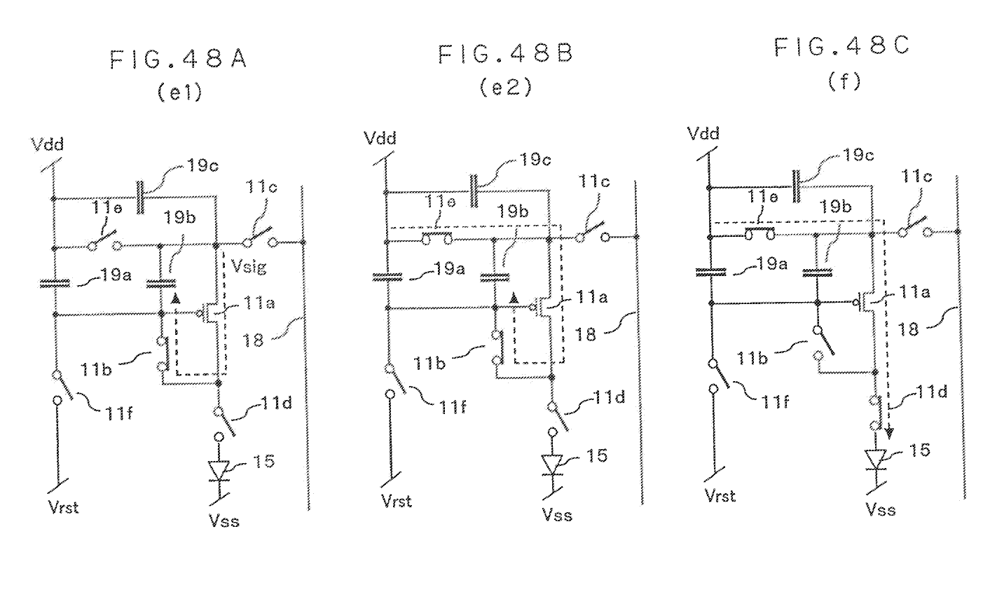

By increasing the ON resistance of the switch transistor 11b, the period of FIG. 45(d2) can be increased, and the mobility correction can be stably carried out. The ON resistance can be increased by increasing the ON voltage (VGL). Preferably, the adjustment is made for individual panels. The adjustment can be readily performed with the use of the power circuit 12 described in FIG. 60 and elsewhere. By adjusting or setting the ON resistance, the period of FIG. 45(d2) can be held constant. The same applies to the embodiment of FIG. 48.

As represented in FIG. 78, FIG. 79, FIG. 98, and FIG. 99, it is preferable to control or vary the duty ratio in correlation with the illumination rate. In this way, power consumption can be averaged by suppressing the peak current. The duty ratio is made smaller (reduced) at high illumination rates. This suppresses the peak current.

The ON time ratio (%) (hereinafter, “ON ratio”) for one horizontal scan period (1H) corresponds to the period of FIG. 45(d2). The ON time is the ON time (closed time) of the switch transistor 11b. When 1H is 20 μs, 10% ON time is 2 μs.

The mobility correction effect of the drive transistor 11a is enhanced as the ON ratio increases. However, in this case, discharge occurs in the capacitor 19. This increases the gate terminal potential of the drive transistor 11a (toward the anode voltage), and varies the current that flows into the EL element 15.

The mobility correction effect of the drive transistor 11a attenuates as the ON ratio decreases. However, the charge in the capacitor 19 is maintained, and the gate terminal potential of the drive transistor 11a does not change from the state (FIG. 45(d1)) after the offset cancel.

In the offset cancel drive, black gradations (low gradations) are offset canceled, and the characteristic variation of the drive transistor 11a is not noticeable. However, in white gradations (high gradations), the characteristic variation of the drive transistor 11a becomes noticeable because of the far distance from the offset cancel point. Mobility accounts for such characteristic variations of the drive transistor 11a. The mobility correction is performed by the operation of FIG. 45(d2).

For the reasons above, the operation of FIG. 45(d2) is not usually required at low gradations. However, at high gradations, the characteristic variation of the drive transistor 11a can be corrected by performing the operation of FIG. 45(d2). The characteristic variation correction effect by the operation of FIG. 45(d2) is dependent on the ON ratio. The high gradation correction effect is enhanced as the ON ratio increases, and attenuates as the ON ratio becomes smaller. The operation of FIG. 45(d2) is usually not required at low gradations.

At low illumination rates, the number of low gradation display pixels is large. At high illumination rates, the number of high gradation display pixels is large. It is therefore preferable that the ON ratio be determined as indicated by the dashed line in the lower graph of FIG. 78. Specifically, the ON ratio is 0 (the operation of FIG. 45(d2) is not performed) at a low illumination rate, and it is increased as the illumination rate increases. That is, the period of FIG. 45(d2) is increased.

It should be noted here that the large numbers of low gradation display pixels at low illumination rates are statistics, and it may not be the case in actual practice. Similarly, the large numbers of high gradation display pixels at high illumination rates are based on statistics. In actual practice, the number of low and high gradation display pixels varies depending on display patterns, and the type of video signal. It is therefore preferable that the ON ratio be made variable according to display patterns, and the type of input video signal (PC video, AV video, etc.).

An embodiment of this is represented by the solid line in the lower graph of FIG. 78. The ON ratio is at maximum when the illumination rate is 20%, and is made smaller at lower and higher illumination rates.

The ON ratio and the illumination rate, described as being related to each other in the embodiment of FIG. 78, are not limited to this embodiment. The ON ratio may be time (for example, 2 μs) instead of a ratio. The illumination rate may be a histogram of each gradation. Further, the illumination rate may be power consumption, or a current that flows in the display region 31.

As illustrated in FIG. 79, the number of gradations used may be varied in correlation with the illumination rate. In FIG. 79, the source driver IC 14 accommodates RGB of 10 bits (1024 gradations). The number of gradations used is varied according to the illumination rate. For example, when the number of usable gradations is 1024, an image can be displayed using gradation 1 to gradation 1024, and the usable gradation of 256 means that an image can be displayed using gradation 1 to gradation 256 (gradation 257 to gradation 1024 are not usable; see also FIG. 99).

The number of usable gradations affects the current flown into the EL element 15. When the number of usable gradations is 1024, and gradation 1024 is used, the maximum current can be flown into the EL element 15. When the number of usable gradations is 525, the luminance will be only half the luminance of gradation 1024 even when the maximum gradation 525 is designated (for ease of understanding, the gamma curve is considered linear).

In the embodiment represented by the solid line in FIG. 79, an image can be displayed with up to 1024 gradations at illumination rates of 25% or less. At the illumination rate of 100%, an image can be displayed with up to only 256 gradations. In a range of illumination rate from 25% to 100%, a gradation display can be realized over the gradation range of 1024 to 256, in proportion to the illumination rate.

The number of usable gradations for a particular illumination rate is determined by first finding the illumination rate, and multiplying the input video signal by this illumination rate or similar data.

In FIG. 78, it is preferable that the change point a be variably set. The variable point is stored in EEPROM. The same applies to point b, and to points d and e of FIG. 79. The straight line or curve may have a number of bends.

For ease of explanation, the embodiment above described the case where the gamma curve of the video signal is a straight line. However, in actual practice, the gamma curve is a function with a gamma value of 2, 2.2, or in the vicinity of these values.

For example, when the brightness of gradation 1024 is 1.0, and the characteristic curve has a gamma of 2, the brightness is 0.75, 0.50, and 0.25 for gradations 887, 724, and 512, respectively. When the characteristic curve has a gamma of 2.2, the brightness is 0.75, 0.50, and 0.25 for gradations 898, 747, and 545, respectively. Thus, in actual practice, the gradations to be controlled or set should be determined using these values of brightness (luminance, illuminance) as reference.

By adjusting or setting the short time period, the mobility variation of the drive transistor 11a can be compensated in certain amounts. Preferably, the short time period is set in conformity with the characteristic of the drive transistor 11a of the panel.

In a display panel of an embodiment of the present invention, the control of illumination rate, duty, and the maximum number of usable gradations can be readily realized by controlling or setting the switch transistor 11d that controls the current flowing in the current path of the EL element 15, the video signal voltage Vsig output by the source driver IC 14, the magnitude of the reset voltage Vrst, the gamma circuit of FIG. 108 and FIG. 109, and the magnitude and/or apply time of cancel voltage Vr. These can be realized with unique, additional effects when combined with the control or change of the voltages with the power circuit of, for example, FIG. 61, and the control or change of the cathode (anode) voltage according to temperature, external light, or illumination rate as in FIG. 98 and FIG. 99.

In the embodiment of FIG. 43 and FIG. 45, the offset cancel period is the period from bt to 2t of FIG. 44 within 1H. However, the embodiment is not limited to this. In FIG. 43(d), the switch transistor 11a may be turned off, and the switch transistor 11b may be turned on (the other switch transistors 11e, 11f, 11d are OFF) to maintain longer than 1H period (after 2t in FIG. 44). This is possible because the offset cancel state is sustained by the video signal voltage Vsig maintained at point a even after the switch transistor 11c is turned off. Accordingly, the offset cancel time will not be insufficient. In FIG. 43(d), the period in which the switch transistor 11c is turned off, and the switch transistor 11b is turned on (the other switch transistors 11e, 11f, 11d are OFF) is preferably varied according to the magnitude of the video signal voltage Vsig applied to pixel 16.

The other structure will not be described because it is essentially the same as that described in FIG. 1 and elsewhere. In the structure of FIG. 42, a three-select circuit may be provided at the output terminal of the source driver IC 14.

The same applies to the other embodiments of the present invention.

FIG. 46 is a modification example of FIG. 42. FIG. 46 differs from FIG. 42 in that it additionally includes a capacitor 11c, as in FIG. 1. The capacitor 11c functions and operates in basically the same ways as in FIG. 1.

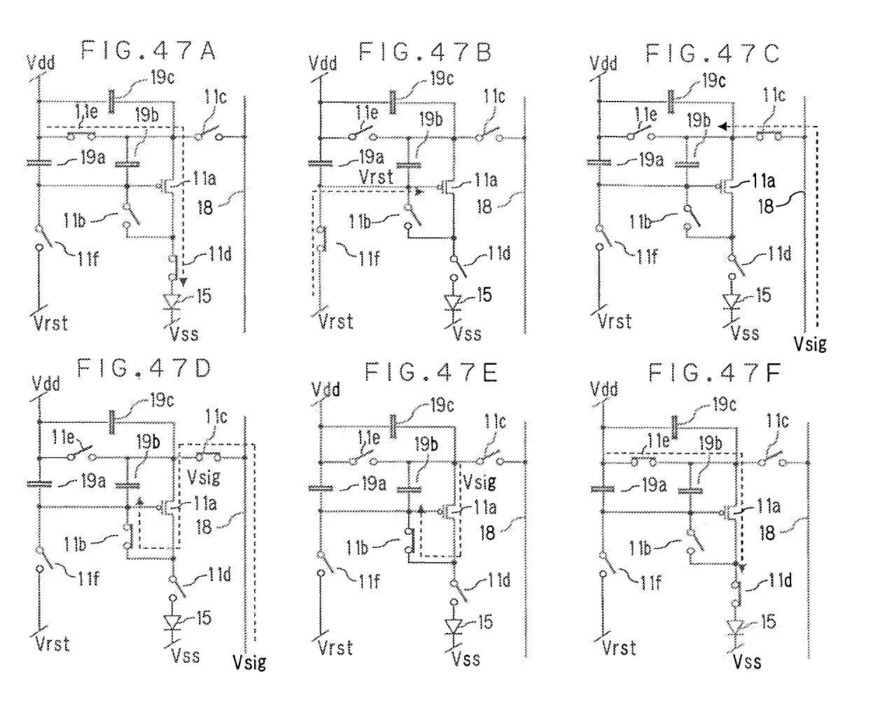

FIG. 47 is an explanatory diagram explaining the operation of the pixel configuration of FIG. 46. In FIG. 47, as in FIG. 43, the current path is indicated by dashed line, and the switch transistors 11 are depicted as switches. The transistors 11 are OFF when the switches are open, and ON when the switches are closed.

In the state of FIG. 47(a), current is supplied to the EL element 15, and the EL element 15 emits light (illumination).

In FIG. 47(b), the switch transistor 11f turns on, and the reset voltage Vrst is applied to the gate terminal of the drive transistor 11a. Preferably, the reset voltage Vrst is at least −2 V and at most 3 V.

As the switch transistor 11f turns on, the reset voltage Vrst is applied to the gate terminal of the drive transistor 11a. During the time period in which the reset voltage Vrst is applied, the switch transistors 11b, 11e, 11c, and 11d are OFF.

Next, as illustrated in FIG. 47(c), the switch transistor 11c is turned on. As the switch transistor 11c turns on, video signal voltage Vsig is applied to point a of FIG. 42.

As a result of the foregoing operation, the reset voltage Vrst is applied to point b of FIG. 42, and then the video signal voltage Vsig is applied to point a. Ideally, the voltage Vsig is divided between the maintain capacitors 19a and 19b. The proportions of the divided voltages are determined by the capacitance ratio of the maintain capacitors 19a and 19b.

The operation of FIG. 47(c) is the same as that of FIG. 43(c). The operation of FIG. 47(d) is the same as that of FIG. 43(d).

The difference from the embodiment of FIG. 43 is the operation of FIG. 47(e). Specifically, by the voltage applied to one terminal (point a in FIG. 46) of the capacitor 19c, the video signal voltage Vsig remains being supplied to the drive transistor 11a even after the switch transistor 11c has been turned off, and the offset cancel period continues. Thus, by the effect of the capacitor 19c, the offset cancel period continues regardless of whether the video signal voltage Vsig is supplied from the source driver IC 14. Note that the operation of FIG. 47(f) is the same as that of FIG. 43(e).

In the embodiment of FIG. 46, in actual practice, the voltage reflected (varied) at point b varies depending on such factors as the capacitances of the capacitors 19a and 19b, the parasitic capacitance of the drive transistor 11a, the parasitic capacitance of the other switching transistors 11, and the punch-through voltage of the gate signal lines 17. Thus, in the present embodiment, the capacitance of the capacitor 19, and the operation of the switching transistors 11 are determined taking into account the influence of these factors. This is not a departure from the technical idea of the present embodiment. Note that the capacitances or the capacitance ratio of the capacitors 19b and 19a are determined according to the voltage set to point b, as in the embodiment of FIG. 42. Further, as in FIG. 51, the reset voltage Vrst may be varied (nonlinearly) with respect to the drive voltage Vsig.

FIG. 48 is another embodiment of the driving method of the embodiment described in FIG. 45, relating to the embodiment of FIG. 46. In the driving method of FIG. 48, the period of FIG. 47(e) is divided into two periods (FIG. 45(e1), FIG. 45(e2)).

In the driving method represented in FIG. 48(e2), the switch transistor 11e is turned on for a short time period with the switch transistor 11b turned on, before the period of FIG. 48(f). In other words, it is a driving scheme in which the ON state of the switch transistor 11b is extended for a short time period when turning on the switch transistor 11e, as in the embodiment of FIG. 45.

The other structure will not be described because it is essentially the same as that described in FIG. 1 and elsewhere. In the structure of FIG. 42, a three-select circuit may be provided at the output terminal of the source driver IC 14. The same applies to the other embodiments of the present invention.

In the embodiment described in FIG. 42 and elsewhere, the reset voltage Vrst applied to the drive transistor 11a is generated from the video signal voltage Vsig, or generated in correlation with the video signal voltage Vsig.

FIG. 52 is another embodiment of the present invention. In the embodiment of FIG. 52, the reset voltage Vrst is generated from a video signal in the source driver IC 14. In FIG. 52, a switch circuit 431 selects the reset voltage Vrst generated in the source driver IC 14b, and the video signal voltage Vsig generated in the source driver IC 14a.

A common video signal data (gradation data) is applied to the source driver IC 14a and the source driver IC 14b. The source driver IC 14a converts the video signal data to video signal voltage Vsig, and applies it to terminal a of the switch circuit 431. The source driver IC 14b converts the video signal data to reset voltage Vrst, and applies it to terminal b of the switch circuit 431. The source driver IC 14b converts the input video signal data using a look up table.

The conversion data of a look up table circuit is stored in EEPROM 753. The data stored in the EEPROM 753 is preferably created by measuring the panel characteristics (see FIG. 75, FIG. 76, and FIG. 77), and by reflecting the measured panel characteristic variations, and panel characteristics in the data. Switches S1 to Sn select terminal a or terminal b once in 1H.

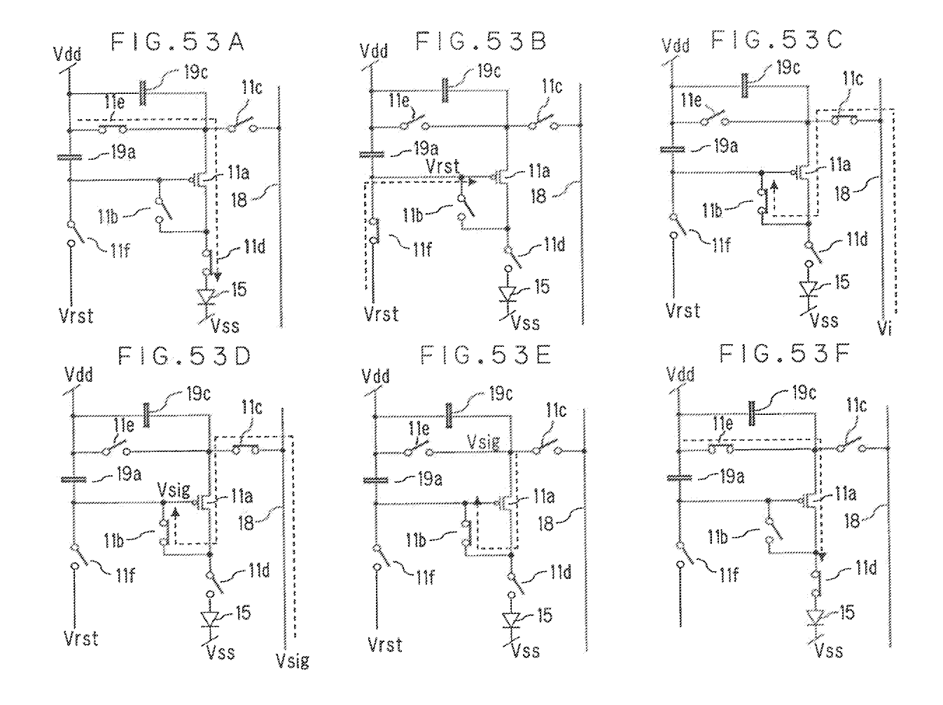

FIG. 53 is an explanatory diagram explaining the operation of the pixel configuration of FIG. 52. In FIG. 52 and other figures, the current paths indicated by dashed line, and the switch transistors 11 are depicted as switches. The transistors 11 are OFF when the switches are open, and ON when the switches are closed.

In the state of FIG. 53(a), current is supplied to the EL element 15, and the EL element 15 emits light (illumination). The anode electrode Vdd applies anode voltage to the drive transistor 11a via the switch transistor 11e, and current is supplied to the EL element 15 according to the gate terminal potential maintained in the drive transistor 11a by the capacitors 19a and 19b.

The voltage program operation (the operation or period in which the current flowing into the EL element 15 of the pixel 16 is refreshed) begins in FIG. 53(b). First, switch transistor 11f turns on, and the reset voltage Vrst is applied to the gate terminal of the drive transistor 11a. That is, a reset voltage Vrst based on video signal voltage Vsig is written into the gate terminal of the drive transistor 11a.

The reset voltage Vrst is preferably at least −5 V and at most −1 V. Here, reset voltage Vrst<initial voltage Vi. Preferably, reset voltage Vrst+1.5<initial voltage Vi. This is to allow the initial voltage Vi to be written into the gate terminal of the drive transistor 11a. More specifically, the foregoing relation is satisfied so that the initial voltage Vi applied to the source terminal of the drive transistor 11a can be written into the gate terminal via the channel of the drive transistor 11a during the writing of the reset voltage Vrst applied to the gate terminal of the drive transistor 11a.

As the switch transistor 11f turns on, the reset voltage Vrst is applied to the gate terminal of the drive transistor 11a. During the time period in which the reset voltage Vrst is applied, the switch transistors 11b, 11e, 11c, and 11d are OFF state.

Next, as illustrated in FIG. 53(c), the switch transistors 11c and 11b are turned on. At the same time, the source driver IC 14b outputs initial voltage Vi. This operation is as in the pixel configuration of FIG. 1.

In FIG. 53(c), the switch circuit 431 selects terminal b. As a result, by the application of the initial voltage Vi output from the source driver IC 14b, a current flows toward the gate terminal of the drive transistor 11a via the switch transistor 11c, the drive transistor 11a, and the switch transistor 11b.

The time period in which the switch circuit 431 selects terminal b is set to at least 1/20 and at most ¼ of 1H. Specifically, when 1H (one horizontal scan period) is 20 μs, the select period is from 1 μs to 5 μs. In the other period of 1H, the switch circuit 431 selects terminal a. In the select period of terminal a, a video signal voltage is applied to the source signal line 18.

In the remaining period of 1H, as illustrated in FIG. 53(d), video signal voltage Vsig is applied to the source signal line 18. Here, the switch transistors 11e, 11d, and 11f are open, and the switch transistors 11c and 11b are closed. By setting the switch transistors 11 this way, the video signal voltage Vsig is applied to the gate terminal of the drive transistor 11a through the channel of the drive transistor 11a. The current (drain current) for the video signal voltage Vsig decreases nonlinearly after the application of the reset voltage Vrst, as represented in FIG. 49. The offset cancel continues for 1H (one horizontal scan period, bt to 2t in FIG. 54).

In FIG. 53(e), the offset cancel period is sustained by the video signal voltage Vsig maintained by the capacitor 19c of the pixel 16, as explained in FIG. 1 and FIG. 2.

FIG. 53(f) represents an emission period of the EL element 15. The switch transistors 11c, 11b, and 11f are OFF (open), and the switch transistors 11e and 11d are ON (closed). The anode voltage supply Vdd supplies current to the EL element 15 via the switch transistor 11e, the drive transistor 11a, and the switch transistor 11d.

By the ON/OFF control of at least one of the switch transistors 11d and 11e, the image display of FIG. 12, FIG. 13, FIG. 98, FIG. 99, and elsewhere can be realized. The image quality can be improved and the current can be suppressed with the duty drive and the peak current suppress drive. Note that the control timing at which the ON/OFF voltage for each gate signal line 17 is applied is controlled according to the operation of each switch transistor 1.

By dividing the period of FIG. 53(f) into two periods (FIG. 45(d1), FIG. 45(d2)) as in FIG. 45, the mobility variation of the drive transistor 11a can be corrected. This was described with reference to FIG. 45, and will not be described further.

The foregoing operation is basically as in the operation of FIG. 1, and will not be described further.

FIG. 54 is a modification example of FIG. 53. In FIG. 54, the reset voltage Vrst is generated from video signal data in the source driver IC 14b.

In FIG. 54, a level shift circuit 541 of the array substrate functions to shift a certain voltage. For example, when the voltage shift of the level shift circuit 541 is 4 V, and the video signal voltage output by the source driver IC 14a is 2 V, the voltage (reset voltage Vrst) applied to the gate terminal of the drive transistor 11a is 2−4=−2 V. When the video signal voltage output by the source driver IC 14a is 5 V, the voltage (reset voltage Vrst) applied to the gate terminal of the drive transistor 11a is 5−4=1 V.

Thus, in the embodiment of FIG. 54, the operation of FIG. 53(b) is not required. Further, during the operation of FIG. 53(c), the output voltage of the Level shift circuit 541 is applied as reset voltage Vrst to the drive transistor 11a. The reset voltage Vrst is applied to the drive transistor 11a as the switch transistor 11f turns on.

FIG. 55 is another embodiment of the EL display device of the present embodiment. In the embodiment of FIG. 55, a source driver IC 14V outputs video signal voltage as a video signal, and a source driver IC 14I outputs video signal current as a video signal. Note that, for ease of explanation, it is assumed here that the source driver IC 14V and the source driver IC 14I receive the same video gradation signal. With the same video gradation signal input, the current that flows in the EL element 15 of the pixel 16 in response to the voltage programming that has taken place in the pixel 16 by the output of the source driver IC 14V ideally coincides with the current that flows in the EL element 15 of the pixel 16 in response to the current programming than has taken place in the pixel 16 by the output of the source driver IC 14I.

The output voltage of the source driver IC 14V initiates the offset cancel operation of the drive transistor 11a of the pixel 16. Here, the source driver IC 14V is capable of voltage correction, but incapable of mobility correction. The source driver IC 14I is capable of mobility correction.

A feature of FIG. 55 is that the voltage programming is performed by the video signal voltage output by the source driver IC 14V, and the video signal current output by the source driver IC 14I is used for mobility correction.

The video signal voltage Vsig is applied to a source signal line 18V, and to the pixel 16 as the switch transistor 11c turns on. Video signal voltage Isig is applied to a source signal line 18I, and to the pixel 16 as the switch transistor 11g turns on.

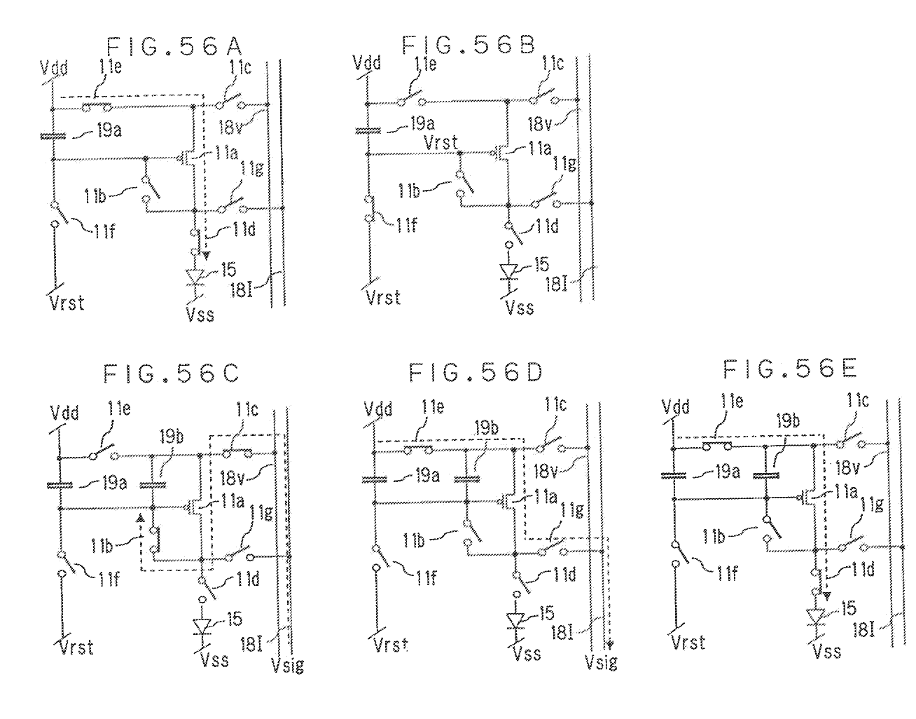

FIG. 56 is an explanatory diagram explaining the pixel configuration of FIG. 55. In FIG. 56, the current path and the signal path are indicated by dashed line, and the switch transistors 11 are depicted as switches. The transistors 11 are OFF state when the switches are open, and ON state when the switches are closed.

In the state of FIG. 56(a), current is supplied to the EL element 15, and the EL element 15 emits light (illumination).

The voltage program operation (the operation or period in which the current flowing into the EL element 15 of the pixel 16 is refreshed) begins in FIG. 56(b). First, switch transistor 11f turns on, and the reset voltage Vrst is applied to the gate terminal of the drive transistor 11a. The reset voltage Vrst is preferably at least −2 V and at most 3 V.

As the switch transistor 11f turns on, the reset voltage Vrst is applied to the gate terminal of the drive transistor 11a. During the time period in which the reset voltage Vrst is applied, the switch transistors 11b, 11e, 11c, and 11d are OFF state.

Next, as illustrated in FIG. 56(c), the switch transistor 11c is turned on. As the switch transistor 11c turns on, the video signal voltage Vsig is applied. As an example, the video signal voltage Vsig is at least 0 V and at most 5 V. The video signal voltage Vsig varies according to a video signal.

By the foregoing operation, the reset voltage Vrst is applied to the gate terminal of the drive transistor 11a of FIG. 56, and then the video signal voltage Vsig is applied. The foregoing operation is the same as or analogous to the operation of the pixel configuration of, for example, FIG. 1, FIG. 42, and FIG. 52.

FIG. 43(d) represents a mobility correction period by the video signal current Isig from the source driver IC 14I. The signal Vsig is cut off as the switch transistor 11g turns on and the switch transistor 11c turns off, and the signal Isig is applied to the pixel 16.

Isig flows via the anode voltage Vdd and the channel of the drive transistor 11a, as indicated by dashed line in the figure. Isig realizes the current program, and corrects the mobility difference.

FIG. 56(e) represents an emission period of the EL element 15. The switch transistors 11c, 11b, and 11f are OFF (open), and the switch transistors 11e and 11d are ON (closed). The anode voltage supply Vdd supplies current to the EL element 15 via the switch transistor 11e, the drive transistor 11a, and the switch transistor 11d.

By the ON/OFF control of at least one of the switch transistors 11d and 11e, the image display of FIG. 12 and FIG. 13 can be realized (duty drive). The image quality can be improved and the current can be suppressed with the duty drive and the peak current suppress drive.

Note that the control timing at which the ON/OFF voltage for each gate signal line 17 is applied is controlled according to the operation of each switch transistor 1. The control of the gate driver circuit 12 can be realized by applying the signal from the source driver IC 14 after level shifting with the level shift circuit 32, as in FIG. 3.

The embodiment of FIG. 55 includes the source driver IC 14V that generates voltage signal Vsig, the source driver IC 14I that generates current signal Isig, the source signal line 18V that transmits signal Vsig, and the source signal line 18I that transmits signal Isig.

In the embodiment of FIG. 58, a source driver IC 14a serves as both the source driver IC 14V and the source driver IC 14I. Further, only one kind of source signal line 18 is provided.

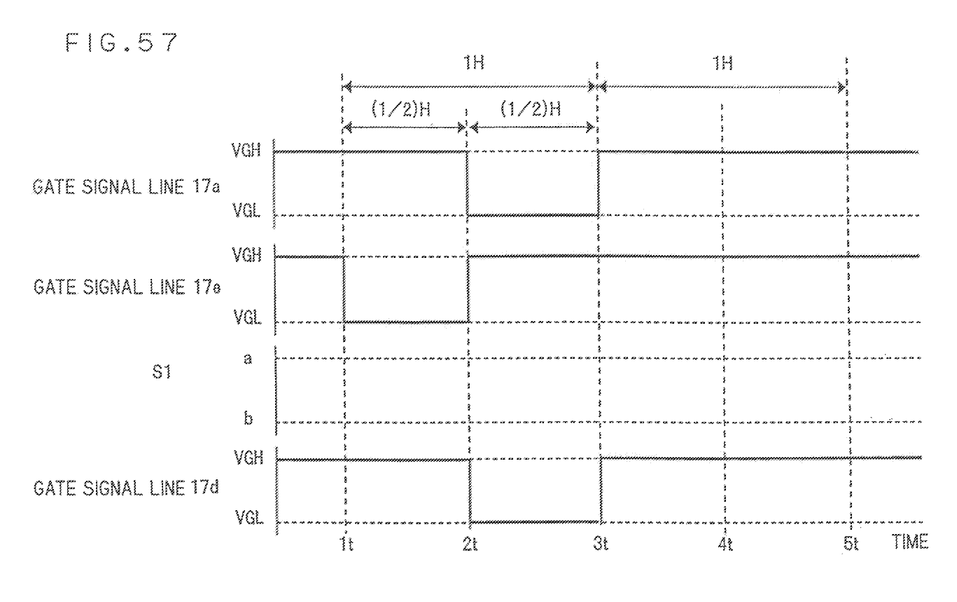

As illustrated in FIG. 57, the source driver IC 14a generates signal Vsig in the first half (½H period) of 1H, and applies the signal Vsig to the source signal line 18, turning on the switch transistor 11c and realizing the operation of FIG. 56(c). Further, as illustrated in FIG. 57, the source driver IC 14a generates signal Vsig in the second half (½H period) of 1H, and applies the signal Isig to the source signal line 18, turning on the switch transistor 11g and realizing the operation of FIG. 56(d).

FIG. 59 is a modification example of FIG. 58. In FIG. 59, the capacitor 19b is provided for each pixel 16. The structure, function, and operation of the capacitor 19b were described with reference to FIG. 4 and FIG. 5, and will not be described further.

The transistors used in this embodiment are not limited to TFTs, and may be realized by bipolar transistors. The materials used for the TFT are not limited either. For example, polysilicon, crystalline silicon, and amorphous silicon may be used.

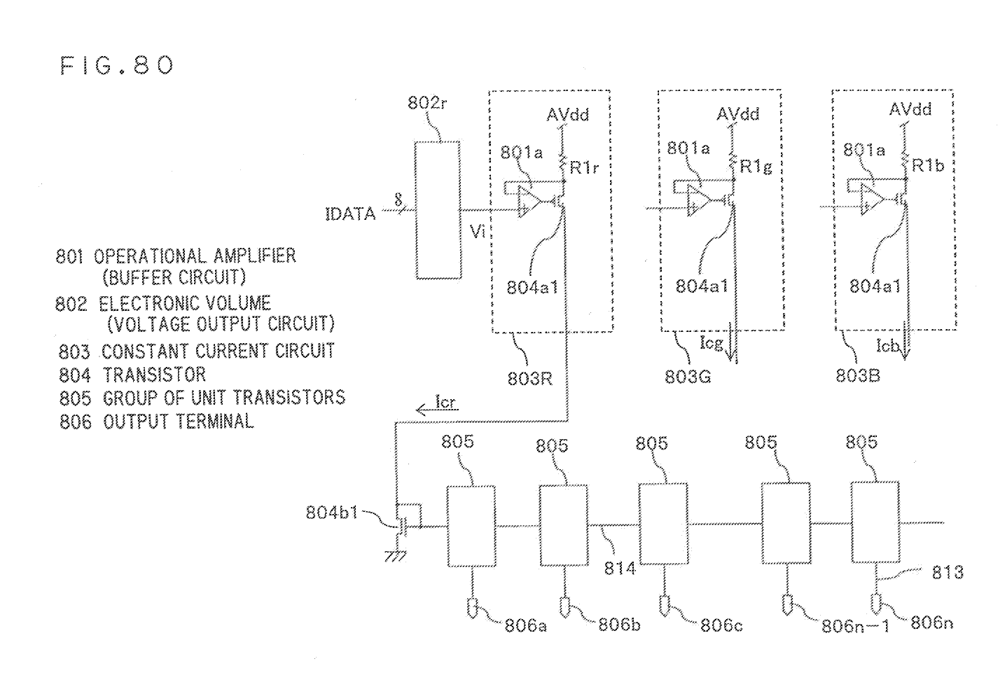

FIG. 80 is an explanatory diagram of a circuit that generates a program current (video signal) of the source driver circuit 24 in the EL display device of this embodiment. The source driver circuit 14 includes reference current circuits (constant current circuits) 803 (803R, 803G, 803B), corresponding to red (R), green (G), and blue (B), respectively.

The reference current circuit 803 includes a resistor R1 (R1r, R1g, R1b), an operational amplifier 801a, and a transistor 804a. The resistor R1 (R1r, R1g, R1b) is configured so that its value can be independently adjusted according to the gradation current of R, G, and B. The resistor R1 is an external resistor externally provided for the source driver circuit 14.

A voltage Vi is applied to the plus terminal of the operational amplifier by an electronic volume 806. The voltage Vi is obtained by dividing a stable, reference voltage Vb with a resistor R. The electronic volume 806 varies the output voltage Vi with signal IDATA. The reference current Ic becomes (VS−Vi)/R1. The reference currents Ic (Icr, Icg, Icb) of RGB are independently varied with their respective reference current circuits 803.

The voltage is varied with the electronic volume provided for each color of RGB. Thus, the value of the voltage Vi output from the electronic volume 806 is varied with the control signal applied to the electronic volume 806. The voltage Vi varies the magnitude of the RGB reference current, and the magnitude of the gradation current (program current) Iw output from a terminal 806 varies proportionally.

The generated reference current Ic (Icr, Icg, Icb) is applied to a transistor 804b from a transistor 804a. The transistor 804b and a group of transistors 805 form a current mirror circuit. In FIG. 80, the transistor 804b1 appears as a single transistor; however, the transistor 804b1 is actually a set of unit transistors 812 (a group of transistors) as is the transistors 805.

A program current Iw from the group of transistors 805 is output from the output terminal 806. The gate terminal of the each unit transistor 812 of the transistors 805, and the gate terminal of the transistor 804b are connected to each other with a gate wire 814.

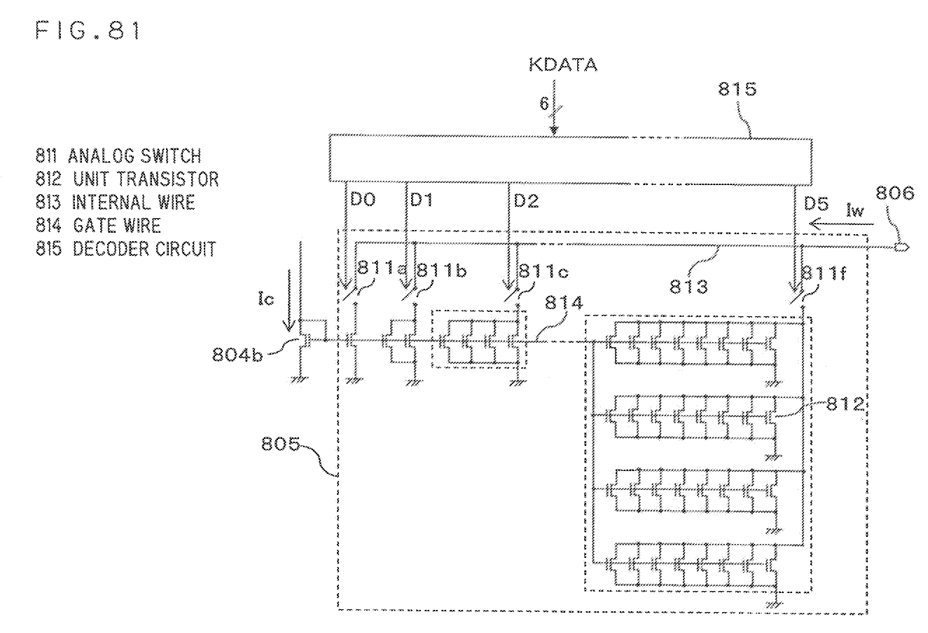

The transistors 805 are formed as a collection of the unit transistors 812, as illustrated in FIG. 81. For ease of understanding, it is assumed here that the conversion of video data into program current occurs either proportionally or in a correlated manner. The video signal selects a switch 811, and the selection of the switch 811 produces program current Iw as a collection (addition) of the output currents of the unit transistors 812. The video signal can be converted into program current Iw in this manner. In the present embodiment, the unit current of the unit transistors 812 corresponds in magnitude to the video data being “1”.

The unit current is the magnitude of one unit of program current which the unit transistors E12 output according to the magnitude of reference current Ic. When the reference current Ic varies, the unit current output by the unit transistors 812 varies in proportion. This is because the transistor 804b and the unit transistors 812 form a current mirror circuit.

Each transistor 805 of RGB is a collection of unit transistors 812, and the magnitude of the output current (unit program current) of the unit transistors 812 can be adjusted by the magnitude of the reference current Ic. By adjusting the magnitude of the reference current Ic, the magnitude of the program current (constant current) Iw of each gradation can be varied for each color of RGB. Thus, in an ideal state in which the unit transistors 812 of RGB have the same characteristics, the white balance of the display image in the EL display device can be adjusted by varying the magnitude of the reference current Ic of the reference current circuits 803 of RGB.

With an increased reference current, the emission luminance of the EL element 15 can be increased. With a reduced reference current, the emission luminance of the EL element 15 can be reduced. The consumed current can be averaged and a high luminance display can be realized when the process circuit of FIG. 83 is used to perform processes such as addition and a histogram process of the video signals (Y/UV, COMP signals, etc.), and vary the reference current based on the result of these processes.

Further, as represented in FIG. 99, the same effect can be obtained by varying the maximum number of usable gradations based on the result of a video signal process. The effect becomes particularly prominent when the present embodiment, which can realize a desirable offset cancel, a desirable contrast display, and an accurate maximum luminance, is combined with the methods of, for example, FIG. 83, FIG. 99, FIG. 78, and FIG. 79.

For ease of explanation, the description below will be given through the case where the group of transistors 805 of the source driver circuit (IC) 14 has 6 bits. In FIG. 81, the unit transistors 812 are provided for each constant current data (D0 to D5). The number of unit transistors 812 is 1, 2, 4, 8, 16, and 32 for D0 bit, D1 bit, D2 bit, D3 bit, D4 bit, and D5 bit, respectively.

Whether the output current of the unit transistors 812 of each bit is output to the output terminal 806 is determined by the ON/OFF control of the analog switches 811 (811a to 811f). A decoder circuit 815 decodes input video data KDATA. The analog switches are ON/OFF controlled according to the video signal data KDATA.

The program current Iw flows, through an internal wire 813. The potential of the internal wire 813 is at the potential of the source signal line 18. The potential of the internal wire 813 is at most AVdd and at least GND. The potential of the source signal line 18, when in a steady state by the application of constant current Iw to the source signal line 28, is at the voltage of the gate terminal of the drive transistor 11a of the pixel 16 (in the case of the pixel configuration of FIG. 3).

In the embodiment described above, the circuit that outputs a program current is installed in the source driver IC 14. Instead, the source driver IC 14 may include a circuit that outputs a program voltage. Further, the source driver IC 14 may include both the circuit that outputs a program current, and the circuit that outputs a program voltage. For ease of explanation, the description below will be given through the case where the source driver IC 14 outputs a program voltage as a gradation signal (video signal voltage Vsig).

FIG. 102 is a block diagram of the source driver IC 14 (source driver circuit 14). As illustrated in FIG. 102, the source driver IC 14 includes a shift register (Shift Register) 1022, a mini LVS receiver circuit (Mini-LVDS Receiver) 1021, RGB gamma circuits (R GMA, G GMA, B GMA) 1024, a line latch circuit (Line Latch) 1023, an output buffer (Output Buffer) 1026, a digital-analog converter (Digital Analog Converter) 1025, and a switch circuit (Switch) 1027, among other elements. The circuit that outputs a program current or a program voltage corresponds to the digital-analog converter (also referred to as “DAC”) 1025, and the output buffer circuit 1026.

A SEL signal of 2 bits controls the shift register (Shift Register) 1022, limiting the number of channels output from the output buffer (Output Buffer) 1026. The number of channels is selected from 720, 684, 642, and 618.

The mini LVS receiver circuit (Mini-LVDS Receiver) 1021 receives LV0A, LV0B, LV1A, LV1B, LV2A, LV2B, LV3A, LV3B, LV4A, LV4B, LV5A, LV5B, LV6A, LV6B, LV7A, LV7B, CLKA, and CLKB. The video signal voltage Vsig data are 10 bit data of R, G, and B.

The RGB gamma circuits (R GMA, G GMA, B GMA) 1024 have the structure illustrated in FIG. 108. FIG. 108 illustrates the circuit of only one of R, G, and 13. That is, the EL display device of this embodiment includes three independent gamma circuits of R, G, and B. The same applies to the other gamma circuits.

The circuit structure of FIG. 108 includes 6 taps, and voltages VX1 to VX6 are settable. A DA converter is connected to each of the voltages VX1 to VX6. When the drive transistor 11a is a P-channel transistor, the tap for VX5 is open. When the drive transistor 11a is an N-channel transistor, the tap for VX2 is open. The six taps VX1 to VX6 are substantially symmetrical about R1 at the middle point. This enables the gamma circuit of FIG. 108 to accommodate the drive transistor 11a, regardless of whether it is a P-channel transistor or an N-channel transistor.

The terminals of VX2 and VX5 are particularly important. The EL display device is capable of producing a desirable black display. When the drive transistor 11a is a P-channel transistor, VX1 corresponds to the lowest gradation display, and VX2 provides the next gradation set in the black region. Setting VX2 is important to realize a desirable image display. No setting is required for VX5 because it corresponds to a region where the gradations change linearly. Setting VX4 and VX6 is sufficient. When the drive transistor 11a is an N-channel transistor, VX6 corresponds to the lowest gradation display, and VX5 provides the next gradation set in the black region. Setting VX5 is important to realize a desirable image display. No setting is required for VX2 because it corresponds to a region where the gradations change linearly. Setting VX1 and VX3 is sufficient.

Note that, in ladder resistors 1061 of FIG. 108, the gradation output terminal is omitted. In actual circuit, a gradation output terminal is formed between the ladder resistors. For example, the resistor R3 has gradations 0 to 63, and an output terminal for gradations 1 to 62 is provided. The resistor R2 has gradations 63 to 319, and an output terminal for gradations 64 to 318 is provided. The resistor R1 has gradations 319 to 703, and an output terminal for gradations 320 to 702 is provided. The resistor R2 has gradations 703 to 959, and an output terminal for gradations 704 to 958 is provided. The resistor R4 has gradations 959 to 1023, and an output terminal for gradations 960 to 1,022 is provided. R2=R1·2/3, R3=R2/4, and R4=R3·63/64.

Note that, in FIG. 108, when the lowest gradation is V0 (gradation 0), the voltage V0 of the lowest gradation is common to RGB (the same voltage is set). Similarly, the voltage V0 is common to RGB in FIG. 106 and FIG. 109.

In FIG. 108, the display luminance of the display screen 31 is controlled by controlling at least one of the setting terminals of VX1 to VX6, based on the sum or total of video signals, or histogram processing (weighting for each color of RGB) calculated or performed in the process circuit of FIG. 83.

Note that, in FIG. 102, the gamma circuits are described as having the circuit structure of FIG. 108. However, the invention is not limited to this. The gamma circuit structures of FIG. 106 and FIG. 109 may be employed as well.

In FIG. 106, a ladder resistor 1061c is connected to a selector circuit 1063b and an amplifier 1062b at one end, and a selector circuit 1063c and an amplifier 1062c at the other end. These selector circuits and amplifiers are used for voltage settings. The amplifier 1062b is used to set voltage V1 for gradation 1, and the amplifier 1062c is used to set voltage V1023 for the highest gradation 1023. Voltage V0 for gradation 0 is set by a selector circuit 1063a and an amplifier 1062a. The selector circuit 1063a is a selector circuit that selects one out of 128 junctions. The selector circuit 1063b is a selector circuit that selects one out of 64 junctions. The selector circuit 1063c is a selector circuit that selects one out of 256 junctions. The range of voltages selected and varied is represented by the following relationship: selector circuit 1063c>selector circuit 1063a>selector circuit 1063b.

The ladder resistors 1061b and 1061c are independently provided for RGB (three sets). Voltage V0 is common to RGB. Accordingly, the ladder resistor 1061a is common to RGB (only one is provided). The diagram also illustrates gamma blocks 1064R, 1064G, and 1064B.

FIG. 107 represents an example of gamma curve settings based on the gamma circuit of FIG. 106. The voltage range of the gamma curve is AVdd to AVss (GND). Generally, the voltages of the source driver IC 14 (AVdd, power voltage; AVss, GND voltage) are used.

As represented in FIG. 107, a variety of gamma curves can be created. Voltage V0 for gradation 0 is common to RGB. Voltage V1 for gradation 1 can be independently set for RGB. The voltages for gradation 1 to the highest gradation (V1023) can be independently set for RGB, and the gamma curve is linear in this range. This makes it easier to set a digital gamma, and the black luminance can be easily adjusted taking V0 at origin. However, the number of bits is 10 in this embodiment because 8 is insufficient. The gradations voltages V1 to V1023 can be set only by setting V1 and V1023. This makes the white balance adjustment of RGB easier.

FIG. 109 is a structure in which a voltage is set for the intermediate taps V7, V19, V43 V87, and V171 of a ladder resistor 1062g.

The voltage for tap V7 is set with a ladder resistor 1061f, the selector circuit 1063c, and the amplifier 1062b. The voltage for tap V19 is set with a ladder resistor 1061e, a selector circuit 1063g, and the amplifier 1062c. The voltage for tap V43 is set with a ladder resistor 1061d, a selector circuit 1063f, and an amplifier 1062d. The voltage for tap V87 is set with the ladder resistor 1061c, a selector circuit 1063e, and an amplifier 1062e. The voltage for tap V171 is set with the ladder resistor 1061b, a selector circuit 1063d, and an amplifier 1062f. The voltage for tap V255 is set with the ladder resistor 1061a, the selector circuit 1063c, and the amplifier 1062g. V0 is common to RGB, and is set with a ladder resistor 1061h, the selector circuit 1063a, and the amplifier 1062a.

FIG. 110 represents an example of gamma curve settings based on the gamma circuit of FIG. 109. The voltage range of the gamma curve is AVdd to AVss (GND). AVdd is the power voltage of the source driver IC 14, and AVss is the GND voltage of the source driver IC 14.

As represented in FIG. 110, the RGB circuit of this embodiment includes gamma blocks 1064 (1064R, 1064G, 1064B), independently provided for RGB. In each gamma block 1064, the tap position (V7, N19, V43, V87, V171) can be independently set for RGB. The voltages for gradation 1 to the highest gradation (V255) can be independently set for RGB. This makes it easier to adjust the black luminance, taking V0 at origin. The number of bits is 8.

In FIG. 102, FIG. 106, FIG. 108, and FIG. 109, gradation voltage V0 is the lowest voltage, and the darkest display is set. V1023 is the highest gradation, and the brightest display is set. When the drive transistor is a P-channel transistor, the voltage is higher toward V0 (for example, 5 V), and lower toward V1023 (for example, 0 V).

The driving method (gradation peak process or the like) that manipulates the maximum display gradation as described in FIG. 99 is performed by controlling the gamma circuits of FIG. 102, FIG. 106, FIG. 108, and FIG. 109.

For example, in the gamma circuit of FIG. 106, the selector circuit 1063c is controlled, and the voltage output from the amplifier 1062c is varied based on the sum or total of video signals, or histogram processing (weighting for each color of RGB) calculated or performed in the process circuit of FIG. 83. When the total is small, the output voltage of the amplifier 1062c is varied toward the lower voltage side to enable a brighter display. When the total is large, the output voltage of the amplifier 1062c is varied toward the higher voltage side to lower display luminance, in an effort to counteract the large current consumption in the display region 31, and the overheating of the panel.

Similarly in the gamma circuit of FIG. 108, the input voltage at VX6 is varied based on the sum or total of video signals, or histogram processing (weighting for each color of RGB) calculated or performed in the process circuit of FIG. 83. When the total is small, the input voltage of VX6 is varied toward the lower voltage side to enable a brighter display. When the total is large, the input voltage of VX6 is varied toward the higher voltage side to lower display luminance, in an effort to counteract the large current consumption in the display region 31, and the overheating of the panel.

Note that, in FIG. 108, the input voltages of VX1 to VX5 are also varied as required, in addition to VX6. A total of six DA converters are connected to VX1 to VX6, and the data of the DA converters are varied based on the total or other variables to control the voltage input to VX1 to VX6. The DA converters are provided either internally in the circuit 1024, or externally.

Similarly in FIG. 109, the selector circuit 1063c is controlled, and the voltage output from the amplifier 1062g is varied based on the sum or total of video signals, or histogram processing (weighting for each color of RGB) calculated or performed in the process circuit of FIG. 83. When the total is small, the output voltage of the amplifier 1062g is varied toward the lower voltage side to enable a brighter display. When the total is large, the output voltage of the amplifier 1062g is varied toward the higher voltage side to lower display luminance, in an effort to counteract the large current consumption in the display region 31, and the overheating of the panel.

Note that, in FIG. 109, in addition to varying the output voltage of the amplifier 1062g, the select positions of the selector circuits 1063a through 1063f, and the output voltages of the amplifiers 1062a, 1062h, and 1062b through 1062f are varied based on the operations of the selector circuit 1063c and the amplifier 1062g.

The line latch circuit (Line Latch) 1023 latches input data, and includes a two-stage buffer circuit of at most 720 channels×10 bits.

The switch circuit 1027 outputs PRC voltages (cancel voltage Vr, reset voltage Vrst, etc. to the source signal lines 18 according to input PRCON signal.

A three-select circuit (select switch circuit) 1041 may be provided between the source driver circuit (IC) 18 and the source signal lines 18 (FIG. 3, FIG. 104). Note that the number of selects in the select circuit 1041 is not limited to three, and may be six or other numbers. When the select circuit is a three-select circuit, there are provided R terminal, G terminal, and B Terminal, and one of the terminals is selected in synchronism with the clock.

The select circuit 1041 is disposed as illustrated in FIG. 103. The select circuit includes an input terminal connected to the signal output terminal of the source driver circuit 14, and a select output terminal connected to the source signal line. The select circuit 1041 includes plural terminal sets, each including an input terminal and a plurality of select output terminals connectable to the input terminal.

The select circuit 1041 selects one or more terminals from the multiple select output terminals, and the signal of the source driver circuit 14 applied to the input terminal of the select circuit 1041 is applied to one or more source signal lines 18 connected to the output terminals so selected.

Preferably, the terminal set of the select circuit 1041 includes one input terminal, and at least three select output terminals which are connected to a source signal line 18R for transmitting a red signal, a source signal line 18G for transmitting a green signal, and a source signal line 18B for transmitting a blue signal, respectively. The source driver circuit 14 is an IC chip including semiconductor, and the select circuit 1041 is formed on the array substrate by polysilicon technology.

FIG. 103(a) illustrates a display panel layout in which the longer side of the screen 31 is laid horizontally (portrait layout), and in which the source driver circuit 14 is disposed on the upper side or lower side of the screen (landscape layout) FIG. 103(b) illustrates a display panel layout in which the longer side of the screen 31 is laid horizontally, and in which the source driver circuit 14 is disposed on one end (left or right) of the screen.

The signal output from the source driver circuit 14 is distributed to the source signal lines 18R, 18G, and 18B by the select circuit 1041. The select circuit 1041 is directly formed on the array substrate by polysilicon technology. The select circuit 1041 may be formed from a silicon chip, and may be mounted on the array substrate by COG technology. Further, the select circuit 1041 may be installed in the source driver circuit 14 as a switch circuit of the source driver circuit 14.

When the select circuit 1041 is selecting the R terminal, the output signal from the source driver circuit 14 is applied to the source signal line 18R. When the select circuit 1041 is selecting the G terminal, the output signal from the source driver circuit 14 is applied to the source signal line 18G. When the select circuit 1041 is selecting the B terminal, the output signal from the source driver circuit 14 is applied to the source signal line 18B.

When the select circuit 1041 is selecting the R terminal, the G terminal and B terminal are open. Here, the parasitic capacitor 142 maintains the potentials of the G terminal and B terminal. When the select circuit 1041 is selecting the G terminal, the R terminal and B terminal are open. Here, the parasitic capacitor 142 maintains the potentials of the R terminal and B terminal. When the select circuit 1041 is selecting the B terminal, the G terminal and R terminal are open. Here, the parasitic capacitor 142 maintains the potentials of the G terminal and R terminal.

The source driver IC 14 of the EL display device of the present embodiment is structured so that it can be connected to the select signal line 1043 at two chip positions, making it possible to accommodate the both layouts illustrated in FIG. 103(a) and FIG. 103(b) with a single chip (IC). Further, two output terminals are provided to be connected to the gate signal lines 12.

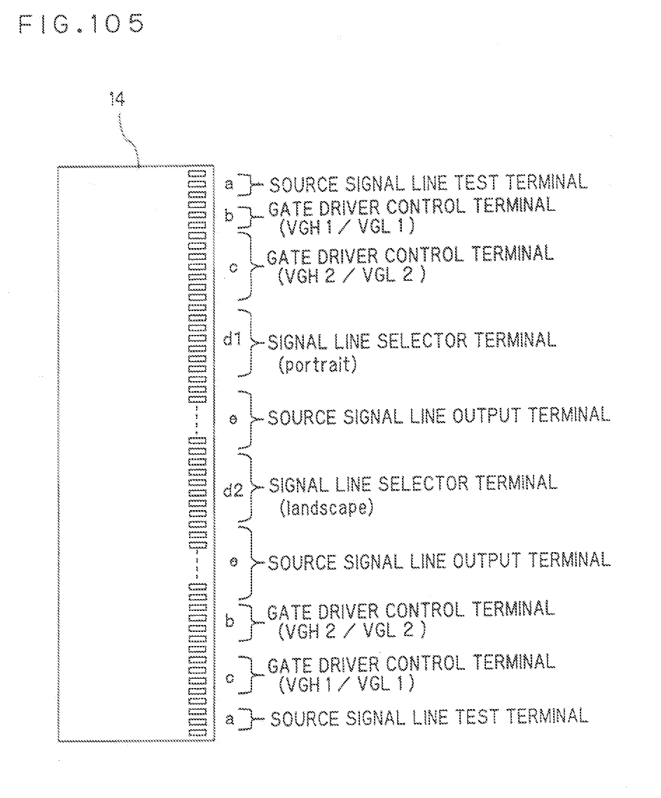

FIG. 105 is an explanatory diagram of an output terminal layout of the source driver IC 14 (IC chip) of this embodiment. At the both ends, the IC chip includes test terminals for the source signal lines. The test terminals have the same structure as the output terminals of the video signal voltage Vsig, but are not connected to the source signal lines. Further, whether to output the video signal voltage Vsig can be set by test commands.

On the inner side of the source signal line test terminals, gate driver control terminals are provided that output gate driver control signals to the gate driver circuit 12. Two kinds of gate driver control terminals are provided: gate driver control terminals (VGH1/VGL1) to output signals of VGH1−VGL1 level; and gate driver control terminals (VGH2/VGL2) to output signals of VGH2 level-VGL2. VGH1/VGL1 and VGH2/VGL2 are selected according to the characteristics of the switch transistors 11, or display quality. VGH1/VGL1 and VGH2/VGL2 were described with reference to FIG. 3, and will not be described further.

The select signal line 1043 of the terminal (R terminal, G terminal, or B terminal) selected by the select circuit 1041 is connected to a signal line selector terminal. In the portrait layout of FIG. 104(a), the select signal line 1043 is connected to the signal selector terminal disposed more toward an end than the center of the chip (portrait). In the landscape layout of FIG. 104(b), the select signal line 1043 is connected to the signal selector terminal disposed at the center of the chip (landscape). The source signal lines 18 are connected to source signal line output terminals (note that the select circuit 1041 is disposed between the source signal line output terminals and the display screen 31).

The foregoing is applicable not only to the EL display panel or EL display device having the pixel configuration of FIG. 1, but to EL display panels and EL display devices having other pixel configurations (for example, FIG. 4, FIG. 5, FIG. 10, FIG. 11, FIG. 25, FIG. 29, FIG. 31, FIG. 33, FIG. 35, FIG. 37, FIG. 42, FIG. 46, FIG. 52, FIG. 54, FIG. 55, FIG. 58, FIG. 59, FIG. 86, FIG. 90, FIG. 91, FIG. 92, FIG. 93, FIG. 94, FIG. 95, FIG. 113, FIG. 123, FIG. 124 through FIG. 128).

The same can be said for the other embodiments. For example, the pixel configurations exemplified above or described in this specification may be combined with the methods or schemes of, for example, FIG. 12, FIG. 13, FIG. 61, FIG. 75, FIG. 76, FIG. 77, FIG. 78, FIG. 79, FIG. 83, FIG. 84, FIG. 85, FIG. 98, FIG. 99, FIG. 100, and FIG. 101, or the configurations, structures, or methods of FIG. 7, FIG. 8, FIG. 9, FIG. 60, FIG. 83, FIG. 96, FIG. 102, FIG. 103, FIG. 104, FIG. 106, FIG. 107, FIG. 108, FIG. 109, FIG. 110, FIG. 111, FIG. 112, and FIG. 129.

FIG. 84 is an embodiment in which the maximum displayable luminance of the panel is 400 (nt) at the peak, and 200 nt in a white raster display (illumination rate=100%). Note that the peak luminance (the luminance displayable by the pixel of the maximum gradation in the vicinity of 0% illumination rate) and the luminance at the maximum power (generally, the luminance displayable by the pixel in a white raster display (maximum gradation) at 100% illumination rate) differ by a factor of at most 6 and at least 1.5. In this specification, the factor is 2. Further, it is assumed that the peak luminance is the luminance of black display pixels in the vicinity of 0% illumination rate.

The luminance is determined by the maximum number of usable (displayable) gradations, and the duty ratio. The duty ratio is as described in FIG. 12, FIG. 13, and elsewhere. Further, it is assumed here that the video signal has 10 bits for each color of RGB (1024 gradations: gradation 1 to gradation 1024). As an example, in FIG. 84, by the gradation number control, the maximum luminance (Max) is 400 nt (the luminance displayed by the pixel that has received a video signal of gradation 1024) at illumination rates or 25% or less, and is 200 nt (the luminance displayed by the pixel that has received a video signal of gradation 1024) at 100% illumination rate. The plot of maximum number of usable gradations against illumination rate in FIG. 84(a) may be a curve, or it may include a number of bends (by settings).

The control of the maximum number of usable (displayable) gradations is the control of the video signal voltage Vsig applied to the source signal lines 18, or the video signal voltage Vsig written into the pixels 16. Further, the maximum number of usable (displayable) gradations is determined by the video data input to the EL display crevice, or the video signal voltage Vsig written into the pixels 16.

The foregoing is also applicable to the determination of a duty ratio in a duty drive.

The maximum number of usable (displayable) gradations is the maximum number of usable (displayable) gradations on the display screen 31. The period of the maximum number of usable (displayable) gradations on the display screen 31 is not limited to one frame (one field), and may extend over a plurality of frame (field) periods. For example, when the maximum number of usable (displayable) gradations is 768, the maximum number of usable (displayable) gradations is limited to 768 in four frame periods, and the maximum number of usable (displayable) gradations is varied to 1024 in the next frame 5 and subsequent frames. The description concerning the period is also applicable to the duty ratio in a duty drive.

Note that the maximum usable (displayable) gradation drive and the duty drive may be performed in combination. For example, in an exemplary driving method, the maximum number of usable (displayable) gradations (maximum usable (displayable) gradation number) is set to 768, and the duty ratio is set to 1/2 in the first frame. In the second frame, the maximum number of usable (displayable) gradations (maximum usable (displayable) gradation number) is set to 1024, and the duty ratio is set to 3/4.

Note that the maximum number of usable (displayable) gradations (maximum usable (displayable) gradation number), and the duty ratio are not limited to changes that take place stepwise in frame (field) cycles, and may be changed gradually within a frame (field). For example, when the maximum number of usable (displayable) gradations (maximum usable (displayable) gradation number) is 768 and 1024 in the first and third frames, respectively, the maximum number of usable gradations for image display in the second frame (field) is an intermediate gradation between gradation 768 and gradation 1024.

The change from gradation 768 to gradation 1023 may begin partway through the first frame, or the maximum number of usable (displayable) gradations (maximum usable (displayable) gradation number) may change from 76) to 1024 from the beginning of the third frame. The description concerning the change (switch) is also applicable to the duty ratio in a duty drive.

It is not necessary to determine the maximum number of usable (displayable) gradations (maximum usable (displayable) gradation number) or the duty ratio in every frame (field). They may be determined in even-numbered frames (fields), or at the intervals of multiple frames or random numbers of frames.

For example, in a still image display, the maximum number of usable (displayable) gradations (maximum usable (displayable) gradation number), or the duty ratio may be determined at long cycle intervals, and intermediate values of the gradations or ratios so determined may be used (gradually varied) in frames in which the maximum number of usable (displayable) gradations (maximum usable (displayable) gradation number), or the duty ratio are not determined.

In a moving image display, the maximum number of usable (displayable) gradations (maximum usable (displayable) gradation number), or the duty ratio is determined in every frame (field).

The foregoing is applicable not only to the EL display panel or EL display device having the pixel configuration of FIG. 1, but to the EL display panels and EL display devices having other pixel configurations (for example, FIG. 4, FIG. 5, FIG. 10, FIG. 11, FIG. 25, FIG. 29, FIG. 31, FIG. 33, FIG. 35, FIG. 37, FIG. 42, FIG. 46, FIG. 52, FIG. 54, FIG. 55, FIG. 58, FIG. 59, FIG. 86, FIG. 90, FIG. 91, FIG. 92, FIG. 93, FIG. 94, FIG. 95, FIG. 113, FIG. 123, FIG. 124, FIG. 125, FIG. 126, FIG. 127, FIG. 128). Further, the foregoing is also applicable to the other driving schemes and configurations described in this specification. Further, the foregoing is also applicable to apparatuses using an EL display device or an EL display panel (for example, FIG. 7, FIG. 8, FIG. 9).

FIG. 84 is an embodiment performing gradation settings with a gamma curve (gamma=2). In FIG. 84(a), the vertical axis represents maximum number of usable gradations. The maximum number of usable gradations is the maximum gradation displayed at a given illumination rate, or the maximum gradation number that can be used. The maximum gradation number is determined by multiplication using the illumination rate as a coefficient. The figure represents maximum gradation numbers.

For ease of explanation, each figure refers to illumination rate. The illumination rate can be regarded as the current that flows in the display screen 31 (when anode and cathode voltages are constant). When anode or cathode voltage is varied, it is preferable to reflect this change. That is, the illumination rate correlates with the power used in the display region of the display panel. As such, the maximum usable gradation may be determined based on power. Note that, the power or current includes not only those used in the display region 31 of the display panel, and may include the power or current used in peripheral circuitry.

FIG. 84(a) represents a normal display state, and the duty ratio is 1/1. That is, the black insertion display of FIG. 12 and FIG. 13 is not performed. This state is a drive state capable of a maximum luminance display.

In FIG. 84, it is preferable that the point of change, point a, be variably set. The variable point is stored in EEPROM. The same applies to point b. The straight line or curve may have a number of kinked points.

For example, when the brightness of gradation 1024 is 1.0, and the characteristic curve has a gamma of 2, the brightness is 0.75, 0.50, and 0.25 for gradations 887, 724, and 512, respectively. When the characteristic curve has a gamma of 2.2, the brightness is 0.75, 0.50, and 0.25 for gradations 898, 747, and 545, respectively. Thus, in actual practice, the gradations to be controlled or set should be determined using these values of brightness (luminance, illuminance) as reference.

In order to reduce the luminance to ¼ of the level of FIG. 84(a), the number of display gradations is reduced. The technical idea behind this is the same as in FIG. 84(a). In FIG. 84(b), the display luminance is 200 nt at gradation 724 (see the scale on the right of FIG. 84(a)). At gradation 362, the display luminance is ¼, 50 nt, on the gamma curve (gamma=2). In the same manner, at gradation 512, the display luminance is ½, 100 nt, on the gamma curve (gamma=2). At gradation 627, the display luminance is 150 nt, ¾ of 200 nt, on the gamma curve (gamma=2). Note that these gradation numbers are presented merely for ease of explanation, and the embodiment is not limited to these values.

As illustrated in FIG. 84(b), the change in luminance from a normal display luminance to a ¼ luminance is generally realized by changing the number of display gradations. As illustrated in FIG. 84(b), when reducing the luminance from the 100% illumination rate of FIG. 84(a) to ¼ (50 nt), the maximum usable gradation is changed to 362 (specifically, gradation 1 to gradation 362 are used for 50 nt display). When reducing to ½ (100 nt), the maximum usable gradation is changed to 512 (specifically, gradation 1 to gradation 512 are used for 100 nt display). When reducing to 150 nt, the maximum usable gradation is changed to 627 (specifically, gradation 1 to gradation 627 are used for 150 nt display). The number of usable gradations is changed in this manner for any other screen luminance.

As described above, the number of usable gradations is controlled (maximum usable gradation (maximum display gradation) control) when reducing the normal luminance to as low as ¼.

To further reduce screen luminance, in the present embodiment, the duty ratio control (FIG. 12, FIG. 13) is performed to control screen luminance, as represented in FIG. 84(c). The luminance is controlled by increasing or decreasing the area of the display region 53 or non-display region 52. Since the duty ratio control does not change the number of display gradations, a desirable gradation display can be performed.

FIG. 84(c) is an embodiment in which duty control is performed from a ¼ luminance (200 nt) to a 1/100 luminance (2 nt). The lowest luminance is 4 at for peak luminance, and 2 nt for white raster. In FIG. 84(c), the maximum number of usable gradations is 362 at 100% illumination rate, and 512 in the vicinity of 0% illumination rate (in the vicinity because 0% illumination rate means a black: raster display, in which no pixel illuminates).

By the foregoing control (FIG. 84(a), FIG. 84(b), FIG. 84(c)), the screen brightness can be adjusted to 1/100.

In FIG. 84, it is also preferable that point a and point b be variably set. Points a and b can be changed by first determining the illumination rate, and then changing, according to the value of the illumination rate, the coefficient multiplied with the video signal voltage or video signal data input to the EL display device. Preferably, this is performed with a delay time and a hysteresis operation. The foregoing is also applicable to the other embodiments of the present invention.

As described above, in the present embodiment, the maximum usable gradation (the maximum number of usable gradations) is reduced to vary luminance over the luminance range of from the maximum luminance (state of FIG. 84(a)) to a predetermined luminance (¼ luminance in FIG. 84(a) and FIG. 84(b)). For a lower screen luminance range, the luminance is varied by varying the duty ratio, as represented in FIG. 84(c). When varying the duty ratio, the number of display gradations does not change (maintained). The present invention, by the maximum gradation number control, enables brightness control of the display screen 31 in a relatively brighter display luminance range, and duty ratio control in a low luminance display. The duty ratio control is particularly effective when performed in a very dark environment such as in a dark room. This is because the brightness control by duty ratio does not reduce the number of usable gradations, and therefore realizes a desirable gradation display. In a high luminance display, because the number of usable gradations is large, an image display is hardly affected even when the number of usable gradations is reduced by the maximum usable gradation number control.

As described above, the characteristic or distribution of video signal voltage Vsig is detected, or the detection of characteristics or the like is performed based on video signal voltage Vsig, and the maximum usable gradation number control is preferably used for the control of varying the maximum display luminance of the screen, and the duty ratio control is preferably used for the brightness control (brightness adjustment) of the display screen 31 in a manner that depends on external illuminance or the like. As described above, in the present embodiment, the screen luminance of the display screen 31 is varied by the duty ratio control when performing a low luminance display (low luminance region), whereas the luminance is varied by varying the number of usable gradations when performing a high luminance display of above a certain level (high luminance region). In the latter case, the duty ratio is fixed at, for example, 1/1.

However, the present embodiment is not limited to this, and the duty ratio may be set to 1/2 or varied in a high luminance region. Further, the number of usable gradation numbers may be varied also in a low luminance region.

In FIG. 84(a), the luminance of maximum gradation is varied from 400 nt to 200 nt (½). However, the embodiment is not limited to this. The maximum luminance may be set to 100 nt, ¼ of 400 nt. Further, in FIG. 84(b), the maximum luminance is varied from 200 nt to 50 nt (¼). However, the embodiment is not limited to this. The maximum luminance may be set to 25 nt, ⅛ of 200 nt. Further, in FIG. 84(c), the maximum luminance is varied from 50 nt to 2 nt ( 1/25). However, the embodiment is not limited to this. The maximum luminance may be set to 1 nt, 1/50 of 50 nt.

As described above, according to target specifications, the variable range and position of the maximum number of usable gradations, and the variable range and position of the maximum luminance are changed by means of software. These changes can readily be made by a controller unit of the source driver IC 14. Video signal data, illumination rate, or the like are used as input variables. The change position, variable position, or the like are stored in external memory of the EEPROM 753.

The problem of burn-in that occurs on the display screen 31 of the EL display device can be solved by using a graphic controller 1292, and a flash memory 1291 having a capacity for the number of pixels, as illustrated in FIG. 129. The flash memory (flash ROM) 1291 stores therein illumination time of each pixel, and a life curve of the EL element for each color of RGB. The graphic controller 1292 maintains the illumination time of the display panel, and calculates the brightness (magnitude of flowing current) of each pixel from the video signal voltage Vsig, with the configuration of FIG. 83.

The graphic controller 1292 determines a decrease in the luminance of each pixel from the illumination time and current of each pixel, by performing calculations or other processes. A decrease in luminance is written into the flash ROM 1291 when turning off the EL display device, and read out from the flash memory 1291 when the EL display device is subsequently turned on. The graphic controller 1292 then adds correction data to the video signal so as to compensate for the luminance decrease of each pixel determined previously. By the foregoing process, burn-in (a decrease in the luminance of the EL element in each pixel) is compensated for with the correction data. There will accordingly be no burn-in.

The foregoing is applicable not only to the EL display panel or EL display device having the pixel configuration of FIG. 1, but to EL display panels and EL display devices having other pixel configurations (for example, FIG. 4, FIG. 5, FIG. 10, FIG. 11, FIG. 25, FIG. 29, FIG. 31, FIG. 33, FIG. 35, FIG. 37, FIG. 42, FIG. 46, FIG. 52, FIG. 54, FIG. 55, FIG. 58, FIG. 59, FIG. 86, FIG. 90, FIG. 91, FIG. 92, FIG. 93, FIG. 94, FIG. 95, FIG. 113, FIG. 123, FIG. 124 through FIG. 128).

The same can be said for the other embodiments. For example, the pixel configurations exemplified above or described in this specification may be combined with the methods or schemes of, for example, FIG. 12, FIG. 13, FIG. 61, FIG. 75, FIG. 76, FIG. 77, FIG. 78, FIG. 79, FIG. 83, FIG. 84, FIG. 85, FIG. 98, FIG. 99, FIG. 100, and FIG. 101, or the configurations, structures, or methods of FIG. 7, FIG. 8, FIG. 9, FIG. 60, FIG. 83, FIG. 96, FIG. 102, FIG. 103, FIG. 104, FIG. 106, FIG. 107, FIG. 108, FIG. 109, FIG. 110, FIG. 111, FIG. 112, and FIG. 129. Further, the foregoing is also applicable to the display panels (display devices) and the driving methods of the First and Second Embodiments, and the Fourth through Seventh Embodiments.

### Fourth Embodiment

The following will describe the Fourth Embodiment of the present invention.

FIG. 60 is an explanatory diagram of a power circuit (power IC) of an EL display device of the Fourth Embodiment. With the power circuit of the present embodiment, processes such as inspection, aging, and luminance adjustment can be readily performed.

A battery applies voltage Vin (at least 2.3 V and at most 4.6 V) to terminal Vin of a power circuit 602. The power circuit (power IC) 602 produces voltages required for the EL display device. The voltages (anode voltage Vdd, cathode voltage Vss) and their currents supplied to the EL element are generated by a DCDC circuit.

In the DCDC circuit, a coil Lp is used for voltage Vdd of the positive polarity, and a coil Ln for voltage Vss of the negative polarity. That is, necessary voltage values are generated by resonation using coils.

Anode voltage Vdd is common to analog voltage Avdd of the source driver circuit 14 (Vdd=Avdd). Voltage Avdd is the power supply voltage of the source driver circuit 14. Analog voltage Avdd is the reference voltage of a video signal. Because the drive transistor 11a is a P-channel transistor, the anode terminal is connected to an anode electrode (voltage Vdd). That is, the reference voltage of the drive transistor 11a is at the anode voltage Vdd. The analog voltage of the source driver circuit 39 is Avdd, and Avdd is the reference (when the video signal voltage is voltage Avdd, the amplitude voltage of the video signal is 0 V).

Note that voltage Avdd may be higher than anode voltage Vdd by at least 0.2 V and at most 1.0 V. For example, when the anode voltage is 4.6 V, voltage Avdd is at least 4.8 V and at most 5.6 V. In this way, display contrast can be improved.

With Avdd=Vdd, a program setting of the drive transistor 11a with the video signal becomes easier. Further, the number of power supplies used in the EL display device can be reduced.

The drive transistor 11a of the pixel 16 is a P-channel transistor. With Vdd=Avdd, the potential of the gradation voltage and the anode potential Vdd vary together, making it possible to realize a desirable gradation display. The reference point of the amplitude voltage applied to the drive transistor 11a varies with the anode voltage Vdd generated in the power circuit (IC) 602 even when Vdd varies due to variations. This makes it possible to improve the accuracy of the program setting of the drive transistor 11a with a video signal.

Note that when the drive transistor 11a of the pixel 16 is an N-channel transistor, the reference voltage of the video signal is ground (GND) voltage.

The power circuit 602, with a linear regulator circuit, produces a logic voltage Dvdd of the source driver circuit. Dvdd=1.85 V. Further, with a charge pump circuit, the power circuit 602 produces a power supply (VGH, VGL) of the gate driver circuit 12. The charge pump circuit uses a capacitor Cp for voltage VGH of the positive polarity, and a capacitor Cn for voltage VGL of the negative polarity. That is, necessary voltage values are generated with the charge pump circuit that includes the capacitors and the oscillating circuit.

Note that voltages, such as VGH and VGL, used in the gate driver circuit 12 may be generated by the charge pump circuit formed in the source driver circuit 14. In this case, off switches are provided for the VGH and VGL output circuits of the source driver circuit 14 (source driver circuit 14 is furnished with an output off function).

In the embodiment below, the power circuit 602 is described as being provided with VGH, VGL, Vrst voltage generating circuits 601. When the VGL, VGH, Vrst voltage generating circuits 601 are provided in the source driver circuit 14, the source driver circuit 14 may operate in synchronism with the power circuit 602 in the present embodiment.

Voltage Avdd and voltage Dvdd may be generated by a regulator circuit. Battery voltage Vin is input to the regulator circuit to produce voltage Dvdd. Further, battery voltage Vin is input to the regulator circuit to produce voltage Avdd.

In the EL display device of the present embodiment, the gate driver circuit 12a driving the switch transistor 11c that applies the video signal voltage Vsig to the pixel 16 has ON voltage VGH1, and OFF voltage VGL1. The gate driver circuit 12b driving the switch transistor 11d that performs the ON/OFF control of the current flown in the EL element 15 has ON voltage VGH2, and OFF voltage VGL2. VGH1=VGH2, and |VGL1|<|VGL2|. In this embodiment, the drive voltages (VGH2, VGL1) of the gate signal lines 17 that select pixels 26 and write video signals differ from the drive voltages (VGH2, VGL2) of the gate signal lines 17 that control the current flown to an EL element 35.

When the power voltage of the source driver circuit 24 is Avdd (V), and anode voltage is Vdd (V), Vdd−1.5 (V)≦Avdd≦Vdd.

When the ON or OFF voltage of the gate driver circuit is VGH (V), and the anode voltage is Vdd (V), Vdd+0.2 (V)≦VGH≦Vdd+2.5 (V).

As an example, the cathode voltage Vss ranges from −4.5 V to −1.0 V, and the anode voltage Vdd ranges from 3.5 V to 7.0 V. Vss, Vdd, VGH, and VGL are supplied from the power circuit, and the values of the respective voltages are varied or set as required.

The present embodiment provides an output open function to accommodate adjustments such as in an aging step, defect inspection, and luminance adjustment.

The output open function is realized by switches. As illustrated in FIG. 60, a switch (SW1, SW2, SW3, SW4, SW5, SW6, SW7) is provided on the output stage of each voltage generating circuit 601.

In the output open function, another voltage is applied to the output terminal of the power circuit 602 by turning off the switch SW (high impedance). For example, when Vdd=5 V, a voltage of 7 V can be applied to the Vdd output terminal by turning off the switch SW2 of the Vdd output terminal. When Vss=−3 V, a voltage of −5 V can be applied to the Vss output terminal by turning off the switch SW1 of the Vss output terminal.

This function is adapted so that the off-leak current that occurs when the switch SW of each terminal is turned off and an external voltage is applied to the terminal is 10 μA or less. This can be realized by a circuit structure in which a voltage is applied to the FET gate terminal of each switch SW via a buffer circuit.

The switch SW1 functions to turn off voltage Vss (high impedance). The switch SW2 functions to turn off voltage Vdd (high impedance). The switch SW3 functions to turn off voltage Avdd (high impedance). The switches are realized by analog switches, MOS switches, and the like.

Similarly, the switch SW4 functions to turn off (high impedance) the logic voltage Dvdd used in the source driver circuit 14, and the switch SW5 functions to turn off voltage VGH (high impedance). The switch SW6 functions to turn off voltage VGL (high impedance), and the switch SW7 functions to turn off voltage Vrst (high impedance).

Note that the switches (SW1 through SW7) are not necessarily required to form a distinct switch circuit. For example, the switch SW2 as a physical entity is not required when the output Vdd can be equivalently turned off by stopping the oscillating voltage applied to the Vdd generating circuit 601b. That is, the switches SW can be regarded as the function of stopping the operation of the voltage generating circuits 601.

The output circuit of the power voltage includes a transistor (FET), and a predetermined voltage is generated by resonating the FET switch with a diode and external coils (Ln, Lp). OFF voltage is applied to the gate terminal of the resonated FET, or the FET is turned off to prevent a voltage output from the FET. As a result, the output terminal of the power circuit 602 is turned off (high impedance). Further, a reverse bias may be applied to the diode installed in the power circuit 602 to turn off the diode. Further, as illustrated in FIG. 61, a switch circuit 611 may be externally provided for the power circuit 602. The switches SW may be realized by a relay circuit or the like.

OFF voltage is applied to the gate terminal of the transistor on the output stage of the power circuit 602 so that there is high impedance between the channels of the transistors. Note that, a protection diode is formed on the output stage of the power circuit 602, and the off state is maintained by connecting a sufficiently high voltage to the protection diode to prevent leak.

The output open function is not limited to being installed in the power circuit 602. For example, as illustrated in FIG. 61, the switch portion may be provided as the switch circuit 611. The switch circuit 611 is formed of a silicon chip, and mounted on a flexible substrate 755 or the like. The switch circuit 611 is realized by MOS-FET or the like.

That is, the off (high impedance) function of the present embodiment can be sufficiently realized when the terminals of the power circuit 602 equivalently assume a high impedance state relative to outside, or when another voltage can be externally applied to the terminals of the power circuit 602 in a high impedance state or upon entering a high impedance state.

The power circuit of this embodiment includes a negative power supply diode and a FET. The power circuit further includes a standard data bus such as SM bus, making it possible to set an output voltage or the like by commands transmitted to a standard data bus.

The voltages that can be set by commands are VGH, VGL, Vss, and Vrst. These voltages can be set at 0.5 V intervals. Note that two kinds of voltages, VGH1 and VGH2, may be produced for VGH, and two kinds of voltage, VGL1 and VGL2 may be produced for VGL.

The voltages can be readily varied by the provision of a DA converter circuit in the power circuit 602. The output open function can be controlled by commands. For example, the voltage Vss terminal can be turned off by command control via the standard data bus (SM bus, I2C Bus, etc.). The commands specify which switch to turn on or off.

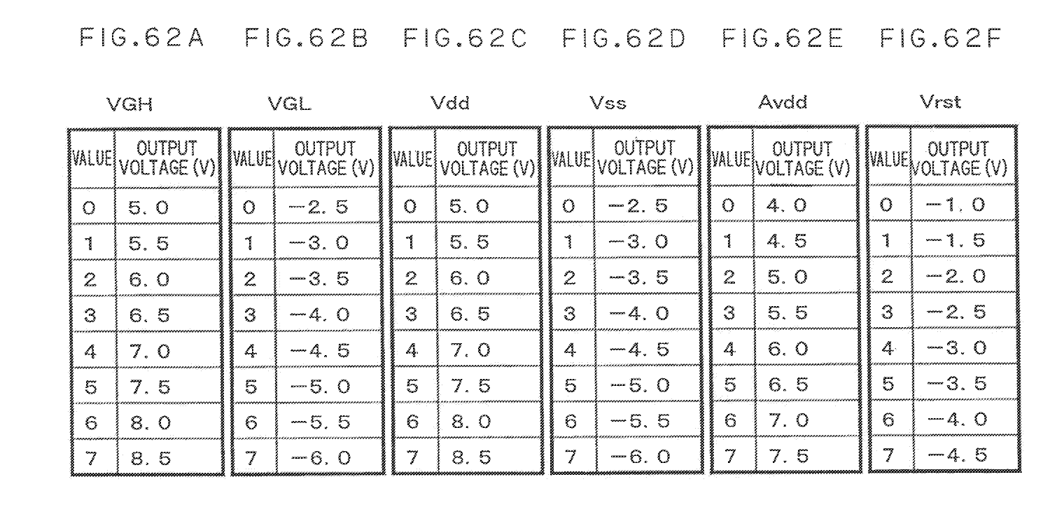

FIG. 62 represents set values of voltages VGH, VGL, Vdd, Vss, Vrst, and Avdd. These values are set at 0.5 V intervals according to the “value” of the commands. The voltage VGH is set so that its value is at least 1.0 V (or at least 0.5 V) higher than the value set for the voltage Avdd. The voltage VGL is set so that its value is equal to the value of Vss.

Preferably, the voltage values of FIG. 62 are stored in the EEPROM 753 (FIG. 75) so that the values can be changed according to use. For example, in FIG. 62, the voltage value of VGH is 5.0 V at value 0. This voltage is read out from the EEPROM 753, and changed to 4.5 V. Preferably, the voltage intervals are also variable according to the data stored in the EEPROM 753.

The voltages VGH, VGL, Vdd, Vss, Vrst, and Avdd are used in a panel adjusting step of this embodiment by being varied. Further, these voltages are used in a peak current suppress drive by being varied.

Voltage VGH ranges from 5.0 V to 9 V, inclusive, and may be set at 0.5 V intervals within this range. As required, the voltage may be set at 10 mV intervals. The same applies to the other voltages. For ease of explanation, this embodiment will be described through the case where the voltage is basically set at 0.5 V intervals, although this is not limiting to the invention.

As an example, voltage VGL ranges from −6.0 V to −0.5 V, inclusive, and the voltage may be set at 0.5 V intervals within this range. Voltage Vss ranges from −6.0 V to −0.5 V, inclusive, and the voltage may be set at 0.5 V intervals.

Preferably, voltage Vss is varied at 0.1 V intervals. It is particularly preferable that voltage Vss be varied according to the temperature of the EL display panel.

The output open function may be turned on/off by hard terminal control. For example, the first and second pins of the power circuit 602 are TEST1 and TEST2, respectively. When TEST1 is ‘H’, the outputs of Vdd and Vss terminals are OFF. When TEST1 is ‘L’, the Vdd and Vss terminals are in a voltage output state. When TEST2 is ‘H’, the outputs of the VGH and VGL terminals are OFF. When TEST2 is ‘L’, the VGH and VGL terminals are in a voltage output state.

Note that the output open function means a state in which mainly the voltage output terminals are separated from outside. Specifically, it is a state in which a current from other power supply does not flow into, for example, the power IC 602, or does not flow out even when a voltage or a current from other power supply is applied to the voltage output terminals or other places. A state similar to these is also confined within the meaning of the output open function. Further, the output open function is based on the technical idea of this kind.

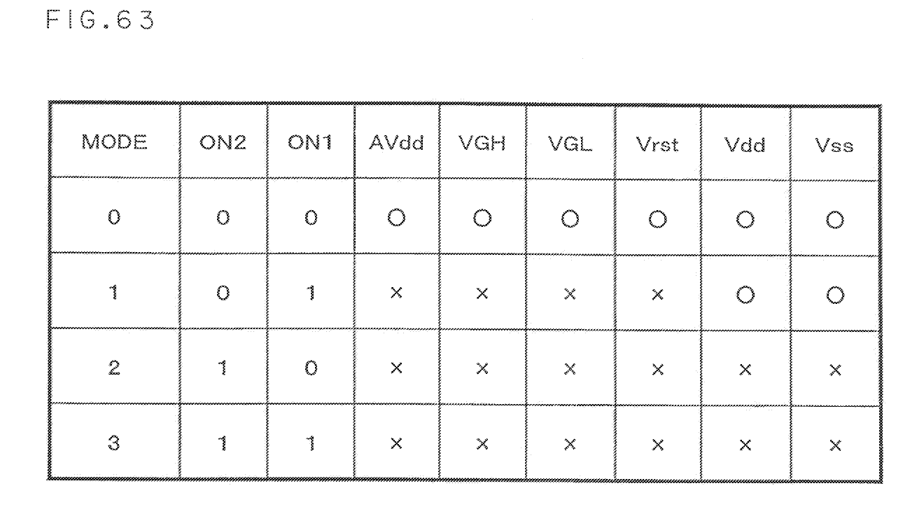

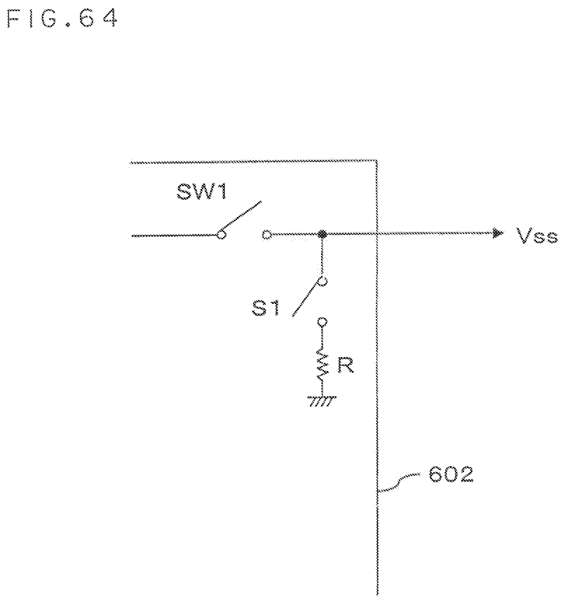

Further, a logic voltage is set to a plurality of pins so that a voltage of a 5.0 V to 8.0 V range is set to VGH and output from the terminal. FIG. 63 represents a relationship between the output voltage of TEST mode and a discharge circuit (FIG. 64).

The discharge circuit is provided for the output of each power supply. FIG. 64 illustrates the discharge circuit. FIG. 64 illustrates only the output stage of Vss; however, the discharge circuit is also formed for the other output stages Vdd, Avdd, VGH, VGL, and Vrst. When the off switch SW1 is OFF, the switch S1 is turned on to discharge the charge at the Vss terminal via a resistor R. The resistance of the resistor R is 30Ω to 100Ω for the output (Vss, Vdd) associated with the DCDC circuit, and 200Ω to 1 kΩ for the output (VGH, VGL) associated with the charge pump circuit. In this manner, the value of resistor R is larger for the voltage generated in the charge pump circuit than for the voltage generated in the DCDC circuit.

The switch S1 forming the discharge circuit is also adapted to operate according to command settings. That is, whether to initiate the discharge operation can be set by commands.

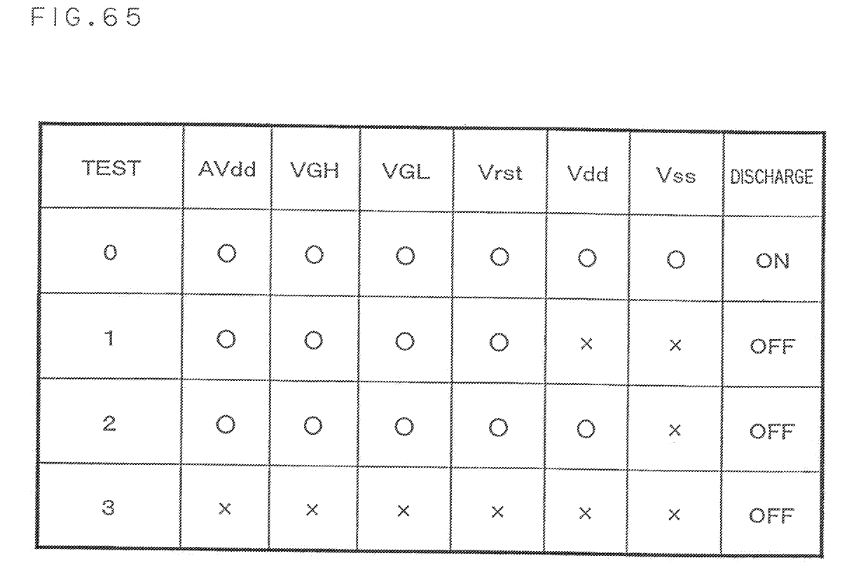

As represented in FIG. 65, Avdd may not have any discharge when TEST=3. In FIG. 63, the output terminals of the all voltages (Avdd through Vss) are maintained in a discharge state in MODE 0. This is important in protecting the EL display device from external noise. It is also important to maintain the Vdd and Vss terminals in a discharge state, when only the ON1 command is specified in MODE 1.

When there is only ON1 command, the terminals of the voltage (Avdd, VGH, VGL, Vrsr) used for the source driver circuit 14 and the gate driver circuit 12 are not discharged, and the terminal of the voltage applied to the EL element 35 is discharged. With ON1 and ON2 commands (MODE 3), discharge does not occur in any of the voltage terminals.

Note that the start-up of the power circuit (power IC) 602 is controlled by the operation or effect of a soft start circuit so that there will be no flow of a rush current. The soft start time is set to at least 3 ms and at most 20 ms.

The power circuit (power IC) 602 includes an overcurrent protecting circuit and a thermal shutdown circuit. The operating time of the overcurrent protecting circuit is set within a range of from 50 ms to 200 ms, inclusive.

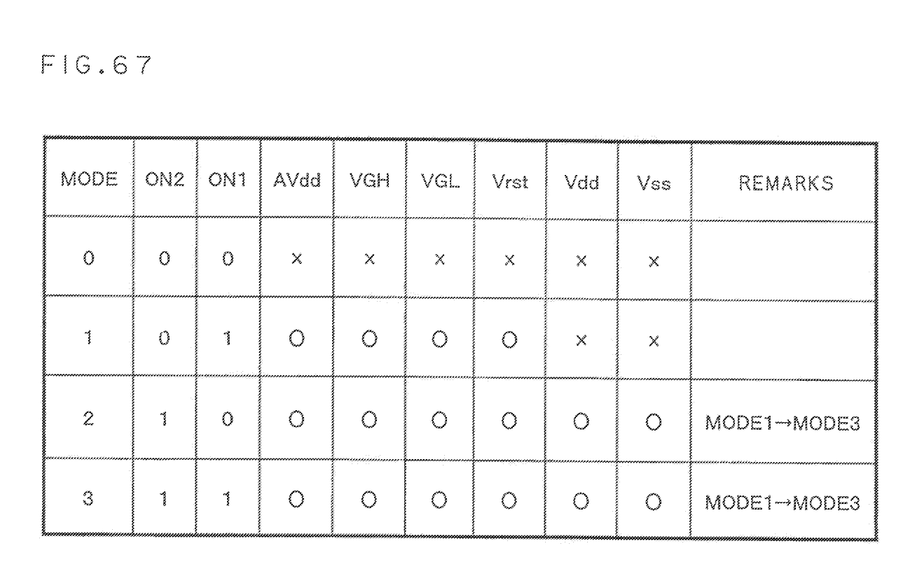

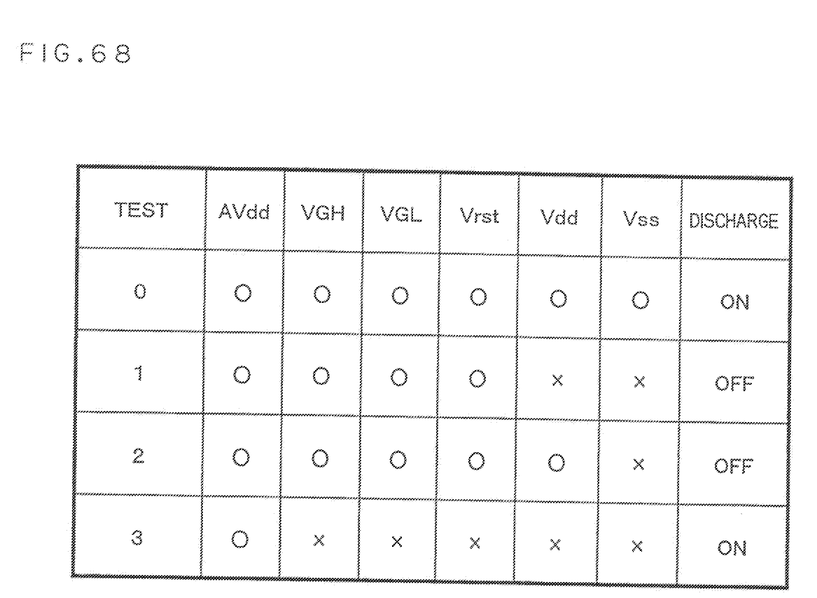

As described above, the discharge operation is performed also in the TEST state of FIG. 65. Test 0 is a normal operating state. For the outputs of Avdd, VGH, VGL, Vrst, Vdd, and Vss, the discharge circuit operates according to the MODE of FIG. 67 (discharge circuit is ON). The discharge circuit does not operate in TEST 1, TEST 2, and TEST 3 (discharge circuit is OFF, non-operating state). Note that, as represented in FIG. 68, the discharge circuit may be operative in TEST 3.

As illustrated in FIG. 64, the discharge circuit includes a switch S1, and a discharge resistor R. The discharge resistor R is used to discharge the charge of the terminal or wire (in an example of FIG. 64, Vss terminal or Vss wire). The switch S1 comes into operation when stopping the output voltage of the power circuit 602, and when varying the value of the power voltage.

In the power circuit 602 of this embodiment, the oscillating frequency of the DCDC circuit can also be set by the command from the source driver circuit 14.

One of the oscillating frequency is selected from 0.6 MHz, 1.2 MHz, and 1.8 MHz. The oscillating frequency is set so that it is an integer multiple (0.6 MHz, 1.2 MHz, 1.8 MHz). One of the oscillating frequencies is set within a range of 1.0 to 1.6 MHz (1.2 MHz in this embodiment). This frequency range is preferable because it does not cause beat noise on the display screen 31.

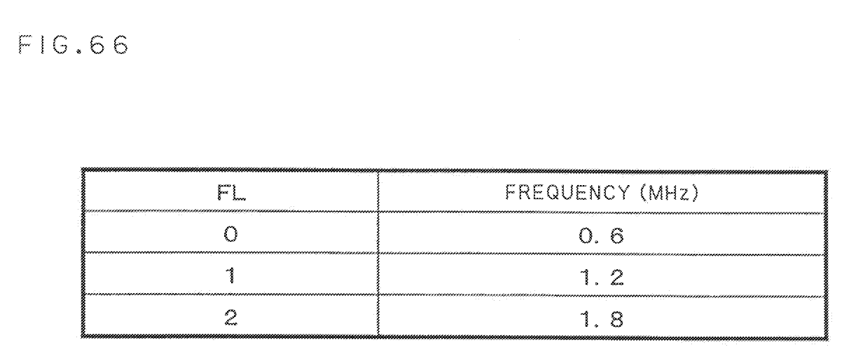

The oscillating frequency is represented in FIG. 66. The oscillating frequency can readily be set by selecting one of the resistors installed in the power circuit. The oscillating frequency can be varied by setting FL commands. When the oscillating frequency is low, the size of the external coils (Lp, Ln) of the power circuit increases. Conversion efficiency also increases. When the oscillating frequency is high, the size of the external coils of the power circuit decreases. Conversion efficiency often decreases.

The power circuit of the present embodiment is used for cellular phones. In this embodiment, the oscillating frequency is switched according to the transmission method of the cellular phone. In the case of CDMA, the DCDC oscillating frequency is set to 0.6 MHz. In GSM, a 1.2 MHz oscillating frequency is used. In this embodiment, the oscillating frequency is switched by commands in CDMA and GSM. In other words, the oscillating frequency is switched according to the receiving method of the cellular phone.

FIG. 63 represents whether the discharge circuit operates in the test mode (TEST), which is the operation mode of the power circuit of this embodiment. In FIG. 63, the open circle indicates an output of a corresponding voltage, and the cross indicates there is no output. ON indicates that the discharge circuit is operating (switch S1 is ON in FIG. 64), and OFF indicates that the discharge circuit is in a non-operating state (switch S1 is OFF in FIG. 64).

For example, when the value of TEST mode is 1 (set value 1), Avdd, VGH, VGL, Vdd, Vrst, and Vss are output, and the discharge circuit is ON. When the value of TEST mode is 2 (set value 2), Avdd, VGH, and VGL are output, and the discharge circuit is OFF.

The power circuit 602 of this embodiment has MODE, as represented in FIG. 67.

In MODE, the rise and fall sequences of the power circuit 602 are performed. The sequences are performed in ON1 and ON2.

When MODE=0 (MODE command value is 0, MODE 0), ON1 and ON2 are both 0 (OFF).

When MODE=1 (MODE command value is 1, MODE 1), ON1=1 (ON), and ON2=0 (OFF).

When MODE=2 (MODE command value is 2, MODE 2), ON1=0 (OFF), and ON2 is 1 (ON). When MODE=3 (MODE command value is 3, MODE 3), ON1 and ON2 are both 1 (ON). Note that, in FIG. 67, the open circle indicates that there is an output of a corresponding voltage, and the cross indicates there is no output of a corresponding voltage.

When ON1=1, the power voltages (Avdd, VGH, VGL, Vrst) of the source driver circuit 14 and gate driver circuit 12 rise. When ON2=1 (ON), the anode voltage Vdd and cathode voltage Vss are supplied to the EL display device.

In the rise sequence, in the present embodiment, ON1 is set first, followed by ON2. In the rise sequence, the gate driver circuit 12 and the source driver circuit 14 come into operation, and then voltages, such as anode voltage, supplied to the EL element 35 is applied. Reversing this state causes an unnecessary emission state in the EL display device.

In the fall sequence, in the present embodiment, ON2 is released first (ON2=0), followed by ON1 (ON1=0). In the fall sequence, a reverse flow from the anode terminal to the source driver circuit 14 may occur and destroy the source driver circuit or other element unless the voltages of the gate driver circuit 12 and the source driver circuit 14 are turned off after cutting the anode voltage Vdd and the cathode voltage Vss.

For this reason, the state of MODE=2 must be prevented. When the first state of the rise sequence is MODE=3 because of noise or the like, MODE 1 is set first before MODE 3 is executed. Further, when the first state of the rise sequence is MODE=3 because of noise or the like, MODE 1 is set first before MODE 3 is executed. As described above, in this embodiment, a self-correcting logic is installed that operates when the operation starts from an abnormal state.

In the case of the fall sequence, ON2=0 from the state of MODE 3. This is followed by the state of MODE 1, and then MODE 0.

In MODE 0, all the output voltages are OFF. In MODE 1, the analog voltage Avdd of the source driver circuit 14, and the voltage (VGH, VGL) of the gate driver circuit 12 are ON, and anode voltage Vdd and cathode voltage Vss are OFF. In MODE 2 and MODE 3, the analog voltage Avdd of the source driver circuit 14, and the voltage (VGH, VGL) of the gate driver circuit 12 are ON, and anode voltage Vdd and cathode voltage Vss are ON. MODE 2 is prohibited.

FIG. 68 represents a setting state of a discharge operation for the MODE (see FIG. 64). In FIG. 68, the open circle indicates a discharge operation (a corresponding switch S is ON as in FIG. 64 (switch S1 in FIG. 64)). The cross indicates that the switch S is OFF (no discharge operation).

In MODE 0, all the output voltages are OFF, and as such all terminals are in a discharge state. In MODE 1, the analog voltage Avdd of the source driver circuit 14, and the voltage (VGH, VGL) of the gate driver circuit 12 is ON, and anode voltage Vdd and cathode voltage Vss are OFF. As such, only the anode voltage Vdd and cathode voltage Vss are in a discharge state. In MODE 2 and MODE 3, the analog voltage Avdd of the source driver circuit 14, and the voltage (VGH, VGL) of the gate driver circuit 12 are ON, and the anode voltage Vdd and cathode voltage Vss are ON. As such, there is no discharge in all outputs (no operation). MODE 2 is prohibited.

As described above, a discharge state is created for the terminals with no voltage output. This makes it possible to prevent unnecessary operation or malfunction of the EL display device, and prevent the EL display device from electrical destruction.

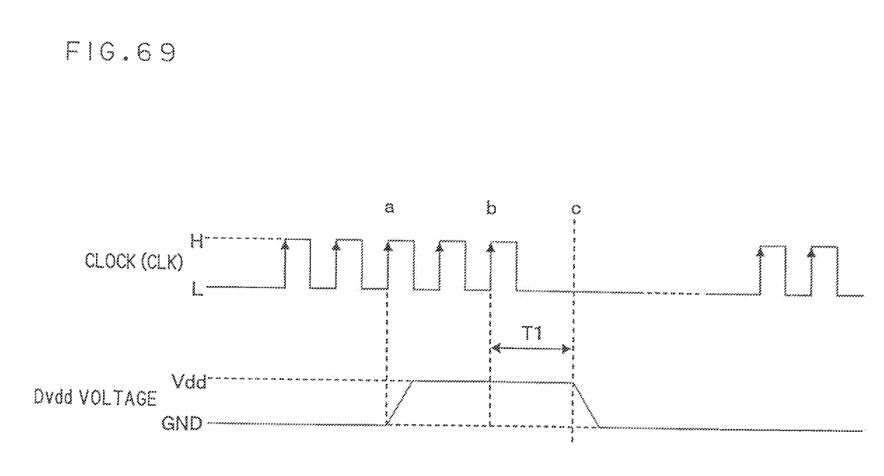

The ON/OFF terminals are terminals to start the power circuit. In response to a clock signal applied to the ON/OFF terminals, voltage Dvdd is output. The clock signal detects a rise or fall of a signal, and, upon detection of a rise or a rising edge of more than one clock signal, logic voltage Dvdd is output (see FIG. 69).

As the clock signal, the video signal clock or horizontal synchronizing signal HD applied to the EL display device of this embodiment are used. The video signal is generated by the graphic controller of the apparatus in which the EL display device of this embodiment is incorporated.

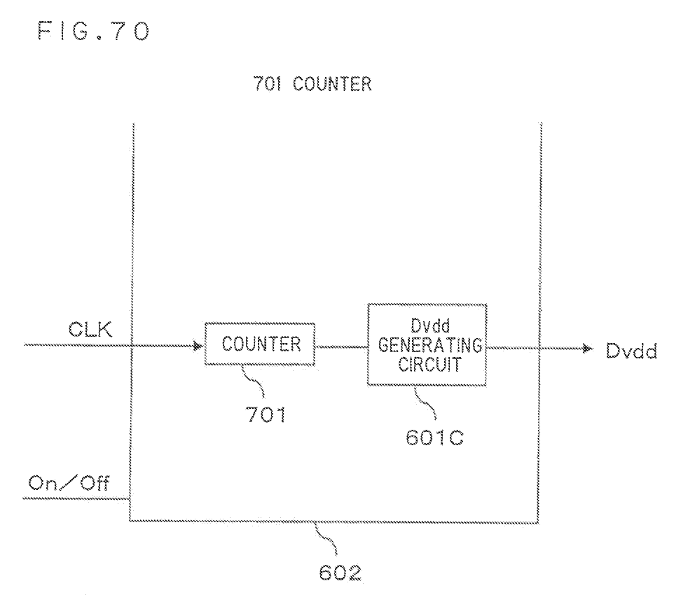

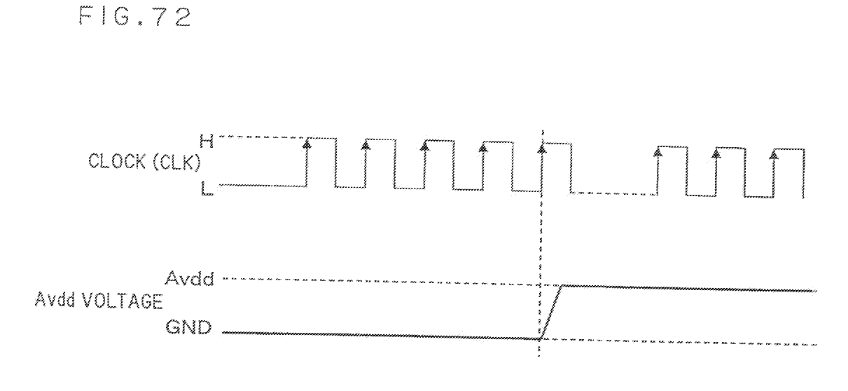

As represented in FIG. 69, a rise of the clock (CLK) signal is detected, and a counter 701 in the power circuit 602 counts up (see FIG. 69, FIG. 70, and FIG. 72). On the third clock, voltage Dvdd is output. The number of clocks needed to raise the power supply is settable by commands.

In FIG. 69, Dvdd is output at point a where the third clock occurs. The clock signal may be detected by detecting a fall of the clock. The both edges of the clock may be detected. The clock is not counted when the clock intervals are shorter than a certain length. This setting is made by a low-pass filter installed in the power circuit 602.

When the clock is blocked for a certain period, the output of voltage Dvdd is stopped. In FIG. 69, the output is stopped when period T1 is 30 ms or longer. At the same time, the count value of the counter 701 is cleared. The counter 701 then starts counting from 0.

In the embodiment of FIG. 69, the ON/OFF (output, stop) of voltage Dvdd is made by the clock. However, the invention is not limited to this. For example, voltages Vdd, voltage Vss, VGH, and VGL may be ON/OFF Controlled. Further, the voltages, such as VGH and VGL, that are required for the gate driver circuit 12 and output with a charge pump may be output on the third clock, and the DCDC voltage, such as Vdd and Vss, supplied to the EL element 35 may be output on the 30th clock.

The same applies to the fall. The DCDC voltage, such as Vdd and Vss, supplied to the EL element 35 may be stopped after 30 ms, and at the same time, the discharge circuit (see FIG. 64, FIG. 68) may be operated so that, after 100 ms, the voltages such as VGH and VGL required for the gate driver circuit 12 may be stopped with a charge pump (a simultaneous discharge circuit operation). That is, the voltage output is controlled by the number of clocks, or clock intervals.

Voltage Dvdd is a logic voltage of the source driver circuit 14. At the rise of Dvdd, the power supply for the I2C bus (or SM bus) is supplied, enabling command communications between the source driver circuit 14 and the power circuit 602. The source driver circuit 14 transmits an ON sequence command (ON command) to the power circuit 602 via the I2C bus (or SM bus), and the power circuit 602 outputs other voltages (VGH, VGL, Vss, Vdd, etc.).

The fall of the power circuit 602 occurs (the voltage output is stopped) in response to an OFF sequence command (OFF command) sent from the source driver circuit 14 to the power circuit 602. Note that the power circuit 602 assumes an OFF state also when the clock signal (CLK) illustrated in FIG. 69 is interrupted.

Voltage Dvdd is a logic voltage used in the source driver circuit 14. The logic operation of the source driver circuit 14 does not start without the input of a logic voltage, and the start sequence of the EL display device does not start. However, power is consumed when the voltage generating circuit 601c for Dvdd is ON at all times (even when the EL display device is not used). There will be no unnecessary power consumption when the Dvdd generating circuit is turned on with a clock as in FIG. 69 and FIG. 70. Further, there will be no unnecessary power consumption with a configuration in which the Dvdd circuit assumes a non-operating state when there is no clock input for a certain time period.

In the embodiment of FIG. 69, voltage Dvdd was described to rise in response to a clock input. However, the invention is not limited to this. The other voltages, such as Avdd, may be adapted to rise. It is preferable that the number of clocks to raise the voltage be settable by commands or the like. It is also preferable that fall time T1 be settable by commands or the like.

Further, it is preferable that the counter value be cleared when there is no clock for EL certain time period. For example, when the third clock signal (CLK) is not input within 20 ms from the input of the second clock signal (CLK), the counter of the power circuit 602 is cleared and returns to 0. The counter is also cleared when the power circuit 602 has accepted the off sequence. The clear time is settable by commands.

Time T1 to clear the counter is likely to involve a vertical synchronizing signal as a clock. Thus, in the case of 30 frames, T1 must be at least 35 ms. Further, in order to prevent count up malfunction due to noise, T1 must be 100 ms or less (0.1 Hz). Further, the counter is adapted to operate by the main clock of the video signal. When the image clock of the display device is 3 MHz, the counter is adapted to operate in 3 MHz. However, when adapted to operate at too fast a clock speed, the counter easily malfunctions by external noise. Thus, the clock is set to 10 MHz or less. That is, the clock ranges from 0.1 Hz to 10 MHz, inclusive. Preferably, a horizontal synchronizing signal (HD) is used as the clock. The horizontal synchronizing signal ranges from about 8 KHz to 30 KHz, inclusive. Thus, the clock is adapted to operate in a range of from 8 KHz to 10 MHz, inclusive.

Further, to prevent malfunction due to the input of an abnormal clock (external noise) in a short time period, a no-pass filer of, for example, a capacitor is formed.

The counter 701 is cleared when the power IC 602 is turned off. The counter 701 is also cleared in response to the input of a software reset or a hardware reset of the EL display device. The counter 701 is initialized when the power IC 602 is turned on.

The voltage Dvdd may be adapted to be output on the third clock signal (CLK), and the voltage Avdd may be adapted to be output on the fifth clock signal (CLK), as represented in FIG. 72. That is, the voltage to rise is specified by the number of clock signals (CLK). The same is applicable to the fall of a voltage. The number of clocks counted is preferably 2 to 5, inclusive. This is to prevent malfunction due to noise, and to reduce the start-up time.

Further, once the counter has reached a specified value, the output of voltage may not be stopped unless there is input of a reset signal from the source driver circuit 14 to the power circuit 602.

The voltage Dvdd is generated using a regulator. A leak current flows and power is consumed when the regulator is in an operating state. There will be no leak current when the regulator is adapted to start upon detection of a clock as in FIG. 69 and FIG. 70. Thus, no power is consumed when the EL display device is in a non-operating state.

The power circuit 602 of this embodiment is adapted so that the voltage is output in response to the input of an ON command when the clock signal (CLK) is input. Further, the output of voltage is stopped in response to the input of an OFF command when the clock signal (CLK) is input. The output terminals are OFF.

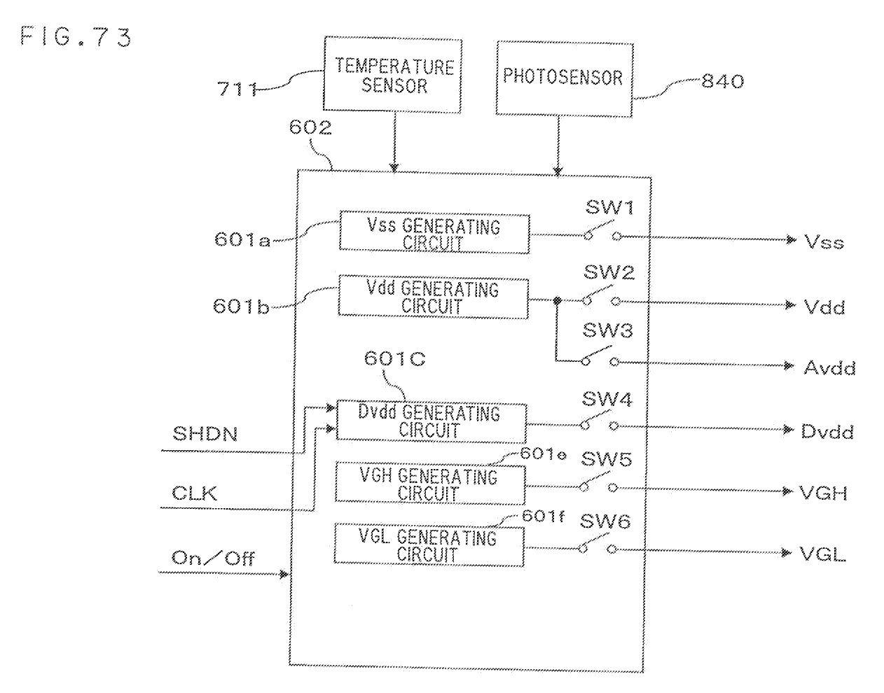

The present embodiment is not limited to the foregoing example. For example, as illustrated in FIG. 73, an ON/OFF terminal (hard pin) may be provided to which a voltage is forcibly output.

The following describes the rise sequence with reference to FIG. 75.

In response to the horizontal synchronizing signal (HD) or the main clock (CLK) input to the power circuit 602, the Dvdd generating circuit 601c (FIG. 70) counts the clock, and the regulator of the Dvdd generating circuit comes into operation when specific numbers of clocks have been counted. The regulator circuit regulates the input battery voltage Vin, and outputs 1.85 V (1.8 V series).

As described above, CLK or HD, and Vin are the only signal or voltage supplied to the power circuit 602 through the connector 751. A panel 34 and a flexible substrate 756 are electrically connected to each other with the ACF 755, and therefore cost will not increase even when the number of power voltages output from the power circuit 602 is large. The power circuit 602 is mounted by flip chip (COF) technology.

The 1.85 V voltage is the logic voltage of the source driver circuit 14 or the like. The logic voltage Dvdd is the power supply of the SM bus, and the power voltage of the EEPROM 753 and the flash memory 752. Thus, with voltage Dvdd, the logic system of the EL display device is started.

The source driver circuit 14 starts the rise sequence in response to the input of the logic voltage Dvdd, and the input of a reset signal command supplied through an external three-line serial bus.

When the source driver circuit 14 receives the reset signal command, and the initialization of the power circuit 602 completes (MODE 0 in FIG. 67), the source driver circuit 14 sends ON command (ON1, ON2; FIG. 67) to the power circuit 602 via SM bus. Basically, the ON sequence is MODE 0 (ON1 and ON2 are OFF)→MODE 1 (only ON1 is ON)→MODE 3 (ON1 and ON2 are ON).

In response to the ON1 command, the voltages Avdd (analog voltage of the source driver circuit 14), VGH, and VGL are output. Avdd and the anode voltage Vdd are the same voltages (see, for example, FIG. 61). Avdd is output with ON1; however, the anode voltage Vdd is not output because SW2 is in the OFF state. SW2 becomes ON by ON2 command. By the ON1 command, VGH is output when SW5 is turned on, and VGL is output when SW6 is turned on.

The application of voltage Avdd to the source driver circuit 14 enables output of the gradation voltage or the like. Voltages VGH and VGL are applied to the gate driver circuit 12. VGH and VGL set the potential of the gate signal lines 17 of the gate driver circuit 12. The source driver circuit 14 applies a start (ST) signal and a clock (CLK) signal to the gate driver circuit 12. The source driver circuit 14 also applies, for example, a video voltage signal of a black gradation to the source signal lines 18. The gate driver circuit 12 controls the pixels 16 in a black display state.

The transition from ON1 command (MODE 1 in FIG. 67) to ON2 command (MODE 3 in FIG. 67) takes at least one frame period, and preferably at least two frame periods. This is because the anode voltage Vdd and the cathode voltage Vss are applied after the display screen 31 is brought into a black display state. If the anode voltage Vdd and the cathode voltage Vss are applied before the display screen 31 assume a black display state, an unnecessary image may be displayed.

The source driver circuit 14 then outputs a video signal to the source signal lines 18 according to the input video signal (RGB), horizontal synchronizing signal (HD), vertical synchronizing signal (VD), and clock (CLK).

The source driver circuit 14 sends ON2 command to the power circuit 602. The ON2 command turns on SW1 and SW2, and the anode voltage Vdd and the cathode voltage Vss are applied to the display screen 31. The application of anode voltage Vdd and cathode voltage Vss causes the EL display device to display an image.

Thereafter, the source driver circuit 14 determines the illumination rate from the video signal based on calculations or other operations of the current flowing in the display screen 31, and performs a duty ratio drive below the peak current. Further, as required, the source driver circuit 14 sends a command to the power circuit 602 to vary anode voltage Vdd and cathode voltage Vss.

Note that when the sequence malfunctions and starts from MODE 2 as in FIG. 67, MODE 1 is executed before MODE 3. When the sequence malfunctions and starts from MODE 3, MODE 1 is executed before MODE 3.

In the OFF sequence (fall sequence), MODE 1 is executed. Prior to the execution of MODE 1, the source driver circuit 14 creates a black display on the display screen 31. The black display is realized by applying a black gradation signal (low gradation) to the source signal lines 18, and writing this signal to the pixels 16. After the black display, the source driver circuit 14 sends a command to the power circuit 602 to effect MODE 1 (ON2 is OFF).

By the OFF instruction of the ON2 command, SW1 and SW2 turn off, stopping the supply of anode voltage Vdd and cathode voltage Vss to the display screen 31.

The source driver circuit 14 then sends a command (ON1 is OFF) so that the power circuit 602 is MODE 0.

The transition from MODE 1 to MODE 0 in FIG. 67 takes at least one frame period, and preferably at least two frame periods. This is because the gate driver circuit 12 is stopped after completely discharging the anode voltage Vdd and the cathode voltage Vss from the terminals or the like. With the ON2 command OFF (0), SW2 and SW1 turn off. Here, the discharge circuit is operated as in FIG. 64 and FIG. 68. This is to avoid an unnecessary image display, which may occur when the anode voltage Vdd and cathode voltage Vss are not completely discharged.

With the ON1 command OFF, SW5 and SW6 turn off, stopping the voltages Avdd (analog voltage of the source driver circuit 14), VGH, and VGL. Finally, CLK or HD applied to the power circuit 602 stops, and Dvdd stops.

In the embodiment of, for example, FIG. 61 and FIG. 73, a shutdown terminal (SHDN) is provided. The SHDN terminal is provided to output (or not to output) a voltage in response to ON/OFF command even when there is no input of a clock signal (CLK). When the logic voltage to the SHDN terminal is at L level, the power supply operation described in FIG. 69 and FIG. 72 are performed.

When the logic voltage to SHDN terminal is H level, ON/OFF command is accepted even with the absence of a clock signal (CLK). The normal state of the shutdown terminal (SHDN) is 0 (GND), and a Dvdd output state is set by an external clock. When the shutdown terminal (SHDN) is H, Dvdd is output even when there is no input of a clock.

The provision of the shutdown terminal (SHDN) is effective when the power circuit 602 of this embodiment is used in an inspection step. In an inspection step (dot defect detection, characteristic evaluation), the frame rate is reduced. For example, the refresh time of an image display is varied from 60 per second to 20 per second. Further, using a test transistor 754, a signal voltage is applied to the source signal lines 18 to display an image. For this reason, a video signal used as a clock (main clock, horizontal synchronizing signal clock) may not be available. Further, the clock cycle is considerably long, longer than period T1 of FIG. 69, and the voltage output stops. In this case, the voltage output cannot be turned on/off with a clock. To avoid this, in the present embodiment, the voltage output is forcibly controlled using the shutdown terminal (SHDN).

In FIG. 61, FIG. 73, and elsewhere, the shutdown terminal (SHDN) is provided only for the Dvdd generating circuit. However, the invention is not limited to this, and the shutdown terminal (SHDN) may also be provided for the other voltage generating circuits 601. Further, the power circuit 602 may be adapted to be entirely ON/OFF controlled by the shutdown terminal (SHDN).

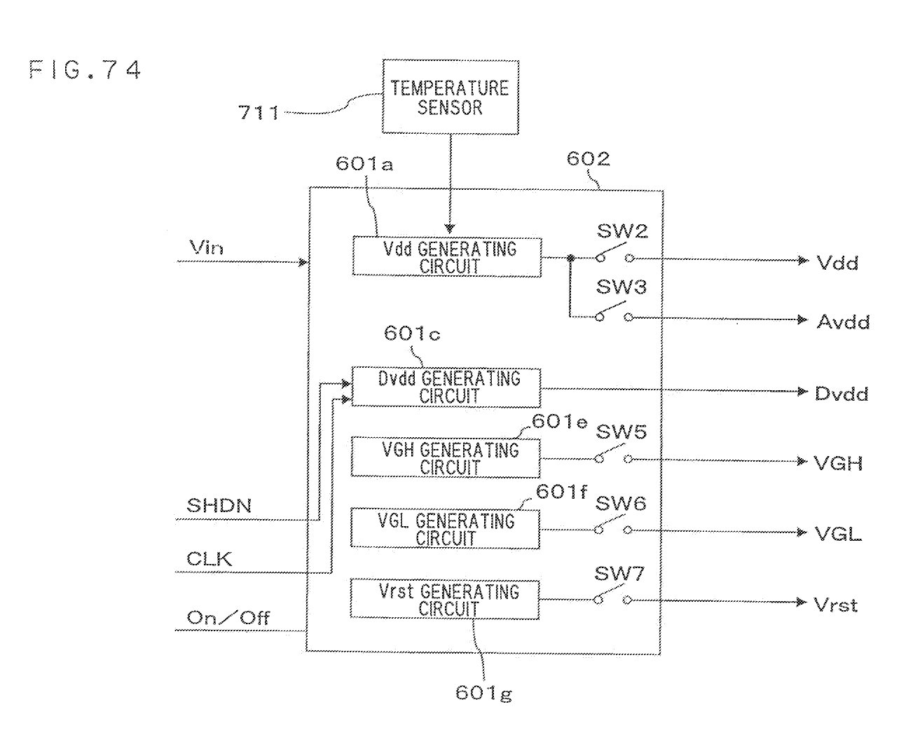

As illustrated in FIG. 74, the voltage Vss generating circuit may be omitted. In this case, the cathode voltage of the EL display device is GND. The output of the Dvdd voltage generating circuit 601c does not have a switch. This is because the output and non-output of Dvdd can be controlled by the logic signal of CLK or SHDN. Another reason is that, absent the Dvdd supply, the logic of the source driver circuit 14, which controls each switch SW, cannot operate and fails to generate a SW control command.

The description of this embodiment is given through the case where the power circuit 602 is an IC. However, the invention is not limited to this. For example, the power circuit 602 may be realized by discrete components. The reset voltage Vrst is used in an EL display device having the pixel configuration of FIG. 74.

With the Dvdd activated, the logic circuit unit of the source driver circuit 14 starts, enabling data to be sent to a standard data bus such as SM bus Using the standard data bus (such as SM bus), the source driver circuit 14 sets the value of the voltage (VGH, VGL, Vss) output by the power circuit. The source driver circuit 14 also sets an oscillating frequency. Further, Avdd (Vdd), VGH, and VGL are output from the power circuit 602.

The power circuit 602 is mounted on a flexible substrate (bilayer structure) 756, as illustrated in FIG. 75.

A gold bump is formed on each output terminal of the power circuit 602, and the power circuit (602 is mounted by flip chip technology using ACF (anisotropically conductive film connections).

FIG. 75 also illustrates a group of test transistors 754. The test transistors 754 are respectively provided for the source signal lines 18. As illustrated in FIG. 76 and FIG. 77, the test transistors 754 may be mounted on the other side (position B) of the surface on which the source driver circuit 14 is mounted. Note that the source driver circuit 14 is not limited to an IC, and may be a source driver circuit formed by, for example, low-temperature polysilicon technology. A three-select circuit 1041 may be formed.

Switches SW3, SW4, and SW6 are not formed, or may be omitted. A Dvdd of 1.85 V is output by the clock signal of a video signal. Accordingly, the switches are not required. Avdd is output simultaneously as the DCDC circuit oscillates. Avdd is the analog power voltage of the source driver circuit 14. Avdd is also the power voltage of the internal shift registers of the gate driver circuit 12.

The source driver circuit 14 sends the ON/OFF control signal for each power supply to the power circuit 602, through the standard data bus such as SM bus and I2C Bus. Note that the operation speed of SM bus and I2C Bus is set to at least 10 KHz and at most 10 MHz.

With the command ON1, the VGH switch SW5 and the VGL switch SW6 turn on. With the switches SW5, SW6, and SW7 turned on, VGH, VGL (VGL1), and Vrst are output, and the gate driver circuit 12 starts. The start pulse (ST1, ST2), clock (CLK1, CLK2), and updown (UD) applied to the gate driver circuit 12 are controlled by the source driver circuit 14. The internal shift registers of the gate driver circuit 12b are cleared, and all the gate signal lines 17b assume a non-select state.

Next, with the command ON2, the Vdd switch SW2 and the Vss switch SW1 turn on. With the switches SW1 and SW2 turned on, the anode voltage Vdd and the cathode voltage Vss are output.

A battery of the main body supplies voltage Vin to the power circuit 602. Voltage Vin is supplied to the power circuit 602 via the connector 751. From one voltage Vin, the power circuit 602 generates voltages (anode voltage Vdd, cathode voltage Vss, VGH, VGL, Avdd, Dvdd=1.85 V) required for the EL display panel. The flexible substrate 756 and the array substrate 755 are ACF (anisotropically conductive film) connected. That is, since the flexible substrate 756 and the array substrate 755 are bonded to each other, no connector is required for the output voltage of the power circuit 602 to be applied to the EL display panel 755.

In the embodiment of FIG. 75, the power circuit is mounted on the flexible substrate 756, and the power circuit 602 is operated to perform adjustments such as luminance adjustment and white balance adjustment. Thus, the variations in the generated voltages of the power circuit 602, if any, do not pose any problem, because the EL display panel is adjusted taking into consideration these variations. Further, aging can be performed desirably by using the actual voltages, such as VGH and VGL. However, in aging, the absolute value (potential difference) of VGH−VGL is increased more than in a normal display.

A current limit function is used for the operation inspection of the EL display device of the present embodiment.

The current limit function is a function that sets the maximum output current for Vss or Vdd. For example, when the limit current of voltage Vss is 0.5 A, and the Vss output current exceeds 0.5 A, the internal oscillating frequency is reduced to prevent the output current from becoming 0.5 A or more. In this case, the output voltage Vss generally decreases. When the limit current of Vss is set to 1.0 A, and the Vss output current exceeds 1.0 A, the internal oscillating frequency is reduced to prevent the output current from becoming 1.0 A or more. In this case, the output voltage Vss generally decreases.

The power circuit 602 of this embodiment is adapted so that the voltages Vss and Vdd can be set in two stages of current limits. The two stages are, for example, 0.5 A and 1.0 A. The value of current limit is switched between the aging step and the module final inspection step.

When command IMN is 0, the limit current (A) by the current limit function for the voltage Vss is 0.5 A. When command IMN is 1, the limit current (A) by the current limit function for the voltage Vss is 1.0 A.

When command IMP is 0, the limit current (A) by the current limit function for the voltage Vss is 0.5 A. When command IMP is 1, the limit current (A) by the current limit function for the voltage Vss is 1.0 A.

In this manner, the limit current can be individually set for Vdd and Vss. Further, in this embodiment, the limit current value is set in two stages, 0.5 A and 1.0 A. However, the invention is not limited to this, and the value may be set in three or more stages.

The current limit function is used in the inspection or adjusting step of the EL display device. For example, in the shipping inspection of the EL display device, the limit current is set to 0.5 A. The set value is 1.0 A in normal operation. The limit current is set to 0.5 A to display an adjusted image on the EL display device.

In the EL display device, the current that flows in the illumination region varies according to the display image.

For example, in a black raster display, the current that flows in the display screen is ideally 0 A. In a white raster display, the maximum current flows when the peak current suppress drive is not set. When the peak current suppress drive is in operation, there will be no flow of a current that is equal to or greater than a set current.

In the EL display device, the magnitude of the current that flows in the display screen varies depending on the type of image. Thus, in an inspection configuration of the EL display device, whether the current limit function is operating can be found by sequentially displaying images of known currents on the EL display device.

For example, consider that the currents that flow in the display screen are 0.6 A and 0.4 A in image 1 and image 2, respectively, with respect to a smaller than usual limit current (0.5 A in this embodiment).

If the current limit function does not operate on image 1 displayed on the EL display device, it can be said that the current limit function is malfunctioning. On the other hand, if the current limit function operates on image display 2 displayed on the EL display device, it can be said that there is error in the current limit function or in other places. It is also possible to know whether the peak current suppress drive is operating properly. The value of current limit can be varied by commands. By varying the value of current limit using commands during an inspection, the operating state of the EL display device can be inspected. That is, plural limit set values are provided for the power IC 602, and a current limit value is set from these limit values. The operation of the current limit function is then accessed by displaying images of known currents.

The current that flows in the power circuit 602 increases when the duty ratio is increased, and decreases or varies when the duty ratio is decreased.

In this embodiment, the power circuit 602 and the EL display panel are operated together (simultaneously) to perform adjustments, aging, or other procedures. The EL display device of this embodiment includes the unit constructed from the power circuit 602 and the EL display panel (interconnected to each other). With this construction, the connector 751 requires fewer pins, and the cost can be reduced. Further, ideal adjustments of luminance variation and white balance are possible. For this, the output open function of the power circuit 602 is effectively used in this embodiment.

The embodiment has been described to provide the output open function in the power circuit 602. However, the embodiment is not limited to this. For example, the analog switch and the relay circuit may be disposed between the anode output terminal of the power circuit 602 and an anode wire 761 of the EL display panel. That is, the switch circuit or the like may be externally disposed or formed for the power circuit 602.

The source driver circuit 14 controls the start pulse (ST1, ST2), clock (CLK1, CLK2), and updown (UD) applied to the gate driver circuit 12. As a result, an image is displayed. In one frame period, a start signal ST1 is applied to the gate driver circuit 12a. A start pulse ST2 is applied to the gate driver circuit 12b to accommodate a duty drive.

The flexible substrate 756 is ACF connected to the array substrate 755 (EL display panel) to complete the EL display device (see also FIG. 75). Elements such as the power circuit 602, EEPROM 753, and the flash memory 752 are mounted on the flexible substrate 756. The voltage VGH that turns off the test transistor 754 (VGL when the test transistor 754 is an N-channel transistor) is supplied from the power circuit 602.

In the embodiment described above, VGH, VGL, Avdd, Dvdd, Vdd, and Vss are generated mainly by the power circuit (power IC) 602. However, the embodiment is not limited to this.

FIG. 96(a) illustrates a structure in which the power circuit (power IC) 602 generates two voltages, Vdd and Vss, and the source driver IC 14 generate the other voltages (Dvdd, Avdd, VGL, VGH, etc.). ON/OFF control of Vdd and Vss is performed by the source driver IC 14 through S-Wire signal line.

FIG. 96(b) illustrates a structure in which the power circuit (power IC) 602 generates three voltages, Vdd, Vss, and Avdd, and the source driver IC 14 generates the other voltages (Dvdd, VGL, VGH, etc.). ON/OFF control of Vdd and Vss is performed by the source driver IC 14 through S-Wire signal line. Avdd is the analog voltage of the source driver IC 14. Avdd may be generated by the source driver IC 14, or may be generated by the external power circuit (power IC) 602 and supplied to the source driver IC 14, as illustrated in FIG. 96(b). Avdd is higher than Vdd by at least 0.2 V and at most 1.0 V. Further, Avdd is set so that it does not exceed the withstand voltage 5.5 V of the source driver IC 14. In this way, the amplitude range of the video signal voltage Vsig output by the source driver IC 14 can be increased, and a desirable image display can be performed.

FIG. 76 and FIG. 77 are explanatory diagrams representing a method of inspection and adjustment of the EL display device using the output open function of the power circuit of the present embodiment. The description of the embodiment below is based on the pixel configuration of FIG. 3. However, the invention is not limited to this, and any pixel configuration, such as the pixel configuration of a current driving scheme, and the pixel configuration of a voltage drive, can be used.

FIG. 76 represents a method of adjusting the luminance, white balance, and contrast of the EL display device. In FIG. 76, the output open function of the power circuit 602 is used to turn off the switch SW1. That is, the cathode voltage Vss is not output, and the output terminal has high impedance. A probe 764 probes pad P1 at the output terminal of the cathode voltage Vss. An ammeter 763 to measure current is disposed between the probe 764 and the external power supply Vsst. Note that cathode voltage Vsst for adjustment=cathode voltage Vss for image display.

When the drive transistor 11a of the pixel 16 is a P-channel transistor, the cathode electrode is turned off, and the current of a cathode wire 762 is measured. When the drive transistor 11a of the pixel 16 is an N-channel transistor, the anode electrode is turned off, and the current of the anode wire 761 is measured.

The source driver circuit 14 controls the gate driver circuit 12 to enable image display. The reference current Ic is of a usual size. The emission luminance of the display screen 31 varies in proportion to the magnitude of the reference current. When the magnitude of the reference current varies from 1 to 2, the luminance of the display screen 31 becomes twice as large. The power used by the display screen 31 also increases by a factor of 2.

In the EL display device, the cathode current Is of the display screen 31 flows into the cathode wire 762. The anode current of the display screen 31 flows into the anode wire 761.

In the structure of FIG. 76, the output terminal of the cathode voltage of the power circuit 602 is OFF, and because it is connected to the external cathode voltage Vsst, the current that flows in the cathode wire 762 flows into the external cathode voltage Vsst via the probe 764 and the ammeter 763. This enables the ammeter 763 to measure the current used in the display screen 31. The cathode current Is is measured because the current that flows in the cathode wire 762 is the current that flows in the display screen 31. The anode current Ip that flows in the anode wire 761 partially flows into the source driver circuit 14 and the output stage as a program current.

Note that Vddt and Vsst are voltages that are externally set, or generated by external generators, in an inspection or aging configuration. Vddt and Vsst serve to vary voltage values.

In the EL display device, the magnitude of cathode current Is is proportional to emission luminance. Thus, by measuring a cathode current, the emission luminance of the display screen 31 can be grasped. As described above, by adjusting the cathode current to be a predetermined current, the emission luminance of the display screen 31 can be adjusted.

Note that the current, such as the cathode current, that flows in the display screen may be measured by measuring the voltage across the terminals of a pickup resistor disposed on the wire through which the current flows. This is also applicable to the other current measurement methods described in this embodiment.

In the embodiment of FIG. 76, the cathode current that flows in the entire display screen 31 is measured. However, the embodiment is not limited to this. For example, the cathode current of pixels in part of the display screen 31, or in a predetermined area of the display screen 31 may be measured. The cathode current so measured can be used to estimate the cathode current that flows in the entire display screen 31. In a white raster display in which the whole screen has the same luminance, such a partial cathode current can be used to readily estimate the entire cathode current of the display screen 31.

Further, the display screen 31 may be divided into predetermined areas, and the cathode current may be measured in each area. In this way, the characteristic distribution of the display screen 31 can be measured. The display screen 31 can be divided in units of pixel columns or pixel rows, or in a matrix format.

The following describes the case where the pixel 16 employs a voltage program scheme. The magnitude of the cathode current is adjusted (display luminance adjustment) by setting a certain value for the gradation number (size of video signal) of the video signal applied to the display screen 31, and controlling an amplitude adjusting resistor of the source driver IC 14.

The power supply (circuit) IC 12 appropriately sets voltages such as Avdd, VGH, VGL, and Vrst. Further, the cathode voltage Vss terminal is turned off to enable the measurement of cathode voltage.

By controlling the amplitude adjusting resistor, the gradation amplifiers of the upper and lower voltages are varied. By increasing the gradation amplifier for which the upper voltage is set (brought closer to Vdd), the corresponding black levels of low gradations can be adjusted. By decreasing the gradation amplifier for which the lower voltage is set (brought closer to GND), the corresponding white levels of high gradations can be adjusted. In this embodiment, the output gradation is set as the maximum gradation, and the gradation amplifier of the lower voltage is varied. The gradation amplifier value of the lower voltage is adjusted so that the value of the cathode current takes a desired value.

The cathode current Is increases as the output voltage of the gradation amplifier for which the lower voltage is set is reduced, thereby increasing the emission luminance. That is, the magnitude of the cathode current is measured with the ammeter 763, and the adjustment is finished when the current takes a predetermined value. By performing this for RGB, the white balance can be adjusted.

Note that the voltages VGH, VGL, and Vdd output by the power circuit 602 are set as the voltages of normal display. Further, in this embodiment, the gate driver circuit 12a operates on VGH1 and VGL1, and the gate driver circuit 12b operates on VGH2, and VGL2=GND. VGH1=VGH2.

The white balance adjustment can be realized this way. Further, the emission luminance of the display screen 31 can also be adjusted. The contrast adjustment of the EL display device can be realized by adjusting the cathode current that flows in a black display.

The magnitude of cathode current Is (display luminance adjustment) is adjusted by setting the lowest gradation number for the current applied to the display screen 31, and controlling the amplitude adjusting resistor 101 described in FIG. 10. By controlling the amplitude adjusting resistor 101, a gradation amplifier 102H is varied. By increasing the output voltage of the gradation amplifier for which the upper voltage is set (brought closer to Vdd), the cathode current Is in a black level drops. By decreasing the output current of the gradation amplifier for which the upper voltage is set, the cathode current increases. The adjustment is finished when the cathode current Is takes a desired value.

The following describes the case where the pixel 16 employs a current program scheme. The magnitude of the cathode current Is is adjusted (display luminance adjustment) by setting a certain value for the gradation number of the video signal (size of video signal) applied to the display screen 31, and varying the magnitude of the reference current. The certain value set for the gradation number of the video signal (size of video signal) is generally the maximum gradation number. Increasing the magnitude of the reference current increases the cathode current Is, and accordingly emission luminance increases. Thus, the magnitude of the cathode current Is is measured with the ammeter 763, and the adjustment is finished when the current takes a predetermined value.

The white balance can be adjusted by performing this for RGB. The reference current after the white balance adjustment (luminance adjustment) is Ik. The reference current Ik is individually set for RGB (Ikr for red (R), Ikg for green (G), and Ikb for blue (B)).

The magnitude of cathode current Is is adjusted (display luminance adjustment) by setting a certain value for the gradation number of the video signal (size of video signal) applied to the display screen 31.

The magnitude of the reference current is adjusted while sustaining (maintaining) the values Ik (Ikr for red (R), Ikg for green (G), and Ikb for blue (B)) that have been obtained by the white balance adjustment.

The gradation number of the video signal (size of video signal) in a black level is the lowest gradation. In a current drive, the program current is 0 at the lowest gradation. The black level is adjusted by applying a voltage of the lowest gradation from the voltage generating circuit of the source driver IC 14 to the pixels 16. The voltage of the lowest gradation is obtained by varying the potential output by the gradation amplifier that generates the upper voltage. In this state, the magnitude of the cathode current is measured with the ammeter 763, and the adjustment is finished when the current takes a predetermined value.

The foregoing is applicable to the EL display panels or EL display devices of, for example, FIG. 1, FIG. 4, FIG. 5, FIG. 10, FIG. 11, FIG. 25, FIG. 29, FIG. 31, FIG. 33, FIG. 35, FIG. 37, FIG. 42, FIG. 46, FIG. 52, FIG. 54, FIG. 55, FIG. 58, FIG. 59, FIG. 86, FIG. 90, FIG. 91, FIG. 92, FIG. 93, FIG. 94, FIG. 95, FIG. 113, FIG. 123, and FIG. 124 through FIG. 128.

The same can be said for the other embodiments. For example, the pixel configurations exemplified above or described in this specification may be combined with the methods or schemes of, for example, FIG. 12, FIG. 13, FIG. 61, FIG. 75, FIG. 76, FIG. 77, FIG. 78, FIG. 79, FIG. 83, FIG. 84, FIG. 85, FIG. 98, FIG. 99, FIG. 100, and FIG. 101, or the configurations, structures, or methods of FIG. 7, FIG. 8, FIG. 9, FIG. 60, FIG. 83, FIG. 96, FIG. 102, FIG. 103, FIG. 104, FIG. 106, FIG. 107, FIG. 108, FIG. 109, FIG. 110, FIG. 111, FIG. 112, and FIG. 129.

### Fifth Embodiment

The following will describe the Fifth Embodiment of the present invention.

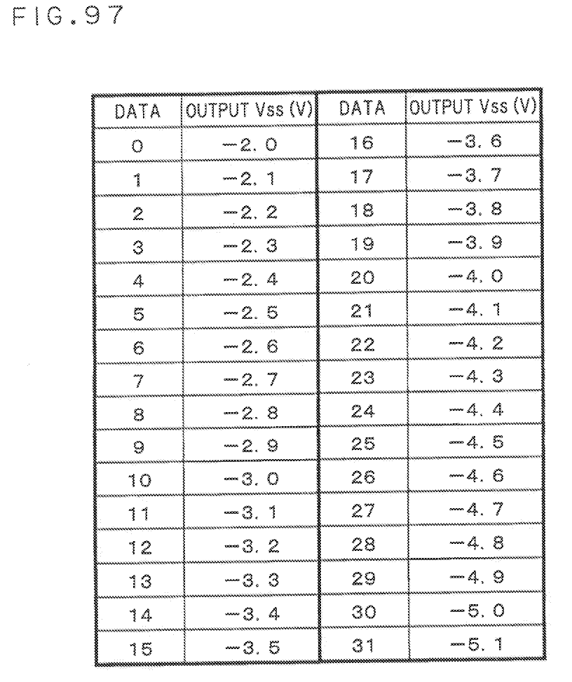

A power circuit (power IC) 602 of the present embodiment is adapted to vary the cathode voltage Vss by commands, as represented in FIG. 62 and FIG. 97. In FIG. 97, Vss is variable over the range of −2.0 V to −5.1 V with (command) data 0 to 31 (5 bits). The voltage is varied at no more than 0.1 V intervals. When the interval exceeds 0.1 V, luminance occurs on the display screen 31 upon varying the voltage.

The cathode voltage Vss is changed using the S-Wire signal, as described with reference to FIG. 96.

The cathode voltage Vss is changed in steps of no more than 0.1 V. FIG. 98 represents how this is done. FIG. 98A represents panel temperature (temperature in the display region of the panel, or more broadly, panel module temperature).

A temperature sensor 711 is installed in the source driver IC 14. In the source driver IC 14, the output voltage or the like of the temperature sensor 711 installed therein is analog-digital (DA) converted to obtain temperature data, and the temperature change data (see FIG. 97) is transmitted to the power circuit (power IC) 602 via the S-Wire signal line to change or vary the cathode voltage Vss or the like. The temperature sensor 711 may be installed in the power circuit (power IC) 602. Further, the temperature sensor 711 may be disposed anywhere on the panel module 34.

The temperature sensor 711 is not limited to one whose output is linear to the temperature The output may digitally vary in steps. Further, the output may vary with respect to a predetermined temperature. For example, the output value may be 0 (logic voltage) at temperatures of 0° C. and higher, and may vary to 1 (logic voltage) at temperatures below 0° C.

The cathode voltage Vss becomes smaller with decrease in panel temperature (0° C.). The anode voltage Vdd remains constant. Thus, the absolute values of the anode voltage Vdd and the cathode voltage Vss are increased as the panel temperature decreases. This is because the voltage across the terminals of the EL element 15 increases as the temperature of the EL element 15 decreases.

In the driving method of this embodiment, at temperatures of point a and higher in FIG. 98, the terminal voltage (anode-cathode voltage) is set to a voltage that is necessary for the emission of the EL element 15. There is almost no voltage margin. The voltage across the terminals of the EL element 15 increases as the panel temperature decreases. Because the terminal voltage has no voltage margin, the emission luminance of the EL element 15 drops unless some measure is taken. For this reason, the cathode voltage Vss is made smaller based on panel temperature.

In the embodiment of FIG. 98, the cathode voltage Vss is constant at temperatures of point a and higher, and at temperatures of point b and lower. The panel temperatures at point a and point b are stored in a memory such as the EEPROM 753 (FIG. 75) for use. The values of point a and point b are variable. FIG. 98 and FIG. 99 represent, as an example, how the cathode voltage Vss is varied, as indicated by solid line and dashed line. The anode voltage Vdd may be varied based on the output data (output value) of the temperature sensor 711.

In FIG. 98 and FIG. 99, the horizontal axis of the graph represents temperature. However, the temperature may be replaced with the output data (output value) of the photosensor 840. Voltages such as anode voltage Vdd, cathode voltage Vss, VGH, VGL, and Avdd are varied based on the output data (output value) of the photosensor 840.

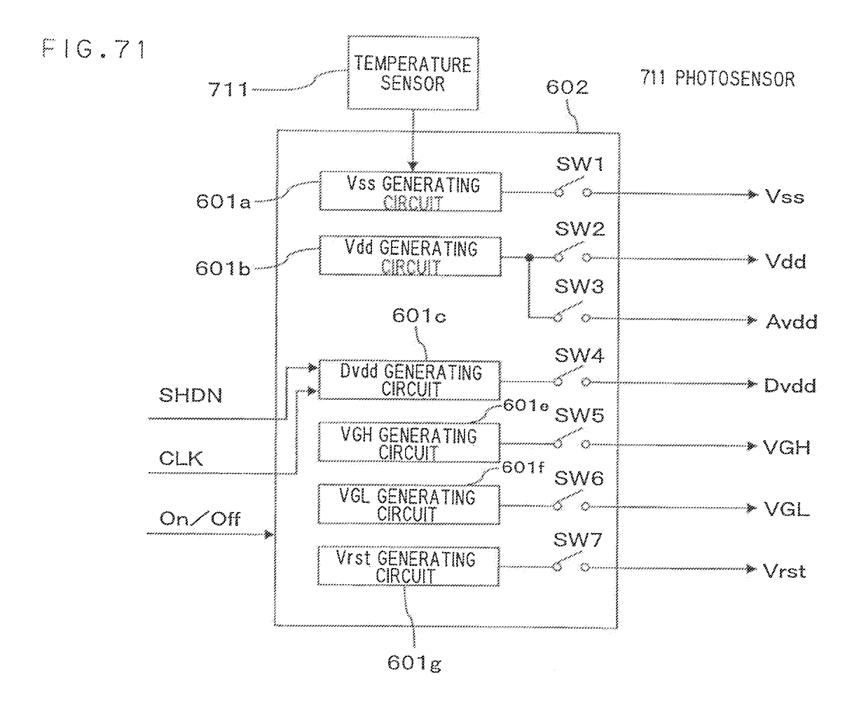

In the foregoing description of the embodiment, the temperature sensor 711 is installed in the source driver IC 14. However, the invention is not limited to this, and the temperature sensor 711 may be externally disposed or formed as, for example, a thermistor, for the power circuit (power IC) 602 (or the source driver IC 14) as illustrated in FIG. 71, and the cathode voltage Vss may be changed or varied based on temperature data obtained by the analog-digital (DA) conversion of the output voltage or the like of the temperature sensor 711.

Further, as illustrated in FIG. 83, the temperature sensor 711 may be installed in the panel module circuit 830, and the cathode voltage Vss may bus varied according to the output result of the temperature sensor 711. Further, the duty control or the maximum usable gradation control may be performed.

Further, in this embodiment, at least one of the cathode voltage Vss and the anode voltage Vdd is varied. However, the embodiment is not limited to this. As represented in FIG. 98 and FIG. 99, VGH and VGL may be varied according to changes in cathode voltage Vss or anode voltage Vdd. For example, when the cathode voltage Vss and the voltage VGL are −4 V and −4.5 V, respectively, VGL may be varied to −5.5 V when the cathode voltage Vss is varied to −5 V. It is preferable that VGH1, VGH2, VGL1, and VGL2 be independently varied.

The analog voltage Avdd of the source driver circuit 14 may be varied as well. For example, when the anode voltage Vdd and the voltage VGH are +5 V and +6.0 V, respectively, VGH may be varied to +6.5 V when the anode voltage Vdd is varied to +5.5 V.

The cathode voltage Vss is made smaller as the panel temperature decreases. Thus, lower panel temperatures increase the power of the panel module. Increased power means eliminating the capacitor margin of the power circuit (power IC) 602. This may lead to overheating of the panel.

To deal with this, in the present embodiment, a duty drive is performed according to (based on) the panel temperature, as represented in FIG. 98(b). Here, the duty drive will not be described because it was already described in FIG. 12, FIG. 13, FIG. 83, FIG. 84, and elsewhere.

In this embodiment, the duty ratio is 6/8 at panel temperatures of −20° C. and lower, as indicated by solid line in FIG. 98(b). The duty ratio is 8/8=1 at panel temperatures of 40° C. and higher, and as such, at −20° C., the current that flows in the display region 31 of the panel theoretically becomes 6/8. Thus, despite the reduced cathode voltage Vss at low temperatures, the concurrent duty drive prevents an increase of the current flow in the panel, and overheating of the panel does not occur. Further, the power supply of the power circuit (power IC) 602 only needs a capacity required for the panel temperatures of 40° C. and higher.

In this embodiment, the duty ratio is constant at 8/8 at temperatures of point c and higher, and 6/8 at or below point e, as indicated by solid line in FIG. 98(b). The panel temperatures and the duty ratios at point c and point e are stored in a memory such as the EEPROM 753 (FIG. 75) for use. The values of point c and point e are variable. Further, a duty drive as indicated by dashed line in FIG. 98(b) may be performed. In this case, the panel temperature and the duty ratio at point d are stored in a memory such as the EEPROM 753 (FIG. 75) for use. The value of point d is variable.

In the embodiment of FIG. 98, the current that flows into the display region 31 of the panel is controlled by varying the duty ratio with respect to temperature (0° C.). However, the embodiment is not limited to this. In FIG. 99(b), the current that flows in the panel is controlled according to the maximum usable gradation. The control by the maximum number of usable gradations is described in FIG. 84.

As described above, in this embodiment, the temperature sensor 711 is provided, and the duty drive (FIG. 84, FIG. 98) is performed based on the output result of the temperature sensor 711. Further, the drive that controls the maximum number of usable gradations (FIG. 84, FIG. 99) is also performed based on the output result of the temperature sensor 711. Further, the present embodiment, in which the temperature sensor 711 is provided, is a driving scheme in which the duty drive (FIG. 84, FIG. 98), and the drive that controls the maximum number of usable gradations (FIG. 84, FIG. 99) are performed simultaneously based on the output result of the temperature sensor 711.

In the embodiment indicated by solid line in FIG. 99(b), the maximum usable gradation (maximum display gradation) is 1024 at the panel temperatures of 40° C. and higher. That is, an image is displayed over the full range of 10 bits. Here, the current that flows in the display region 31 is not suppressed. The maximum usable gradation (maximum display gradation) is 768 at the panel temperatures of −20° C. and below. It is therefore possible to achieve a nearly ½ reduction in the current that flows in the display region 31, provided that the gamma curve has the characteristic with a gamma of 2. Thus, despite the reduced cathode voltage Vss at low temperatures, the concurrent control (drive) of the maximum usable gradation (maximum display gradation) prevents an increase of the current flow in the panel, and overheating of the panel does not occur. Further, the power supply of the power circuit (power IC) 602 only needs a capacity required for the panel temperatures of 40° C. and higher.

In the embodiment indicated by solid line in FIG. 99(b), the maximum usable gradation (maximum display gradation) is constant at 1024 at the temperatures of point c and higher, and 768 at or below point e. The panel temperature and the maximum usable gradation (maximum display gradation) at point c and point e are stored in a memory such as the EEPROM 753 (FIG. 75) for use. The values of point c and point e are variable. Further, the control of maximum usable gradation (maximum display gradation) as indicated by dashed line in FIG. 99(b) may be performed as well. As above, the panel temperature and the maximum usable gradation (maximum display gradation) at point d are stored in a memory such as the EEPROM 753 (FIG. 75) for use. The value of point d is variable.

In the foregoing description of the embodiment, the temperature sensor 711 is installed in the source driver IC 14. However, the invention is not limited to this, and the temperature sensor 711 may be externally disposed or formed as, for example, a thermistor, for the power circuit (power IC) 602 (or the source driver IC 14) as illustrated in FIG. 71, and the cathode voltage Vss or the like may be changed or varied based on temperature data obtained by the analog-digital (DA) conversion of the output voltage or the like of the temperature sensor 711. Further, as illustrated in FIG. 83, the temperature sensor 711 may be installed in the panel module circuit 830, and the cathode voltage Vss may be varied according to the output result of the temperature sensor 711. Further, the duty control, and the maximum usable gradation control may be performed (FIG. 98, FIG. 99).

Further, the output result of the temperature sensor 711 may be linked to the brightness control of the screen (FIG. 100, FIG. 101). For example, when the temperature is −20° C. or less, and the power consumption of the panel is large, the duty ratio is reduced from the level specified in FIG. 98 (for example, from 6/8 to 5/8) in a low illuminance environment (when the output of the photosensor 840 is small). It is also possible, for example, to reduce the maximum displayable (usable) gradation specified in FIG. 99 (for example, from 768 to 650).

The foregoing is also applicable to the EL display panels and the EL display devices described in, for example, FIG. 1, FIG. 4, FIG. 5, FIG. 10, FIG. 11, FIG. 25, FIG. 29, FIG. 31, FIG. 33, FIG. 35, FIG. 37, FIG. 42, FIG. 46, FIG. 52, FIG. 54, FIG. 55, FIG. 58, FIG. 59, FIG. 86, FIG. 90, FIG. 91, FIG. 92, FIG. 93, FIG. 94, FIG. 95, FIG. 113, FIG. 123, and FIG. 124 through FIG. 128.

The same can be said for the other embodiments. For example, the pixel configurations exemplified above or described in this specification may be combined with the methods or schemes of, for example, FIG. 12, FIG. 13, FIG. 61, FIG. 75, FIG. 76, FIG. 77, FIG. 78, FIG. 79, FIG. 83, FIG. 84, FIG. 85, FIG. 98, FIG. 99, FIG. 100, and FIG. 101, or the configurations, structures, or methods of FIG. 7, FIG. 8, FIG. 9, FIG. 60, FIG. 83, FIG. 96, FIG. 102, FIG. 103, FIG. 104, FIG. 106, FIG. 107, FIG. 108, FIG. 109, FIG. 110, FIG. 111, FIG. 112, and FIG. 129.

### Sixth Embodiment

The following will describe the Sixth Embodiment of the present invention.

FIG. 130 represents an embodiment in which the anode voltage Vdd and the cathode voltage Vss are varied based in the output result of the photosensor 711. The luminance of the display screen 31 is reduced when the output value (output data) of the photosensor 711 is small (10 Lx or less). Thus, the maximum current flown to the EL element 15 can be reduced. This makes it possible to lower the anode voltage Vdd and the cathode voltage Vss, or the potential difference between the anode voltage Vdd and the cathode voltage Vss.

On the other hand, when the output value (output data) of the photosensor 711 is large (5,000 Lx or more), the luminance of the display screen 31 is increased. Because this increases the maximum current flown to the EL element 15, the voltage across the terminals of the EL element 15 also increases. This makes it possible to increase the anode voltage Vdd and the cathode voltage Vss, or the potential difference between the anode voltage Vdd and the cathode voltage Vss.

In the embodiment of FIG. 130, the control is performed with respect to the maximum number of display gradations. However, the control may be performed with respect to the duty drive as in FIG. 98. Further, the embodiments of FIG. 98 and FIG. 99 may be combined with the control that is based on the output result of the photosensor 711.

The reaction time constant of the photosensor 711 is preferably 1 second or more.

As described above, in the present embodiment, the photosensor 840 is provided, and the duty drive (FIG. 84, FIG. 98) is performed based on the output result of the photosensor 840. The drive (FIG. 84, FIG. 99) that controls the maximum number of (usable) displayable gradations is also performed based on the output result of the photosensor 840. Further, the present embodiment, in which the photosensor 840 is provided, is a driving scheme in which the duty drive (FIG. 84, FIG. 98), and the drive that controls the maximum number of usable gradations (FIG. 84, FIG. 99) are simultaneously performed based on the output result of the photosensor 840. The cathode voltage control (FIG. 97) may be performed at the same time.

In the embodiment of FIG. 98, the cathode voltage Vss is varied according to (based on) the panel temperature. However, the embodiment is not limited to this. The cathode voltage Vss is varied only when the drive transistor 11a is a P-channel transistor. When the drive transistor 11a is an N-channel transistor, the anode voltage needs to be varied. That is, in the present embodiment, at least one of the anode voltage Vdd and the cathode voltage Vss is varied according to the panel temperature. Further, the potential difference between the anode voltage Vdd and the cathode voltage Vss is varied (adjusted or set) according to temperature.

In a driving method of this embodiment, the voltage between the terminals of the EL element 15 increases as the panel temperature decreases, and because there is no voltage margin in the voltage between the terminals of the EL element 15, the emission luminance of the EL element 15 drops. To avoid this, the cathode voltage Vss is made smaller according to the panel temperature. However, lowering the cathode voltage Vss increases the potential difference between the anode voltage Vdd and the cathode voltage Vss, while the cathode current remains the same. This increases power. It is therefore possible to employ a scheme in which the cathode voltage Vss is increased (the potential difference between the anode voltage Vdd and the cathode voltage Vss is made smaller) with a decrease in panel temperature so as to lower the cathode current and thereby suppress a power increase in the EL display device. As described above, in the driving scheme of the present embodiment, the power of the EL display device (the power used in the display region 31) is controlled according to the panel temperature.

In the foregoing description of the embodiment, the voltage between the terminals of the EL element 15 is described to increase with decrease in panel temperature (temperature of the EL element 15). However, in a configuration in which the voltage between the terminals of the EL element 15 decreases with decrease in panel temperature (temperature of the EL element 15), the control of the embodiment above is reversed. As described above, in the driving scheme of this embodiment, the power of the EL display device (the power used in the display region 31) is controlled according to the panel temperature.

The foregoing is applicable not only to the EL display panel and EL display device having the pixel configuration of FIG. 1, but to the EL display panels and EL display devices having other pixel configurations (for example, FIG. 4, FIG. 5, FIG. 10, FIG. 11, FIG. 25, FIG. 29, FIG. 31, FIG. 33, FIG. 35, FIG. 37, FIG. 42, FIG. 46, FIG. 52, FIG. 54, FIG. 55, FIG. 58, FIG. 59, FIG. 86, FIG. 90, FIG. 91, FIG. 92, FIG. 93, FIG. 94, FIG. 95, FIG. 113, FIG. 123, and FIG. 124 through FIG. 128).

The same can be said for the other embodiments. For example, the pixel configurations exemplified above or described in this specification may be combined with the methods or schemes of, for example, FIG. 12, FIG. 13, FIG. 61, FIG. 75, FIG. 76, FIG. 77, FIG. 78, FIG. 79, FIG. 83, FIG. 84, FIG. 85, FIG. 98, FIG. 99, FIG. 100, and FIG. 101, or the configurations, structures, or methods of FIG. 7, FIG. 8, FIG. 9, FIG. 60, FIG. 83, FIG. 96, FIG. 102, FIG. 103, FIG. 104, FIG. 106, FIG. 107, FIG. 108, FIG. 109, FIG. 110, FIG. 111, FIG. 112, and FIG. 129.

Further, the foregoing embodiment is also applicable to the other driving schemes and the configurations described in this specification. Further, the foregoing is applicable to apparatuses using an EL display device or an EL display panel (for example, FIG. 7, FIG. 8, FIG. 9).

The EL display device of the present embodiment includes the photosensor 840 that obtains the intensity of external light, as illustrated in FIG. 83. The brightness of the display screen 31 is varied according to the external light (generally, the intensity of light falling on the display region 31, or the light incident on the display region 31), based on the output of the photosensor 840. The panel brightness represented in FIG. 100 corresponds to the maximum luminance in the display region 31 of the panel. It also corresponds to the quantity of light flux radiating out of the display region 31 of the panel.

In the graph of FIG. 100, the horizontal axis represents the result of the analog-digital conversion (AD conversion) performed after the current-voltage conversion of the output current of the photosensor 840.

As represented in FIG. 100, the brightness of the panel is at B1 when the AD conversion value is smaller than L1. The brightness of the panel is at B2 when the AD conversion value is smaller than L2. The brightness of the panel is at B3 when the AD conversion value is smaller than L3. The brightness of the panel is at B4 when the AD conversion value is smaller than L4. The brightness of the panel is at B5 when the AD conversion value is larger than L4. The number and the values of L1 to L4, and the number and the values of B1 to B5 are stored in a memory such as the EEPROM 753 (FIG. 75) for use.

External light often varies abruptly. It is therefore required to ensure that the panel brightness does not follow such abrupt changes.

To deal with this, as represented in FIG. 101, the illuminance of external light (intensity of external light) is averaged (indicated by solid line), and the average result is used to take moving averages (indicated by dashed line). In the embodiment of FIG. 101, two average results are used to take the moving average. The number of data averages used to take the moving average may be 2, 3, 6, or any other number, and accordingly the number of moving averages is variable. The moving averages so obtained are used to decide the brightness of the panel.

Note that, as illustrated in FIG. 83, the duty drive, the maximum usable gradation control, the reference current control, and the cathode (anode) voltage control are performed based on the output of the photosensor 840. That is, the control of FIG. 100 and FIG. 101 is performed in combination with the control of, for example, FIG. 83, FIG. 84, FIG. 98, and FIG. 99.

As illustrated in FIG. 73, the photosensor 840 may act on the power circuit (power IC) 602 to vary the output voltage (anode voltage, cathode voltage) of the power circuit (power IC) 602 (FIG. 97). Further, as illustrated in FIG. 96, the output of the photosensor 840 may be fetched by the source driver IC 14, and the output current (voltage) of the photosensor 840 may be AD converted by the source driver IC 14. Based on the result of AD conversion, the source driver IC 14 performs the duty drive, the maximum usable gradation control, the reference current control, the gamma curve control, and the cathode voltage (anode voltage) control (FIG. 12, FIG. 13, FIG. 62, FIG. 84, FIG. 97, FIG. 98, FIG. 99, FIG. 100, FIG. 101).

The embodiment above is applicable to the other driving schemes and configurations described in this specification. Further, the foregoing is applicable to apparatuses using an EL display device or an EL display panel (for example, FIG. 7, FIG. 8, FIG. 9).

It is also effective to change the gamma curve based on the output result of the photosensor 840. In the EL display panel in particular, the low gradation portion is not viewable under daylight, while the display image is desirable indoors. This is because the EL display panel is self-emitting. As a countermeasure, the gamma curve may be changed according to the intensity of external light. The gamma curve may be switched by a user operating a switch. To change the gamma curve, smaller gammas are used under strong external light to make the entire screen brighter.

Here, the gamma curve is described as being switched according to the intensity of external light. However, the invention is not limited to this. The gamma curve may be changed using the functions (such as addition and weighting) of the arithmetic circuit of FIG. 83.

It is preferable that the panel brightness be switched by a user using a button, or automatically switched in a setting mode or by detecting the brightness: of external light. It is also preferable that the display luminance be settable (for example, 50%, 60%, or 80%) by a user. Further, it is preferable to rewrite the duty ratio curve or the slope using an external microcomputer. It is also preferable to select one of the duty ratio curves stored in the memory (see FIG. 84 and FIG. 98, and the description relating to these figures).

Preferably, the duty ratio curve or the like is selected taking in account one or more of the following: APL level, maximum luminance (MAX), minimum luminance (MIN), and the distribution state (SGM) of luminance (see FIG. 82, FIG. 83, and FIG. 84, and the description relating to these figures).

In the display panel (display device) of this embodiment, the brightness is adjusted by the duty ratio control, the reference current ratio control, the maximum usable gradation control, or the like. Further, the brightness may be automatically adjusted by detecting the intensity of external light with the photosensor. The foregoing is also applicable to the contrast adjustment, the duty ratio control, and the maximum display gradation driving scheme described in FIG. 99.

The foregoing is applicable not only to the EL display panel and EL display device having the pixel configuration of FIG. 1, but to the EL display panels and EL display devices having other pixel configurations (for example, FIG. 4, FIG. 5, FIG. 10, FIG. 11, FIG. 25, FIG. 29, FIG. 31, FIG. 33, FIG. 35, FIG. 37, FIG. 42, FIG. 46, FIG. 52, FIG. 54, FIG. 55, FIG. 58, FIG. 59, FIG. 86, FIG. 90, FIG. 91, FIG. 92, FIG. 93, FIG. 94, FIG. 95, FIG. 113, FIG. 123, and FIG. 124 through FIG. 128).

The same can be said for the other embodiments. For example, the pixel configurations exemplified above or described in this specification may be combined with the methods or schemes of, for example, FIG. 12, FIG. 13, FIG. 61, FIG. 75, FIG. 76, FIG. 77, FIG. 78, FIG. 79, FIG. 83, FIG. 84, FIG. 85, FIG. 98, FIG. 99, FIG. 100, and FIG. 101, or the configurations, structures, or methods of FIG. 7, FIG. 8, FIG. 9, FIG. 60, FIG. 83, FIG. 96, FIG. 102, FIG. 103, FIG. 104, FIG. 106, FIG. 107, FIG. 108, FIG. 109, FIG. 110, FIG. 111, FIG. 112, and FIG. 129.

Further, the embodiment above is also applicable to the other driving schemes and configurations described in this specification. Further, the foregoing is also applicable to apparatuses using an EL display device or an EL display panel (for example, FIG. 7, FIG. 8, FIG. 9).

### Seventh Embodiment

The following will describe the Seventh Embodiment of the present invention.

First, a display apparatus (EL display device) of the Seventh Embodiment is described in which an EL display device employing a driving scheme of this embodiment is used as a display.

FIG. 7 is a plan view of a cellular phone as an information terminal device provided as an example of the EL display device. A housing 73 includes an antenna 71 and other components. The figure also illustrates a switch key 72a used to vary the brightness of the display screen, a power ON/OFF key 72b, a key 72c used to switch the operation frame rate of the gate driver circuit 12b, and a photosensor 75. The photosensor 75 is provided for the automatic luminance adjustment of a display screen 22, which is performed by varying the duty ratio or other variables according to the intensity of external light.

FIG. 8 is a perspective view of a video camera. The video camera includes a camera (image capturing) lens unit 83, and a video camera main body 73. The EL display panel of this embodiment is used as a display monitor 74. The display screen 22 is freely adjustable so that it can rotate with an angle on a fulcrum 81. When not used, the display screen 22 is stored in a storage 83.

The EL display panel or EL display device of the present embodiment is applicable not only to the video camera but to the electronic camera as illustrated in FIG. 9. The EL display device of the present embodiment is used as a monitor 22 attached to a camera main body 91. The camera main body 91 includes a shutter 93, and switches 72a and 72c.

### Modification Example

The following will describe a modification example of the present invention.

The technical ideas of the embodiments described in this specification can be combined with one another. For example, the embodiment forming the capacitor 19b of FIG. 1 may be combined with the embodiment forming the multiple source signal lines of FIG. 16. Further, the embodiment forming the capacitor 19b of FIG. 1 may be combined with the embodiment using the current supply 312 of FIG. 31.

Further, the embodiment forming the capacitor 19b of FIG. 1 may be combined with the embodiment forming the capacitor 19b of FIG. 32. Further, the embodiment with the pixel configuration having the capacitor 19b of FIG. 1 may be combined with the driving method of FIG. 45 and FIG. 48.

Further, the configurations of FIG. 31 and FIG. 42 or FIG. 45 may be combined. Further, the configuration or scheme described in FIG. 5 in which the reset voltage Vrst is written into the pixels of the preceding stage (the immediately preceding pixel row) when a gate signal line 17a through which a video voltage is written to this row is selected is also applicable to the other embodiments of the present invention.

In addition to the combinations of two technical ideas, three or more technical ideas may be combined. For example, FIG. 5, FIG. 4, and FIG. 55 may be combined. Further, FIG. 5, FIG. 42, and FIG. 13 may be combined. In this manner, the embodiments described in this specification can be combined to provide another embodiment in the present invention.

Further, in addition to the pixel configurations and driving methods, the driver configuration or other configurations of FIG. 6 or FIG. 3 can be appropriately combined with the other configurations or driving methods. Further, in addition to the pixel configurations and driving methods, the driving method of FIG. 12 or FIG. 13 can be appropriately combined with the other configurations or driving methods.

The foregoing is applicable not only to the EL display panel and EL display device having the pixel configuration of FIG. 1, but to the EL display panels and EL display devices having other pixel configurations for example, FIG. 4, FIG. 5, FIG. 10, FIG. 11, FIG. 25, FIG. 29, FIG. 31, FIG. 33, FIG. 35, FIG. 37, FIG. 42, FIG. 46, FIG. 52, FIG. 54, FIG. 55, FIG. 58, FIG. 59, FIG. 86, FIG. 90, FIG. 91, FIG. 92, FIG. 93, FIG. 94, FIG. 95, FIG. 113, FIG. 123, FIG. 124, FIG. 125, FIG. 126, FIG. 127, and FIG. 128).

The same can be said for the other embodiments. For example, the pixel configurations exemplified above or described in this specification nay be combined with the methods or schemes of, for example, FIG. 12, FIG. 13, FIG. 14 through FIG. 41, FIG. 61, FIG. 75, FIG. 76, FIG. 77, FIG. 78, FIG. 79, FIG. 83, FIG. 84, FIG. 85, FIG. 98, FIG. 99, FIG. 100, and FIG. 101, or the configurations, structures, or methods of FIG. 7, FIG. 8, FIG. 9, FIG. 60, FIG. 83, FIG. 96, FIG. 99, FIG. 100, FIG. 101, FIG. 102, FIG. 103, FIG. 104, FIG. 106, FIG. 107, FIG. 108, FIG. 109, FIG. 110, FIG. 111, FIG. 112, and FIG. 129.

Note that the combinations of the foregoing configuration and the driving method, and the combinations of the foregoing configurations and the driving methods applied to, for example, FIG. 7, FIG. 8, FIG. 9 also fall within the scope of the present invention.

### INDUSTRIAL APPLICABILITY

An EL display device according to the present invention can provide a sufficient offset cancel period, and therefore can realize a desirable offset cancel. It is therefore possible to cancel characteristic variations which may occur in drive transistors 11a. As a result, a desirable image display is realized.

What is claimed is:

1. An EL display device including a display screen in which a plurality of pixels each having an EL element is disposed in a matrix,
the EL display device comprising:
a source driver circuit to output a video signal voltage;
a gate driver circuit to select a pixel in the display screen;
a first capacitor to maintain the video signal voltage; and
a drive transistor to supply current to the EL element of the pixel,
the video signal voltage being applied to the drive transistor to perform a predetermined operation, and being written into the first capacitor, and
the video signal voltage maintained in the first capacitor being used to perform an offset cancel operation.

2. An EL display device including a display screen in which a plurality of pixels each having an EL element is disposed in a matrix,
the EL display device comprising:
a source driver circuit to output a video signal voltage;
a gate driver circuit to select a pixel in the display screen;
a first capacitor to maintain an operational signal voltage; and
a drive transistor to supply current to the EL element of the pixel,
the operational signal voltage being applied to the pixel via the drive transistor to perform a predetermined operation, and being written into the first capacitor, and
the operational signal voltage written into the first capacitor being used to continue the predetermined operation, after stopping the application of the operational signal voltage.

3. The EL display device according to claim 1 or 2, further comprising a first switch transistor that applies a reset voltage to each of the pixels, wherein the first switch transistor is of a multigate structure.

4. The EL display device according to claim 1 or 2, further comprising a second switch transistor in a current path leading to the EL element,
wherein the second switch transistor is ON/OFF controlled to create a band-like non-display region on the display screen, and
wherein the non-display region displaces the display screen in a frame cycle.

5. The EL display device according to claim 1 or 2, further comprising:
a third switch transistor that applies the video signal voltage to each of the pixels; and
a second capacitor formed between a gate terminal and a drain terminal of the third switch transistor.

6. The EL display device according to claim 1 or 2, further comprising a level shift circuit in the gate driver circuit, or on an input stage of the gate driver circuit,
wherein the level shift circuit level shifts an output signal of the source driver circuit: before the output signal is input to the gate driver circuit.

7. The EL display device according to claim 1 or 2, wherein the gate driver circuit is formed of a P-channel transistor or an N-channel transistor.

8. The EL display device according to claim 1 or 2,
wherein the source driver circuit is a semiconductor IC,
wherein the source driver circuit is mounted on a substrate on which the display screen is formed, and
wherein a light shielding film is formed between the source driver circuit and the substrate.

9. The EL display device according to claim 1 or 2, further comprising a first source signal line and a second source signal line, the first and second source signal lines being formed for the pixels disposed in a column of the matrix,
wherein the pixels to which a first video signal voltage is applied through the first source signal line are different from the pixels to which a second video signal voltage is applied through the second source signal line.

10. The EL display device according to claim 1 or 2, further comprising a temperature sensor, and a voltage generating circuit that generates a voltage applied to the EL element,
wherein the voltage generating circuit varies the voltage based on an output of the temperature sensor.

11. The EL display device according to claim 1 or 2, further comprising a temperature sensor,
wherein a maximum display gradation used in the display screen is varied based on an output of the temperature sensor.

12. The EL display device according to claim 10 or 11, wherein the temperature sensor is installed in the source driver circuit.

13. The EL display device according to claim 1 or 2, wherein the source driver circuit includes a plurality of select switch circuits that selects a source signal line.

14. The EL display device according to claim 1 or 2, further comprising a photosensor that detects brightness of external light,
wherein brightness of the display screen is varied based on an output of the photosensor.

15. The EL display device according to claim 1 or 2, further comprising a circuit that generates a reset voltage applied to the pixels,
wherein the reset voltage is varied based on the video signal voltage.

16. The EL display device ac-cording to claim 1 or 2, wherein the pixels are of multiple colors, and wherein a pixel electrode of each pixel has a different area depending of the color.

17. The EL display device according to claim 2, wherein the operational signal voltage is the video signal voltage, and wherein the predetermined operation is an offset cancel operation.

18. The EL display device according to claim 2, wherein the operational signal voltage is a reset signal voltage, and wherein the predetermined operation is a reset operation.
